(19) United States
(12) Patent Application Publication
(10) Pub. No.: US 2025/0379933 A1
(43) Pub. Date: Dec. 11, 2025

(54) Live chat client application for connecting with available agents of any website and application

(71) Applicant: Yogesh Rathod, Mumbai (IN)

(72) Inventor: Yogesh Rathod, Mumbai (IN)

(21) Appl. No.: 17/917,258

(22) PCT Filed: Feb. 10, 2021
(86) PCT No.: PCT/IB2021/051053

§ 371 Date: Oct. 9, 2024

(30) Foreign Application Priority Data
Apr. 9, 2020 (WO) PCT/IB2020/053394
Dec. 4, 2020 (WO) PCT/IB2020/061492

(51) Int. Cl. H04M 1/72436; H04L 51/04; H04M 1/72469; H04M 3/51; H04M 3/523

(52) U.S. Cl. CPC H04M 1/72436; H04L 51/04; H04M 1/72469; H04M 3/5191; H04M 3/523

(57) ABSTRACT

The method and systems for automatically identified currently viewing website domain name or a uniform resource locator (URL), receiving, by the server, said automatically identified website domain name or the uniform resource locator (URL), a request or an invitation for initiating a communication including live chat, puts the request for initiating a communication including live chat from the first user and the second user in a communication including live chat queue of the website or the uniform resource locator (URL) associated account, for available or identified or relevant agents to pick up, routing request or invitation for initiating a communication including live chat from the first user and the second user according to a pre-set rules and start a communication including live chat by available agent by selecting particular request for initiating a communication including live chat from the queued communication including live chats.

### FIELD OF INVENTION

The present invention relates generally to different types of text call services including Call For Instant Messaging (CIM) Service wherein user or caller or requester/requestor or inviter can make call or send request or provide indication in one or more form with intention to real-time communication with callee or invitee or requestee and enable to add incoming calls and make call to add call accepted uses to selected call, Call For Sending Message/SMS (CMS) Service wherein user can make call and in the event of acceptance of call, display message send by said caller to said callee and Call For Posting & Getting Reactions (CPR) Service, wherein make call and in the event of acceptance of call, display message or one or more types of contents and enable caller and callee to exchange messages or comments or enable receiving user(s) of said contents to provide one or more types of real-time or near real-time reactions including like, dislike, select or provide emoticons or stickers, share, reply, comments, and rank. In another embodiment present invention also discloses text call trigger(s), formation, orchestration, program, and activities, location or place, triggers and rules based text calls, wherein triggering of events based on logged or detection of activities, actions, events, transactions, status, location or location associated identified place, one or more types of data related to or associated with user and connected users of user and one or more identified rules. In other embodiments present invention teaches centralized live chat application for enabling users to get live chat support from websites, places of business. The present invention also relates to different types of centralized live communication including live chat applications for users for enabling users to connect with available agent or contact(s). In other embodiments present invention discloses different communication medium for caller and callee or communication participants during particular communication or communication session.

### BACKGROUND OF THE INVENTION

At present by using voice call, the user can make voice calls and in the event of acceptance of a call can talk with the called user. Users can also make video calls and converse visually with called users.

Present invention enables user to select one or more contacts or one or more types of one or more unique identities and make text call by providing one or more types of one or more text call indications in one or more forms including displaying incoming call user interface, ringing called user's device, sending and displaying one or more types of notification including push notification or in-application notification or in-browser notification and in the event of tap or click on notification or “accept” button of incoming text call user interface, displaying to calling and/or callee one or more types of applications, user interfaces, media and media and any combination thereof like chat interface or instant messaging interface or short message service (SMS) application or user interface or feed or newsfeed or post viewing user interface which enables calling user and/or called user to send and receive messages or one or more types of contents including text, photos, videos, uniform resource location (URL) or links, location information, emoticons, stickers, files, voice files and like, provide one or more types of reactions including like, dislike, comments, ratings, provide emoticons. In another embodiment enables user to select one or more contacts or one or more types of one or more unique identities and make text call by providing one or more types of one or more text call indications in one or more forms including based on user pre-set or provided settings, automatically turn on user device and automatically open application and automatically display one or more types of one or more user interfaces including chat user interface or instant messaging user interface or short message service user interface or application to calling user or inviter and/or called user or callee or invitee.

Extensible Messaging and Presence Protocol (XMPP) is a communication protocol for message-oriented middleware based on XML (Extensible Markup Language). It enables the near-real-time exchange of structured yet extensible data between any two or more network entities. It used for near real-time instant messaging (IM), presence information, and contact list maintenance. Designed to be extensible, the protocol has been used also for publish-subscribe systems, signaling for VoIP, video, file transfer, gaming, the Internet of Things (IoT) applications such as the smart grid, and social networking services.

The Session Initiation Protocol (SIP) is a signaling protocol used for initiating, maintaining, and terminating real-time sessions that include voice, video and messaging applications. SIP is used for signaling and controlling multimedia communication sessions in applications of Internet telephony for voice and video calls, in private IP telephone systems, in instant messaging over Internet Protocol (IP) networks as well as mobile phone calling over LTE (VoLTE). SIP is only involved in the signaling operations of a media communication session and is primarily used to set up and terminate voice or video calls. SIP can be used to establish two-party (unicast) or multiparty (multicast) sessions. It also allows modification of existing calls. The modification can involve changing addresses or ports, inviting more participants, and adding or deleting media streams. SIP has also found applications in messaging applications, such as instant messaging, and event subscription and notification. Voice and video media streams are typically carried between the terminals using the Real-time Transport Protocol (RTP) or Secure Real-time Transport Protocol (SRTP).

Present invention enables initiating or starting or establishing real-time session or communication session based on one or more types of indications in one or more forms provided by invitee or callee or requestee or called user including human mediated actions including tapping or clicking on “accept” button or provided or identified by invitee or callee or requestee or called user's device, sensors, triggering of one or more types of triggers, detection of pre-defined voice commands, recognition of pre-defined face(s) and expressions or pre-defined object(s) including logo, design or brand name or product, identification of pre-defined one or more types or combination of senses of sensors of called user's device, identification of biometric fingerprints of invitee or callee or requestee or called user, identification of haptic contact engagement at particular pre-defined area of screen of user device, expiration of pre-set duration of timer, identification of pre-defined geofence or place or location, identification of type of or named activity, action, status, event, transaction, communication, sharing, updates, tag(s), keyword(s), one or more types of fields and associated value(s) or range of values and identification of rule(s). In another embodiment present invention enables ending or terminating or cancelling of real-time session or communication session based on one or more types of indications in one or more forms provided by calling and/or called user (i.e. inviter and/or invitee or caller and/or callee or requestor and/or requestee user) including human mediated actions including tapping or clicking on “end” button or provided or identified by calling and/or called user's device(s), sensors, triggering of one or more types of triggers, detection of pre-defined voice commands, recognition of pre-defined face(s) and expressions or pre-defined object(s), identification of pre-defined one or more types or combination of senses of sensors of calling and/or called user device, identification of biometric fingerprints of calling and/or called user, identification of haptic contact engagement at particular pre-defined area of screen of user device, expiration of pre-set duration of timer or schedule, identification of type of or named activity, action, status, event, transaction, communication, sharing, updates, tag(s), keyword(s), one or more types of fields and associated value(s) or range of values and identification of rule(s).

Instant messenger is instant transmission of message and not instant viewing and conversing & replying. So like Voice Call and Video Call now by using present invention user can make text call for real-time conducting messaging and conversation in the form of text, location information, uniform resource locator (URLs), and photos, videos, audio, voice, images, emoticons and stickers files and other files sharing, publishing, collaboration, and take actions. In the event of tapping or clicking on contact or unique identity or selecting one or more contacts and/or unique identities to start text call(s), each called person's phone will ring. Once it has accepted the call, a chat window opens and the chat conversation begins and connection remains up-to end of call by calling or called user. Present invention introduces and enables real-time instant messaging (RIM) server, client applications, platform and services which enables the user to real-time view and respond to received messages. Server monitors, tracks, logs and stores real-time responses on sent messages of each contact of each user including average duration within which user gets response message on sent message from each contact.

In voice call, only voice is not enough all times, voice lacks privacy and voice is not always suitable. Instant Messaging is instant transmission of message. In the current scenario due to lots of push notifications, SMS and WhatsApp messages, there is no guarantee of real-time conversation and instant viewing or replying of messages. Video call is data hogs, lacks privacy and not always suitable. If voice and video call are available then why not text call for real-time making of call and starting of messaging including text conversation and sharing of files.

In voice call, only voice communication happened and no other functionalities possible including view and search conversations, attend multiple voice calls at a time, use templates, user actions or requirement or call or call type specific call-to-actions and sharing media, voice quality matters where user is in crowded place, poor phone signals quality. Anybody surrounding the person can hear call conversations hence it's not private. Voices disturb others during meetings, inside the class room, and while in the movie theatre. At present, due to lots of SMS, push notifications, Instant Messages including WhatsApp™ messages, there is no guarantee of real-time viewing and replying of messages. Whereas in Text Call including Call for Instant Messaging (CIM) text call type, like caller can real-time communicate via voice call, video call and now user can communicate with called user(s) via text call between start and end call session. Users can make ephemeral messaging or save call conversations at local storage of device and/or cloud storage and can search conversations including search name, date and time and call wise conversations. Due to text calls, users can use readymade and contextual templates and contents, and user actions. In text call users can get enough time to think and respond, pause and restart communication. Further in text call users can attend multiple calls, make group calls (any numbers), add incoming calls to current call and make calls and add one or more contacts to current call, view and read current conversations when required and due to text, caller can conduct clear communication with callee.

Call for Instant Messaging (CIM) is a combination of instant messaging and phone call wherein a user can instant connect like a phone call, but communicate like chat or instant messenger. So, no voice and no waiting which satisfy the user's real-time chat needs. Like voice call, video call, instant messaging, and short message service (SMS), now users can use a new type of communication application and service.

Advantages of Text Call over Voice and Video Call and instant messaging are, (a) When voice call is not possible: When the user is in a meeting, inside movie theatre, event, hospital, school or college class room, at night and real-time call require then user can make text call and conduct real-time conversation. Instead of making voice phone or VOIP calls, users can make text calls. In voice calls people need to leave the place and find a quiet place to talk with others. Instant messenger means instant transmission of messages. It does not mean instant viewing and replying to messages. It does not mean instant real-time conversation. Due to the influx of incoming various types of messages (e.g. WhatsApp), SMS and notifications, there is no guarantee of real-time viewing & replying of messages and conversation. (b) When Private real-time talk required before other persons at public places e.g. colleagues, partners, employees, teachers, students, guests, family, friends, relatives, anonymous persons and like the user can prefer text calls. In voice calls anybody can hear a voice. Due to voice communication, no privacy is possible and in instant messenger real-time viewing and replying of messages and real-time conversation is not possible. (c) When voice call is not preferred or accepted by the receiver (e.g. Local shop marketing, customer, and support) because during voice call, the user needs a great amount of attention. That's why users avoid calls from anonymous persons. In instant messaging most of the time people ignore messages. There is no option of Opt-In in Instant Messaging. So, the caller needs to make a text call in this situation. (d) When voice quality is not proper and real-time phone call require: For example, when user is in transit (train etc.) and the network signal is not proper and when user surround crowded place having lot of voice (e.g. market, event . . . ) then Text Call is best mode of communication. In voice call good quality of incoming and outgoing voice is required in voice call and in instant messenger real-time viewing and replying of messages and real-time conversation is not possible. (e) Short real-time or quick communication or answer need: For example, when the user wants to provide a particular type of info. e.g. Say “Ok”, “Thanks”, “Coming in 5 minutes”, Provide confirmation, acceptance, status, data, updates and like. Then people will prefer text call over voice call in this scenario. In instant messaging there is no guarantee of real-time reply from the recipient of the message. (f) When agenda or purpose specific real-time call require: For example “Dress is ready”, “Is food ready?”, “Your number pls?”, “What's menu today?”, “Where are you”, “When will you come”, and one or more types of Updates/Status/Confirmation/Plan/Actions/Tasks and Workflow then user like to user text call. Generally, in voice call non-purpose specific time-consuming talk also happened and in instant messaging no real-time communication and answer possible. (g) When slow motion conversation required: In text call, person will get enough time to response (e.g. for thinking, taking decision . . . ) and also maintained real-time talk session in Text Call, whereas in voice call communication is very fast and during call user need to speak continuously and instant messaging is slow motion communication but it's not within real-time conversation call session. (h) Text call is very suitable when a user wants to make real-time call(s) to multiple persons to talk about a particular plan (e.g. event, travel, movie, lunch or dinner etc.). In text calls the user can view the talked info again and again (e.g. menu item, place and event details, date and time, location, amount etc.). In voice call, users need to remember what other users talked to decide the plan (e.g. menu item, place and event details, date and time, location, amount etc. User does not get enough time to think.

Real-time making of calls and conducting messaging conversations with multiple persons is not possible or very time-consuming and tedious because no guarantee of real-time reply. (i) Saving call specific conversation: In Text Call users can save conversations which are easily searchable, processable, sharable. Caller and callee can view logged records of call conversation multiple times during call. Recording voice and searching voice conversations is a time consuming and tedious process. Instant messenger and SMS have the same features but they are not real-time calls. So, users cannot determine, search, process and view particular call specific conversation within the call session (within start and end of call. (j) In text calls, a single person or individual user can attend multiple calls at a time. Attending multiple calls at a time is not possible in voice call. Communicating with multiple users is possible in instant messenger and SMS, but they do not provide real-time call and conduct messaging features. (k) Text Conversation and sharing of photo, video, location information, files, emoticons, stickers and audio take place within call session (within start and end of call). A Text call is a connection over a cellular and data network between the called party and the calling party. In voice call, only real-time voice conversation takes place within the call session (within start and end of call) and in instant messaging, there is no call flow. Users can send messages anytime and recipients can reply messages anytime.

Current problems of short message service (SMS) are due to large volume of SMS, people can ignore reading of SMS, no guarantee of instant reading and viewing of SMS, no guarantee of instant response of SMS. It is a non-real time text messaging service unlike voice which is real-time. SMS length is about 160 characters (maximum) and no rich content and integrated call-to-actions except short links and have limited functionalities. Present invention enables Call for Sending Message/SMS (CMS) service which real-time confirms viewing of SMS or message and possibilities of getting instant response. Users can prepare SMS or messages and make calls for sending messages/SMS (CMS) including selected contacts and unique identities, mutual connections or opt-In contacts only. In the event of acceptance of CMS call, displaying SMS or message to call accepted user and send or show status or confirmation of acceptance of CMS call and viewing of SMS or message or rejection of call (miss call) to calling user. Users are enabled to block contact if not relevant. Users can make CMS calls with No Reply required/User can Reply if wish/No Reply options. Advantages of CMS over SMS are (a) Opt-In contacts: People can call to or accept calls of known persons or opted contacts only. (b) CMS's are read: Due to call, CMS messages are read. (c) CMS guarantees real-time views and then people can respond immodestly by next CMS. If a person not available or busy then miss call. (d) Realtime Call-to-actions: Confirmation (e.g. click inside SMS to confirm OTP), book, opt-in, subscribe, get appointment, order, buy, participate in event, share contact info. (f) CSM is ubiquitous: Due to worldwide partnerships with Mobile Network Operators CMS will omni present. (g) CMS's may cost money: Because CMS messages are paid for, they tend to provide valuable content which is relevant to the recipient. (h) CMS is versatile: CMS has so many different uses and can be used for a wide range of communication needs.

Live streaming video e.g. Periscope enables users to broadcast video privately to specific followers or friends. But it's limited to live video, users cannot post photos, selected videos and one or more types of contents and posts and get customized types of reactions. For example, in Facebook™ users can share posts in Newsfeed with friends and they can anytime provide one or more types of reactions (e.g. Like, Comments). There is no guarantee of real-time viewing of posts and getting reactions from friends. Users need too many time view notifications and logs to view which friends viewed posts and provided reactions (e.g. Like, Comments), so it's very time consuming, tedious and slow-motion process. Due to many posts posted by and received from many friends, users lost interests.

Call For Posting & Getting Reactions (CPR) Service enables user to prepare post and make CPR call to selected contacts and groups (best friends and family) and in the event of acceptance of CPR call, display said post to all called users and enable them to real-time provide reactions (e.g. like, dislike, rate, comment, select emoticons (e.g. wow, surprise) and stickers) and messaging, User can make CPR call to closed and best contacts and real-time get their views and different types of reactions.

Examples and use cases of CPR are (a) users can make CPR calls and share posts related to new clothes worn by the user and get instant reactions from all best friends. Instant gratification makes user excited and feel that all friends are near. (b) user can make CPR call and share travel related photos related to particular place and get instant views and reactions from family. (c) User can make CPR call and post birthday related to photos and get involve relatives and friends who are far and not attended birthday party. (d) User can make CPR call and post photos while getting university degree and get instant response from well-wishers. (e) Make CPR call and post jokes, quote, News or microblog and get views and reactions. (e) Make CPR call and ask question to get real-time answers, (f) Make CPR call and display call to actions and ask to take call to actions, (g) Make CPR call and provide tips, information, notification and reminders, (h) Make CPR call and post surprise video and get reactions, (i) Take photo of news and make CPR call and share with contacts, (j) Prepare Tweet and make CPR call and display Tweet, (k) Select photos/videos and make CPR call and display posted ephemeral photos/videos (l) other use case of CPR call are it's useful for Good News, providing surprise, share very useful information, use cases where immediate attention required, share high quality and selected photography, share important screenshots, personal photographs, behind the scenes shots of your workplace, quote graphics and share about current event, share about food and recipe like today's menu, status like current eating at restaurant, share about new cloths, current event including birthday, anniversary, festival, party, exhibition, movie, play, shows, share related to purchased products & services, product reviews, movie reviews, get recommendation (this or that), share about current place and associated activity, share useful information and related solution of problem, tips, what's new, comments, suggestions, advice, warning, important or preferred news, tell stories, trending topics, send invitation, announcement, reminder, status, and updates, share about current plan, schedule, share about traveling including currently visited point of interest (POI), eating, cloths, activities, shopping, attending, post about current activities including watching, viewing, attending, eating, accompanied with, reading, listening, playing (e.g. sports, games), and like, share quality selfie, web links, announce requirement (Ask suggestion, recommendation, tips, alternatives), share popular content, say congratulations, provide confirmation, tell good morning-afternoon, evening, post interested or important advertisements, deals, promotion, coupons, vouchers, offer, sample, invitation, contest, survey, coming soon, upcoming sales/offers, post or share about office and business related like upcoming event, new job listings or open positions, behind the scene, daily activities of your business or job, conference, meeting, post that contains a call-to-action, work in progress, task, plan status, workflow, job and tweet, post real-time ephemeral content. Industry wide usage of CPR are in short talks, post about current location, place, purchase, activities and event, related to slow motion conversation, confirmation, instruction, status, updates, news, questions and answers, buy products, ratings and reviews, provide info.—what, where, when, how, why), CPR is very useful in finance (Banks, Payments, Transactions etc.), health, fitness and beauty, buying, e-commerce, ordering, booking, appointment, availability, advertising, marketing, offers, promotion, selling, survey and reactions, publishing (Posts—Photo, Video etc.), cloths, fashion and lifestyle, travel, entertainment, food, event, local, jobs, education, on-demand service providers, group plan, group notifications (about event, party, new stocks etc.), get and Provide, support and others.

Text Call for Mobile Network Operators (MNOs) enables mobile network operators to online registering, reviewing and signing partnership agreements based on revenue sharing. Mobile operator is presented with user interface or application for defining one or more types of text call services plans including bundle new text call services in existing postpaid and prepaid plans or create new plans including combined or individual one or more types of plans for Call For Messaging (CIM), Call For Sending Message & SMS (CSM) and Call For Posting & Getting Reactions (CPR) tariff plans which covers numbers of text calls (CIM, CMS, CPR), duration of text calls (CIM, CMS, CPR), data and SMS bundle and like and include in mobile operator's monthly price plans with standard voice calls, SMS and data. Mobile operators can market and promote subscription of text calls including Call For Messaging (CIM), Call For Sending Message & SMS (CSM) and Call For Posting & Getting Reactions (CPR) services among existing and new millions of subscribers and displaying user interface to existing subscribers of partnered mobile network(s) for enabling them to easily select and subscribe or use trial or update or upgrade or un-subscribe and make subscription payment for one or more types of text call plans including individual or in combination CIM, CMS, CPR plans, install, uninstall, update and upgrade text call application, make payment for subscription. Subscribers of CIM, CSM & CPR services need to install android or iOS or Windows client applications for smart phones, personal computers, tablets, laptops and smart devices from app stores or via website to access Call for Messaging (CIM), Call for Sending Message & SMS (CSM) and Call for Posting & Getting Reactions (CPR) services. Subscribers can use trial period and then get CIM, CSM & CPR services bill and make payment for Call for Messaging (CIM), Call for Sending Message & SMS (CSM) and Call for Posting & Getting Reactions (CPR) services. Server 110 monitors and tracks usage of text calls services (CIM, CMS, CPR) by each mobile operator and enable mobile operators to share revenue with serve 110 or make payment.

Mobile operators can create package(s) or separate charges for each sub-services including take extra charges for Text Call on PC/Tablet/Wearables (Smartwatch Ringing), One to one call, One to many including Group Calls and Call to Pre-created or selected contacts (No. Limits or Ranges as per Pack), Multi Calls (No. Limits or Ranges as per Pack), Add Incoming call to current call (No. Limits or Ranges as per Pack), Make call and add to current call (No. Limits or Ranges as per Pack), Auto Calls (No. Limits or Ranges as per Pack), Customized Service (Formation and Rule based Call Flows & Management), Enterprise Account (Multi users) including small (shops, professionals, service providers, web sites), Medium (Chain stores, retailers, brands, schools, colleges, Marketing agencies, hospitals,) and Large (Call centers, Customer support for companies, Banks). Tariff Plans/Packs/Add-Ons/Recharge based on Local, National and International text calling (CIM, CMS, CPR), Prepaid and Postpaid account, Packs based on Duration, Number of Calls, and Bundled Data and SMS Plan and Other services including Cloud Storage, Language translation, Ringtones, Emoticons and Stickers. Mobile operators can bundle other useful services including payment services, cloud storage for call recording, searching and management, real-time language translations, real-time speech to text and text to speech (For Hand free), Virtual goods, Ringtones, Wall papers, Emoticons, Avatars and Stickers, Contents (Re-sharable, videos, Customized content e.g. Event Post . . . ) and Templates (Ready to use text, photo, post . . . ). Text call enables mobile operators to partnering with text all based on profitable revenue sharing, and easy to sell text call services among existing mass subscribers by the Telco salesforce because text call services are useful for each subscriber, easy to understand by the end-user because they are already used to with voice and video call or phone flow and instant messengers, have a direct connection with the core business of Telcos including Data and SMS, are highly profitable, delivering high margins and high EBIT (better than EBITDA), require no CAPEX neither for Telcos nor for end-users, require no unnecessary installations (if pre-installed with mobile handsets), are fully responsive and easily accessible via the Cloud, have an immediate Time to Market, are backed up by comprehensive support (support, helpdesk, security, legal advice.) and help mobile operators to increase ARPU and customer satisfaction while reducing churn, can be equipped with powerful features (in-app payment services, cloud storage, language translations, ringtones, emoticons, contents and templates . . . ). These services will help to boost SMS and data usage on the network. Some 87 percent of consumers in emerging markets state they are willing to pay for high-value digital services via mobile devices. Text call services easily combined with existing Voice call, Data and SMS services for each subscriber.

Present invention also enables real-time instant messaging (RIM) protocol, server, platform, client applications and services, wherein receiving a first message from a first user for sending to a second user; displaying the first message from the first user to the second user; initiate timer, start timer and in the event of sending first message by the second user for the first user, stop timer, reset time and send and display said second message to the first user and display said timer duration with said message; based on said calculated duration or timer, determine starting of call or starting of communication or starting of session and determine type of messaging including real-time instant messaging or normal instant messaging and displaying indication about starting of call or session or conversation and type of message to the first user and the second user; in the event of receiving or identifying one or more types of indication about ending of communication session or ending of call current conversation in one or more form, end call or end session or end conversation, log call including first user's unique identity, second user's unique identity, duration of communication, start and end of conversation date and time, number of messages or content items sent, received or viewed, title or subject or agenda or conversation; and monitoring, tracking, calculating, logging or storing period of time require to sending or receiving each next message from the last received or sent message from/to the first user or from/to the second user and based on said data analytics identifying or calculating rank of each contacts of each user.

At present live chat allows customers to communicate with customer service representatives in real time. Rather than having to speak with a representative on the phone, visitors on a website can have a live interaction with agents in a chat box within a browser. Instead of waiting for an email response, users can send a message in a chat box, and then wait for an agent to respond to them. Users need to visit websites to access live chat. Each website needs to integrate and maintain live chat provided by different vendors. There is no standardized interface and further there is no single smart client application for live chat for all websites. Live chat obstructs customers or visitors of websites (each page is integrated with live chat). Website integrated live chat obstructs users in viewing website contents. Website integrated live chat also changes the look and feel of a standard website. Each page integrated live chat interface does not look proper. Live-chat is synchronous and does not keep the blocks of chat as historical data. If the customer leaves the page or doesn't answer fast enough, the chat session ends, and they have to explain his problem again. Live Chat integrated with online websites or webpages. There is no smart client application and hence not available across multiple devices, giving customers the freedom to switch between devices, and still see ongoing conversations in their app. Each website has a different live chat interface. No standard interface. Visitors to the website are anonymous. They need to fill out a form to share contact details with each website. Most live chat windows are not suited for mobile devices, which is an inconvenience for many users. Consumers today oftentimes use their phones more than computers, but in order to have an unbroken experience with live chat, they would have to go to a company website on their computer and wait to be assisted. Visitors to the website need to stay in the chat box to communicate with a customer service representative since the conversation will be deleted if the chat box is closed. This detail can be bothersome when visitors have a poor internet connection or have to contact customer service support multiple times, and need to repeat their issues to different agents. In-app messaging is a modernized form of live chat because customers can enjoy an asynchronous form of communication. Not only can users send a message and then exit the app without deleting the conversation, but they can also receive push messages when an agent has responded to their inquiries. These notifications can provide relief to visitors because they will know the instant that their queries have been addressed. But there is no centralized live chat smart client installable application for all websites where users can access Live Chat support from any websites.

Whereas centralized live chat application enables single or one live chat application for all websites/businesses for getting live chat support. Centralized Live Chat App is asynchronous meaning it can keep a conversation history between agent and customer for all websites or brands. The conversation can also continue at different times as one thread, meaning information does not need to be repeated, whereas Live-chat is synchronous and does not keep the blocks of chat as historical data. If the customer leaves the page or doesn't answer fast enough, the chat session ends, and they have to explain his problem again. Because a conversation exists in a third-party channel, the entire conversation history is visible—and also visible to the support agent, too. Cross-device: Unlike Live Chat, Centralized Live Chat App is available across multiple devices, giving customers the freedom to switch between devices, and still see ongoing conversations in their app. Live-chat is mainly adapted to usage on a desktop for sales questions to provide immediate assistance, Centralized Live Chat App can be used throughout the full customer journey, across multiple devices. To be offered as a contact channel to customers, live-chat requires the presence of agents at all times. If no one from the customer service team is available or outside opening hours, live-chat is not displayed in the user interface in the Centralized Live Chat App. One of the specificities of Centralized Live Chat App is the ability to send a pop up to customers browsing a specific page. This can be very useful to target qualified visitors and increase conversions. Centralized Live Chat facilitates making calls and in the event of acceptance of call display chat interface to both user and agent. With one tap users can share contact details or easily share selected user profiles and data with agents. Centralize easy to use mobile smart client applications for all websites (auto identify current viewing website name) where users want to connect with web site's staff or agent or admins for various purposes including ask queries, website current page related products support, negotiate, purchase, access chatbots and like. Messaging applications allow customers to have a conversation with a business representative online. However, unlike live chat, these conversations don't happen in real-time. There is no promise of ‘live’; no offer of immediate assistance. Rather, messaging applications create a more disfluent conversation where both parties can hop in and hop out as convenient. Think WhatsApp and Facebook Messenger, for example. Centralized Live chat software is a business chat tool that powers real-time conversations. So, there is no stop-start element to the conversation. The customer types their message into the chat window of a centralized live chat application, and the live chat agent is active at the other side to offer an immediate response. Messaging apps are convenient for their flexibility, live chat software is convenient for its urgency and immediacy. WhatsApp business is not enabling users to connect with available agents based on automatically identifying currently viewing website or selected or entered website associated agent. WhatsApp business is allowed two-way communications whereas centralized live chat enables users to connect with business or agent of business, so there are no incoming spams. WhatsApp business is restricted whereas centralized live chat app enables both users and agents to share one or more types of contents, products, promotional message, chatbots, call-to-actions, forms, user interface, controls, and any combination thereof during live chat session. WhatsApp business does not allow multiple agents, queuing, transferring of chat, attending multiple customers, menu for enabling users to select particular area or branch and connect with selected area or branch associated agent related to particular website and smart queuing for routing incoming requests to available and relevant agents. Therefore, it is with respect to these considerations and others that the present invention has been made.

At present users visit online e-commerce websites or applications e.g. Amazon and view products catalogues including products photos and details and purchase products. There is no direct interaction with seller or limiter interaction with seller via message. Seller is not directly connected with potential buyer or buyer is also not directly connected with selected seller and further there is no direct live communication with seller for viewing currently available products, compare products, ask queries and view and listen responses, negotiate and then purchase products without visiting online websites or in-person visiting shops. For in-person visit at a particular shop requires a good amount of time and cost.

Present invention enables user to search seller as per search queries or requirement specifications and/or select seller or business account or shop and send message or voice message without disclosing user identity and contact information including name, photo, phone number, email address, user account name, address and location information and instruct selected seller to respond on user or customer selected communication channel including live video or live voice or instant message or live chat. So user can send queries via messages and get response via live video or live voice or instant message or live chat, so user instantly real-time view all required products in shop and ask queries, make comparison, real-time negotiate with seller and if like particular products then make payment, share delivery address & contact information and purchase selected products from said shop without visiting said shop or connect with other stores until user find out required products.

At present, WhatsApp allows users to send and receive messages from/to phone contacts. At present phones allow users to make calls to another user based on phone number. But the user is not able to know live communication including live chat status of contacts of the user, so the user can communicate including send and receive messages or converse via voice or video & audio mode in/within real-time communication including live chat session. Also user not able to select phone number and real-time connection with available agents and communicate including send and receive messages or converse via voice or video & audio mode in/within real-time communication including live chat session with connected agent. At present website integrates with website or webpage, live chat software of different vendors. But user is not able to access all said website or webpage integrated live chat software from different vendors at single client application including mobile client application.

Therefore, it is with respect to these considerations and others that the present invention has been made.

### OBJECT OF THE INVENTION

The principal object of the present invention is to enable different types of text call services including Call For Instant Messaging (CIM) Service wherein user or caller or requester/requestor or inviter can make call or send request or provide indication in one or more form with intention to real-time communication with callee or invitee or requestee and enable to add in-coming calls and make call to add call accepted uses to selected call, Call For Sending Message/SMS (CMS) Service wherein user can make call and—in the event of acceptance of call, display message send by said caller to said callee and Call For Posting & Getting Reactions (CPR) Service, wherein make call and in the event of acceptance of call, display message or one or more types of contents and enable caller and callee to exchange messages or comments or enable receiving user(s) of said contents to provide one or more types of real-time or near real-time reactions including like, dislike, select or provide emoticons or stickers, share, reply, comments, and rank.

Another object of the present invention is to start and end session or real-time session or communication session based on providing or identification of one or more types of indications in one or more formats.

Another object of the present invention is to integrate text call services including Call for Instant Messaging (CIM) Service, Call for Sending Message/SMS (CMS) Service and Call for Posting & Getting Reactions (CPR) Service with phone contacts of phone application of user device, outgoing phone call interface of phone application of user device, and phone dialer of phone application of user device.

The another object of the present invention is to start call based on providing command in one or more form including message or text or voice or icon image or emoticon or voice with one or more controls including accept and reject text call to enabling called user to accept or reject text call and in the event of accept text call by tapping of clicking on “accept” button by called user or send message(s) by called user to calling user starting call session and in the event of text call by tapping or clicking on “end” button or sending command or message in the form of text or icon or image or emoticon or voice ending or terminating call or session or closing user interface and saving or logging calling and called user(s) identities, date and time of start of text call and end of text call and conversation exchanged or shared between start and end of call.

The object of the present invention is to enable text call so user can get many advantages over voice, video call and SMS and instant messaging including CALL FOR TEXT INSTEAD OF VOICE: Like phone call now user can texts call or chat call (vary real-time) and enables real-time communication and interaction, MEDIA SHARING: User can text call and real time share text, link, location, photos or videos, voice and receives likes & comments, MULTI TASK: user can call to multiple users. Multiple tabs enable switching among current active calls associated chat interfaces. It enables simultaneous Chats, so user can chat with multiple people at once, organized neatly in tabs at the top of your chat window, INSTANT: For example user can invite for or organize event e.g. birthday party, anniversary and get feedbacks, COLLABORATION: Group of users can plan meetings, organize things or tasks with minimum messages, PUBLICATION: Receive information as soon as it is published by calling user or author, CUSTOMIZE: User can customize chat interface and calling functionalities, ALTERNATE OF PHONE & CHAT: Reduces phone calls and chat messages, CONVENIENT: User can easily multi-task while waiting or chatting, ONLINE: Real time conversation, the caller is necessarily online, DISCREET: you do not talk, you chat, EFFICIENT: The conversation happens in same session and is dedicated and bounded in time, EPHEMERAL: as a call, the conversation disappears/removes at the end of Text Call or saved (Allow to Save option), COMBINATIONS OF PHONE & CHAT: It provides amazing combinations of phone and chat features, CONNECT WITH YOUR CONTACTS: Your address book is used to quickly connect you with your contacts who have Text Call.

The object of the present invention is to enable real-time instant messaging (RIM) wherein users can view and respond on message real-time or near real-time. Real-time instant messaging (RIM) application updates and publishes the user's online status, monitors and tracks the user's real-time response on other user's messages behavior based on logged data statistics and analytics. Current instant messaging (IM) does not provide real-time response guarantee whereas real-time instant messaging (RIM) enables users to use real-time instant messaging (RIM) application only to send messages which require real-time response and provide real-time response on other user's received messages. Because server monitors, tracks and ranks users based on how fast users respond on other users' messages, other users can view ranks and weights of each contact, so users can also come to know how fast they respond on said user's received message. If a user responds fast to other users' or contacts' received messages then other users or contacts can respond fast to the user's sent messages.

Another important object of present invention is to provide centralized live chat application to enable users to connect with available agents from multiple agents related to currently viewing or selected or entered websites for getting live chat support.

Another important object of present invention is to enable users to search, select on maps or select from nearby places, particular places for instantly connecting with available agents related to said selected place for getting live chat support or sending and receiving messages. Users can also select other than chat communication medium, application, interface, channel and service including video call, video conferencing, video messages, audio messages, phone call, voice over internet protocol (VOIP) and any combination thereof.

Another important object of present invention is to enable instant messenger sending and receiving instant message as well as also conduct live chat or video call or voice call, send and receive video or voice or text messages, share contents and participate in video conference, wherein business register with system provide business details and profile. Customer can provide various types of settings with each selected business or brand or place or website, wherein settings comprises allow or nor allow business to send message, make phone or VOIP or video to user, configure do not disturb policy, follow business to receive contents within instant messenger or chat interface and define rules for connecting to user by selected or particular type(s) of business(es) including only current place of user associated business, past transacted or visited or interacted business, selected type(s) of activities or categories or keywords or interest or preferences specific businesses, selected businesses, searched and viewed or transacted websites of businesses, subscribed services related businesses, connect at particular time or time range, including or excluding days, dates, date ranges, time, ranges for connecting or communicating or sending contents to/with user, connect only for selected type of purposes including providing offer, providing information about arrivals of new products and services, innovations, free gifts or voucher or coupon or samples, support services, knowledge and information related to selected products and services and like.

The other object of present invention is enabling the first user to use the first communication medium from first user device to communicate with second user on second user device via second communication medium.

The other object of present invention is enabling user to select currently viewing website in web browser or application integrated control or button to allow mobile client application to access currently viewing website associated domain name or uniform resource locator (URL) and enable user to connect with available agent associated with said currently viewing website associated domain name or uniform resource locator (URL) for live communication including live chat. In another embodiment mobile client application of user device, automatically receives currently viewing website associated domain name or uniform resource locator (URL) via web browser installed add-ons or plug-ins.

The other object of present invention is allow user to live communicate including live chat with one or more types of contacts of user including phone contacts, social network contacts, email contacts, one or more types of identities of connected users, interest specific or type or queries including natural query, structured query language (SQL) query specific users of network.

The other object of present invention is allow users to live communicate including live chat with selected phone numbers associated with an available agent.

The other object of present invention is to provide a single mobile client application to enable users to select online or web based live chat applications related to a particular website or business or application from list to connect with the available agent.

The other object of present invention is to enable a user to select one or more types of unique identity(ies) of un-registered users or entities and enable to send, view and respond messages.

The other object of present invention is to enable a user to select a website domain name or uniform resource locator (URL) or business name or place or place of business name or account name and enable the user to connect with the available agent for live communication including live chat. In another embodiment mobile client application of user device, automatically receives currently viewing website associated domain name or uniform resource locator (URL) via web browser installed add-ons or plug-ins and automatically connects the user with automatically identified currently viewing website or application associated agent.

### DETAIL DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” or “in an embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on”. In addition, as used herein, the term “chatcall” or “chat call” is equivalent to the term “text call” or “text calls” or “Textcall” or “T call” which comprises various types of text calls including call for real-time instant messaging (CIM), call for real-time sending and displaying message or SMS (CMS) and call for real-time sending or posting and displaying one or more types of contents or post(s) and get various types of reactions (CPR).

As used herein, the term “receiving” text call(s), requests, updated status, responses, communications and any types of multimedia contents from a device or component includes receiving the text call(s), requests, updated status, responses, communications, and any types of multimedia contents indirectly, such as when forwarded by one or more other devices or components. Similarly, “sending” text call(s), requests, updated status, responses, communications, and any types of multimedia contents to a device or component includes sending the text call(s), requests, updated status, responses, communications, and any types of multimedia contents indirectly, such as when forwarded by one or more other devices or components.

In an embodiment in the event of acceptance of call for chatting, starting chat session; and in the event of ending of call by calling or called user ending chat session.

In an embodiment in the event of acceptance of a call within pre-set duration, starting chat session.

In an embodiment maintaining a chat session during call or within call.

In an embodiment in the event of acceptance of call for chatting, start chat session; and in the event of ending of call by calling or called user end chat session.

In an embodiment in the event of acceptance of a call within pre-set duration, start a chat session.

In an embodiment maintain chat session during call or within call.

In an embodiment automatically identifying currently viewing website name or uniform resource locator (URL) and viewing user's identity and in the event of sending message from a chat interface, identifying identified uniform resource locator (URL) associated available agent and starting chat session and enabling user and agent to sending and receiving of messages or automatically identifying identified uniform resource locator (URL) associated available agent and displaying chat interface, starting chat session and enabling user and agent to sending and receiving of messages.

In an embodiment identifying uniform resource locator (URL) based on monitoring and tracking currently viewing website's uniform resource locator (URL) or domain name via browser installed plug-in or in-app browser control or selecting of integrated widget from currently viewing website or webpage.

In an embodiment end chat session based on closing of application, non-sending or non-receiving of messages within pre-defined time period, manually selecting end control, issuing of end command via providing text or voice command.

In an embodiment further identifying an agent based on the user selected option or menu item from the displayed menu.

In an embodiment enabling user to enter or select uniform resource locator (URL); identifying entered or selected uniform resource locator (URL); identifying identified uniform resource locator (URL) associated available agent; and displaying chat interface, starting chat session and enabling user and agent to sending and receiving messages.

In an embodiment enabling the user to enter a uniform resource locator (URL) in the address bar of the browser including mobile browser or in-app browser control.

In an embodiment enabling user to select uniform resource locator (URL) from one or more types of lists including bookmarked, favorite or liked, searched, transacted, visited, categories directories and past communicated websites, visited places associated corresponding websites, received emails or messages associated corresponding websites, calendar entries associated corresponding websites, viewed or received posts associated corresponding websites, viewed search results associated corresponding websites, interest, logged activities, interacted entities and places specific corresponding websites.

In an embodiment enabling the user to search and select uniform resource locator (URL).

In an embodiment end chat session based on closing of application, non-sending or non-receiving of messages within pre-defined time period, manually selecting end control, issuing of end command via providing text or voice command.

In an embodiment further identifying an agent based on user selected option or menu item from displayed menu.

In an embodiment accessing selected place and user identity; identifying selected place associated available agent; and displaying chat interface, starting chat session and enabling user and agent to send and receive messages.

In an embodiment enabling the user to select a place on maps.

In an embodiment enabling users to search and select places on maps.

In an embodiment enabling the user to select current or nearest place on maps.

In an embodiment enabling to automatically identify current place on maps based on user device current location associated with identified place.

In an embodiment enabling a user to select a place on maps from nearby places. wherein enabling the user to select places on maps from selected category specific nearby places.

In an embodiment enabling a user to select a place on maps from pre-set or entered location nearby places.

In an embodiment enabling a user to select a place on maps from pre-set or entered location nearby places selected category specific nearby places.

In an embodiment enabling the user to select a place on maps from list.

In an embodiment enabling the user to select places on maps from identified places, wherein identifying places located within the predefined radius or within the threshold distance of the location of the user device.

In an embodiment enabling the user to use displayed, by the hardware processor via the network interface component and the network, place the plurality of places on maps associated or linked or connected or embedded or integrated or displayed graphical user interface for conducting live chat with said identified place associated available agent.

In an embodiment displaying centralized live chat graphical user interface at prominent place or beside/with/in/surround particular place icon or image or name or area.

In an embodiment in the event of selecting a particular place, displaying centralized live chat graphical user interface.

In an embodiment in the event of selecting a particular place, displaying graphical user interface or live chat control including button or icon or link and in the event of selecting graphical user interface or control, displaying centralized live chat graphical user interface.

In an embodiment enabling user to select current location associated place, current place, select place from nearby places or select place from selected category specific nearby places, search and select place, select sub-place, select floor and select place from indoor maps, select place from list of places including favorite, liked, bookmarked, visited, transacted, plan to visit places.

In an embodiment plotting on the maps graphical user interface, places and associated details, wherein each plotted place associated or integrated with a selectable, accessible and actionable graphical representation or graphical indicator or control or icon or name.

In an embodiment identifying user device current location associated place or place of business or merchant based on sufficiently matching monitored and tracked current location of user client device with location information associated with the places from places database, wherein location information associated with the place comprises address, geo-coordinates or GPS coordinates, unique geocode, pre-set pointer on maps, pre-defined geofence.

In an embodiment generate, by the hardware processor of a server coupled to a user mobile device via a network interface component and a network, a maps; display, by the hardware processor of a server coupled to a user mobile device via a network interface component and a network, generated maps and/or list of maps linked places, wherein displayed maps or list comprises one or more places or places of businesses or merchants and each place associated details including at least name or icon; in the event of selecting particular place from displayed places on maps or from maps linked list of places, display, by a hardware processor, a centralized live chat graphical user interface; and receive from the centralized live chat graphical user interface of the user client application or user client device or user mobile device, by a hardware processor of a server coupled to a user mobile device via a network interface component and a network, request or instruction to connect user with selected place or place of business associated available agent for conducting or starting live chat or sending and receiving message.

In an embodiment in the event of selecting a particular place from displayed places on maps or from maps linked list of places, displaying, by a hardware processor, a centralized live chat control.

In an embodiment in the event of selecting said centralized live chat control associated with said particular place, displaying, by a hardware processor, a centralized live chat graphical user interface for enabling the user to chat with the currently available or identified or connected agent.

In an embodiment generating, by the hardware processor of a server coupled to a user mobile device via a network interface component and a network, a maps; displaying, by the hardware processor of a server coupled to a user mobile device via a network interface component and a network, generated maps, wherein displayed maps comprises one or more places or places of businesses or merchants and each place associated details including at least name or icon; displaying, by a hardware processor, a centralized live chat graphical user interface with each displayed place on maps; and receive from the centralized live chat graphical user interface of the user client application or user client device or user mobile device, by a hardware processor of a server coupled to a user mobile device via a network interface component and a network, request or instruction to connect user with selected place or place of business associated available agent for conducting or starting live chat or sending and receiving message.

In an embodiment outputting, by a mobile computing device and for display at a presence-sensitive display, a maps graphical user interface including a plurality of places, wherein each place from a plurality of places is associated with at least an icon and/or name associated with a place; receiving, by the mobile computing device and from the presence-sensitive display, an indication of a first user input detected by the presence-sensitive display at a location of the presence-sensitive display associated with the icon and/or name; and responsive to receiving the indication of the first user input, outputting, by the mobile computing device and for display at the presence-sensitive screen, a centralized live chat graphical user interface to enable user to chat with currently available or connected or identified or assigned agent related to said selected place.

In an embodiment receiving, by a hardware processor of a server coupled to a user mobile device via a network interface component and a network, one or more criteria and/or location information; generating, using the hardware processor, a map based on said received one or more criteria and/or location information, wherein the generated map comprises plotting on the generated map each identified or determined place(s) based on said received one or more criteria and/or location information; displaying on said generated map, by the hardware processor via the network interface component and the network, one or more graphical place indicators to indicate locations of the identified places, wherein in the event of user selecting of particular graphical representation or graphical indicator or icon on a map display, after the map is generated and after the graphical indicator of each identified place is displayed, displaying graphical user interface (GUI), wherein graphical user interface (GUI) enables user to chat with currently available or connected or identified or assigned agent related to said selected place.

In an embodiment location information comprises monitored and tracked user mobile device current location, location set by user, check in place and automatically determined location or place or geofence associated with particular place.

In an embodiment criterion may comprises search query, selected category, selected place, selected place from list of places including bookmarked, liked, favorite, visited, plan to visit, and transaction places, selected location, nearby places, current place, and any combination thereof.

In an embodiment monitoring and tracking, by the hardware processor via the network interface component and the network, user device location; displaying, by the hardware processor via the network interface component and the network, categories nearby places based on monitored and tracked location of user device; enabling a user to select a place from displayed list of nearby places; enabling to use, by the hardware processor via the network interface component and the network, a graphical user interface for conducting chat with currently available or connected or identified or assigned agent related to said selected place.

In an embodiment displaying a place or place of business details including distance from monitored and tracked user device current location.

In an embodiment displaying a place or place of business details including updated distance from monitored and tracked user device current location or continuously updated location.

In an embodiment displaying a place details including the place or place of business name, category, location or full or partial address, logo or icon or image, place business hours and current status including open or close, and ratings, maps and address, photos, ratings and reviews, description, contact information including phone number, email and website.

In an embodiment enabling the user to filter displayed list of places based on distance, stats including open or close, service type including home delivery available, ratings, category.

In an embodiment enabling the user to search a place or the place of business within the displayed list.

In an embodiment displaying a place associated one or more types of actions including call, chat, maps for direction, ratings and comment box.

In an embodiment enabling a user to select or input a location or type of location; displaying, by the hardware processor via the network interface component and the network, categories nearby places based on the selected location; enabling the user to select the place from displayed list of nearby places; enabling to use, by the hardware processor via the network interface component and the network, a graphical user interface for conducting chat with currently available or connected or identified or assigned agent related to said selected place.

In an embodiment selected location comprises current location, automatically determined location, selected or inputted area or suburb, pin code, locality, road, nearby place or point of interest, selected location on map, selected point on map, draw location on map, full or partial address and one or more type of location code.

In an embodiment user to business and business to user communication based on user privacy settings and pre-defined rules comprising: receiving request from identified user to apply privacy settings and defined rules on selected one or more business accounts; storing identified user applied privacy settings and defined rules associated with selected one or more business accounts; displaying to each business account associated enterprise user or admin, business associated applied privacy settings and defined rules by each users of network; showing or activating or enabling in each business account related interface, communications, sharing and call-to-actions controls associated with each user based on applied privacy settings and defined rules by corresponding each user related to business; receiving communication or sharing or call-to-action request from the business account associated interface to selected one or more users; identifying applied privacy settings and defined rules associated with said selected each users; and based on identified applied privacy settings and defined rules, communicating received communication or establishing communication session, send or display shared contents and call-to-actions to one or more selected users.

In an embodiment showing or hiding or enabling or disabling or activating or deactivating controls related to the user based on user applied privacy settings and defined rules.

In an embodiment rules comprises allow one or more selected types, medium, channels of communication, sharing, call-to-actions based on included or excluded selected days, dates ranges and time ranges, allow number of times communications or sharing of contents within pre-set duration including per day, allow for selected types of purposes, tasks, actions, transactions, and offers, allow only for selected named products, services, brands, selected categories or types of products, services, brands, allow per communication for maximum pre-set duration only, allow incoming real-time communication based do-no-disturb policies, allow based on each time ser acceptance of communication or content, allow if offer lowest price then published price disclosed by user for particular product or services, allow only for purchased products and services, automatically connect me if purchase or subscribe or order or participate in deals or book or get appointment, automatically connect me with current location associated place or place of business, do not allow if global off setting, allow if requirement send, allow for new products and services or allow for selected types of products and services, response me only if send message or SMS or email, allow to send message only if connect, if video call allow only my voice, if video or voice call send messages and settings comprises play different types of ringtones and vibrations based on type of settings, do not show identity and contact information.

In an embodiment method for real-time or live chatting in instant messaging comprising: sending message to selected contact or business account name with or without disclosing user identity; enabling to send instant message by selecting send instant message control or enabling to send message for conducting live chat or real-time communication by selecting live chat or real-time communication control; in the event of receiving message from user, identifying available agent for real-time chatting or communication with said message sender and enabling identified agent to start sending or receiving message; in the event of receiving message from user, identifying non-availability of agent for real-time chatting with said message sender, displaying queuing indication or send response message(s) later.

In an embodiment making or receiving video call or voice call including phone call or VOIP call with or without disclosing calling user's identity; in the event of acceptance of call, enabling or allowing called user to converse or response in video or voice; and instead of converse or response in video or voice, send message(s) by caller or calling user to called user.

In an embodiment registering user as social support service provider including customer support service, live chat service; sending message to selected contact or business account name with or without disclosing user identity; in the event of receiving message from user, identifying one or more matched and available social support service provider(s) for real-time chatting or communication with said message sender and enabling user and social support service provider(s) to start sending or receiving message or real-time chatting or communication.

In an embodiment automatically identify monitored and tracked user device current location associated place; automatically identify said identified current place associated available agent; and displaying graphical user interface for enabling users to start communication including live chat or real-time messaging or real-time communication or instant messaging or video call or voice call with said identified available agent.

In an embodiment automatically add to contact or add to one or more lists or connect or follow business account by user based on identification of transaction, making of payment, ordering, booking, reservation of table, participate in deals, follow, connect, like, add to list, send message or SMS or email, make video or voice or text call, adding phone number or email or website name or contact information, visiting website or visiting website and spent pre-set duration of time, visiting place, selecting place on map, added or liked by one or more selected contacts, scan or take photo of products, adding name of brands, products, services, become member, subscribed services, installation of applications, receiving indication from linked systems or user accounts on one or more external domains, applications, websites, and social networks.

In an embodiment displaying suggested business account(s) to user based on searched websites, liked products, services, brands, transactions, received emails, calendar entries, logged activities, actions, transactions, visited places, checked in places, participations and interacted entities, visited websites, installed applications, subscribed services, user related data on one or more external domains, applications, websites, and social networks; enabling user to add to contact or add to one or more lists or connect or follow one or more selected business accounts from said suggested lists of business accounts.

In an embodiment receiving from a first client device associated with a first user, a first communication of a first type or medium or channel of communication on a second user interface in second client device associated with a second user and receiving from the second client device associated with the second user, a second communication of a second type or medium or channel of communication on a first user interface in the first client device associated with the first user.

In an embodiment enable the first user and the second user to select type of communication.

In an embodiment enable the first user to select or pre-set or request or instruct to use the selected type of communication for the second user.

In an embodiment type of communication comprises instant message, short message service (SMS), real-time voice message, cellular phone call, Voice over Internet Protocol (VoIP), video call, video message, voice message, live chat or real-time chat with available agent or staff person or selected contact, live video broadcasting or streaming or sending live or real-time video from one or more types of camera including mobile phone video camera, portable and movable wireless video camera, in-store selected wall or shelf/shelves video camera(s).

In an embodiment based on receiving communication associated type of communication, automatically selecting or embedding in communication thread or parent communication interface associated user interface.

In an embodiment receiving from a first user a selection of a second user from a contact list.

In an embodiment contact list comprises one or more types of unique identities including phone numbers, user names, social or professional network connections, followers, business account names, business page uniform resource locators (URL), website names or uniform resource locators (URLs), groups of users, place names, place of business names, email addresses, location address, namespaces and person names.

In an embodiment do not disclose identity and contact information of the first user to the second user.

In an embodiment disclose identity and contact information of the second user to the first user.

In an embodiment user can view in threads all exchanged and stored communications via relevant types of communication medium or channel including instant message, short message service (SMS), video message, voice message, video call, voice call, cellular phone call, and associated communications in text message, video message, recorded phone call(s), recorded video calls(s), recorded live chat conversations, saved video or audio or live chat and converted script of video to voice and text format metadata including sender name or nick name of sender, receiver name or nickname, date and time, type and name of communication, duration, number of characters, associated reactions including bookmarked, liked, remind later, notes, associated action, reactions and call-to-actions including select emoticons, expressions (e.g. like, dislike, wow), follow, connect, share contact information, book (tickets, table, appointment), buy, add to cart, participate in group deal, claim coupon or voucher or offer, participate in event, become member, make payment, order, sell, view, provide status, location information and updates, reshare and one or more types of digital contents.

In an embodiment during established communication session between a first user and second user, receiving from a first client device associated with the first user, communication of a first type on a second client device associated with the second user; and receiving from the second client device associated with the second user, communication of a second type on the first client device associated with the first user.

In an embodiment receiving from a first user interface of a first client device associated with a first user, communication of first type on a second user interface of a second client device associated with a second user; and receiving from the second user interface of the second client device associated with the second user, communication of second type on the first user interface of the first client device associated with the first user.

In an embodiment receiving requestor's or calling user's unique identity and one or more unique identity(ies) of requestees or called users; sending one or more types of indications or signals or notifications of request or invitation or call in one or more forms to device of said one or more identity(ies) of respective requestee; displaying or providing said one or more types of indications or signals or notifications of request or invitation or call in one or more forms and/or displaying chat or instant messaging user interface or application or said unique identity associated chat or instant messaging user interface or application or one or more types of graphical user interfaces, applications, media and any combinations thereof; and in the event of receiving one or more types of indications or signals or notifications of accepting of request or call or starting of communication including click or tap on accept button by called user, click or tap on contact of calling user, click or tap on call request notification, send first message, providing call acceptance related voice command, open camera or open camera in background and providing pre-define face or body expression(s) or receiving automatically acceptance of request or call, providing one or more types of sensor indication, providing fingerprint, displaying chat or instant messaging user interface or application or said unique identity of requestee or called user or said one or more unique identity(ies) of requestees or called users' associated chat or instant messaging user interface or application or one or more types of graphical user interfaces, applications, media and any combinations thereof.

In an embodiment enabling calling user to select currently active text call and add said accepted text call to said selected currently active text call.

In an embodiment in the event of acceptance of request or call or invitation or sending first message by called user or requestee or invitee, initiate or start session or call.

In an embodiment in the event of receiving session or call ending indication, ending or terminating session or call.

In an embodiment enabling, calling and called users to send and receive and view messages or one or more types of contents within said start and end of session or call.

In different types of embodiments enabling to manage and maintain session from requesting call to during active call or within call session or within start or initiating and end or terminating of real-time session and managing a session of real-time messages between two or more participants, wherein manage and maintain session comprises maintaining real-time text call session or controlling communication session by employing signaling protocol, receive request for the establishment of a text call session, establishment or set up of text call session connection based on receiving one or more types of indication from called user(s) and release or terminate of text call session connection based on receiving one or more types of indication from text call calling or called user, establish two-party (unicast) for individual text call or multiparty (multicast) sessions for group text call, transmitting a series of related messages or one or more types of contents or real-time instant messages or instant messages in the context of a communications session for conducting instant messaging in a one-to-one or one-to-many mode and to do an attachment file transfer, establishing text call session when user accepts text call or send first message within pre-set duration of receiving of request from calling user and then brought to an end text call session in the event of text call end by calling and/or called user or any other reasons, manage established text call communication session which may involve more than one message in each direction, wherein established session is the requirement to perform a connection-oriented communication, facilitate communicating parties to hold current state information and save information about the session history in order to be able to communicate, keeping track of a calling and called user's activities across sessions of interaction with the system, storing and updating text call session information, provides the mechanism for opening, closing and managing a text call session between end-user application processes, manage communication sessions which consist of requests and responses that occur between applications, wherein if a connection is not used for a long period, the text call session-layer protocol may close it and re-open it and call is only active as long as the session is active, and are ended when the text call session is disconnected, registering for presence information and receiving notifications when such events occur, managing a session of real-time messages between two or more participants, set up text call session by exchanging certain information, allows modification of existing text call calls including changing addresses or ports, inviting more participants, and adding or deleting media streams, register session, initiate a dialog for establishing a call, confirm that an entity has received a final response to an INVITE request, in the event of receiving termination signal then end a call, cancel any pending request, modify the state of a session without changing the state of the dialog, initiates a subscription for notification of events from a notifier, inform a subscriber of notifications of a new event, publish an event to a notification server, deliver a text message, normal and expedited data exchange, a quarantine service which allows the sending presentation entity to instruct the receiving text call session entity not to release data to its presentation entity without permission, interaction management so presentation entities can control whose turn it is to perform certain control functions, resynchronization of a text call session connection, reporting of unrecoverable exceptions to the presentation entity, text call session announcement and text call session invitation, maintain text call session profile or session description comprises originator and session identifier including username, unique identity, network address, protocol version number, protocol version number, session name, session title or short information, URI of description, zero or more unique identities including email address or phone number with optional name of contacts, bandwidth information, encryption key, time the session is active, zero or more repeat times, media name and transport address, media title or information field, connection information and if network not available or other reasons then retry or reconnect connection and enable to pause, restart, automatically pause or restart text call and automatically end text call based on various factors, participants of the same text call chat session are connected either to a centralized server, or in a peer-to-peer fashion, wherein the server or the peer-to-peer network keeps a roster of participants in the session, and handles participant joining and leaving, when a participant sends a message, the message is relayed by the server or the network to all participants.

In an embodiment one or more types of indications or signals or notifications of request or invitation or call in one or more forms comprises incoming call user interface with accept, reject and other controls for enabling to accept or reject call within pre-set duration else treat call as rejected call or miss call, notification including push notification, SMS notification and in-application notification for enabling to tap or click on notification or SMS to open incoming call user interface or open said requestor's or calling user's contact's associated chat or instant messaging user interface or application, incoming call indication or status within chat or instant messaging user interface for enabling to tap on contact and start communication, message with accept, reject and other controls within chat or instant messaging user interface for enabling to accept or reject request or call within user interface within pre-set duration else treat call as rejected call or miss call and directly display chat or instant messaging user interface and enable to send first message to provide indication of acceptance of request or call within pre-set duration else treat call as rejected call or miss call.

In an embodiment automatically accept text call or automatically provide one or more types of indications or signals or notifications of accepting of request or call based on monitored and tracked current location of user device and said identified location associated place and said receiving incoming text call from said place associated text call unique identity including phone number, website name, user name, email address and like, privacy settings including select contacts, preferences including type of users and schedule of automatically accept text calls or automatically accept text calls from list of unique identities or group(s) or type of users including customers, current transaction or activity or action and receiving incoming text call from said transaction or activity or action associated unique identity of text call, automated message providers including notifications, alerts, reminders, updates, status, news and triggering of one or more types of pre-defined triggers, execution of rules, recognition of voice, face or body expressions or object(s), senses, activities, actions, event(s), transactions, status, calendar entries, schedule, place or location, keywords, fields and associated values, communication, task, follow-ups and one or more types of call-to-actions and command(s).

In an embodiment one or more types of indications or signals or notifications from requestee(s) or called user (s) comprises acceptance of call, receiving call acceptance or call start command, receiving first message or acceptance of request or call in one or more forms including indication via one or more types of senses, expressions, voice commands, emoticons.

In an embodiment receiving requestor's unique identity and one or more unique identity(ies) of requestees; sending one or more types of indication or signal or invitation or notification in one or more forms to device of said one or more identity(ies) of respective requestee; in the event of, providing by the requestee, one or more types of indications or signal or acknowledgement in one or more forms including clicking or tapping on accept button or calling user's contact or contact item or pre-set region of screen of user device or user interface or providing pre-set voice command or expressions including pre-set face expression or providing particular combination of senses via utilizing sensors including shake device in particular pre-set manner, change orientation as per rules, applying of one or more types of haptic contact engagements, sending message starting sending of messages within pre-set duration of receiving of said indication or notification, or first message after receiving of said indication or notification, sending one or more types of emoticons or stickers, and sending one or more types of text or tag or command, automatically initiating or starting or establishing real-time session and displaying one or more types of applications, graphical user interfaces (GUIs), set of controls, one or more types of media and any combination thereof to requestor or caller or inviter or calling user or user and/or requestee or callee or invitee or called user or user; and in the event of, providing by the requestor and/or requestee, one or more types of session ending or termination indications in one or more forms including clicking or tapping on end button or pre-set region of screen of user device or user interface or providing pre-set voice command or expressions including pre-set face expression or providing particular combination of senses via utilizing sensors including shake device in particular pre-set manner, change orientation as per rules, applying of one or more types of haptic contact engagements, sending command message in the form of text, image, video, icon, and voice format during said established session, end or terminate said real-time session.

In an embodiment receiving requestor's unique identity and one or more unique identity(ies) of requestees; sending one or more types of indication or notification in one or more forms to device of said one or more identity(ies) of respective requestee; and enabling to initiating or establishing or restarting, holding, maintaining, updating, notifying, canceling, ending and terminating real-time session based on triggering or identification or executing of one or more types of triggers including timer, date and time, one or more types of senses of sensors, one or more types of haptic contacts including haptic contact engagement at particular pre-defined region of screen, detection of voice, recognition of object or face or expressions, selecting or executing one or more commands, actions or functions, identification of particular location, geofence, place, geocoordinates, recognition of nearby type, name of person or identity, identification of settings, preferences including auto acceptance of call within pre-set duration or user interface or application is open or online or available or pre-set status and presence information, identification of particular type or name of activity, action, event, transaction, tag, value, status and updates, and any combination thereof), rules, settings, and policies for communication including interactive information exchange, messaging, instant messaging, publishing.

In an embodiment receiving by a server, a selection of at least one user or contact or one or more types of unique identity, a request for initiating a call or send indication in one or more types or forms including particular type of haptic contact including long press at particular region of device or user interface, and a selection of type of call or a selection of one or more types of one or more applications, user interfaces and media and any combination thereof from a plurality of applications, user interfaces and media provided by one or more sources; and in the event the one or more callee accepts an initiated call or provide indication in one or more types of forms and as per rule(s) including accepts an initiated call within pre-set duration or send indication in the form of status, schedule, selected type or tag, message, and command or instruction, start communication session and presenting said selected type of call specific one or more types of one or more applications, user interfaces, media and any combination thereof or said selected one or more types of one or more applications, user interfaces, media and any combination thereof to caller and/or one or more callee.

In an embodiment receiving by a server from a user or inviter user, a selection of at least one unique identity including contact, a request for initiating real-time or near real-time communication or notification including selected or inputted type of communication including very urgent or immediate, urgent, at earliest, within particular duration, at particular scheduled time or date & time, any time or normal and selected or inputted one or more messages or contents or any form of indication of type of communication including voice, icon, image, animation, emoticon, sticker, multimedia, audio, ringtone, ringtone for pre-set duration, photo, video, code, alert or notification, call, text, status, one or more types of sensors signals or indications including one or more types of vibration, turn device on or turn device light on or off or blink and any combination thereof; sending said request for initiating real-time or near real-time communication or sending notification including selected or inputted type of communication and message(s) or content(s) to the said selected contact or invitee or sending indication in any form; and in the event the receiving user or invitee starts communication or messaging with said inviter user, logging messaging or communication from indication of start up-to indication of ending of messaging or communication including start date and time, inviter and invitee identity, end date and time, duration, selected and determined type of communication, exchanged messages or shared contents.

In an embodiment enabling to inviter or calling user and invitee or called user to send ending indication in the form of voice, icon, image, animation, emoticon, sticker, multimedia, audio, ringtone, ringtone for pre-set duration, photo, video, code, alert or notification, call, text, status, one or more types of sensors signals or indications including one or more types of vibration, turn device on or turn device light on or off or blink, select, tap on end control or button or switches and any combination thereof.

In an embodiment automatically identify, end of communication or messaging after determination of inactiveness of communication or messaging session participant user(s) for pre-set duration.

In an embodiment displaying indication of starting of communication or messaging in the form of text, icon, animation, any combination thereof.

In an embodiment displaying indication of ending of communication or messaging in the form of text, icon, animation, any combination thereof.

In an embodiment receiving by a server from a caller user, a selection of at least one unique identity including contact, a request for initiating a call; and in the event the one or more callee accepts an initiated call as per rule(s) including accepts an initiated call within pre-set duration or send first message to calling user, enabling caller and one or more callee to send and receive message(s) and one or more types of contents or media.

In an embodiment receiving by the server, a termination indication from the caller or the callee, the termination indication indicating the ending of the call and based on the termination indication, terminate the call.

In an embodiment receiving by a server from a caller user, a selection of at least one unique identity including contact, a message(s) or agenda of call or one or more types of media and a request for initiating a call; and in the event the one or more callee accepts an initiated call as per rule(s) including accepts an initiated call within pre-set duration or send first message to calling user, enabling one or more callee to view said received message(s) or agenda of call or one or more types of media and enabling caller and one or more callee to send and receive message(s) and one or more types of media.

In an embodiment receiving by a server from a caller user, a selection of at least one unique identity including contact, a message(s) or one or more types of media and a request for initiating a call; and in the event the one or more callee accepts an initiated call as per rule(s) including accepts an initiated call within pre-set duration, enabling one or more callee to receive and view the message(s) or one or more types of media.

In an embodiment enabling called user or viewing user of message to send viewing confirmation to calling user.

In an embodiment enabling callee to accept or reject calls.

In an embodiment receiving by a server from a caller user, a selection of at least one user or contact or one or more types of unique identity, a request for initiating a call and a selection of type of call or a selection of one or more types of one or more applications, user interfaces and media and any combination thereof from a plurality of applications, user interfaces and media provided by one or more sources; and in the event the one or more callee accepts an initiated call as per rule(s) including accepts an initiated call within pre-set duration, start communication session and presenting said selected type of call specific one or more types of one or more applications, user interfaces, media and any combination thereof or said selected one or more types of one or more applications, user interfaces, media and any combination thereof to caller and/or one or more callee.

In an embodiment in the event the one or more callee accepts an initiated call as per rule(s) enabling the caller and/or one or more callee in real-time to access said presented one or more types of one or more applications, user interfaces, media and any combination thereof and provide one or more types of reactions including like, dislike, rate, reshare and select or send one or more types of emoticons and stickers.

In an embodiment receiving by the server, a termination indication from the caller or the callee, the termination indication indicating the ending of the call and based on the termination indication, terminate the call or terminate said communication session or close said displayed one or more types of one or more applications, user interfaces, media and any combination thereof.

In an embodiment in the event of receiving by the server, a termination indication from the particular participant member of call, closing or hiding said displayed one or more types of one or more applications, user interfaces, media and any combination thereof from the device of said particular participant member of call.

In an embodiment in the event of initiation of call, displaying an outgoing call interface to the caller, wherein said interface enables the caller to terminate said initiated call before acceptance of call by the callee and in the event of initiation of call, presenting an incoming call interface to the callee, wherein allowing the callee to respond to the initiated communication within particular period of time or duration or as per rules, the response comprising one of: accept, reject, remind later, or respond with text.

In an embodiment one or more types of applications, interfaces, forms, web pages, web sites, user controls, user actions, functions, controls, objects and one or more types of media comprises a chat application, an instant messenger application or a messaging application, an e-mail application, a short message service (SMS) interface, MMS interface, a survey or feedback form, a profile form, a wizard, a photo viewer, a video viewer, a content viewer or a media viewer, a feed graphical user interface, one or more types of controls including like button, comment textbox, one or more types of media including a photo, a video, a text, a link, a location, an emoticons and any combination thereof, wherein enabling to select default or enable to pre-select or pre-set or pre-selection of one or more types of one or more applications, interfaces and media.

In an embodiment select user(s) or contact(s) from list of users or contacts comprises one or more types of unique identity including unique phone numbers of phone book of device, unique user name, unique identity of external websites, applications, servers, devices and social networks including Facebook, Snapchat, Twitter and Google identity, email address, unique website name, group(s), category or set of contacts and list of user(s) or contact(s).

In an embodiment show indication that real-time communication session is active in both caller computing device and the callee computing device, wherein indication including typing status, online or offline status or icon, and timer to indicate communication session is not ended.

In an embodiment before sending request to accept initiated call to the callee, check is made whether do not disturb, block, scheduled and mute applied and in the event of do not disturb, block, scheduled and mute applied, rejecting request.

In an embodiment enable and inform about pause or restart of said established call to the caller and the callee, wherein in the event of pause preventing the caller and the callee to communicate with each other and in the event of restart enabling the caller and the callee to communicate with each other.

In an embodiment receiving requestor's or calling user's unique identity and one or more unique identity(ies) of requestees or called users; sending one or more types of indications or signals or notifications of request or invitation or call in one or more forms to device of said one or more identity(ies) of respective requestee; generating and displaying, each called user specific tab comprises called user's name, icon, thumbnail of called user's profile photo or image, profile link, one or more types of controls or actions or call-to-actions including cancel call for cancelling text call before text call accepted by called user; in the event of receiving one or more types of indications or signals or notifications regarding acceptance or starting of text call, updating and displaying, each call accepted called user specific tab comprises called user's name, icon, thumbnail of called user's profile photo or image, profile link, one or more types of controls or actions or call-to-actions including end call for ending active text call and displaying chat or instant messaging user interface to calling and/or called user and enabling calling user and called user to send and receive messages; and enabling calling user to switch tab and send and view received messages related to said selected tab associated called user or contact.

In an embodiment in the event of more than one active text call and receiving incoming text call request then generating and displaying tab comprises calling user's name, icon, thumbnail of calling user's profile photo or image, profile link, one or more types of controls or actions or call-to-actions including accept, reject, remind later, respond with text incoming text call and other one or more types of controls.

In an embodiment in the event of receiving text call ending indication from calling or called user, ending text call and removing tab from calling and called user's interface.

In an embodiment in the event of receiving tab closing indication from the user, removing tab from the user interface.

In an embodiment receiving requestor's or calling user's unique identity, selected unique identity(ies) or selected group(s) identity(ies) and associated one or more unique identity(ies) of group members or requestees or called users; sending one or more types of indications or signals or notifications of request or invitation or call in one or more forms to device of said one or more identity(ies) of respective requestee; displaying or providing said one or more types of indications or signals or notifications of request or invitation or call in one or more forms and/or displaying chat or instant messaging user interface or application or said unique identity associated chat or instant messaging user interface or application or one or more types of graphical user interfaces, applications, media and any combinations thereof to each group members or requestees or called users; and in the event of receiving one or more types of indications or signals or notifications of accepting of request or call or starting of communication from at least one group member or all group members, displaying group chat or instant messaging user interface or application to said each called users.

In an embodiment in the event of ending a text call by calling user. end group text call.

In an embodiment in the event of ending a text call by group member enable said group member to leave from group text call.

In an embodiment in the event of ending of text call by all group members or at least one group member of the last remaining two group members then end text call.

In an embodiment receiving one or more types of indications or signals or notifications of incoming text call; and selecting currently active text call from list of currently active text calls and then accepting said incoming text call or accepting said incoming text call and then selecting currently active text call from list of currently active text calls to add said accepted incoming text call to said selected currently active text call.

In an embodiment in the event of providing or inputting and executing pre-defined command to start text call, displaying system message with cancel control to enable calling user to cancel outgoing text call before text call accepted by called user and sending system message to each called user(s) wherein system message comprises request to start call with accept, reject and one or more controls for enabling receiving user or called user to accept or reject or respond with text call; in the event of non-accepting text call within pre-set duration, provide indication of missed text call to calling and called user and enable called user to text call again by using recall control; in the event of rejection of text call, provide indication of rejection of text call to calling and called user; in the event of acceptance of text call, provide indication of starting of text call, initiate text call communication session and enable calling and called user to send and receive messages or one or more types of contents; in the event of providing or inputting and executing pre-defined command to end or terminate text call, ending text call, end text call communication session and provide end call indication to calling and called users of text call.

In an embodiment the graphical user interface (GUI) comprising: displaying graphical user interface comprising list of contacts; in the event of haptic contact engagement to particular contact list item and in the event of releasing haptic contact engagement from said particular contact list item, making text call to said contact list item associated contact or unique identity, displaying outgoing text call status, indication and controls including cancel control to cancel outgoing text call before acceptance of text call by said selected contact, displaying contact graphical user interface comprising highlighting calling user's contact list item and displaying status and indication of incoming text call; in the event of haptic contact engagement to said called user's contact list item and in the event of releasing haptic contact engagement from said called user's contact list item after making text call and before acceptance of text call by said called user, cancel or end said text call; in the event of non-acceptance of text call, displaying missed call indication to calling user in called user's contact list item and called user in calling user's contact list item interface; in the event of haptic contact engagement to said incoming text call associated contact's list item and in the event of releasing haptic contact engagement from said incoming text call associated contact's list item, displaying call started indication to calling user and called user, starting call duration timer, displaying or activating chat or instant messaging user interface to calling and called users and enable calling and called user to send and receive messages and one or more types of digital contents; in the event of haptic contact engagement and release from pre-defined region of screen or user interface, pausing text call and provide text call pause status and indication to calling and called user and in the event of haptic contact engagement and release from pre-defined region of screen or user interface or sending message by calling or called user, restarting said paused text call and provide text call restart status and indication to calling and called user; in the event of haptic contact engagement and release from said called user's contact list item by calling user or in the event of haptic contact engagement and release from said calling user's contact list item by called user, ending text call and not allowing calling and called users to send or receive messages and one or more types of contents and provide or view one or more types of reactions and statistics on contents.

In an embodiment receiving requestor's or calling user's unique identity and one or more unique identity(ies) of requestees or called users; send one or more types of indications or signals or notifications of request or invitation or call in one or more forms to device of said one or more identity(ies) of respective requestee; generating and displaying, each called user specific tab comprises called user's name, icon, thumbnail of called user's profile photo or image, profile link, one or more types of controls or actions or call-to-actions including cancel call for cancelling text call before text call accepted by called user; in the event of receiving one or more types of indications or signals or notifications regarding acceptance or starting of text call, updating and displaying, each call accepted called user specific tab comprises called user's name, icon, thumbnail of called user's profile photo or image, profile link, one or more types of controls or actions or call-to-actions including end call for ending active text call and displaying chat or instant messaging user interface to calling and/or called user and enabling calling user and called user to send and receive messages; enabling calling user to switch tab and send and view received messages related to said selected tab associated called user or contact; receiving requestor's or calling user's unique identity and one or more unique identity(ies) of requestees or called users and receiving request to group text call; sending one or more types of indications or signals or notifications of request or invitation or call in one or more forms to device of said one or more identity(ies) of respective requestee; generating and displaying, group text call specific tab comprises group name, icon, image, profile link of group comprises profile of each called user or member of said group, one or more types of controls or actions or call-to-actions including cancel call for cancelling text call before text call accepted by any called member of group; in the event of receiving one or more types of indications or signals or notifications regarding acceptance or starting of text call, updating and displaying, group text call specific tab comprises group name, icon, image, profile link of group comprises profile of each called user or member of said group, one or more types of controls or actions or call-to-actions including end call for ending active text call and displaying group chat or instant messaging user interface to calling and/or each called user and enabling calling user and each called user to send, receive and view messages and one or more types of contents; enabling calling user to switch tab and send and view received messages related to said selected tab associated called users or group members.

In an embodiment in the event of identifying at least one active call and receiving request of accepting incoming text call, generating and displaying tab, wherein tab comprises calling user's name, icon, profile photo and profile link and accept and reject controls and one or more types of other controls including remind me and respond with message controls for enabling called user to accept text call or reject text call or respond with message and take one or more actions.

In an embodiment in the event of cancel text call, missed text call, rejection of text call and ending of text call, removing tab called user's related tab from calling user's interface and removing calling user's related tab from called user's interface.

In an embodiment in the event of ending of group text call by calling user, end group call and remove group text call tab from all group members' interface.

In an embodiment in the event of leaving a group text call by a member of said group, remove the group text call tab from the interface of said leaving member.

In an embodiment automatically make one or more types of text call (CIM, CMS and CPR) or sub type of text calls including displaying bill for making payment text call, survey and feedback text call, offer text call, notification text call, wherein automatically make one or more types of text call based on triggering of on one or more types of pre-defined triggers including identification of current place of user device based on monitored and tracked current location of user device, receiving indication of user's transaction based on linked system or scanned receipts, identification of contextual nearby users or contacts, identification of updates including whether, stock price, sports scores, news, status and like, determination of particular type of activity, identification of data or updated data or status via linked systems, databases and one or more types of sources, detection of voice or voice command, recognition of object(s), face(s) and expressions, detection of particular date and time, schedule, time or time range, identification of entering or dwelling or exiting in particular pre-defined geofence, detection of current calendar entries related to current event, travel, meeting, viewing of particular show, movie, television program, during, after and before travelling or arriving or reaching at particular place.

In an embodiment enabling Real-time Instant Messaging (RIM) server, client applications, platform and service wherein the user expects real-time responses. In the event of sending a first message by a first user to a second user and receiving a first message from the second user, initiate or start call and in the event of non-receiving of messages after pre-set duration then treat call as end and log call including both user's identities, exchanged messages, start and end date and time. In the event of non-receiving of a first message from the second user within pre-set duration treat call as missed call or rejected call and inform both user and log call and remind first user after default or pre-set duration or intervals and remind second user after default or pre-set duration or intervals, wherein remind user via default or pre-set ringtones, vibrations, notification, message and any combinations thereof or based on settings remind when user turn on device, open application or when online. In another embodiment monitoring, tracking and logging user's real-time messaging behavior including identify how fast user sends and receives messages in each incoming and outgoing call which determine based on time gap between receiving message and responding message on said received message, calculation of total duration of call and number of messages or number of characters in total number of messages sent and received in each or all calls. In an embodiment real-time instant messaging rules including first user can send message(s) to second user only when second user's status is online or application is open or device is turn on, provide response via message, provide ranking of contacts of user based on how fast said contact respond on user's sent message(s) which determined based on pre-set range of duration or time (e.g. 1 second to 15 seconds) second user take to respond on user's last message, provide “end” or “bye” indication to end call or non-sending and non-receiving of message within pre-set duration then treat call as end. In an embodiment displaying rank with each contact (e.g. 7/10) contacts as per rank, wherein most real-time responding contact show top or provide weight to each user based on monitored and tracked real-time response behavior.

Thus, features of text calls are (1) Tap on contact to real-time start chat calling like phone calling (2) Tap on group name to start group chat calling, (3) Like phone call user can access favorite, chat call logs (recent), block contacts, miss calls, respond with text, reject call, set ringtones, mute, do not disturb options, (4) Like chat user can provide or access status, last seen, profile, current location or place, manage groups, show typing status & online status, apply privacy settings, (5) Ephemeral or saved based on calling user's allow to save settings, (6) Multi Chat Calls, (7) Add to Chat Call options, (8) Pause or restart Chat Call, (9) Integrated chat option access including input text, select emoticons, capture or select photo, record or select video, record voice message & select current location or place, (10) After phone call now Text Call is disruptive and can disrupt. Text Call is fast and more personal. It helps in delivering a relevant message to the right person at the right time.

Specification discloses different types of features of text call including (1) Favorite Contacts and Text Call favorite, (2) Text Call Logs (Recent)—Incoming, Outgoing, Cancelled & Missed Call Statistics, (3) Search Contacts for Text Call, (4) Tap on Contacts to Text Call (While Calling Showing Outgoing Call Interface to Caller and Incoming Call Interface to Calling User(s)) (a) Caller can End Call, Change Text Call to Phone, SMS, Email, Normal Chat and (b) Calling User can Accept/End Call, Remind Me Later or Respond with Text, (5) Refresh to update status, (6) Create & Manage Published Groups (like WhatsApp group) for Text Call to group, (7) Create & Manage Private Group (i.e. set of categories contacts) for Text Call to group, (8) Invite one or more selected friends who does not install Text Call, (Invite via SMS, WhatsApp, Email, Facebook etc.), (9) Select contacts/groups for Multi Text Call, (10) Select contacts/groups for Group Text Call, (11) Add to Chat Call options, (12) Block/Un-block Contacts, (13) Miss Text Calls, (14) Respond with text, (15) Reject call, (16) Set Ring Tones or Vibrate when incoming calls, (17) Set Message Alert/Notification Tone, (18) Set Vibrate when new message arrive, (19) Set Answer Vibration, (20) Set End Vibration, (21) Set Play Tone, (22) Set Pause Tone, (23) Set Wallpaper, (24) Mute (From-To), (25) Do Not Disturb options (Manual, Scheduled, Allow Call From selected, Accept Repeated Calls only, (26) Auto Reject Mode, (27) Auto Redial, (28) Integrated chat option access including input text, select emoticons, capture or select photo, record or select video, record voice message & select current location or place, (29) Play or Pause Current Call related Chat, (30) Set Font Side, (31) Ephemeral or Allow to Save, (32) View Online/Offline Status, (33) Update Status, (34) Last Seen, (35) Create & Manage Detail Profile, (36) Set & View Current Location or Check-In Place, (37) Show Typing Status, (38) Backup & Restore Saved Conversation, (39) Change Number, (40) Delete Account, (41) Logout

(42) Conversation History, (43) Share Contact, (44) View Phone Contact.

Usage and needs of text call are text Call is very much useful in your day to day activities: Instantly know that receiver received read message(s) in real-time and will respond to message(s) instantly, instantly get answer or response, instantly solve problem, instantly share photo or video and real-time get response including likes & comments from your friends. Text Call is equal to alternate of Phone Call which is non obstructed and multi-tasking) as well as real-time sending & receiving messages or sharing of photo or video, If need connect fast and then slow motion exchanging of text, photo or video (provide guarantees that user views & respond message(s) immediately), No waiting time for responses . . . like in current chat apps, Sometimes few friends are available and few not then it will delay in plan, task, activities, travel plan etc., Text Call enables same time viewing of messages and responding of messages. Like phone calls, users can immediately converse (texting) with contacts. No long waiting time for responses. Not missing someone (friends) while converse in groups. It makes your contacts quickly connectable & responsive. No matter where the user is, the user's friends are always at your fingertips. Instantly converse to your heart's content with texting, photo, video, voice to all your friends and family on Text Call, Share your favorite snaps—Got a favorite photo to share?, Send instantly it over Text Call to friends and family and instantly get response, likes, comments etc., Record life's current moments and instantly share them with the people who matter most and get their reviews, feedbacks, Feel your friends and family vary near to you, Keep your secrets safe. Send MESSAGES that auto-delete after ending of call, and Optimized for low data usage, automatically connect you to Text Call friends that are in your address book, Privacy at the core. Just register with your mobile phone no personal information required (profile is optional) and Share your best moments and expect real-time viewing and real-time responses.

Advantages of Text Call over Voice and Video Call are (a) When you travel: When you're in transit, conversing on the voice phone call can be irritating and insensitive to those around you. This is especially true for commuters in transit after a long day of work. If you're en route to dinner from the office and are running five minutes behind, shoot a quick text call to your dining companion instead of phone calling. (b) When discussing sensitive information: If you're stuck in a public place but need to have a time-sensitive conversation in which private information is being discussed, you're better off making a text call than trying to make a secretive, hushed voice or video phone call. (c) When organizing a group: When trying to corral a large group of people to confer over a point or make plans to meet, the most efficient way to do so is making a group text call that allows everyone to communicate openly, instead of reaching out to each person separately. (d) When you want your business to engage: Many businesses have been turning to texting in recent years as a way to communicate more effectively with customers. According to textrequest.com, of the 8 trillion texts sent in 2014, 95 percent were read within three minutes. Additionally, consumers are more likely to engage with text messages than voice calls or emails, making them a smart way to call attention to your business. So real-time calls are a choice over current instant messaging where customers opt-in. (e) When you're shy: For introverts or those who find themselves unnerved at the thought of expressing an important feeling or opinion in person or over the phone, texting serves as an easier option that may help you say what you need to say without bumbling over your words. These are hidden strengths of being an introvert.

Text calls differentiate over other communication technologies. At present mobile phone users receive lots of push notifications, SMS and WhatsApp or other messenger's messages and many of them are not relevant that's why there is no guarantee of real-time viewing and replying of messages. So Instant Messenger is instant in transmission or pushing of messages but not instant in viewing and replying of messages. Instant messaging (IM) technology is a type of online chat that offers real-time text transmission over the Internet. But instant messenger or messaging apps does not facilitate real-time making of call and in the event of acceptance of call, display messaging app and enable to real-time start conversations up-to end of call by caller or callee i.e. real-time viewing, replying and exchanging of messages. That's why there is a need for Text Call. If subscribers pay for voice phone calls then if they accustomed with or needed Text Call then why not they pay for Text Call? Unregistered users or users who do not install text call applications can get notification or SMS and can click on notification or link and can view incoming text call interface and can accept or reject calls. For making calls, users need to install a text call application, subscribe service (if required) and register with the server.

In an embodiment global text call (CIM/CMS/CPR) server 110 connected with client's applications and enable secure end-to-end encryption, secure cloud storage service for storing call conversations, provide multiple languages support and language translation service (any language to any other language)

In an embodiment text call (CIM/CMS/CPR) services are available for mobile network subscribers wherein text call service can use both data and cellular service to transmit messages and data in a similar fashion to making a phone call. Every smart mobile device can send and receive text messages via Text Call, which is a great substitute for voice calls in case a voice-based communication is not possible. Text call is available on all platforms and devices. Real-time texts can be sent between any two individuals who pay for the Text Call service. In other words, users can send texts to people who don't share the same operating system or software. Text call possible via data as well as cellular network—it's a phone service, you pay your mobile provider for the service. Mobile carriers offer unlimited Text Call plans as well as other plans that charge by the Text Call or put a cap on how many Text Calls and per Text call texts can be sent and received in a billing cycle. In another embodiment Text call also free to use, with the costs offset by advertising. Text call uses cellular networks to make calls and send and receive text messages, similar to making phone calls. Text call also uses data networks to make calls and send and receive text messages, similar to making VOIP calls, so users can pay mobile providers for the Text Call service as per subscribed plans.

Mobile network operator's revenue model for text calls is (a) Like Voice Calls and SMS Now Text Call bundle with Prepaid and Postpaid Tariff Plans. (b) Text Call Pay Per Text Call/Packages/Tariff Plans/Bundles for Subscribers (c) Text Call works in both cellular networks (using SMS) and Data Network, so data and SMS bundle Offers are possible with Text Call/CIM plan. (d) Text Call Service may comprise Free Data and unlimited SMS for Text Call, Cloud Storage, Ringtones, Emoticons & Stickers, Wallpapers, Templates and Conversation related Contextual contents. (e) Revenue sharing model (% of Revenge from Text Call Service Subscribers, Text Call advance volumes purchase or commitment)

Examples and use cases of Text Call (CIM/CMS/CPR) are (a) real-time general and short conversations (b) Real-time conversations on particular topic, agenda, subject, task, activity, action, event, transaction, status, updates, workflow, follow-ups, confirmation, plan, schedule, place, product, service, news. (c) Field Service Dispatch: From dispatching technicians to providing real-time incident tracking and appointment ETAs to customers. (d) Appointments and Reminders: Doctors, dentists, salons and other businesses reduce missed appointments through automated appointment confirmations, appointment changes and timely reminders. (e) Flight Info, Arrivals, and Departures: provide or request arrival and departure information by CIM using just their flight number and time. The airline will also CIM to customers with important updates such as gate changes and flight delays. (f) Bill Payment Reminders: Nobody likes missed bill payments, least of all businesses collecting payment from customers. Organizations can benefit their bottom line and customers alike by sending timely reminders by CIM when payments are almost due, on the day they are due, and when they are overdue. CIM can also be used to send details of balances remaining on loans or other credit arrangements and to encourage customers to renew a subscription or product. (g) Tracking Goods from Depot to Door: Anything that means less time waiting at home for deliveries can only be a good thing. Package delivery companies can keep customers informed by CIM. From dispatch confirmation and tracking details to giving customers the freedom to defer delivery or choose a convenient one-hour delivery slot, CIM can improve the customer experience and help delivery companies to reduce costs due to wrongly delivered or lost items. (h) Send Critical System Alerts to Those Who Matter: send out automated alerts the moment a security breach or system malfunction is discovered, ensuring the right information is delivered to the palm of those who need to know, reliably and quickly. (i) Auto Services and Auto Dealers: With CIM, you can easily get the conversation started before customers step foot in the showroom. It allows you to quickly answer questions about inventory, specific features, or hours including Test drive appointment, Service reminder, Service completion, Follow-up, Paperwork request, Inventory check. CIM helps customers remember the important stuff—and you stay in touch, no matter if it's a new lead or existing customer. ( ) Home Services: Send a quick note about estimated technician arrivals, scheduled services, or chat with customers about a busted product. User for scheduled services, “We're on Our Way”, Inventory check, Quote confirmation, Photos. (k) Medical: Appointment reminders, Office directions, Payment requests (l) Retail: Storefront directions, Inventory check, Photo exchange for repairs, Anniversary reminders, re-orders, repeat purchases, and renewals, Offers, discounts and promotions (m) Hospitality: CIM adds a hint of luxuriousness and convenience to any hospitality experience. If customers want to check room availability or check out upgrade offerings, CIM allows you to provide that information quickly and easily. Other examples are use text call for room availability check, booking confirmation, Upgrade offerings, do not disturb. (n) Transactional Messaging: The types of transactional messages include order confirmations, shipping and delivery notifications, welcome messages, and password reset links. For example, a business could send an order confirmation notification that re-directs customers to an in-app page where they can review order details and receive recommendations on what other similar purchases were. (o) Event triggers: Send targeted and behavior-based messages to customers. For example, you can help customers complete their purchase by automatically reaching out with a CIM.

Communication is the core of any business, there are infinite use cases where text call fits perfectly across all industries, few popular use cases are (a) Health Care: Lets the patients reach the clinic/hospital for checking doctor availability, booking appointment, reschedule appointment, lab test booking, getting lab test results, order medicines etc. (b) E-Commerce: Allow client to place order through all messaging application and give option to track the order, collect feedback and suggestions, conduct interactive games and quiz, collect payment etc. (c) CRM: Let customers contact the support/sales from their favorite messaging app, convert chat messages as tickets, get ticket status, create multiple chat agents and route incoming chats to different agents, create sticky agents and much more. (d) Automobile: Allow your Customers Connect you through all messaging apps for New Sales Enquires, Service Request, Service Status, Periodic Checkup Offers, Spare Parts & Accessory Enquires. (e) Grocery Shop/Restaurants: Allow clients to fill their cart and track orders through different messaging apps, Send Payment Link, Save Client address into the database/ERP/CRM automatically. (f) Education: Lets students find the best course for them, get college details, fee details, allow parents to follow their child performance, get the attendance report, mark sheet, upcoming holidays. (g) Real Estate: Lets customers retrieve the project status and project details through different messaging applications. (h) Travel: Offer customers wide range of travel services. Find best deals and offers, PNR Status Check, Availability Checks, Price Comparison, Building Custom Itinerary, Special Request etc. (i) Banking & Insurance: Request for Cheque Book, Balance Check, Lodge a Claim, find product details, get mini statement, Generate Leads, Conduct Survey, Collect Feedback & Complaints. (j) Lead Generation/Call Back: Publish Whatsapp number in all your advertisements to collect leads and call back requests.

Examples and use cases of CMS are (a) Call for providing notification, (b) Travel and tourism: One of the worst parts of traveling is being hit with unexpected delays or schedule changes. To mitigate this, travel and tourism companies will increasingly use CMS's to keep customers informed. (c) Meals: Make call to all commuters and get food order as per schedule time (interval) of call, (d) Shop: Inform opt-in customers about arrival of new products and offers, (e) Financial: Make call to confirm transaction, payment, provide receipt, provide and confirm OTP, (f) Provide Discount Coupons or Vouchers, Virtual Gifts, (g) Appointments—Reminders, confirmation, get pending payments and changes, (h) Customer support, (i) Short surveys, (j) Tracking of order, (k) Important Information: Payment and Transaction, Receipt, Meeting and Appointment Reminder, Bank related, Instalment, Credit card payment to avoid delay charges, Invitation. (l) Send Automated Transactional Alerts: Send automatic alerts about account activity, (m) Send Automated Personalized Messages (n) Send Information to Conference Attendees (o) Use a Date-Based Send: You can send messages on significant dates for each of your contacts (p) Create Multiple-Question Surveys: You can create multiple-question surveys (q) Offer a Limited Number of Coupon Codes.

The present invention uses plurality types of existing technologies, standards, protocols including application layers, singling, transport layers, internet layers, link layers, some of the examples are:

Extensible Messaging and Presence Protocol (XMPP) is a communication protocol for message-oriented middleware based on XML (Extensible Markup Language). It enables the near-real-time exchange of structured yet extensible data between any two or more network entities. The protocol used for near real-time instant messaging (IM), presence information, and contact list maintenance. Designed to be extensible, the protocol has been used also for publish-subscribe systems, signaling for VoIP, video, file transfer, gaming, the Internet of Things (IoT) applications such as the smart grid, and social networking services. The XMPP network uses a client-server architecture. Every user on the network has a unique XMPP address, called JID. The JID is structured like an email address with a username and a domain name (or IP address) for the server where that user resides, separated by an at sign (@), such as username@example.com. Since a user may wish to log in from multiple locations, they may specify a resource. A resource identifies a particular client belonging to the user (for example home, work, or mobile). This may be included in the JID by appending a slash followed by the name of the resource. For example, the full JID of a user's mobile account could be username@example.com/mobile.

The Session Description Protocol (SDP) is a format for describing multimedia communication sessions for the purposes of session announcement and session invitation. Its predominant use is in support of streaming media applications, such as voice over IP (VoIP) and video conferencing. SDP does not deliver any media streams itself, but is used between endpoints for negotiation of network metrics, media types, and other associated properties. The set of properties and parameters are often called a session profile. SDP is extensible for the support of new media types and formats. SDP was originally a component of the Session Announcement Protocol (SAP), but found other uses in conjunction with the Real-time Transport Protocol (RTP), the Real-time Streaming Protocol (RTSP), Session Initiation Protocol (SIP), and even as a standalone protocol for describing multicast sessions. Multimedia is content that uses a combination of different content forms such as text, audio, images, animations, video and interactive content. Session Announcement Protocol (SAP) is an experimental protocol for broadcasting multicast session information. SAP typically uses Session Description Protocol (SDP) as the format for Real-time Transport Protocol session descriptions. Announcement data is sent using IP multicast and User Datagram Protocol. Under SAP, senders periodically broadcast SDP descriptions to a well-known multicast address and port. An SAP listening application can listen to the SAP multicasts and construct a guide of all advertised multicast sessions.

The Session Initiation Protocol (SIP) is a signaling protocol used for initiating, maintaining, and terminating real-time sessions that include voice, video and messaging applications. SIP is used for signaling and controlling multimedia communication sessions in applications of Internet telephony for voice and video calls, in private IP telephone systems, in instant messaging over Internet Protocol (IP) networks as well as mobile phone calling over LTE (VoLTE).

The protocol defines the specific format of messages exchanged and the sequence of communications for cooperation of the participants. SIP is a text-based protocol, incorporating many elements of the Hypertext Transfer Protocol (HTTP) and the Simple Mail Transfer Protocol (SMTP). A call established with SIP may consist of multiple media streams, but no separate streams are required for applications, such as text messaging, that exchange data as payload in the SIP message. SIP works in conjunction with several other protocols that specify and carry the session media. Most commonly, media type and parameter negotiation and media setup are performed with the Session Description Protocol (SDP), which is carried as payload in SIP messages. SIP is designed to be independent of the underlying transport layer protocol, and can be used with the User Datagram Protocol (UDP), the Transmission Control Protocol (TCP), and the Stream Control Transmission Protocol (SCTP). For secure transmissions of SIP messages over insecure network links, the protocol may be encrypted with Transport Layer Security (TLS). For the transmission of media streams (voice, video) the SDP payload carried in SIP messages typically employs the Real-time Transport Protocol (RTP) or the Secure Real-time Transport Protocol (SRTP). SIP is only involved in the signaling operations of a media communication session and is primarily used to set up and terminate voice or video calls. SIP can be used to establish two-party (unicast) or multiparty (multicast) sessions. It also allows modification of existing calls. The modification can involve changing addresses or ports, inviting more participants, and adding or deleting media streams. SIP has also found applications in messaging applications, such as instant messaging, and event subscription and notification. SIP works in conjunction with several other protocols that specify the media format and coding and that carry the media once the call is set up. For call setup, the body of a SIP message contains a Session Description Protocol (SDP) data unit, which specifies the media format, codec and media communication protocol. Voice and video media streams are typically carried between the terminals using the Real-time Transport Protocol (RTP) or Secure Real-time Transport Protocol (SRTP). SIP is a text-based protocol with syntax similar to that of HTTP. There are two different types of SIP messages: requests and responses. The first line of a request has a method, defining the nature of the request, and a Request-URI, indicating where the request should be sent. The first line of a response has a response code. Requests initiate a functionality of the protocol. They are sent by a user agent client to the server, and are answered with one or more SIP responses, which return a result code of the transaction, and generally indicate the success, failure, or other state of the transaction. the Message Session Relay Protocol (MSRP) is a protocol for transmitting a series of related instant messages in the context of a communications session. An application instantiates the session with the Session Description Protocol (SDP) over Session Initiation Protocol (SIP) or other rendezvous methods. In computer science and networking in particular, a session is a temporary and interactive information interchange between two or more communicating devices, or between a computer and user (see login session). A session is established at a certain point in time, and then ‘torn down’—brought to an end—at some later point. An established communication session may involve more than one message in each direction. A session is typically stateful, meaning that at least one of the communicating parties needs to hold current state information and save information about the session history in order to be able to communicate. An established session is the basic requirement to perform a connection-oriented communication. A session also is the basic step to transmit in connectionless communication modes. However, any unidirectional transmission does not define a session. A session identifier, session ID or session token is a piece of data that is used in network communications (often over HTTP) to identify a session, a series of related message exchanges. The session layer provides the mechanism for opening, closing and managing a session between end-user application processes, i.e., a semi-permanent dialogue. Communication sessions consist of requests and responses that occur between applications. Session-layer services are commonly used in application environments that make use of remote procedure calls (RPCs). A communication protocol is a system of rules that allow two or more entities of a communications system to transmit information via any kind of variation of a physical quantity. The protocol defines the rules, syntax, semantics and synchronization of communication and possible error recovery methods. Protocols may be implemented by hardware, software, or a combination of both. Communicating systems use well-defined formats for exchanging various messages. Each message has an exact meaning intended to elicit a response from a range of possible responses pre-determined for that particular situation. The specified behavior is typically independent of how it is to be implemented. Communication protocols have to be agreed upon by the parties involved. Multiple protocols often describe different aspects of a single communication. A group of protocols designed to work together is known as a protocol suite; when implemented in software they are a protocol stack. Messages are sent and received on communicating systems to establish communication. Protocols should therefore specify rules governing the transmission. In general, much of the following should be addressed: Data formats for data exchange, Address formats for data exchange (Addresses are used to identify both the sender and the intended receiver(s). A connection between a sender and a receiver can be identified using an address pair (sender address, receiver address).), Address mapping, Routing, Detection of transmission errors, Acknowledgements, Loss of information—timeouts and retries, Direction of information flow, Sequence control, Flow control and Queueing (Communicating processes or state machines employ queues (or “buffers”), usually FIFO queues, to deal with the messages in the order sent, and may sometimes have multiple queues with different prioritization).

In an embodiments receiving from a first user by a server, selection of control or button from a website or webpage from a web browser, wherein control or button associated with a website domain name or a uniform resource locator (URL); invoking or opening a client application from a mobile device of the first user or enabling a client application of user mobile device to access the website domain name or the uniform resource locator (URL); receiving by a server from a mobile client application of a first user, the website domain name or the uniform resource locator (URL), a request or an invitation for initiating a live chat; receiving from a second user by a server, selection of control or button from a website or webpage from a web browser, wherein control or button associated with a website domain name or a uniform resource locator (URL); invoking or opening a client application from a mobile device of the second user or enabling a client application of user mobile device to access the website domain name or the uniform resource locator (URL); receiving by a server from a mobile client application of a second user, a website domain name, a request or an invitation for initiating a live chat; puts the request or invitation for initiating a communication including live chat from the first user and the second user in a communication including live chat queue of the website or a uniform resource locator (URL) associated account, for available or identified or relevant agents to pick up; routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept chats status turn on by agent; when all agents have one communication including live chat each, the next round will be distributed and it will go on until the concurrent communication including live chat limit of all the agents accepting communication including live chats at the time is reached; with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued chats list or list of requests or invitations for initiating a communication including live chat or selecting particular request or invitation for initiating a communication including live chat from the queued communication including live chats list or list of requests or invitations for initiating a communication including live chat and selecting or clicking or tapping on associated start communication including live chat control or button or by using a keyboard shortcut or by issuing voice command or by sending or responding or replying message.

In an embodiments based on uniform resource locator (URL) identifying website domain name associated sub-account or unique identity of website associated user including vendor or seller, advertiser, listing user, publisher, service provider, developer,

In an embodiments receiving by a server from a mobile client application of a first user, request for cancelling the request or the invitation for initiating a communication including live chat; and cancel the request or the invitation for initiating a communication including live chat.

In an embodiments enabling connected first user and the second user associated connected available agent to exchanges messages.

In an embodiments displaying online status, typing indicator, and message read receipts.

In an embodiments receiving by a server from a mobile client application of a first user, selection of an option from displayed menu, a request or an invitation for initiating a communication including live chat; automatically routing request or invitation for communication including live chat to menu option associated agent or available agent from agents.

In an embodiments in the event of selecting end button or control by the agent or user, ending communication including live chat session.

In an embodiments in the event of selecting end button or control by the agent or the user, ending communication including live chat session and store conversation between start and end session.

In an embodiments allowing owner or admin to set a limit to the number of chats each agents can have at a time by providing settings or editing agent profile.

In an embodiments as soon as one of the agents picks up a chat, others won't be able to do so.

In an embodiments user who are in queue can view queuing status in the form of in-queue icon or animation.

In an embodiments in routing between groups, communication including live chats are also distributed according to groups, wherein automatic communication including live chat routing distributes communication including live chats from a specific group to agents from that group and with the manual communication including live chat selection enabled, only agents from a particular group will receive a notification when a new communication including live chat for that group is available.

In an embodiments admin or agent can transfer communication including live chat between various groups.

In an embodiments displaying communication including live chat request within agent client application, for enable agent to starting the communication including live chat session.

In an embodiments active communication, initiated manually by the agent or automatically by the communication including live chat system as soon as the requestor of communication including live chat meets the predefined criteria, wherein predefined criteria comprises searched keyword, time spend on website or application, encountered error, add to cart one or more or particular numbers or amounts of products and services, wherein once the criteria is met, communication including live chat displays a invitation with a customized message.

In an embodiments enabling agent to view how long a visitor has been waiting to communication including live chat.

In an embodiments displaying pre-communication including live chat survey, wherein pre-communication including live chat survey comprises customer number or user name, PIN, order number, name, selected option from menu, company name, contact information including email.

In an embodiments automatically fill pre-communication including live chat survey form or associated fields and values based on stored identified structured information related to user.

In an embodiments enabling owner or admin to set queue limits, wherein queue limits is the maximum number of communication including live chat users allowed in communication including live chat queue at any one time.

In an embodiments when queue exceeds the set limit, disabling or automatically make unavailable communication including live chat option and any new requestor won't be able to request a communication including live chat session, and will instead see an offline message.

In an embodiments give waiting communication including live chat requesting users, key information such as estimated wait times and alternate support options.

In an embodiments enabling user to show or hide user identity and user profile information including photo, user name, user account name, user identity, phone number, email address, and one or more types of address(es) and user device location information.

In an embodiments receiving, by a server, from a first computing device of a first user automatically identified currently viewing website domain name or a uniform resource locator (URL), wherein automatically identifying currently viewing website domain name or a uniform resource locator (URL) via in-application browser, in-application browser control, application programming interfaces (APIs) and software development toolkits (SDKs) and in user's device installed add-ons and in-browser(s) installed plug-in(s) or add-ons or control(s) or integrated feature or function; receiving, by the server, from a mobile client application of a first user, said automatically identified website domain name or the uniform resource locator (URL), a request or an invitation for initiating a communication including live chat; receiving, by a server, from a second computing device of a second user, automatically identified currently viewing website domain name or a uniform resource locator (URL); receiving, by the server, from a mobile client application of the second user, said automatically identified website domain name or the uniform resource locator (URL), a request or an invitation for initiating a communication including live chat; puts the request or invitation for initiating a communication including live chat from the first user and the second user in a communication including live chat queue of the website or the uniform resource locator (URL) associated account, for available or identified or relevant agents to pick up; routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept communication including live chats status turn on by agent; when all agents have one communication including live chat each, the next round will be distributed and it will go on until the concurrent communication including live chat limit of all the agents accepting communication including live chats at the time is reached; with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued communication including live chats list or list of requests or invitations for initiating a communication including live chat or selecting particular request or invitation for initiating a communication including live chat from the queued chats list or list of requests or invitations for initiating a communication including live chat and selecting or clicking or tapping on associated start communication including live chat control or button or by using a keyboard shortcut or by issuing voice command or by sending or responding or replying message.

In an embodiments displaying available for live communication including live chat status of contacts including phone contacts of user; receiving by a server from a mobile client application of a first user, a selection of a phone number of a second user from a live communication including live chat available status contact list, a request or an invitation for initiating a live communication including live chat and a first message; receiving by a server from a mobile client application of a third user, a selection of a phone number of a second user from a live communication including live chat available status contact list, a request or an invitation for initiating a live communication including live chat and a first message; starting live communication including live chat session of the second user with the first user and displaying the first message from the first user to the second user in the first user related live communication including live chats; and starting live communication including live chat session of the second user with the third user and displaying the first message from the third user to the second user in the third user related live communication including live chats.

In an embodiments receiving from the second user available for live communication including live chat status and selected one or more contacts or groups for publishing or advertising or sharing said updated status of the second user in said list of contacts who are available for live communication including live chat user interface of selected one or more contacts or groups.

In an embodiment in the event of non-replying or non-responding message of the first user by the second user within pre-set duration, notifying the second user to respond message or turn off available for live communication including live chat status.

In an embodiments enabling the second user to select waiting length of duration from list of pre-defined waiting length of duration; sending request to the first user to wait for live communication including live chat for said selected length of duration by the second user; start timer; display timer; in the event of receiving response from the second user within said length of duration, stop timer and hid wherein displaying of timer and in the event of not receiving response from the second user within said length of duration, turn off live communication including live chat availability status of the second user.

In an embodiments status comprises available or not available for live communication including live chat, available or not available for live video & audio or voice conversation, available or not available for live audio or voice conversation, wait for pre-set duration, re-start, pause & end live communication including live chat, offline for pre-set duration or available from or calendar or schedule dates and time of live communication including live chat availability, type of communication channel or medium or interface including live chat, voice and video communication or call.

In an embodiment ranking user for live communication including live chat based on average response time, frequency and duration for availability for live communication including live chat, response time or non-availability after turning on available for live communication including live chat status.

In an embodiment enabling users to show or hide user identity and user profile information including photo, user name, user account name, user identity, phone number, email address, and one or more types of address(es) and user device location information.

In an embodiments receiving by a server from a mobile client application of a first user, a selection of a phone number of a second user from a contact list, a request or an invitation for initiating a communication including live chat; receiving by a server from a mobile client application of a third user, a selection of a phone number of a second user from a contact list, a request or an invitation for initiating a communication including live chat; puts the request or invitation for initiating a communication including live chat from the first user and the third user in a communication including live chat queue, for available or identified or relevant agents to pick up; routing request or invitation for initiating a communication including live chat from the first user and the third user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique phone number associated first available agent with the accept communication including live chats status turn on by agent; when all agents have one communication including live chat each, the next round will be distributed and it will go on until the concurrent communication including live chat limit of all the agents accepting communication including live chats at the time is reached; with manual request or invitation for initiating a communication including live chat routing, the request or invitation for initiating a communication including live chat of the first user and the third user will be directed to the queue and all agents with the accept communication including live chats status will receive a notification about that event, and can pick up the displayed request or invitation for initiating a communication including live chat of the first user or the third user from the queue and start a communication including live chat, wherein start a communication including live chat by selecting particular request or invitation for initiating a communication including live chat from the queued communication including live chats list or list of requests or invitations for initiating a communication including live chat or selecting particular request or invitation for initiating a communication including live chat from the queued chats list or list of requests or invitations for initiating a communication including live chat and selecting or clicking or tapping on associated start communication including live chat control or button or by using a keyboard shortcut or by issuing voice command or by sending or responding or replying message.

In an embodiments receiving by a server from a mobile client application of a first user, a selection of a phone number of a second user from a contact list, a request or an invitation for initiating a communication including live chat and a first message; in the event of starting communication including live chat or accepting request, displaying message to the connected communication including live chat agent.

In an embodiments receiving by a server from a mobile client application of a first user, a selection of a phone number of a second user from a contact list, a request or an invitation for initiating a communication including live chat; receiving by a server from a mobile client application of a first user, request for cancelling the request or the invitation for initiating a communication including live chat; and cancel the request or the invitation for initiating a communication including live chat.

In an embodiment enabling connected first user and the second user associated connected available agent to exchange messages.

In an embodiment displaying online status, typing indicator, and message read receipts.

In an embodiments receiving by a server from a mobile client application of a first user, a selection of a phone number of a second user from a contact list and a selection of an option from displayed menu, a request or an invitation for initiating a communication including live chat; automatically routing request or invitation for communication including live chat to menu option associated agent or available agent from agents.

In an embodiment in the event of selecting the end button or control by the agent of the phone number associated with the second user or the requesting first user, ending communication including live chat session.

In an embodiment in the event of selecting the end button or control by the agent of the phone number associated with the second user or the requesting first user, ending communication including live chat session and store conversation between start and end session.

In an embodiment allowing the owner or admin to set a limit to the number of communication including live chats each agent can have at a time by providing settings or editing agent profiles.

In an embodiment as soon as one of the agents picks up a communication including live chat, others won't be able to do so.

In an embodiment, users who are in queue can view queuing status in the form of in-queue icon or animation.

In an embodiments in routing between groups, communication including live chats are also distributed according to groups, wherein automatic communication including live chat routing distributes communication including live chats from a specific group to agents from that group and with the manual communication including live chat selection enabled, only agents from a particular group will receive a notification when a new communication including live chat for that group is available.

In an embodiment admin or agent can transfer communication including live chats between various groups.

In an embodiment displaying communication including live chat request within agent client application, for enabling agent to start the communication including live chat session.

In an embodiments active communication, initiated manually by the agent or automatically by the communication including live chat system as soon as the requestor of communication including live chat meets the predefined criteria, wherein predefined criteria comprises searched keyword or products and services in catalogue, time spend on viewing catalogues of products and services, add to cart one or more or particular numbers or amounts of products and services, wherein once the criteria is met, communication including live chat displays a communication including live chat invitation with a customized message.

In an embodiment enabling agents to view how long a visitor has been waiting to communicate including live chat.

In an embodiment displaying pre-communication including live chat survey, wherein pre-communication including live chat survey comprises customer number or user name, PIN, order number, name, selected option from menu, company name, contact information including email.

In an embodiment automatically fill pre-communication including live chat survey form or associated fields and values based on stored identified structured information related to the user.

In an embodiment enabling the owner or admin to set queue limits, wherein queue limits is the maximum number of communication including live chat users allowed in communication including live chat queue at any one time.

In an embodiment when the queue exceeds the set limit, disabling or automatically making unavailable communication including live chat option and any new requestor won't be able to request a communication including live chat session, and will instead see an offline message.

In an embodiment give waiting communication including live chat requesting users, key information such as estimated wait times and alternate support options.

In an embodiment enabling users to show or hide user identity and user profile information including photo, user name, user account name, user identity, phone number, email address, and one or more types of address(es) and user device location information.

In an embodiments allowing to list or integrate or provide one or more types of actions, interfaces, features, contents of websites and applications; enabling client application including mobile client application of user device to access, input, search, and select type of action or interface or feature of website and application and name of website or application or business or account or one or more types of unique identity related to particular entity; displaying selected type specific selected website or application or unique identity associated action or interface or feature; and enabling user to access said selected type specific selected website or application or unique identity associated action or interface or feature from client application including single mobile client application.

In an embodiment monitoring, tracking, and logging user interactions, activities, status, actions and reactions with selected one or more types specific actions, interfaces, features of websites and applications and enabling authorized person account holders to access said logs.

In an embodiments one or more types of actions, interfaces, features of websites and applications comprises live chat, phone or voice communication or call, video communication or call, about, help, survey, feedback, complaints, contact, email, phone number, profiles of professionals, address, location, maps and directions, products, services, book, order, buy, get appointment, subscribe, contact form, price, offers, rewards, memberships, customer support, company profile, investor relationships, news, blog, polls, videos, posts, reviews, sign-up, search, payments, social networks including Facebook, Twitter, Instagram, LinkedIn.

In an embodiment allowing to list uniform resource locator (URL) and details of one or more types of actions, interfaces, features, contents related to a website and application.

In an embodiment allowing to integrate one or more types of actions, interfaces, features, contents of particular website and application via software development toolkits (SDKs) and application programming interfaces (APIs).

In an embodiments enabling registered or authorized website or application or business account or account holder to select generalized type of action or feature or application and enable to input, select, import, update or provide one or more types of contents, data or upload, register, list, attach, integrate one or more functions, actions, call-to-actions, interfaces, applications, objects, widgets, forms.

In an embodiment verifying, listing and making available or making searchable for users of a network said features, actions, interfaces, applications, forms, data, contents related to websites, applications and accounts.

In an embodiment enabling users to switch opened tabs, one or more selected types of features related to selected websites or applications or uniform resource locator (URL).

In an embodiment enabling users to show or hide user identity and user profile information including photo, user name, user account name, user identity, phone number, email address, and one or more types of address(es) and user device location information.

In an embodiments integrating within mobile client application, communication including live chat interface or webpage or application or uniform resource locator (URL) of chat interface or webpage or application of respective external or 3rd parties domains including applications and websites; receiving, by the server, from user selection of communication including live chat related to particular website or application from list of integrated communication including live chats of external or 3rd parties domains; invoking or opening communication including live chat interface or webpage or application related to selected website or application; connecting user with available communication including live chat agent; enabling user and connected agent to exchange messages; and storing and logging communication including live chats conversation.

In an embodiment enabling users to switch opened tabs, one or more selected websites or applications or uniform resource locator (URL) associated communication including live chats.

In an embodiments in the event of visiting one or more websites in one or more browsers of one or more user devices including desktop, mobile smartphone, tablet, laptop, automatically identifying currently visiting one or more websites domain names or uniform resource locators (URLs) and enabling mobile client application to receive and access said identified websites domain names or uniform resource locators (URLs)

In an embodiment enabling users to search and select one or more website names, business names, place of business(es), shop name(s), or one or more types of entity name(s) or identity(ies).

In an embodiment enabling users to browse categories directories and select one or more website names, business names, place of business(es), shop name(s), or one or more types of entity name(s) or identity(ies).

In an embodiments enabling user to select one or more website names, business names, place of business(es), shop name(s), or one or more types of entity name(s) or identity(ies) from one or more categories lists including currently visiting websites or business(es) applications, bookmarked, past conversed.

In an embodiment integrating within mobile client application, chat widget related to external or 3r parties domains.

In an embodiment use web browser control or integrated web browser via related APIs/SDKs to invoke or open or display, selected communication including live chat interface or application or web page.

In an embodiment enabling users to access, view, search, export, share past stored communication including live chats conversation.

In an embodiments mobile device sensors via mobile client application for getting monitored and tracked user device current location and associated identified place,

In an embodiment providing general customization, privacy settings, sharing settings, presentation settings for all or selected communication including live chats including interface, text fonts, color and size, wallpaper, share data and apply to all or selected communication including live chats interface.

In an embodiment in the event of ending of communication including live chats session, storing and logging communication including live chats conversation.

In an embodiments integrating external or 3rd parties domains including applications and websites' communication including live chat interface or webpage or application via displaying URL

In an embodiments integrating external or 3rd parties domains including applications and websites' communication including live chat interface or webpage or application via APIs/SDKs

In an embodiments integrating external or 3rd parties domains including applications and websites' communication including live chat interface or webpage or application via APIs/SDKs related to respective communication including live chat software

In an embodiment the selected website or application associated communication including live chat widget allows the user to contact the chat agents directly from a mobile application, wherein the widget can integrate into the central app via APIs/SDKs.

In an embodiments receiving from a first user by a server, selection of control or button integrated within browser; in the event of selection of control or button, identifying currently viewing website domain name or a uniform resource locator (URL); invoking or opening a client application from a mobile device of the first user or enabling a client application of user mobile device to access the website domain name or the uniform resource locator (URL); receiving by a server from a mobile client application of a first user, the website domain name or the uniform resource locator (URL), a request or an invitation for initiating a communication including live chat; receiving from a second user by a server, selection of control or button from a website or webpage from a web browser, wherein control or button associated with a website domain name or a uniform resource locator (URL); invoking or opening a client application from a mobile device of the second user or enabling a client application of user mobile device to access the website domain name or the uniform resource locator (URL); receiving by a server from a mobile client application of a second user, a website domain name, a request or an invitation for initiating a communication including live chat; puts the request or invitation for initiating a communication including live chat from the first user and the second user in a communication including live chat queue of the website or the uniform resource locator (URL) associated account, for available or identified or relevant agents to pick up; routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept communication including live chats status turn on by agent; when all agents have one communication including live chat each, the next round will be distributed and it will go on until the concurrent communication including live chat limit of all the agents accepting communication including live chats at the time is reached; with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued communication including live chats list or list of requests or invitations for initiating a communication including live chat or selecting particular request or invitation for initiating a communication including live chat from the queued communication including live chats list or list of requests or invitations for initiating a communication including live chat and selecting or clicking or tapping on associated start communication including live chat control or button or by using a keyboard shortcut or by issuing voice command or by sending or responding or replying message.

In an embodiment enable or disable web browser integrated communication including live chat button based on availability or non-availability of communication including live chat or availability or non-availability of communication including live chat current status associated with currently viewing website.

In an embodiment in the event of closing an opened website or webpage in browser, based on settings automatically end communication including live chat or notifying user and agent to end communication including live chats.

In an embodiments receiving unique website domain name or phone number or account name or name or keyword(s) and message with sender's unique identity (UID) from sender's device; identifying website domain name or account name or name or keyword(s) associated phone number or use received phone number; generating short link and associating details including sender's identity, said received message from sender, sender's nick name and optionally based on sender's privacy settings, sender's name, phone number, email, contact information and identity or website visitor's information, recipient's name, business name, website, phone number and identity, date and time of sending message; generating SMS/message for said identified or received phone number, wherein generating SMS/message based on or generated message comprises generated short link, general message template and details including sender's nick name and optionally sender's name, contact information, identity and phone number; and sending said generated SMS/instant message to said phone number associated user device; in the event of selecting short link from received SMS or message or received message related notification or notification associated action control or button by recipient, generating and opening webpage or invoking generated webpage or user interface in web browser or web viewer and displaying full or partial message and sender's or visitor's details and enabling to respond or send message from webpage or user interface to sender on sender's device via SMS or message based on sender's phone number or optionally instructing recipient user to install and register application and then send message or reply message from installed application.

In an embodiments receiving by a server from a mobile client application of a first user, inputted or automatically identified and selected or manually selected website domain name or uniform resource locator (URL), a request or an invitation for initiating a communication including live chat; receiving by a server from a mobile client application of a third user, a website domain name or uniform resource locator (URL), a request or an invitation for initiating a communication including live chat; puts the request or invitation for initiating a communication including live chat from the first user and the third user in a communication including live chat queue of the website or a uniform resource locator (URL) associated account, for available or identified or relevant agents to pick up; routing request or invitation for initiating a communication including live chat from the first user and the third user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept communication including live chats status turn on by agent; when all agents have one communication including live chat each, the next round will be distributed and it will go on until the concurrent communication including live chat limit of all the agents accepting communication including live chats at the time is reached; with manual request or invitation for initiating a communication including live chat routing, the request or invitation for initiating a communication including live chat of the first user and the third user will be directed to the queue and all agents with the accept communication including live chats status will receive a notification about that event, and can pick up the displayed request or invitation for initiating a communication including live chat of the first user or the third user from the queue and start a communication including live chat, wherein start a communication including live chat by selecting particular request or invitation for initiating a communication including live chat from the queued communication including live chats list or list of requests or invitations for initiating a communication including live chat or selecting particular request or invitation for initiating a communication including live chat from the queued communication including live chats list or list of requests or invitations for initiating a communication including live chat and selecting or clicking or tapping on associated start communication including live chat control or button or by using a keyboard shortcut or by issuing voice command or by sending or responding or replying message.

In an embodiments automatically identifying, selecting, or displaying for user selection currently viewing website domain name or a uniform resource locator (URL) via in-application browser, in-application browser control, application programming interfaces (APIs) and software development toolkits (SDKs) and in user's device installed add-ons and in-browser(s) installed plug-in(s) or add-ons or control(s) or integrated feature or function.

In an embodiments enabling user to select one or more website domain name(s) or a uniform resource locator (URLs) from one or more lists including categories, bookmarked, past used, or search results. In an embodiments suggesting website domain name(s) or a uniform resource locator (URLs) based on monitored and tracked user device current location or associated identified place, scanned code including QR code or object(s), voice command, recognizing user voice associated identified keywords, past visited places, activities including digital activities, interacted entities, transactions, linked systems, incoming notifications, emails, messages and one or more types of communications, calendar entries, sharing, search results, user profile and user related data, user added or created lists of website domain name(s) or a uniform resource locator (URLs).

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified. For a better understanding of the present invention, reference will be made to the following Detailed Description, which is to be read in association with the accompanying drawings, wherein:

FIG. 1 is a network diagram depicting a network system having a client-server architecture configured for exchanging data over a network implementing various embodiments comprises enabling text call or text calling services including Call For Instant Messaging (CIM) Service, Call For Sending Message/SMS (CMS) Service and Call For Posting & Getting Reactions (CPR) Service, receive registration request, verify and store and receive request to access user's unique identity(ies), profile and settings, import, update and store phone contacts, emails, and unique identities from other sources, receive request to call for real-time messaging to one or more unique identity(ies), receive request to call for sending and displaying message or SMS to one or more unique identity(ies) and receive request to call for sending and displaying post to one or more unique identity(ies).

FIG. 2 illustrates components of an electronic device implementing various embodiments of text call including enabling to send request to call for real-time messaging to one or more unique identity(ies), send and receive messages and contents, and send request to update and access profile, settings, logs, contacts, status, groups, backups, messages, posts or contents, locations and other user and user related unique identities including contacts related data.

FIG. 3 illustrates exemplary graphical user interfaces (GUIs) describing installation of the one or more applications including one or more or in any combinations embodiments or features described in this specification.

FIG. 4 illustrates exemplary graphical user interfaces (GUIs) for enabling users to register with the server 110 or system.

FIG. 5 illustrates exemplary graphical user interfaces (GUIs) for enabling users to provide image, user name. After completion of registration, user can add new contacts with details

FIG. 6 illustrates exemplary graphical user interfaces (GUI) displaying contacts who have text call application or who download, installed and registered application or who registered online application (described in detail in FIGS. 3 to 5) for enabling user to view, search and add or update contacts, tap or click on particular contact to make text call, select one or more contacts to make multi calls or dynamic group calls, select one or more group(s) and/or contacts to make group call, view online status, view updates, view profile information, settings of selected contact or unique identity.

FIG. 7 illustrates exemplary outgoing text call graphical user interfaces (GUI) (FIG. 7 (A)) and incoming text call graphical user interfaces (GUI) (FIG. 7 (B)).

FIG. 8 illustrates exemplary graphical user interfaces (GUI) wherein calling user and/or called user can send and receive & view messages, share contents, view status and updates, pause and restart messaging, save conversations, select and input or take one or more types of contents including text, photo, voice, audio, image, video, location information, uniform resource location (URL) or links or web address or hyperlinks during established call session.

FIG. 9 illustrates exemplary graphical user interfaces (GUI) wherein users can manage favorite contacts and one or more types of unique identities.

FIG. 10 illustrates exemplary graphical user interfaces (GUI) wherein users can view logged calls and associated details.

FIGS. 11-12 illustrates exemplary graphical user interfaces (GUI) wherein enabling users to add or update new contacts and view selected particular contact associated detail information, status, associated groups, view associated current settings, and various types of controls for providing settings.

FIG. 13 illustrates exemplary graphical user interfaces (GUI) wherein enabling users to add, update and remove one or more types of one or more groups including public and private groups, add, update and remove one or more members to one or more selected groups.

FIG. 14 illustrates exemplary graphical user interfaces (GUI) wherein enabling the user to view create groups, select one or more groups from list of created groups and make one or more types of text calls. Users can also view selected group specific information and settings.

FIG. 15 illustrates exemplary graphical user interfaces (GUI) wherein enabling user to select one or more contacts and/or one or more types of unique identity(ies) and make multiple text calls or different types of text calls to each individual said selected one or more contacts and/or one or more types of unique identity(ies). User can manage one or more types of one or more text calls within user interface including switch among current one or more types of one or more text calls and send and view received messages and one or more types of contents, accept or reject incoming text call(s), select one or more contacts and/or one or more types of unique identity(ies) and make new text call(s), select one or more contacts and/or one or more types of unique identity(ies) and make text call and add said call accepted user to selected or current text call and add incoming one or more text call(s) to selected or current text call for enabling to participate in call and send and receive messages and contents.

FIG. 16 illustrates exemplary graphical user interfaces (GUI) wherein enabling user to select one or more types of one or more groups and make one or more types of one or more group text call(s) and in the event of call acceptance by one or more members of said selected one or more groups, enabling call accepted users or members to send and receive or share messages or contents.

FIG. 17 illustrates exemplary graphical user interfaces (GUI) wherein enabling user to make one or more types of one or more text calls within currently active text calls by selecting one or more contacts and/or one or more types of unique identity(ies) and make one or more types of one or more text calls.

FIG. 18 illustrates exemplary graphical user interfaces (GUI) wherein enabling the user to select one or more contacts and/or one or more types of unique identity(ies) and make text call and add said call accepted user to selected or current text call.

FIG. 19 illustrates exemplary graphical user interfaces (GUI) wherein enabling the user to add incoming one or more text call(s) to selected or current text call for enabling to participate in call and send and receive messages and contents.

FIG. 20 (A) illustrates exemplary graphical user interfaces (GUI) wherein users can update status. In another embodiment FIG. 20 (B) illustrates exemplary graphical user interfaces (GUI) wherein the user is configured to select contacts and invite downloading, installing and registering or subscribing text all application(s) and service(s).

FIGS. 21-22 illustrates exemplary graphical user interfaces (GUI) wherein user is configured to view and update user profile details, view and update various types of settings including account settings, text call settings, privacy settings and notification settings, view helps and get support, provide feedbacks and reports, and view terms and privacy.

FIGS. 23-24 illustrates exemplary graphical user interfaces (GUI) wherein user is adapted to make one or more types of text calls including Call For Instant Messaging (CIM) Service, Call For Sending Message/SMS (CMS) Service and Call For Posting & Getting Reactions (CPR) Service directly from or inside phone contacts of phone application of user device, outgoing phone call interface of phone application of user device, and phone dialer of phone application of user device.

FIG. 25 illustrates exemplary graphical user interfaces (GUI) for enabling user to select one or more contacts and/or group(s) and/or one or more types of unique identity(ies) and make call for sending message or short message (SMS) and in the event of call acceptance by callee, displaying said message or short message (SMS) to called user(s). In another embodiment enabling call accepted user(s) to provide said received message or SMS viewing confirmation to the calling user by clicking or tapping on an icon or selecting “confirm”. In another embodiment enabling call accepted user(s) to tap or click on reply button or icon and make one or more types of text call including call for sending message or short message (SMS) and in the event of call acceptance by called user(s), displaying message or SMS to said call accepted user(s). In another embodiment enabling calling users to select or pre-set auto call option, to automatically make calls as per pre-set rules, schedules and intervals up-to call accepted by called user(s).

FIG. 26 illustrates exemplary graphical user interfaces (GUI) for enabling user to select one or more contacts or mutual connections including all or selected friends, family members, professional connections and/or group(s) and/or one or more types of unique identity(ies) and make call for posting post or one or more types of contents and getting one or more types of reactions including like, dislike, ratings, comments, post selected emoticons, stickers, and expressions.

FIGS. 27-28 illustrates exemplary graphical user interfaces (GUI) wherein user can prepare post and make call for real-time publishing or displaying post(s) to called user(s) including contacts, followers, mutually connected users for real-time viewing by called users and getting various types of reactions from called users up-to end of call by calling and/or called user or called user(s) or in another embodiment make call for real-time publishing or displaying post(s) to called user(s) for real-time viewing of said post(s) and enable called users to provide reactions real-time, near real-time or any time.

FIG. 29 illustrates exemplary graphical user interfaces (GUI) for enabling users to access different types of text calls based on one or more commands, actions or functions and associated parameters and parameters associated with one or more types of values, syntax, instructions, triggers, rules from within chat or instant messaging interface.

FIG. 30 illustrates exemplary graphical user interfaces (GUI) facilitating making and managing various types of text calls including accept one or more incoming text calls, make one or more text calls to one or more selected contacts, groups and unique identities including multiple individual or one-to-one text calls, group calls, make text call to dynamically created group, attend or communicate multiple calls by switching tabs or control, pause or restart text call, add incoming text call to selected currently active text call or make text call to particular contact and in the event of acceptance of text call add call accepted user to selected currently active text call.

FIG. 31 illustrates graphical user interface for creating business account and log in with the platform, service, server and system by enterprise user or business or website or place of business on maps;

FIG. 32 illustrates graphical user interface for inviting and adding agents, creating groups of agents and choosing of subscription plan to activate live chat service for customers of business or place of business or connected users of business account;

FIG. 33 illustrates graphical user interface for registering user with the platform, service, server and system;

FIG. 34 illustrates exemplary graphical user interface wherein user can install and register or open installed or log in to open centralized live chat & communication application from particular website or application of business or place of business via integrated widget or directly open installed centralized live chat & communication application from user device and connect with currently viewing website uniform resource locator (URL) associated agent, wherein identify website uniform resource locator (URL) via browser installed plug-in, viewing website in app browser control;

FIG. 35 illustrates graphical user interface for centralized live chat & communication application for user;

FIG. 36 illustrates graphical user interface for centralized live chat & communication application for enterprise user or agent or admin of enterprise user;

FIG. 37 illustrates graphical user interface for menu and sub-menu related to currently viewing website related live chat;

FIG. 38 illustrates graphical user interface for enabling users to search, match, select, select from one or more lists, one or more websites or uniform resource locator (URL) of each selected website and open associated live chat user interface for connecting with the associated agent.

FIG. 39 illustrates graphical user interface for enabling user to connect with agent related to selected website for getting one or more types of support including after purchase support, connected customer support and customer relationship management, providing offer and group deals, inviting, invite for taking one or more types of call-to-actions, return and replacement, how to use product, maintenance, getting customer feedback and reactions and like;

FIG. 40 illustrates graphical user interface for enabling website's agent to communicate or converse with user or customer;

FIG. 41 illustrates graphical user interface for menu and sub-menu related to selected website related live chat;

FIG. 42 illustrates graphical user interface or application of maps, wherein user can search, match, set location and view or search nearby and select or select current place and select associated live chat option or select particular place associated live chat control or option or icon or link to open centralized live chat & communication user interface or application for connecting with associated available agent for sending and receiving messages and conducting communication;

FIG. 43 (a) illustrates graphical user interface related to one or more types of place search results, wherein user can select particular place associated live chat option or control or icon or link to open centralized live chat & communication user interface or application for connecting with associated available agent for sending and receiving messages and conducting communication and FIG. 44 (b) illustrates graphical user interface related to place details wherein user can view details or profile of particular business or website or place or place of business or business account or company or product seller or service provider;

FIG. 44 illustrates maps graphical user interface or application, wherein user can select or click or tap on particular place on maps or maps linked place list item to directly open user centralized live chat & communication application and connecting with available agent for instant conversing with agent in real-time;

FIG. 45 illustrates graphical user interface or application of maps, wherein user can search, match, set location and view or search nearby and select or select current place and select associated live chat option or select particular place associated live chat control or option or icon or link to open centralized live chat & communication user interface or application for connecting with associated available agent for sending and receiving messages and conducting communication;

FIG. 46 illustrates graphical user interface for enabling user to connect with agent related to selected place on map or list or directories or business account profile or business page or website or application;

FIG. 47 illustrates graphical user interface for enabling agent to communicate or converse with particular user;

FIG. 48 illustrates graphical user interface for menu and sub-menu related to selected place related live chat;

FIG. 49 illustrates graphical user interface for enabling user or caller to communicate via first communication medium or channel or interface (e.g. send text message) with other user or callee via second communication medium or channel or interface (e.g. video communication) or default communication medium or as per first user's or caller's choice or selection.

FIG. 50 illustrates graphical user interface for creating business account and log in with the instant messenger platform or service or server or system by enterprise user or business or website or place of business on maps;

FIG. 51 illustrates graphical user interface for enabling user to apply privacy settings and define rules on selected one or more business accounts for enabling business account owner or admins or staff or agents to communicate with user as per said applied privacy settings and defined rules.

FIG. 52 illustrates graphical user interface wherein automatically showing or hiding control related to particular user based on said user applied privacy settings and defined rules on business accounts;

FIG. 53 illustrates graphical user interface for enabling user to connect with agent related to selected business account;

FIG. 54 illustrates graphical user interface for enabling agent to communicate or converse with particular user or connected user;

FIG. 55 illustrates graphical user interface for menu and sub-menu related to selected business account related live chat;

FIGS. 56-57 illustrates graphical user interface(s) for enabling users to select live chat control from a website or application and connect with selected control associated with a unique website domain name or application associated available agent for communication including live chat or voice or video communication.

FIGS. 58-59 illustrates graphical user interface(s) for enabling user to user live communication including live chat.

FIGS. 60-61 illustrates graphical user interface(s) for enabling the user to select phone number and connect with selected phone number associated available agent for communication including live chat or voice or video communication.

FIG. 62 illustrates graphical user interface(s) for enabling users to select website or application or business name from listed websites or applications or business names to connect with selected website or application or business name associated available agent for communication including live chat or voice or video communication.

FIG. 63 illustrates graphical user interface(s) for enabling the user to view browser integrated control for knowing current status of live chat availability and availability of live chat option or feature related to the currently viewing website and select browser integrated control for connecting with the available agent related to the currently viewing website.

FIG. 64 illustrates flowcharts explaining sending message from user's client application to selected un-registered user or one or more types of unique identities or enterprise users or one or more types of entities and receiving message from them or instructing user or make compulsory for user to install and register application, view received message and respond message or start communication session including live chat session for enabling user and agent or user and contact(s) of user to exchanges messages within communication session including live chat session.

FIGS. 65-66 illustrates graphical user interface(s) for enabling user to select one or more website domain name(s) or uniform resource locator(s) and connect with selected website domain name(s) or uniform resource locator(s) associated available agent for communication including live chat or voice or video communication. In some embodiments automatically identify currently viewing website(s) or application(s) and automatically connect users with said automatically identified website domain name(s) or uniform resource locator(s) associated available agent for communication including live chat communication.

FIG. 67 illustrates an example computer system suitable for implementing various components of the system and method for real time call-based system, according to some embodiments;

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” be used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE DRAWINGS

Various embodiments of a system and method for text call services are described. In the following description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

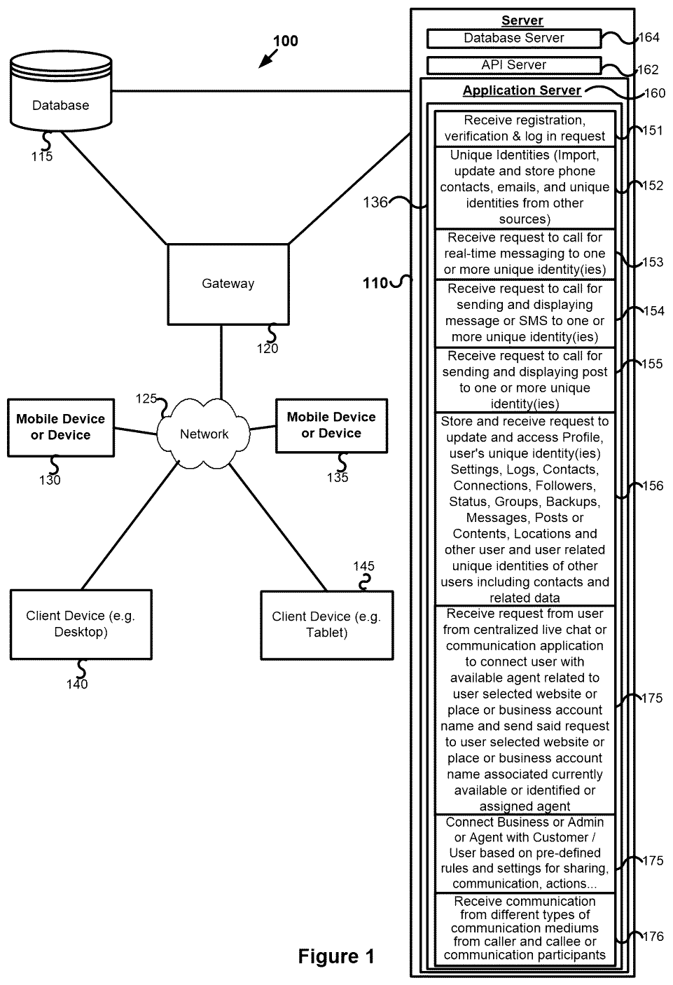

FIG. 1 illustrates a text call services, clients including online and smart client applications, server, method, systems and platform under various embodiments. According to some embodiments, system 100 can be implemented through software that operates on a portable computing device, such as a mobile computing device 110. System 100 can be configured to communicate with one or more network services, databases, objects that coordinate, orchestrate or otherwise register user, store unique identities, store and allow to access contacts, user profile, upload contacts from user device or one or more sources and identify users who registered with the system or server 110 and installed text call applications and identify contacts or unique identities who does not yet register or installed text call applications, receive request to call for real-time messaging to one or more unique identity(ies), receive request to call for sending and displaying message or SMS to one or more unique identity(ies), receive request to call for sending and displaying post to one or more unique identity(ies). Additionally, the mobile computing device can integrate third-party services which enable further functionality through system 100.

While FIG. 1 illustrates a gateway 120, a database 115 and a server 110 as separate entities, the illustration is provided for example purposes only and is not meant to limit the configuration of the various types of text call or real-time communication system. In some embodiments, gateway 120, database 115 and server 110 may be implemented in the various types of text call or real-time communication system as separate systems, a single system, or any combination of systems.

As illustrated in FIG. 1, the various types of text call or real-time communication system may include a calling or called user device or mobile devices 130/140 and website owner or website user device or mobile devices 135/145. Devices or Mobile devices 130/140/135/145 may be particular set number of or an arbitrary number of devices or mobile devices which may be capable of registering with the server 110, verification mobile phone number or one or more types of unique identity(ies), uploading and accessing contacts from server 110, making and attending and managing one or more types of text calls including making and accepting or rejecting call for real-time messaging to one or more unique identity(ies), making and accepting or rejecting call for sending and displaying message or SMS to one or more unique identity(ies), making and accepting or rejecting to call for sending and displaying post to one or more unique identity(ies), update and access profile, settings, logs, contacts, status, groups, backups, messages, posts or contents, locations and other user and user related unique identities including contacts related data, searching, viewing, presenting, posting, sharing, publishing, broadcasting, advertising, sending, presenting, matching, accessing and managing search results. Each device or mobile device in the set of calling or called (s) 130/140/135/140 device or mobile devices may be configured to communicate, via a wireless connection, with each one of the other mobile devices 130/140/135/145. Each one of the mobile devices 130/140/135/145 may also be configured to communicate, via a wireless connection, to a network 125, as illustrated in FIG. 1. The wireless connections of mobile devices 130/140/135/145 may be implemented within a wireless network such as a Bluetooth network or a wireless LAN.

As illustrated in FIG. 1, the types of text call or real-time communication system may include gateway 120. Gateway 120 may be a web gateway which may be configured to communicate with other entities of the types of text call or real-time communication system via wired and/or wireless network connections. As illustrated in FIG. 1, gateway 120 may communicate with mobile devices 130/140/135/145 via network 125. In various embodiments, gateway 120 may be connected to network 125 via a wired and/or wireless network connection. As illustrated in FIG. 1, gateway 120 may be connected to database 115 and server 110 of types of text call or real-time communication system. In various embodiments, gateway 120 may be connected to database 115 and/or server 110 via a wired or a wireless network connection.

Gateway 120 may be configured to receive request of registration and verification, send and receive request of one or more types of text calls including call for real-time messaging to one or more unique identity(ies) (CIM), call for sending and displaying message or SMS to one or more unique identity(ies) (CMS), call for sending and displaying post to one or more unique identity(ies) (CPR), access profiles, contacts and related or associated one or more types of unique identifies, settings, logs, status, backups, messages, SMS, posts, contents, locations, send and receive search queries, search results, posted contents including posts, videos, photos, text, location information to/from mobile devices 130/140/135/145. Gateway 120 may be configured to send and receive one or more types of user data comprises registration details, user mobile phone number, email address, one or more types of unique identities of user, profile, settings, logs, contacts, connections, followers, interacted, related, visited, associated and transacted entities (school, college, restaurants, shops, service providers, sellers) and objects (using or used or purchased products or brands) related one or more types of unique identities, status, groups, backups, messages, posts or contents, locations, connected users' data, user shared data or contents, logs of activities, actions, events, senses, transactions, status, updates, presence information, locations, ad checked-in places to/from mobile devices 130/140/135/145. For example, gateway 120 may be configured to receive registration request, verification request, storing and processing user contacts from user device(s) or from one or more sources, receive request to call for real-time messaging to one or more unique identity(ies), receive request to call for sending and displaying message or SMS to one or more unique identity(ies), receive request to call for sending and displaying post to one or more unique identity(ies), receive request to view, update, process and access profile, settings, logs, contacts, status, groups, backups, messages, posts or contents, locations and other user and user related unique identities including contacts related data, search queries and receive information or logged data about monitored or tracked user arch related activities, actions, status, events, reactions and transactions from client devices 130/140/135/145, receive various types of data and information to database 115 for storage.

As another example, gateway 120 may be configured to serve or send search query specific un-structured contents including matched content from searched webpage, snippet or rich snippet with structured contents or structured site including collection of categories posts, photos, videos, multimedia, texts, locations and associated actions and reactions controls or GUIs to searching user, requesting user, followers and viewers stored in database 115 to mobile devices 130/140. Gateway 120 may be configured to receive search requests from mobile devices 130/140 for searching and presenting structured contents with search results.

For example, gateway 120 may receive a request from a mobile device and may query database or contact database or storage medium 115 with the request for one or more types of text call. Gateway 120 may be configured to inform server 110 of updated data. For example, gateway 120 may be configured to notify server 110 when a new or updated profile, settings, logs, contacts, status, groups, automatically logged user related contacts and unique identities identified including monitored and tracked user interaction with one or more types of entities, activities, senses, updates, status, transactions, participations, communications, collaborations, reactions, registration, linked systems, application installations, triggering of one or more types of triggers, one or more types of digital activities, connected systems, and locations, posts, logged activities, actions, events, transactions, status, reactions of user has been received from a mobile device stored on database 115.

As illustrated in FIG. 1, the text call or real-time communication system may include a database, such as database 115. Database 115 may be connected to gateway 120 and server 110 via wired and/or wireless connections. Database 115 may be configured to store a database of registered user's profile, accounts, posted or shared contents, settings, logs, contacts, connections, followers, status, groups, backups, messages, posts or contents, locations and other user and user related unique identities including contacts related data, followed sources, user data including logged activities, actions, events, transactions, reactions, status, communication, sharing, updates, behaviors, searching activities and payments information received from mobile devices 130/140/135/145 via network 125 and gateway 120.

Database 115 may also be configured to receive and service requests from gateway 120. For example, database 115 may receive, via gateway 120, a request for making one or more types of text call(s) including request to call for real-time messaging to one or more unique identity(ies) (CIM), request to call for sending and displaying message or SMS to one or more unique identity(ies) (CMS), request to call for sending and displaying post to one or more unique identity(ies) (CPR and request to update and access profile, settings, logs, contacts, status, groups, backups, messages, posts or contents, locations and other user and user related unique identities including contacts related data from a mobile device and may service the request by providing, to gateway 120, send text call notification, message, agenda or subject, calling and called user's identities and metadata to called user(s), call status including cancel, accept, reject, end, wait, pause, restart, reject with message, missed call, confirmation, reactions, search query specific search result, search query specific contents including posts, photos, videos, multimedia, text, links or URLs, location information, actions and reactions controls and GUIs, user profile, user data, posted or shared contents, user followers, following users, viewers, contacts or connections, reacted users profile, number of reactions related to particular type of reaction, user or provider account's related data which meet the criteria specified in the request. Database 115 may be configured to communicate with server 110.

As illustrated in FIG. 1, the text call or real-time communication system may include a server, such as server 110. Server may be connected to database 115 and gateway 120 via wired and/or wireless connections. As described above, server 110 may be notified, by gateway 120, of new or updated site content, user profile, user data, user posted or shared contents, actions and reactions, user followed sources and various types of status stored in database 115.

FIG. 1 illustrates a block diagram of the text call or real-time communication system configured to implement the platform where user(s) can make, cancel, accept, reject, terminate, pause, restart, transfer, forward, and manage one or more types of text calls, send and receive messages, contents, posts, data, status, notifications, reactions. While FIG. 1 illustrates a gateway 120, a database 115 and a server 110 as separate entities, the illustration is provided for example purposes only and is not meant to limit the configuration of the text call or real-time communication system. In some embodiments, gateway 120, database 115 and server 110 may be implemented as separate systems, a single system, or any combination of systems.

The server 110 stores database server 164, API server 162 and application server 160 which stores applications, modules, services, APIs, web services 136 including Receive registration request, verify and store and receive request to access user's unique identity(ies), profile and settings 151, Unique Identities (Import, update and store phone contacts, emails, and unique identities from other sources) 152, Receive request to call for real-time messaging to one or more unique identity(ies) 153, Receive request to call for sending and displaying message or SMS to one or more unique identity(ies) 154 and Receive request to call for sending and displaying post to one or more unique identity(ies) 155 to implement operations of various embodiments of the invention and may include executable instructions to access a client device which coordinates operations disclosed herein. Alternately, may include executable instructions to coordinate some of the operations disclosed herein, while the client device implements other operations.

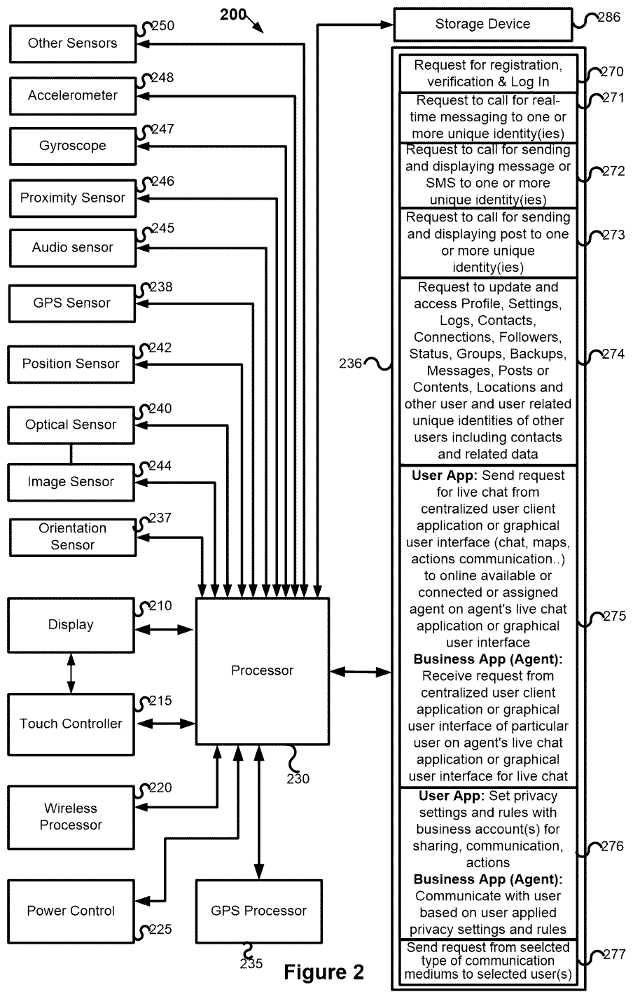

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random-access memory. The memory 236 stores Structured Site/Website Management Application (Smart Client or Web based) 277 to implement operations of one of the embodiments of the invention. The various types of text call application(s) including call for real-time messaging to one or more unique identity(ies) (CIM), call for sending and displaying message or SMS to one or more unique identity(ies) (CMS), call for sending and displaying post to one or more unique identity(ies) (CPR) (Smart Client or Web based) 277 may include executable instructions to access a client device and/or a server which coordinates operations disclosed herein. Alternatively, the text call application(s) (Smart Client or Web based) 277 may include executable instructions to coordinate some of the operations disclosed herein, while the server implements other operations.

The memory 236 stores a request for registration and verification module (Smart Client or Web based) 270 to implement operations of one of the embodiments of the invention. The registration and verification module (Smart Client or Web based) 270 may include executable instructions to access a client device and/or a server which coordinates operations disclosed herein. Alternately, the registration and verification module (Smart Client or Web based) 270 may include executable instructions to coordinate some of the operations disclosed herein, while the server 110 and server module Receive registration request, verify and store and receive request to access user's unique identity(ies), profile and settings module 151 and server module Unique Identities (Import, update and store phone contacts, emails, and unique identities from other sources) 152 implements other operations.

The memory 236 stores a Request to call for real-time messaging to one or more unique identity(ies) module (Smart Client or Web based) 271 to implement operations of one of the embodiments of the invention. The Request to call for real-time messaging to one or more unique identity(ies) module (Smart Client or Web based) 271 may include executable instructions to access a client device and/or a server which coordinates operations disclosed herein. Alternately, the Request to call for real-time messaging to one or more unique identity(ies) module (Smart Client or Web based) 271 may include executable instructions to coordinate some of the operations disclosed herein, while the server 110 and server module Receive request to call for real-time messaging to one or more unique identity(ies) 153 and implements other operations.

The memory 236 stores a Request to call for sending and displaying messages or SMS to one or more unique identity(ies) (Smart Client or Web based) 272 to implement operations of one of the embodiments of the invention. The Request to call for sending and displaying message or SMS to one or more unique identity(ies) (Smart Client or Web based) 272 may include executable instructions to access a client device and/or a server which coordinates operations disclosed herein. Alternately, the Request to call for sending and displaying message or SMS to one or more unique identity(ies) (Smart Client or Web based) 272 may include executable instructions to coordinate some of the operations disclosed herein, while the server 110 and server module Receive request to call for sending and displaying message or SMS to one or more unique identity(ies) 154 implements other operations.

The memory 236 stores a Request to call for sending and displaying posts to one or more unique identity(ies) (Smart Client or Web based) 273 to implement operations of one of the embodiments of the invention. The Request to call for sending and displaying posts to one or more unique identity(ies) (Smart Client or Web based) 273 may include executable instructions to access a client device and/or a server which coordinates operations disclosed herein. Alternately, the Request to call for sending and displaying post to one or more unique identity(ies) (Smart Client or Web based) 273 may include executable instructions to coordinate some of the operations disclosed herein, while the server 110 and server module Receive request to call for sending and displaying post to one or more unique identity(ies) 155 implements other operations.

The memory 236 stores a Request to update and access Profile, Settings, Logs, Contacts, Status, Groups, Backups, Messages, Posts or Contents, Locations and other user and user related unique identities including contacts and related data module 274 to implement operations of one of the embodiments of the invention. The module 274 may include executable instructions to access a client device and/or a server which coordinates operations disclosed herein. Alternately, the module 274 may include executable instructions to coordinate some of the operations disclosed herein, while the server 110 and server module Store and receive request to update and access Profile, user's unique identity(ies) Settings, Logs, Contacts, Connections, Followers, Status, Groups, Backups, Messages, Posts or Contents, Locations and other user and user related unique identities of other users including contacts and related data 156 implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the text call application(s) including call for real-time messaging to one or more unique identity(ies) (CIM) module, controls, client, application, service and Graphical User Interface(s) (GUIs) 271, call for sending and displaying message or SMS to one or more unique identity(ies) (CMS) module, controls, client, application, service and Graphical User Interface(s) (GUIs) 272 and call for sending and displaying post to one or more unique identity(ies) (CPR) module, controls, application, service and Graphical User Interface(s) (GUIs) 273 operating in conjunction with a server 110.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage 236, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application (not shown in figure).

The media capture application includes executable instructions to generate media items such as pictures and videos using the optical sensor 240 or image sensor 244. The media capture application also associates a media item with the geolocation and the position of the mobile device 200 at the time the media item is generated using the GPS sensor 238 and the position sensor 242.

The storage 236 includes a memory that may be or include flash memory, random access memory, any other type of memory accessible by the processor 230, or any suitable combination thereof. The storage 236 stores the registration information, profile, settings, logs including user and user interacted entities, contacts and connections related details about activities, actions, transactions, status, locations and associated places, sharing and communication, contacts, connections, followers, status, groups, backups, messages, posts or contents and messages including photos, videos, text, uniform resource location (URLs), voice, audio, images, emoticons, reactions, location information, data, metadata, system data, statistics, analytics, and other user and user related unique identities of other users including contacts and related data. The storage 236 also stores executable instructions corresponding to the request for registration and verification module (Smart Client or Web based) 270, Request to call for real-time messaging to one or more unique identity(ies) (Smart Client or Web based) 271, Request to call for sending and displaying message or SMS to one or more unique identity(ies) (Smart Client or Web based) 272, Request to call for sending and displaying post to one or more unique identity(ies) (Smart Client or Web based) 273, Request to update and access Profile, Settings, Logs, Contacts, Connections, Followers, Status, Groups, Backups, Messages, Posts or Contents, Locations and other user and user related unique identities of other users including contacts and related data module (Smart Client or Web based) 274.

The display 210 includes, for example, a touch screen display. The display 210 displays the text call graphic user interface(s) including incoming and outgoing user interface(s), sent, received, published and shared messages, notifications, contents, posts, status and user actions. A touch controller monitors signals applied to the display 210 to coordinate the selecting contacts, mutual connections, followers, keywords, categories, types, named entities, type of activities, groups and one or more type of unique identities, select and make one or more types of calls, input, select, capture, record one or more types of media including text, photos, videos, location information, voice, emoticons and stickers, uniform resource locator (URLs), user actions or call-to-actions including cancel, accept, reject, wait, pause, restart, forward, hold, transfer, end or terminate call, set various types of settings, update status, create groups, take actions and like.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

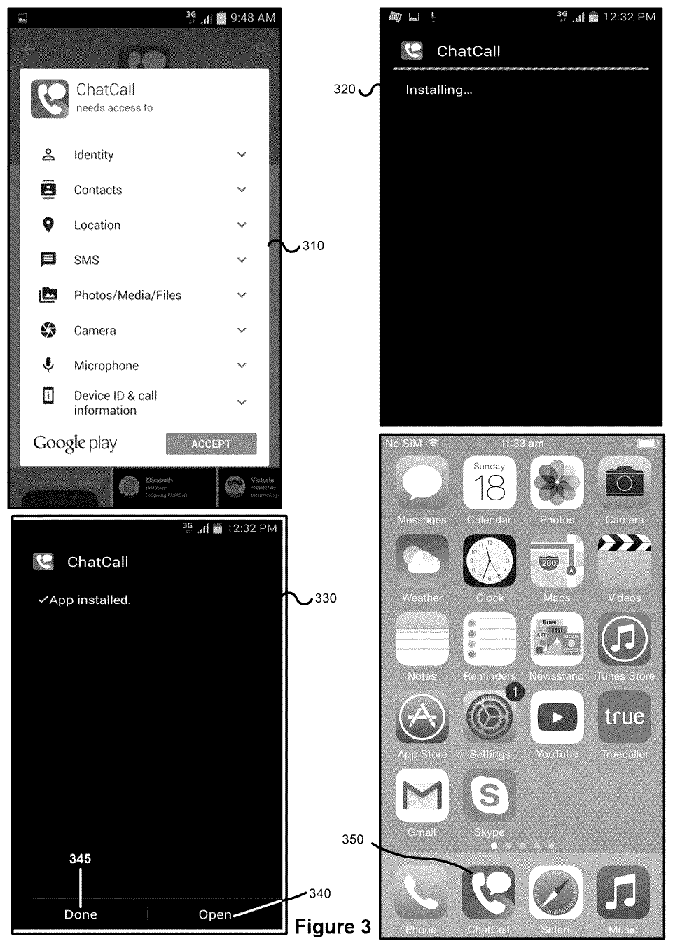

FIG. 3 illustrates exemplary graphical user interfaces (GUIs), wherein user can search, view description and reactions, make payment or make payment for one or more features or upgrades or use as free or sponsored or advertisement supported and/or click or tap on install or update or upgrade control or install or update button or click or tap on one or more application files (e.g. .APK or .EXE or .IPA) available from one or more sources including application stores including website, server 110, external servers, Google Play Store™, Microsoft App Store™ and Apple iTunes App Store™ for installing or updating or upgrading the one or more applications covering one or more embodiments or embodiments in any combinations of present invention described in details throughout the specifications. During installation process user need to provide various permissions 310 to access device resources including storage, data, sensors, features and applications including read phone status and identity, receive text message (SMS), send SMS message, take pictures and videos, record audio, identity approximate location (network-based), precise location (GPS and network-based), modify contacts, read contacts, modify or delete the contents of SD card or external or local memory storage, disable screen lock, find accounts on the device, read Google service configuration, full network access, receive data from the internet, view network connections, draw over other applications, control vibration, prevent phone from sleeping and like, acceptance of terms, conditions and privacy of app store, wherein after providing said permissions 310, app starts installing 320 and after installed 330, user can click or tap on open button 340 or done or open later 345, user can also open app by clicking on application icon or control or link or button or menu item 350. After installed when the user first opens the application then the user is enabled to register the application by providing details and verifying the user device in which the user installed the application.

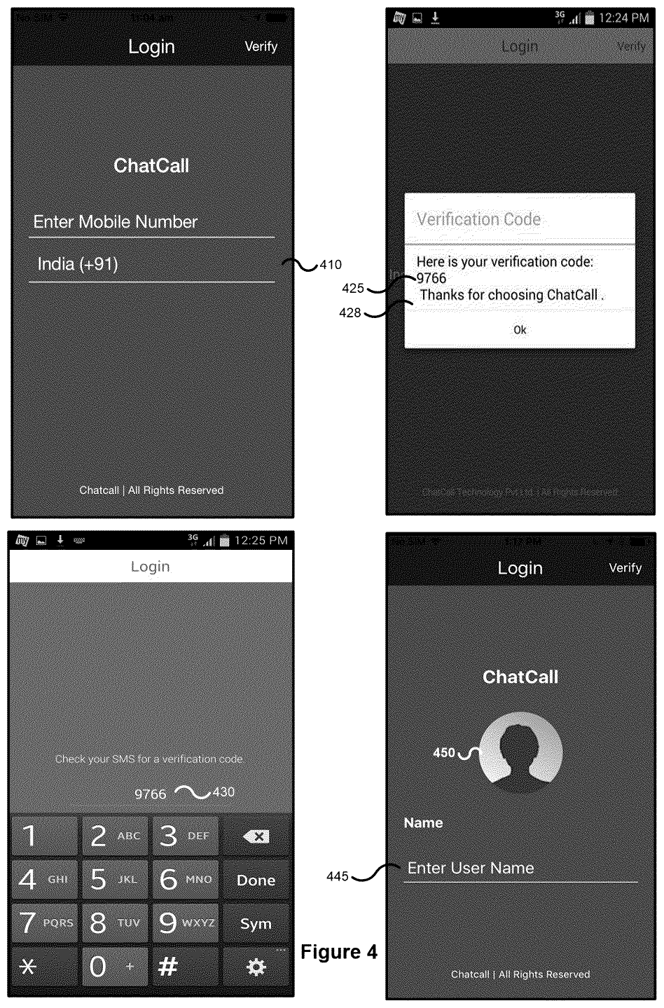

FIG. 4 illustrates exemplary graphical user interfaces (GUIs) for enabling users to register with the server 110 or system. Server 110 module 270 receives a request for registration from the registration user interface and module 151 the client application 200. Users can select country code and select or enter mobile number 410. After providing mobile number, conducting verification of mobile number and user by employing one or more verification techniques including sending One Time Password 425 to said mobile number 410 and enabling the user to enter or select 440 said verification code 425 to verify the mobile number. Users are enabled to provide user name 445 or one or more types of unique identities including unique user name, email address, social account user name(s), unique number(s) including government provided identities, photo of user which can recognize by using face recognition techniques, fingerprints, and so on.

In another embodiment user mobile number verification can be done based on automatic SMS verification including using the SMS Retriever API. With the SMS Retriever API, performing SMS-based user verification in application automatically, without requiring the user to manually type verification codes, and without requiring any extra app permissions. User initiates SMS verification in application. Application makes a request to server 110 to verify the user's phone number 410. Depending on what information is available in server's 110 user database 115, this request might include the user's unique identity (UID), the user's phone number, or both. At the same time, the application calls the SMS Retriever API to begin listening for an SMS response from server 110. Server 110 sends an SMS message 425 to the user that includes a one-time code 425 to be sent back to server 110, and a hash or code that identifies the application. When the user's device 200 receives the SMS message 425, services including Apple services or Google Play services uses the application hash or code to determine that the message is intended for application, and makes the message text available to application through the SMS Retriever API.

Application parses out the one-time code 425 from the message text 428 and sends it back to server 110. Server 110 receives the one-time code 425 from application, verifies the code 425, and finally records that the user has successfully verified their account. If one-time code 425 is not received then the user is enabled to tap on the “Resend” Verification Code option.

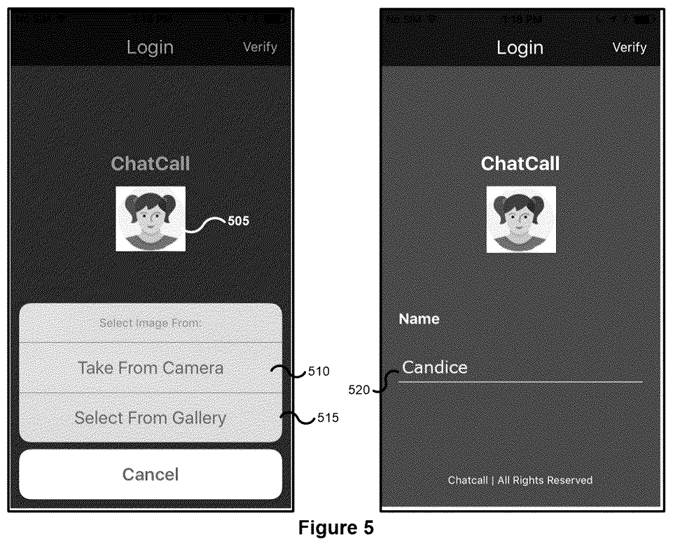

FIG. 5 illustrates exemplary graphical user interfaces (GUIs) for enabling user to provide or select 515 or take 510 user's photo(s) or image(s) or video(s) or avatar(s) or one or more types of visual representations 505 describing user or user's identity. Users can input user name or nickname. In an embodiment user can tap on photo icon 405/505 to add profile photo by selecting photo or capturing new photo and crop photo. Users can enter names for a particular number of characters including maximum Length of 12 characters.

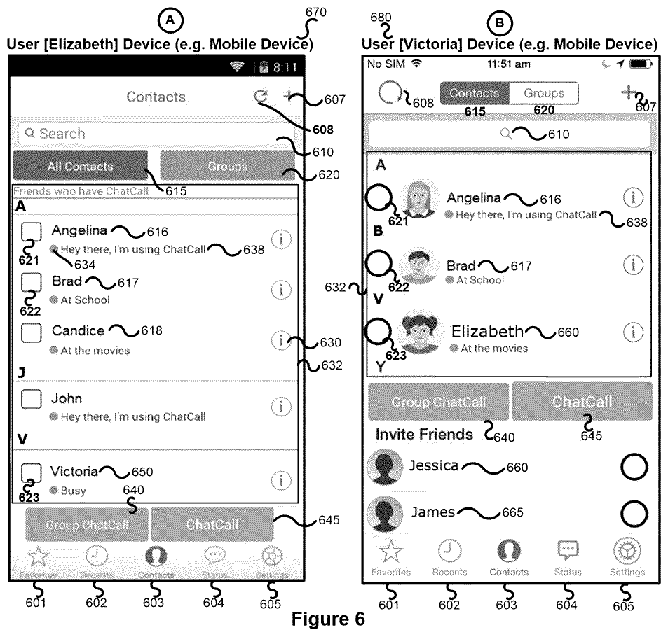

FIG. 6 illustrates exemplary graphical user interfaces (GUI) wherein after registration and verification, server 110 module 152 or system imports or access or uploads or retrieves phone contacts of user devices 200 including mobile phone numbers, email addresses, one or more social account(s) user name(s) and/or server 110 module 152 or system imports or identifies or access or uploads or retrieves one or more types of unique identities of connected or related or determined users of user from one or more applications, services, servers, websites, databases, user's account(s) at various applications and websites including social connections, professional or business connections, interacted or visited or transacted entities (shops, school, college, gym, petrol pump, hotel, restaurants, tourist places and any physical world places or digital world applications or websites and associated user(s)), nearby users, followers, relatives, neighbors or society members, logged activities, actions, events, transactions, places, tasks, status, communication, sharing associated or determined users, purchased products, services and brands associated entities associated authorized and updated users including customer service providers, admins, assistants, and employees or staff members, interest, categories, tags, liked products, services, websites, applications and entities and preferences specific users. In one embodiment server 110 uses a customized version of the open standard Extensible Messaging and Presence Protocol (XMPP). Upon installation, it creates a user account using the user's phone number as the username (Jabber ID: [phone number]@s.chatcall.net). Server 110 automatically compares all the phone numbers from said registered user's device's 200 address book with its central database(s) 115 of server 110 to automatically add contacts to the user's contact list.

In one embodiment users are required to upload their mobile phone's entire address book to the server 110 module 152 so that server 110 module 152 could discover who, among the users' contacts, is available via real time text call-based system e.g. text call's application or service. While this is a fast and convenient way to quickly find and connect the user with contacts who are also using real time text call based system e.g. text call's application or service, it means that their address book was then mirrored on the real time call based system e.g. text call's application or service server(s) 110, including contact information for contacts who are not using real time text call based system e.g. text chat call's application or service.

In an embodiment user can view list of contacts and or one or more types of unique identities including unique user name, unique user identity, nick name or user name, website name, application name, domain address, email address, entity name including school, college, shop, company, and firm name, location or address or geofence or place name, product and brand name, service name, followers, all connections, group name, movie name, show name, television channel name, television serial or program name, vehicle number, bus number, train number, person's one or more types of government identities, bank account number, category, type, keyword, tag and any combination thereof 632 who have installed application. In an embodiment user can view contact's or one or more types of unique identity(ies) status 634 including online or offline status. In an embodiment user can view contact's or one or more types of unique identity(ies) updates or status or activity status 638 including details of current place, current activity, current purchase, accompanied users, status including open, closes, busy, free after particular duration, at school, at movie theatre, at particular mall. In an embodiment user is enabled to view list of contacts or one or more types of unique identity(ies) who does not installed application and enable to select from said list one or more contact or one or more types of unique identity(ies) 660/665 and invite to install text call application(s). In an embodiment enabling user to view all contacts or one or more types of unique identity(ies) by clicking or tapping on “All Contacts” 615 or view created groups including public or private groups or groups wherein user is member or participated or accepted invitation to join group(s) by clicking or tapping on “Groups” tab 620. In an embodiment user can search contacts or groups or one or more types of unique identities 610 based on inputted one or more characters, wherein based on inputting or updating of characters, displaying searched contact list results 632 for enabling user to select one or more contacts (e.g. contacts 621/622/623) or groups or one or more types of unique identity(ies) from searched contact list and make text call or multi call or group call. In another embodiment, the user is configured to filter, bookmark, rank, categories, and sort contacts, groups and or one or more types of unique identity(ies). In an embodiment user can directly tap or click on particular contact or group or one or more types of unique identity to make text calls or group text calls. In an embodiment user can select 621/622/623 one or more contact(s) 616/617/650 and tap on “Group ChatCall or Text call” Button 640 to dynamically or temporarily create a group of selected contacts and make a group text call. In another embodiment user can select (e.g. contacts 621/622/623) one or more contact(s) 616/617/650 and tap on “Multi ChatCall or Text call” Button 645, calling each user separately and in the event of acceptance of call displaying communication or chat or instant messaging user interface separately for each call and enable caller to messaging with each called user or callee separately under separate user interface which user can switch via tab or menu or other types of controls. In another embodiment users can tap or click on refresh 608 button or icon or link or control to update home contacts including update new contacts, update user's online or offline status, updates and other updated information including last seen, updated participating groups, updated profile information, ringtone, logs and settings. In an embodiment user can view profile information, updates, status, and settings related to each contact or group or unique identity(ies) by clicking on contact information icon 630. In an embodiment enabling the user to add new contact(s) or group(s) or group or unique identity(ies) and provide contact details by clicking or tapping on an icon or button or link or control 607. In an embodiment enabling users to add connection details or import connections by inviting contacts or connections of external websites or applications including social networks, professional networks and in the event of acceptance of invitation create mutual connections and add or enable contacts or connections for enabling users to make text calls.

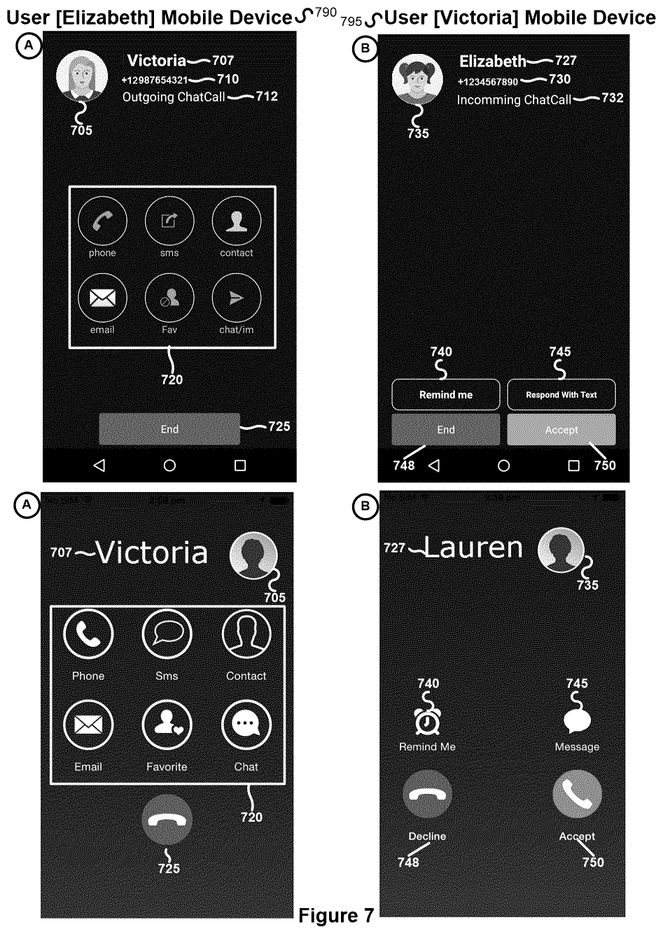

FIG. 7 illustrates exemplary outgoing text call graphical user interfaces (GUI) (FIG. 7 (A)) and incoming text call graphical user interfaces (GUI) (FIG. 7 (B)). In an embodiment in the event of tapping or clicking on contact (for example user [Victoria] 650) or in another embodiment in the event of selecting contact (for example user [Victoria] 650) and tapping or clicking on button or icon or link control 645 with intention to make call or text call or send invitation or send notification or providing one or more types of indication in one or more forms by calling user (for example user [Elizabeth]) from device including mobile phone 200, personal computer, tablet, laptop, smart watch, wearable device and one or more types of smart devices, sending request for text call or sending request for call for instant messaging 271 from client device 200 to server 110 module 153, wherein request comprises calling user identity and metadata, based on settings location information including current place, map, address and associated details, one or more called users' identities, associated settings including ringtone, allow to save, type of call and metadata, status, preferred type of network, selected one or more applications, user interfaces and media and any combinations thereof, date and time of call, calling user device's system data and meta data, subject or agenda or title or message or selected and/or edited template or list. In an embodiment displaying outgoing text call graphical user interfaces (GUI) FIG. 7 (A) with cancel text call and other controls to the calling user. Server 110 module 153 process request and send call request to each called user based on identity in one or more form including send notification including push notification, SMS notification with link for enabling called user to tap on notification or link to open incoming text call user interface for enabling receiving user to accept or reject text call or in another embodiment turn on called user device and displaying incoming text call graphical user interfaces (GUI) FIG. 7 (B) with accept, reject and other controls for enabling called user to accept or reject text call or in another embodiment turn on called user's device and directly open chat user interface or instant messaging application or user interface or open calling user selected application(s) or user interface(s) and display title, agenda, subj, sent media, name, photo and identity of calling user and enable to send message and in the event of sending first message mark as starting of text call. In an embodiment displayed outgoing text call graphical user interfaces (GUI) FIG. 7 (A) enables calling user or inviter or caller (for example user [Elizabeth]) to view profile photo or image 705, name or nickname 707, unique identity e.g. phone number 710, email address, user name, entity name (e.g. brand, shop, company, firm, website, application, and like) of called user or callee (for example user [Victoria]), outgoing call status 712, end call or cancel call by clicking or tapping on button or image or icon or link or control 725 before call except by called user (for example user [Victoria]), switch text call i.e. call for instant messaging (CIM) to phone call or Voice over Internet Protocol (VOIP) or send short message service (SMS) or select contact or favorite unique identity(ies), email or instant messaging or chat or Call For Sending Message/SMS (CMS) or Call For Posting & Getting Reactions (CPR) by selecting preferred option from list of options 720. In an embodiment displayed incoming text call graphical user interfaces (GUI) FIG. 7 (B) enables called user or callee or invitee (for example user [Victoria]) to view profile photo or image 735, name or nickname 727, unique identity e.g. phone number 730, email address, user name, entity name (e.g. brand, shop, company, firm, website, application, and like) of calling user or caller or inviter (for example user [Elizabeth]), listen ringtone of incoming call including text call, incoming call status 732, accept text call or Call For Instant Messaging (CIM) by clicking or tapping on “accept” button 750, reject or end or cancel text call or Call For Instant Messaging (CIM) by clicking or tapping on “reject” or “end” button 748, respond with text or selected or edited templates by clicking or tapping on “respond with text” button 745, end call and remind user later for call or text call by clicking or tapping on “remind me” button 740. In an embodiment non acceptance of incoming call or text call within pre-set or default period of time then said incoming call or text call is considered as missed call and logging and informing calling user and called user about said missed call with details. In an embodiment in the event the device is off and incoming call is coming then automatically turn on the device and display incoming call user interface (FIG. 7 (B)) and based on settings playing pre-set or default or associated ringtone and/or vibration.

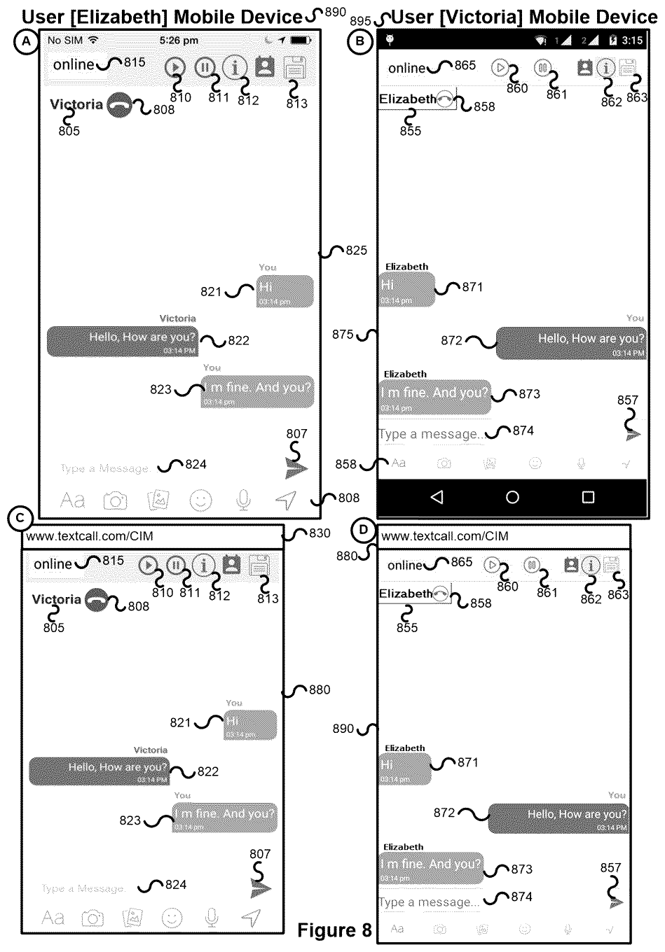

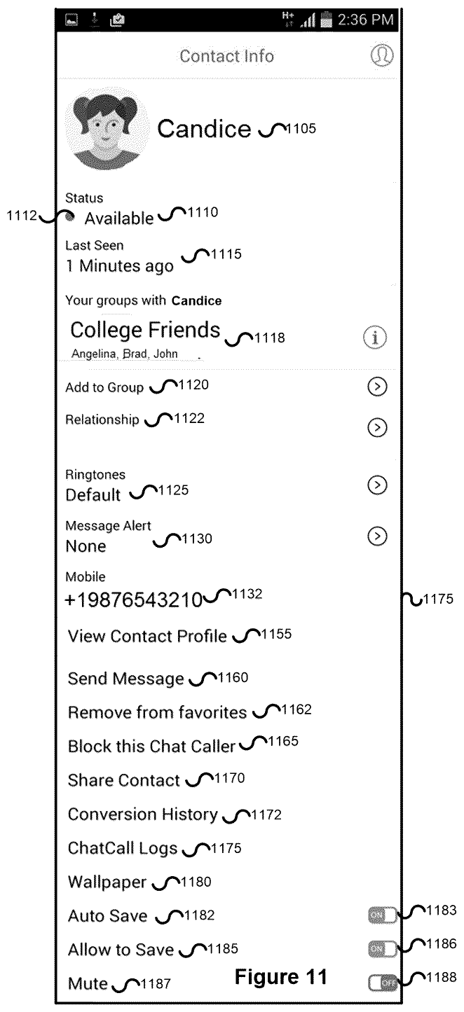

FIG. 8 illustrates exemplary graphical user interfaces (GUI) wherein in the event of clicking or tapping on particular contact or unique identity 650 or selecting particular contact or unique identity 650 and clicking or tapping or selecting text calling button 645, displaying incoming text call user interface FIG. 7 (B) and in the event of text call accepted by said called user by clicking or tapping or selecting incoming text call accept button 750, displaying chat or feed or story or instant messenger user interface or one or more types of one or more applications, user interfaces, media and any combination thereof FIG. 8 (A) to calling user and/or to one or more or each call accepted user(s) FIG. 8 (B). In an embodiment calling and called user can view each other's current online status (815/865). After acceptance of call by called user(s), during current call session, caller and called user(s) can input text 824/874 or prepare one or more types of contents or media including input or select text, search and select location, place & map information, input or select hyperlinks or uniform resource locators (URLs), select or take or capture photos, select or capture videos, select or record audio, search and select images files and other files 808/858, augment, process and format said files or contents and enable to send message or prepared content by clicking on send button 807/857. For example, caller user [Elizabeth] input message “Hi” in input or edit box 824 and tap or click on send button 807 to send said message “Hi” 821 to call accepted user or callee [Victoria], wherein server 110, send and display said message 871 to callee user [Victoria]'s user interface 875. Call accepted user or callee [Victoria] input message “Hello, How are you?” in input or edit box 874 and tap or click on send button 857 to send said message “Hello, How are you?” 871 to calling user or caller [Elizabeth], wherein server 110, send and display said message 822 to caller user [Elizabeth]'s user interface 825. In another embodiment caller [Elizabeth] and call accepted user [Victoria] can pause 811/861 current call or pause 811/861 sending and receiving messages until restart 810/860 by paused user or in another embodiment restart by caller or called user for further continuing sending and receiving messages. In another embodiment users can view and access additional information about contact 812/862 (discussed in detail in FIG. 11). In an embodiment calling and called user can end the call by tapping or clicking or selecting text call end button 808/858 to end the current ongoing text call. In an embodiment in the event of ending of said text call, close current call session for preventing calling and called user to send and/or receive messages after ending of text call and in another embodiment close or hide caller and callee's chat or instant messenger user interface 825/875 for preventing calling and called user to further send and/or receive messages after ending of text call.

In another embodiment in the event of clicking or tapping on particular contact or unique identity 650 or selecting particular contact or unique identity 650 and clicking or tapping or selecting text calling button 645, server 110 receive request to call from calling user [Elizabeth] and in the event of identification of called user as non-registered user or user who does not installed text call application, server 110 sends notification including push notification or SMS with link to called user [Elizabeth] and in the event of clicking or tapping or selection of said received notification or link 880 associated with notification, opening online or web based application or website or webpage access via said web address or uniform resource locator or link 830 and displaying incoming text call user interface with accept and reject controls (FIG. 7 (B)) in the user device's web browser or pre-set or selected or default web browser and in the event of text call accepted by said called user [Elizabeth] by clicking or tapping or selecting incoming text call accept button 750, displaying chat or feed or story or instant messenger user interface or one or more types of one or more applications, user interfaces, media and any combination thereof FIG. 8 (A) to calling user and/or to said non-registered each call accepted user(s) in the user device's web browser or pre-set or selected or default web browser FIG. 8 (D) and enable calling user and call accepted user(s) to send and receive messages, view online status and contact's additional information, and pause, restart and end call.

In another embodiment in the event of clicking or tapping on particular contact or unique identity 650 or selecting particular contact or unique identity 650 and clicking or tapping or selecting text calling button 645 from online or web based application or website or webpage access via web address or uniform resource locator 830 of online or web based application from web browser, server 110 receive request to call from calling user [Elizabeth] and in the event of identification of called user as non-registered user or user who does not installed text call application, server 110 sends notification including push notification or SMS with link 880 to called user [Elizabeth] and in the event of clicking or tapping or selection of said received notification or link 880 associated with notification, opening online or web based application or website or webpage access via said web address or uniform resource locator or link 830 and displaying incoming text call user interface with accept and reject controls (FIG. 7 (B)) in the user device's web browser or pre-set or selected or default web browser and in the event of text call accepted by said called user [Elizabeth] by clicking or tapping or selecting incoming text call accept button 750, displaying chat or feed or story or instant messenger user interface or one or more types of one or more applications, user interfaces, media and any combination thereof FIG. 8 (C) to calling user in the user device's web browser or pre-set or selected or default web browser and/or to said non-registered each call accepted user(s) in the user device's web browser or pre-set or selected or default web browser FIG. 8 (D) and enable calling user and call accepted user(s) to send and receive messages, view online status and contact's additional information, and pause, restart and end call.

In another embodiment to make feel or maintain and manage real-time messaging or instant messaging or chatting and communication between or among calling user and called user(s), displaying and updating online and offline status of calling user to called user(s) and displaying and updating online and offline status of called user(s) to calling user. In another embodiment in the event of non-receiving of message during current text call for pre-set duration of time or interval period, notifying calling and called user(s) about inactiveness. In another embodiment in the event of non-receiving of message during current text call for pre-set duration of time or interval period, automatically end call and remind both calling and called user(s). In another embodiment auto detecting and auto selecting data network or cellular network based on determination of availability or signal strength and informing network signal strength of calling user to called user(s) and informing network signal strength of called user(s) to calling user. In another embodiment enabling calling and called user(s) to pause current text call communication for pre-set duration for user or all participant users and informing text call paused to all participant members of current text call. In another embodiment enabling paused users to restart currently paused communication of currently active text all. In another embodiment notifying text call participant users about paused call after pre-set duration of interval and notifying text call participant users about restarted text call and enable to send and receive messages. In another embodiment in the event of a call paused, the user sends a message, automatically restart text call and notifying each participant user about restarting of text call.

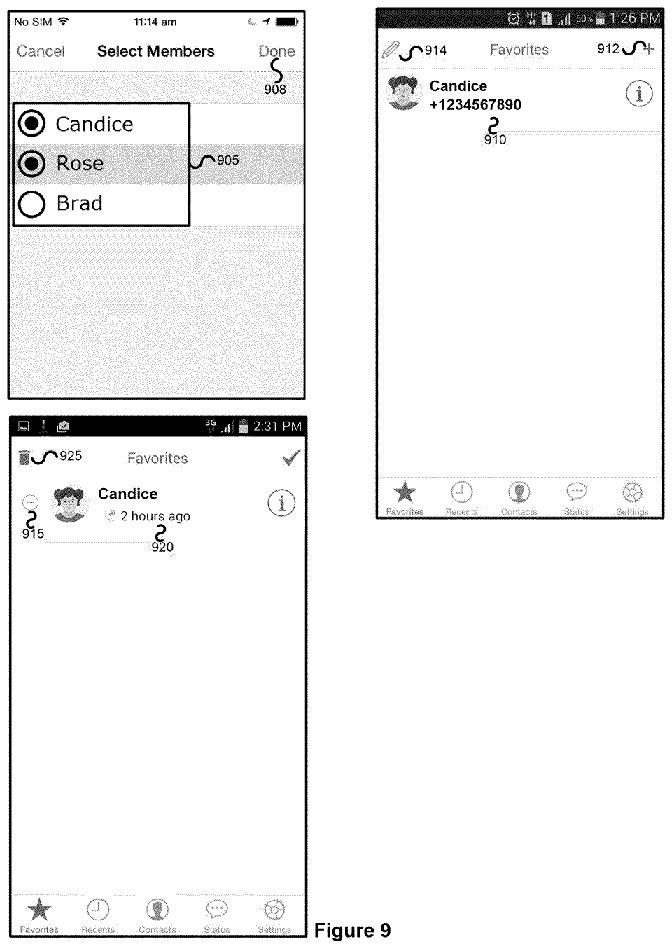

FIG. 9 illustrates exemplary graphical user interfaces (GUI) wherein users can view favorite contacts and one or more types of unique identities 910. User can add new 912 selected on or more contacts and one or more types of unique identities 905 and make said selected contact(s) as favorite contacts 908 or edit 914 remove all 925 or remove 915 selected one or more contacts and one or more types of unique identities 920 from favorite contacts. In another embodiment users can provide rank and weight to contacts. In another embodiment automatically making contact(s) as favorite or automatically providing rank and weight to contact(s) based on relationships, number of calls, frequency of calls, duration of calls, number of messages and contents exchanged or shared or published and number of reactions.

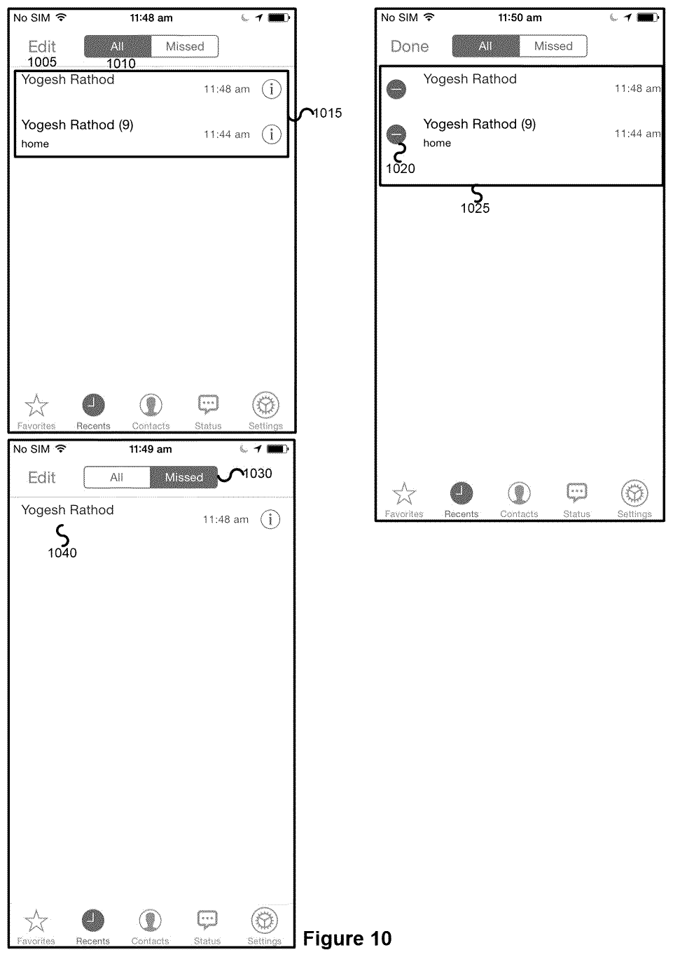

FIG. 10 illustrates exemplary graphical user interfaces (GUI) wherein user can view details of logged different types of text calls 1015 by tapping or clicking on “All” tab 1010, wherein details comprises type of call including CIM, CMS or CPR, called or calling user name, unique identity including user name, nick name, phone number, email address, call start and end date and time of call, call duration, numbers and types of messages exchanged between caller and called user(s), status of call including accepted, missed call, cancelled, rejected, forwarded, transferred, and added call, paused for particular duration, restarted after particular duration, incoming or outgoing call. Users are enabled to tap or click on edit 1005 and remove 1020 selected logged one or more calls details from list 1025. User can access only missed calls 1030 and can click or tap on particular or selected missed details 1040 to make relevant types of text calls.

In an embodiment in the event of clicking or tapping on a particular contact associated icon or button or link 630, displaying user interface (FIG. 11) which enables the user to view selected contact associated detail information, status, associated groups, view associated current settings, and various types of controls for providing settings. FIG. 11 illustrates exemplary graphical user interface (GUI) wherein user can view said selected contact (FIG. 6 (618))/1105 associated updated status 1110, last seen of contact (FIG. 6 (618)/1105) (In an embodiment if user disable user's last seen then user cannot able to view contact's last seen) 1115, view user's group with this selected contact (FIG. 6 (618)/1105), view contact's (FIG. 6 (618)/1105) profile 1155, view contact's profile photo and name 1105, view online (for example in the form of green color)/Offline (for example in the form of red color) status or availability indication 112 of contact, view current location and associated map and place information of contact, add contact to selected publishable or private group(s) 1120, view associated group(s) details 1118, add & view relationship 1122, view & select or set or update ringtone 1125 for this contact, view & select message alert 1130, view phone number and tap to make phone call 1132, view contact's phone book details and profile 1155, send SMS to contact 1160, remove contact from favorite 1162, block/unblock contact 1165 by selecting bock or unblock option, share contact to others 1170, view and delete conversation history of contact 1172, view and clear logs of contact 1175, view & select wallpaper for contact 1180, set automatically save or not save conversations of this contact (if permission is given by this contact) at particular storage including local and/or remote or cloud storage 1182 by clicking or tapping switchable (ON/OFF) button or control 1183, set allow to save or not allow to save to this contact setting 1185 by switching (On) to allow to save and (Off) button 1186 to not allow to save, set mute/unmute call from this contact setting 1187 by switching (On) to mute and (Off) button 1188 to unmute.

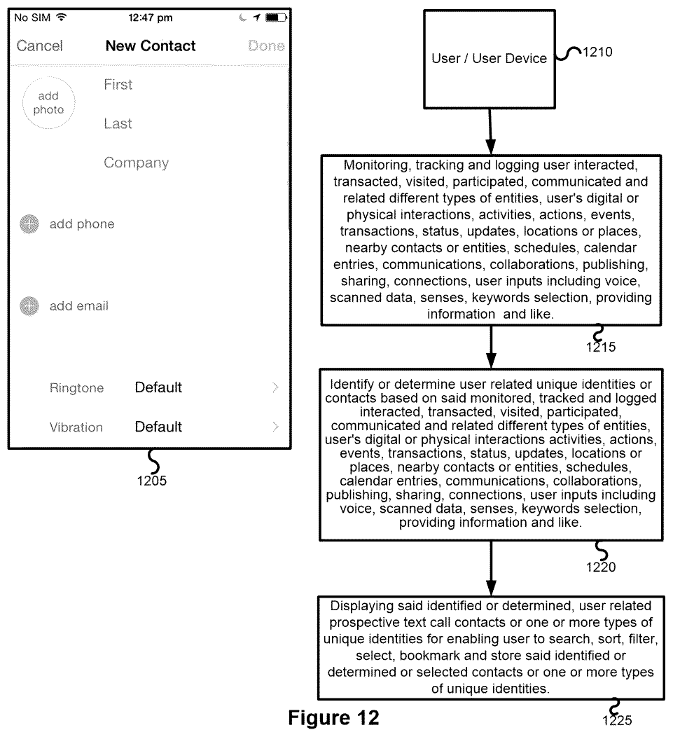

FIG. 12 illustrates exemplary graphical user interfaces (GUI) wherein enabling the user to add new contact by using form or contact user interface 1205. In another embodiment automatically identify, determine and suggest user related other contextual users of network and identify associated one or more types of data or information or profile including one or more types of contact information and unique identities including text call unique identities (phone number, email address, user name, external domains or websites or social networks or applications user names, government provided one or more types of unique identities) for enabling user to search, match, select, bookmark, store text call unique identities or contacts and make text calls to selected one or more unique identities or contacts, wherein monitoring, tracking and logging user or user device 1210 interacted, transacted, visited, participated, communicated and related different types of entities, user's digital or physical interactions, activities, actions, events, transactions, status, updates, locations or places, nearby contacts or entities, schedules, calendar entries, communications, collaborations, publishing, sharing, connections, contacts, user inputs including voice, scanned data, senses, keywords selection, providing information and like, user roles contextual to corresponding interacted or transacted entities, applying one or more rules, and retrieving or accessing user said user's activities related data or logged data from external linked systems, database and sources 1215 and identify or determine user related unique identities or contacts based on said monitored, tracked and logged interacted, transacted, visited, participated, communicated and related different types of entities, user's digital or physical interactions, activities, actions, events, transactions, status, updates, locations or places, nearby contacts or entities, schedules, calendar entries, communications, collaborations, publishing, sharing, connections, contacts, user inputs including voice, scanned data, senses, keywords selection, providing information and like, user roles contextual to corresponding interacted or transacted entities and retrieving or accessing user said user's activities related data or logged data from external linked systems, database and sources 1220 and displaying said identified or determined, user related prospective text call contacts or one or more types of unique identities for enabling user to search, sort, filter, select, bookmark and store said identified or determined or selected contacts or one or more types of unique identities 1225 for enabling user to make one or more types of text call, wherein different types of entities comprises shops, college school, neighbors, students, classmates, nearby users or contacts, teachers, doctors, office staffs, employer, employee, brands, manufacturers, seller or staff related to purchased products or subscribed services, professionals, visited and transacted websites, installed or transacted applications, customers, clients, guests, members, viewers, followers, listeners, readers, commuters, travelers, patients, and visited or transacted place associated contextual users or staffs or customer service providers or assistants or administrators.

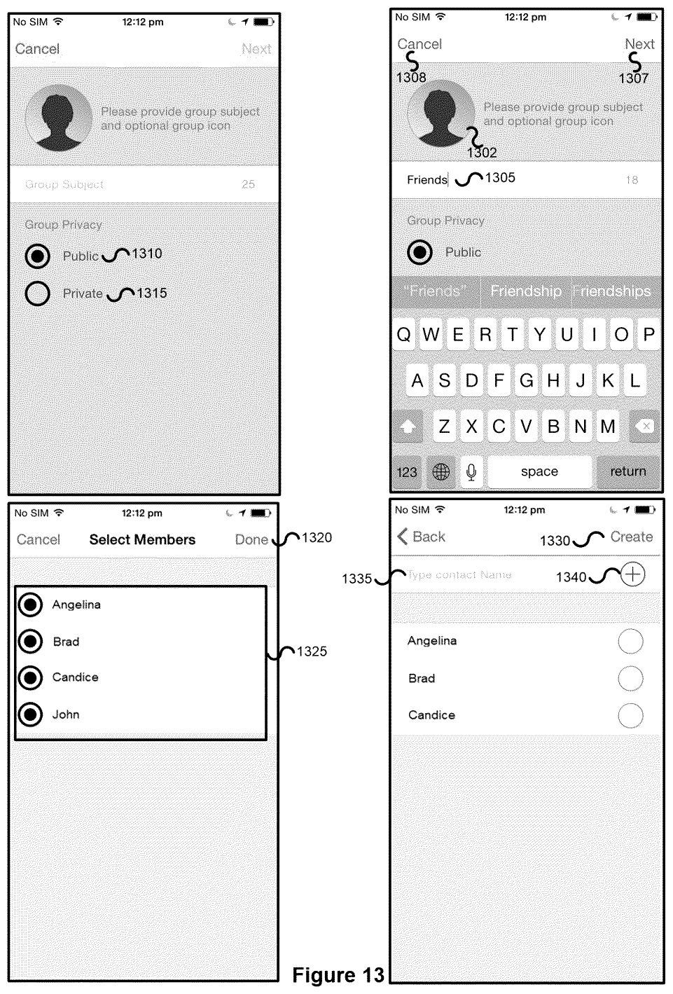

FIG. 13 illustrates exemplary graphical user interfaces (GUI) wherein user is enabled to select publishable or public type group 1310 or private type group 1315, optionally provide group icon by tapping on photo icon 1302, input or add group name or details 1305 and select “Next” 1307. User can click or tap on Cancel 13078 to cancel the creation of this group. User can select one or more members from list of contacts and unique identities 1325 to add to said new group (e.g. Friends 1305) and tap on “Done” button 1320. User is configured to type contact name 1335 to search, select and add members 1340 from searched contacts. Users are enabled to remove already added members from a particular group.

Users can tap on the group information icon 1420 and can view details of selected groups, wherein group details comprises view group photo 1430, group name and details 1435. User is configured to edit group name or details 1435, add or edit group photo 1430, view list of group members or participants names and photos 1460, add group member(s) 1465, delete group member(s) (not shown in figure), user can mute group 1455, view recent locations or current location or place of group members 1445, view shared media 1440. Publishable or public type of group can be viewed and accessed by group members. Users can create a private type of group and add one or more contacts and unique identities and can select a particular private type group and can make group text calling. Private type of group(s) is not publishable or not viewable or accessible by added group contacts and unique identities. Private type of group(s) is only accessible, viewable and updatable by group creator and used only for making multiple text calls or group text calls.

User is configured to click or tap on group name 1415 and make group text call and in the event of text call acceptance by at least one member of said selected group 1415, displaying chat or instant messaging graphical user interface (GUI) 1488 and displaying duration of call, date and time of call, participated group members names and links to view detail profile 1480 and enable participated group members to converse, share or send 1486 and receive messages and one or more types of contents or media including photos, videos, text, audio, voice, images, uniform resource locator (URLs), location information, user actions or call-to-actions and one or more types of digital contents 1481/1482/1483/1484/1485.

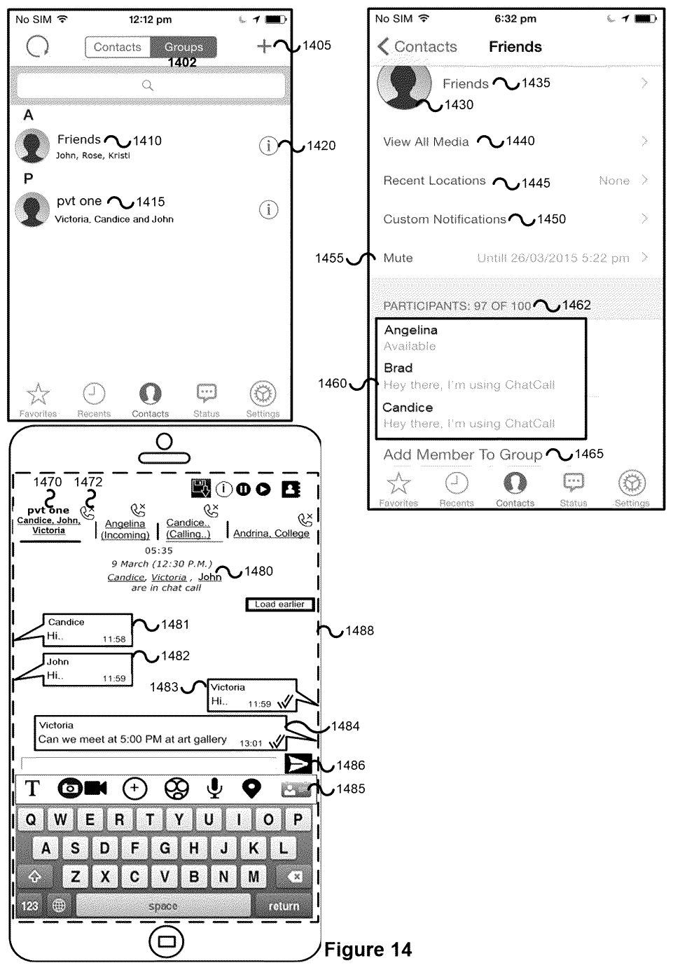

FIG. 14 illustrates exemplary graphical user interfaces (GUI) wherein user can tap or click on public type group (for example “Friends” 1410) to make ChatCall or text call to all group members of selected group 1410 or tap or click on private type group (for example “pvt one” 1415 to make ChatCall or text call to all group members of selected group 1415. In another embodiment, users can select one or more groups 1410/1415 from the list and tap or click on “Group ChatCall or text call” button to ChatCall or text call to all group(s) members. In an embodiment in the event of text call acceptance by at least one member of a selected group, displaying chat or instant messaging user interface to calling and each call accepted group members and all call accepted group members can converse with each other. In another embedment, in a private group call when the call initiator ends the call then the private group call ends from all members. In another embodiment, in public type group calls, any members can end the call to leave conversation and if the last one of the two remaining members ends the call then end the call.

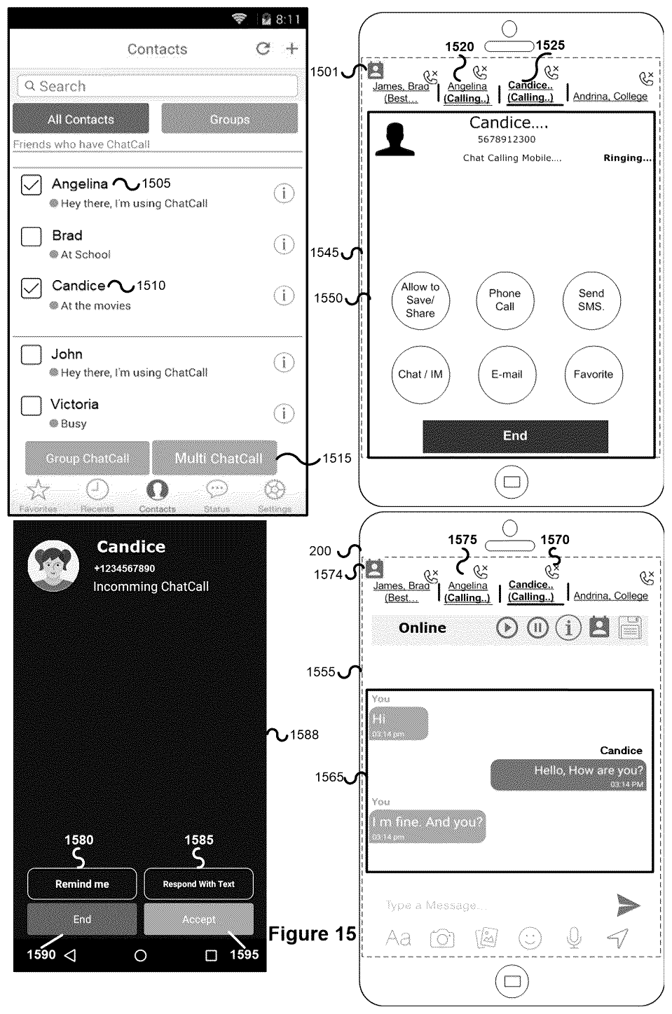

FIG. 15 illustrates exemplary graphical user interfaces (GUI) wherein user can tap or click on checkbox(es) 1505/1510 to select one or more contact(s) and unique identities and can tap or click on “Multi ChatCall” or “Multiple text calls” button or icon or link or control 1515 for one to one text call with each selected contact(s) or unique identities. In the event of selecting one or more contact(s) and unique identities 1505/1510 and making multiple text calls, automatically creating tabs 1520/1525 for each said selected contacts 1505/1510 and displaying outgoing text call interface 1550 to caller user for each text call which can access via said created tabs 1520/1525 for each called contacts or unique identities and displaying incoming text call interface 1588 to each called user or callee for enabling called user to accept 1590, reject 1595, remind me 1580 and remind with text 1585 incoming text call. In the event of acceptance of text call by called user closing outgoing text call interface 1550 related to said called user and displaying chat interface 1555 or instant messenger user interface 1555 or messaging application 1555 or one or more types of one or more applications, user interfaces, media and any combination thereof 1555. In an embodiment user can also view in tabs various information, status and controls including icon, image, name, details of called user in user interface of calling user device and icon, image, name, details of calling user in user interface of called user device, display “outgoing text call” or “calling” and cancel call control or button while outgoing call in tab user interface of calling user device and display “incoming text call” and accept and reject controls or buttons while incoming call in tab user interface of called user device. In the event of acceptance of a text call by called user, display the end button in the tab user interface of both calling and called user device for enabling them to end the call. Calling user can select tab and can view outgoing call interface and can view call status or can cancel call or in the event of rejection or miss call by calling user then hide or close or remove outgoing call interface and said related tab from user interface or in the event of acceptance of call by called user, calling user can converse 1565 with called user via displayed chat interface 1555 or instant messenger user interface 1555 or messaging application 1555 or one or more types of one or more applications, user interfaces, media and any combination thereof 1555. Called user can select tab (if at least two pending or accepted calls) and can view incoming call user interface and in the event of acceptance of call, displaying chat interface or instant messenger user interface or messaging application or one or more types of one or more applications, user interfaces, media and any combination thereof (not shown in figure) and can converse with called user or in the event of reject call or miss call, hide or close or remove incoming call interface and said related tab from user interface. Users can select contacts via clicking on contact icon 1501/1574 and selecting one or more contacts, groups, unique identities inside multiple text calls management parent user interface 1545/1555 and can make one or more text calls or multiple text calls or group text call(s).

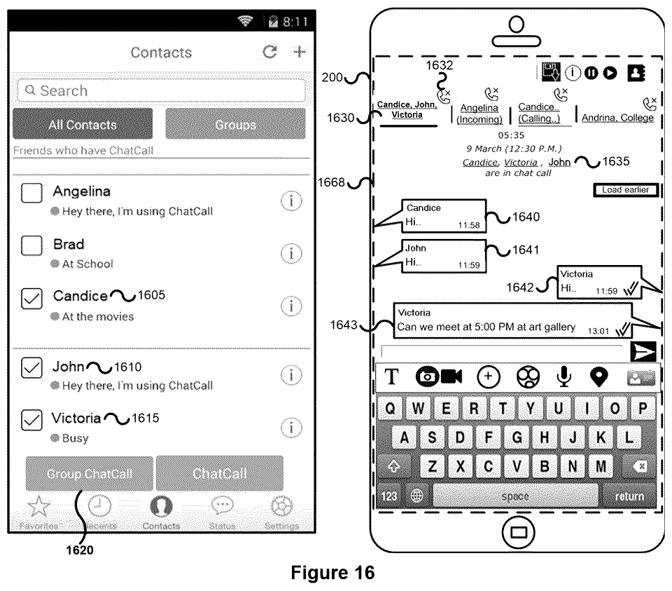

FIG. 16 illustrates exemplary graphical user interfaces (GUI) wherein in another embodiment in the event of selecting one or more types of one or more contacts, unique identities, groups, followers, mutual connected users, types, categories, and keywords related users, queries including structured queries languages (SQL) query(ies) based users 1605/1610/16015 by calling user or automatically determining contacts or users and unique identities based user's current or monitored or tracked or logged activities, actions, participations, status, locations and associated places, communication, schedules, digital activities including visit website, become member, take call-to-action(s), purchase products, make payments, interacted or visited or related or transacted entities including shop, person, school, college, restaurant, brands, purchased products, service providers 1605/1610/16015 or selecting contacts or unique identities from said automatically determined users or contacts 1605/1610/16015 and clicking or tapping on “Group ChatCall” or “Group Text Call” icon or button or control or link 1620, displaying outgoing group (i.e. set of selected contacts or dynamically created group or temporary group) text call user interface to calling user with cancel text call button and displaying incoming text call to each said selected contacts or unique identities and enable to accept or reject group text call. In the event of accepting of group text call, displaying group chat interface 1668 or instant messenger user interface 1668 or messaging application 1668 or one or more types of one or more applications, user interfaces, media and any combination thereof 1668 to each called users and enabling calling user and called users to view participated members details including names, photos, profile links to view detail profile and associated settings (discussed in detail in FIG. 11) 1630/1635 exchange messages or send and receive messages or converse 1640, 1641, 1642, 1643 with each other. In another embedment, in a group or dynamically created group (i.e. set of selected contacts) call when the call initiator ends call 1632 then the ending call from all members 1635. In another embodiment, in group or dynamically created group (i.e. set of selected contacts) call when any members can end call 1632 to leave conversation and if last one of the two remaining members ends call then end call.

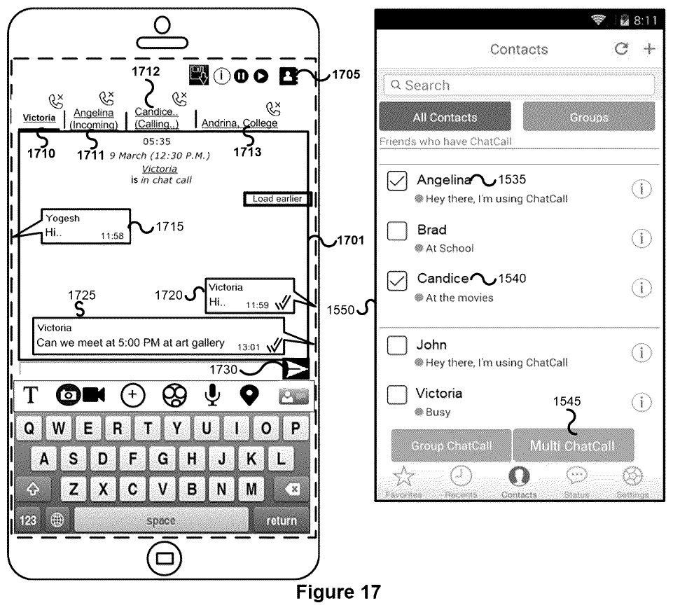

FIG. 17 illustrates exemplary graphical user interfaces (GUI) wherein in an embodiment during ongoing first text call or one or more ongoing one or more types of text calls, enabling user to make one or more subsequent text calls including select particular contact or unique identity and make call, select one or more contacts and unique identities and make multiple text calls individually, select one or more groups and make group call(s), select one or more contacts and unique identities and make group call, select one or more contacts and unique identities and add call accepted users to selected currently active or ongoing text call or add incoming one or more text calls to selected currently active or ongoing text call. FIG. 17 illustrates exemplary graphical user interfaces (GUI) shows different types of calls including active 1710, incoming 1711, outgoing 1712, multi selective contacts and group text 1713 calls. User is configured to switch tabs within parent user interface 1701 to manage selected tab associated active text call and associated chat or instant messaging interface or incoming text call and associated incoming text call user interface with accept, reject and other controls or outgoing text call and associated outgoing text call user interface with cancel text call control or group text call and associated group chat or instant messaging interface or list of contacts and unique identities for enabling user to select one or more contacts and unique identities and make one or more types of text calls including call for instant messaging (CIM), call for message (CMS) and call for posting and reactions (CPR), multiple text calls, group text calls, individual text calls and any combination thereof. For example, when a user clicks or taps on tab 1710 then the user is enabled to view sent and received messages or shared contents and enable to input and send new message 1730 to the called user. Users are enabled to select one or more contacts, groups and unique identities from a list of contacts, groups and unique identities 1550. For example, when a user taps or clicks on a contacts icon 1705 then the user is presented with a list of contacts, groups and unique identities 1550 for user selection. In the event of selection of contacts 1535, 1540 and clicking or tapping on “Multi ChatCall” or “Multi text call” button or control 1545, server receives calling or caller user identity, identities of said selected contacts 1535, 1540, request for making text call to said selected contacts 1535, 1540. Server 110 sends the calling user's identity and associated details to each said selected contact's device and invokes and displays incoming text call user interface to each said called contacts and enables them to accept or reject text calls. In the event of incoming text call acceptance by called user, starting or initiating communication session or channel and displaying chat interface or messaging user interface to both calling user and called user(s) for enabling them to view, access, send, receive, store, remove, edit messages, pause or restart sending and receiving of messages, and end call. In the event of ending of text call by calling or called user, terminate call or ending current text call session or close channel or hide or close said invoked or opened chat interface or messaging user interface from both calling and called user's device.

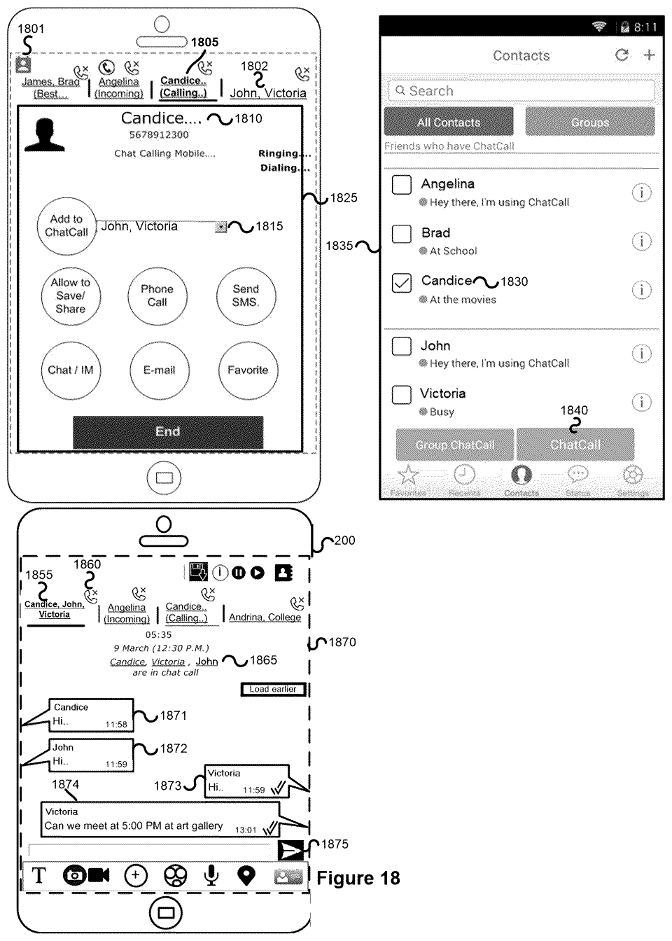

FIG. 18 illustrates exemplary graphical user interfaces (GUI) wherein during at least one active ongoing text call user can click or tap on contact icon 1801 to view list of contact and unique identities 1835 and can select one or more contact(s), unique identities, group(s) and any combination thereof (e.g. select 1830) and make text call 1840 or directly tap on contact 1830 and make text call and in an embodiment displaying outgoing text call interface 1825 to calling user wherein calling user can view list of current ongoing active text calls 1815 including one or more individual text calls and group text calls for enabling calling user to select particular active text call from list. In the event of text call accepted by called user [Candice] 1810 then add said call accepted user [Candice] to said selected text call 1855. In another embodiment enabling user to select one or more contacts (e.g. select 1830) and make text call 1840 or directly tap on contact 1830 and make text call and in the event of call accepted by said called user [Candice], displaying list of current active text calls 1815 for enabling calling user to select particular currently active text call 1815 from list of currently active and ongoing text calls 1815 for adding said call accepted user [Candice] to said calling user selected currently active text call 1815. In another embodiment notifying added call accepted user about adding of call accepted user in particular text call 1855 and provide details about participant members [John] and [Victoria] and in an embodiment displaying all or selected messages exchanged among participant members [John] and [Victoria] before addition of user [Candice] in text call 1855 and enable text call 1855 participant members [John], [Victoria] and [Candice] to send, receive and view messages 1871/1872/1873/1874.

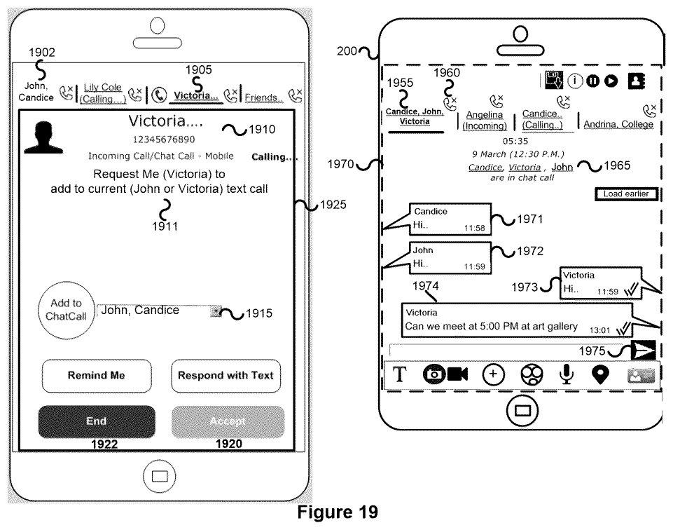

FIG. 19 illustrates exemplary graphical user interfaces (GUI) wherein during at least one active ongoing text call (e.g. 1902) and in an embodiment in the event of incoming text call 1925 user can view list of current ongoing active text calls 1915 including one or more individual text calls and group text calls for enabling user to select particular active text call 1915 from list and can accept 1920 and reject call 1920. For example in the event of selection of current text call [John, Candice] 1915 from list of active text calls 1915 and acceptance of text call by clicking or tapping on accept 1920 button, adding said incoming text call of [Victoria] to current text call [John, Candice] 1902 and displaying updated tab 1955 and updated chat interface or instant messenger interface or one or more types of applications or user interfaces (e.g. 1965) to [John], and [Candice] and displaying chat interface or instant messenger interface or one or more types of applications or user interfaces to newly added user [Victoria] with in an embodiment all conversed messages or in another embodiment only display currently exchanged messages and now enabling [John], [Candice] and [Victoria] 1955 to send and receive messages 1971, 1972, 1973, 1974. In another embodiment enabling the calling user to send requests to add said calling user to particular contact(s)'s text call. For example [Victoria] makes a call with a request to add [Victoria] to a text call wherein participant users are [John] and/or [Candice] or both 1911.

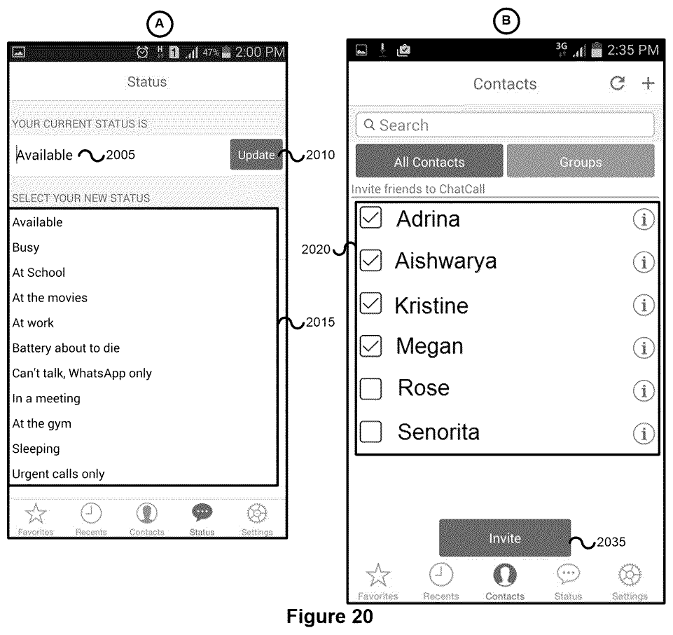

FIG. 20 (A) illustrates exemplary graphical user interfaces (GUI) wherein a user is configured to input or select from list 2015 2010 and set or update current status 2005 of user. In another embodiment FIG. 20 (B) illustrates exemplary graphical user interfaces (GUI) wherein user is configured to select one or more contacts and/or one or more types of unique identity(ies) 2020 and invite 2035 said selected one or more contacts and/or one or more types of unique identity(ies) 2020 from list to using and/or installing text all applications. In another embodiment in the event of non-detection of text call applications and accounts, displaying incoming text call user interface and chat or instant messaging user interface in default or pre-set or installed web browser in website or webpage for enabling non-registered user to accept and attend text call(s) and send and receive messages and one or more types of contents.

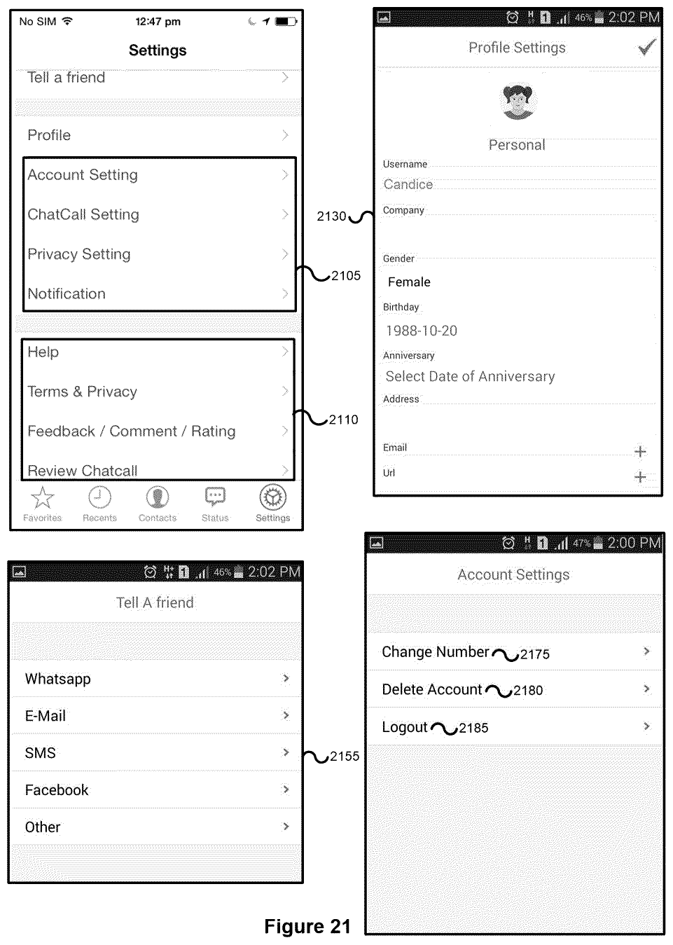

FIG. 21 illustrates exemplary graphical user interfaces (GUI) wherein user is configured to view and update user profile details 2130, view and update various types of settings 2105 including account settings, text call settings, privacy settings and notification settings, and view helps and get support, provide feedbacks and reports, and view terms and privacy 2110. In an embodiment user can invite friends and all or selected contacts and connections of one or more external networks including social networks, applications, websites including phone contacts, email addresses, followers, mutual connections, friends on social networks and professional networks by sending or sharing invitation via one or more external networks including Facebook, E-mail, SMS, WhatsApp, Twitter, Snapchat, Bluetooth, nearby users, scan code, web browser and like 2155. In another embodiment enabling user to change number 2175, verify phone number via one-time password (OTP) and restore backup data from one or more sources or copy data to particular named folder, delete account 2180 and logout from text call application or service 2185.

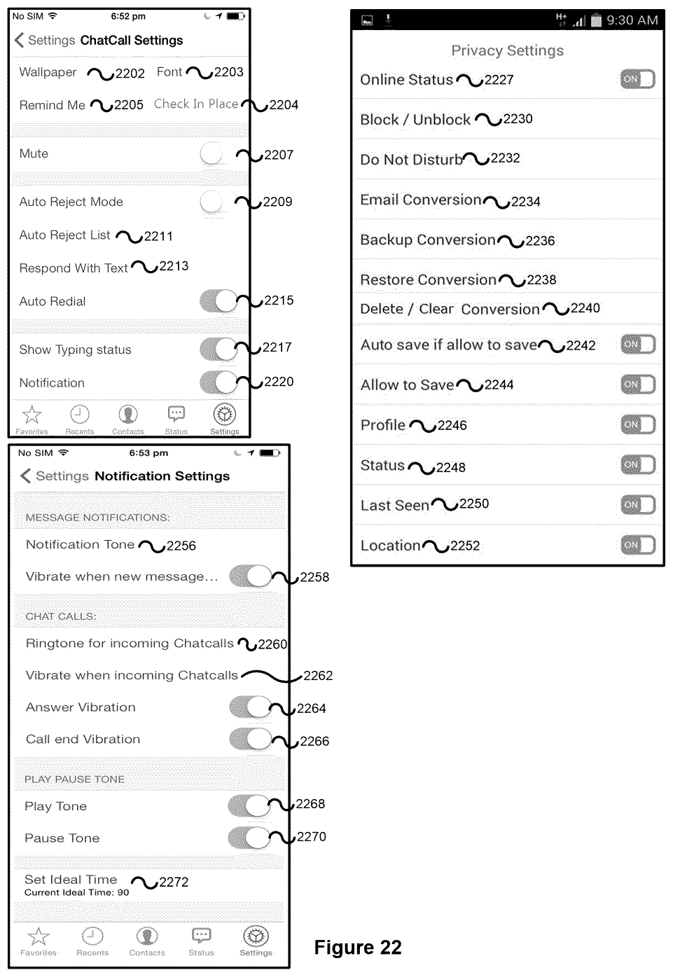

FIG. 22 illustrates exemplary graphical user interfaces (GUI) wherein users can view, set, select, update and apply one or more types of settings including text call settings, notification settings and privacy settings. Text call settings may comprises select or set font name, size, color set font size to small, medium or large 2203, select current place from list 2204 or set check in place to share with all or selected contacts and/or one or more types of one or more unique identities, select wallpaper for all contacts or selected contacts and/or one or more types of one or more unique identities 2202, remind me settings <No. of Hour> 2205, mute or unmute incoming ChatCall or text call from all contacts or selected contacts and/or one or more types of one or more unique identities 2207, set auto reject mode to On or Off by using switch button 2209, manage auto reject list 2211 (Add/Remove Contact(s) to/from List—If Auto Reject Mode is On then all incoming calls from List auto rejected), Update list of respond with text 2213, turn auto redial setting On or Off 2215, select Show or Not Show Typing Status by turn On or Off button 2217, turn notification (On/Off) to receive or not-receive any type of ChatCall or text call notification 2220. Privacy settings may comprises show or not show online status to all contacts or selected contacts and/or one or more types of one or more unique identities 2227, Block or Unblock selected contacts and/or one or more types of one or more unique identities from list 2230, Turn on do not disturb including Manual, allow within pre-set schedule, allow text call from all, or selected contact(s), unique identities & favorite only, accept only repeated calls (for example if somebody call more than 3 times) 2232, Email Conversation of all or selected contacts and unique identities 2234, delete or Clear Conversation of all or selected contacts and unique identities, backup conversation 2236 to local or selected remote cloud storage, restore conversation (For example, For restore user have to uninstall and install app and select “Backup file” from list OR manually copy and replace backup file to ChatCall or text call/Database/Folder and change file name “HH-MM-SEC-DD-MM-YY_ChatCall_DB” to “ChatCall_DB”) 2238, turn on or off auto save conversations of contacts who provided allow to save right to user 2242, Provide allow or not allow to save rights to all or selected contacts and unique identities by turn (On/Off) button 2244, set show profile or not show profile to all or selected contacts and unique identities 2246, set show status or not show status to all or selected contacts and unique identities 2248, set show last seen or not show last seen to all or selected contacts and unique identities 2250, and set show or not show location or place to all or selected contacts and unique identities 2252. Notification settings may comprises message notification including view or play and set notification tone, set vibrate when new message arrives by using turn On or Off switch button 2258, ChatCalls or Text calls notification including view or play and set ringtone for incoming ChatCalls or text calls 2260, set vibrate when incoming ChatCalls or text calls by using turn On or Off switch button 2262, turn On or Off ChatCall or text call answer vibration by using On/Off switch button or control 2264, turn On or Off call end vibration by using On/Off switch button or control 2266, Play/Pause Tone including turn On or Off ChatCall or text call restart or play tone by using On/Off switch button or control 2268, turn On or Off ChatCall or text pause tone by using On/Off switch button or control 2270 and set ideal time for pre-set duration 2272, so in the event of non-sending of message within call session for said pre-set duration then play pre-set ringtone or send notification or message.

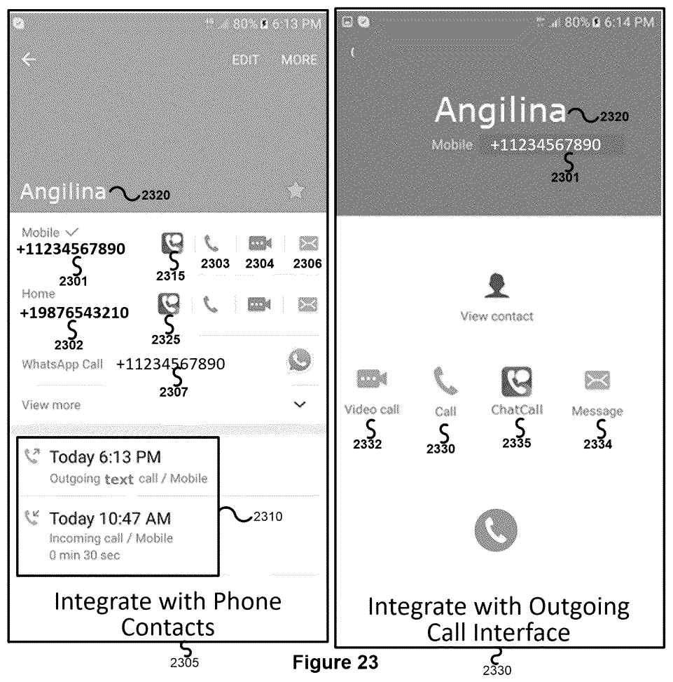

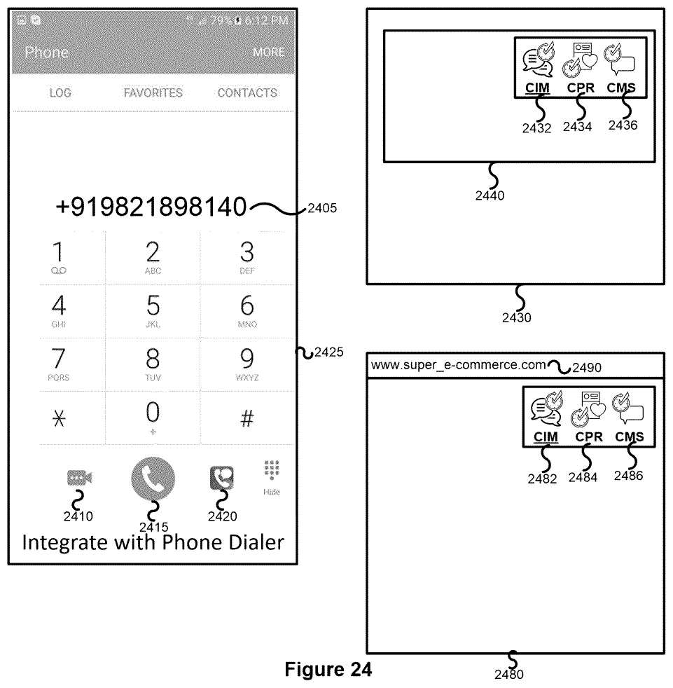

In an embodiment integrating text call application(s) and service(s) to phone contacts, outgoing phone call interface and phone dialer of phone application for enabling user to access text call via selecting text call icon and invoking text call application and making text call to said contact associated or contact's selected phone number associated person. FIGS. 23-24 illustrates exemplary graphical user interfaces (GUIs), wherein enabling user to making text call to inputted phone number 2405 or enabling user to making text call to selected phone contact 2301 associated with particular contact 2320 by clicking or tapping on Phone Contacts 2305 of phone application integrated text call icon 2315/2420 which invokes and displays outgoing text call user interface to calling user with cancel and other controls and incoming text call user interface to one or more called user(s) with accept, reject and other controls and in the event of call acceptance by said called phone contact, displaying chat interface or instant messaging application or user interface and one or more selected applications or user interfaces to calling and called users to enabling calling and called user to send and receive messages up-to end of text call by tapping or clicking on end button by calling and/or called user (discussed in detail in FIGS. 6-8). In another embodiment users can make phone calls to a particular contact's selected phone number and can switch phone calls during calling or during establishment of phone call session to text call by tapping or clicking on text call icon 2335. In another embodiment user can make text call to particular contact's selected phone number and can switch text call to phone call 2330 by tapping or clicking on phone call icon 2303 or switch to video call 2332 or switch to SMS 2334 or switch to default or pre-set instant messenger application (e.g. WhatsApp). In another embodiment text call is integrated with each phone numbers 2301/230 of each contact of phone book contacts of phone application. In another embodiment user can view log details of incoming text calls, outgoing text calls and group text calls 2310, wherein logged text call details comprises type of call, incoming or outgoing text call, date and time, duration of text call, number of messages sent and received, type of network used for text call including cellular or data networks or both, paused duration, restart after duration, call end by user, phone number, profile photo, name and profile link, if group text call then additional details comprises group name, details of participant members, list and logs of past text calls. In an embodiment enabling users to make text calls from phone logs, favorite or suggested contacts, and searched contacts.

In another embodiment enable external developers, websites, applications and service providers to integrate text call application(s) and service(s) with website and web page 2490/2480, application 2430, feature of application 2440, graphical user interface (GUI) 2430, document, form, multimedia or content, control, objects, widget and any types of digital content 2430/2480 and inside 2440 any types of digital contents 2430/2480 via application programming interfaces (APIs) and software development kits (SDKs) by integrating text call button(s) or one or more types of controls 2432/2434/2436/2482/2484/2486 including image, icon, link or web address with said website, web page, application, feature of application, graphical user interface (GUI), document, form, multimedia or content, control, objects, widget and any types of digital content and inside any types of digital contents, wherein text call button(s) or one or more types of controls comprises call for instant messaging (CIM) button or control 2432/2482, call for sending and displaying message or SMS (CMS) button or control 2434/2484 and call for post and get reactions (CPR) button or control 2436/2486 and wherein said button or control associated with one or more types of unique identities including phone number, email address, user name, website name and like. Calling user need to log-in or provide calling user's one or more types of unique identities including phone number, email address, user name or external websites and applications share said calling user's one or more types of unique identities including phone number, email address, username to server 110.

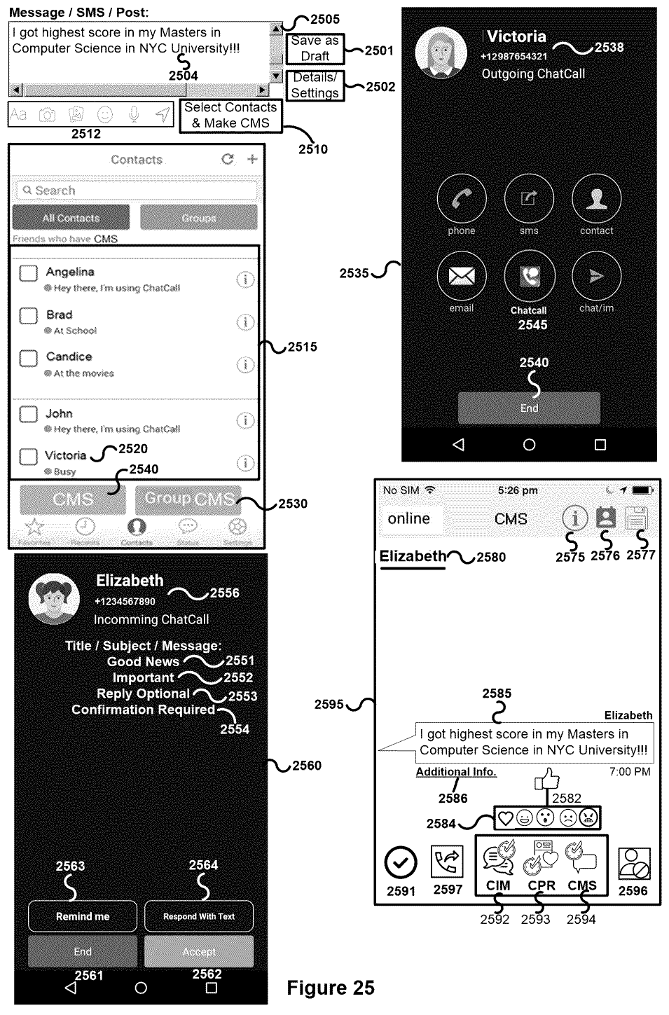

FIG. 25 illustrates exemplary graphical user interfaces (GUIs) wherein user can draft, edit, update, augment 2504 message or SMS or post or one or more types of contents 2505 including input, select, capture and record text, photos, videos, audio, uniform resource location (URL) or links, location information, emoticons, stickers, files, one or more types of digital contents 2512 and any combinations thereof. User is configured to prepare a new message or search, select and edit or augment message or one or more types of contents from list of draft messages or list of templates of messages. Users are enabled to save message 2504 as draft 2501 for later use. After preparing and selecting message 2504 users can click or tap on “Select contact and make call for sending and displaying message or SMS” button 2510 for selecting one or more contacts, connections, followers, groups, unique identities, and queries based users 2515 and make CMS. In an embodiment in the event of preparing and selecting message 2504 and selecting contact 2520 by tapping or clicking on “CMS” button 2540 to select contact(s) from list 2515 and tapping or clicking on “CMS” button 2540 (if individual contact selection from list 2515)/“Group CMS” button 2540 (if more than one contacts or group(s) selection from list 2515) or directly tapping or clicking on individual contact 2520, sending request for call for sending and displaying message or SMS (CMS) 272 from client device 200 to server 110 module 154, wherein request comprises calling user identity and metadata, based on settings location information including current place, map, address and associated details, one or more called users' identities, associated settings including ringtone, allow to save, type of call and metadata, status, preferred type of network, selected one or more applications, user interfaces and media and any combinations thereof, date and time of call, calling user device's system data and meta data, subject or agenda or title or message or selected and/or edited template or list, type of message including No Reply Required, Reply Required or Reply Requested and Reply Optional (default), level of importance of message including important, urgent, general, rank of sender, wherein rank of sender is determined based on number of past accepted CMS calls, number of CMS calls happened between calling and called users, type of relationships, manual rating, favorite contact, frequency of calls and like. In one embodiment displaying outgoing CMS text call interface 2535 with controls including cancel or end control or button to calling user for cancelling outgoing call for sending and displaying message or SMS (CMS). In an embodiment displaying incoming CMS text call interface 2560 with accept button for accepting CMS text call and reject button for rejecting CMS text call and other controls including remind me, respond with text buttons to each called user. In the event of accepting a CMS text call, sending and displaying said prepared or selected message or SMS 2585 to each called user in user interface 2595. In another embodiment enabling the viewing user of said message or called user [e.g. Victoria] to confirm viewing of said message 2585 by tapping or clicking on button or icon or image or control 2591. In another embodiment enabling viewing the user of said message or called user [e.g. Victoria] to select emoticon 2582 from a list of one or more types of emoticons, expressions, reactions or stickers 2584. In another embodiment enabling viewing user of said message or called user [e.g. Victoria] to block or apply do not disturb settings (schedule, allow or not allow for CMS, accept only after pre-set attempt of CMS calls, accept if message is important or no reply required) 2596 for CMS calling user or message sender. In another embodiment enabling the viewing user of said message or called user [e.g. Victoria] to make reply CIM 2592 or CMS 2593 or CPR 2594 to said called user [e.g. Elizabeth] from inside user interface 2595. In another embodiment enabling viewing user of said message or called user [e.g. Victoria] to tap or click on forward 2597 said received message 2585 by selecting contacts and making CMS to said selected contacts and in the event of CMS call acceptance by said selected contact(s), displaying said message 2585 to said selected contact(s). In another embodiment in the event of non-acceptance of CMS call within pre-set duration, logging and informing calling and called user about missed calls with associated details. In another embodiment in the event of rejecting a CMS call by called user, logging and informing calling and called user about rejected calls with associated details. In another embodiment enabling the viewing user of said message or called user [e.g. Victoria] to select contact(s) from list of contacts 2576 and make CIM or CMS or CPR.

In an embodiment user can first select one or more contacts and unique identities and then prepare or select messages and then make a CMS call to said selected one or more contacts and unique identities.

In an embodiment in the event of preparing and selecting message or SMS 2504 and selecting one or more contact(s) 2520 and tapping or clicking on “CMS” button 2540 (if individual contact selection from list 2515)/“Group CMS” button 2540 (if more than one contacts or group(s) selection from list 2515) or directly tapping or clicking on individual contact 2520, sending request for call for sending and displaying message or SMS (CMS) 271 from client device 200 to server 110 module 154, server module 154 sends message or SMS 2504 to said called user(s) and directly displaying said received message or SMS 2585 to called user's interface 2595 and enable message or SMS 2585 receiving or viewing user to tap on “Confirm Viewing” button or icon or image or link or control 2591 for providing one or more types of confirmation or indication of viewing of received message to calling user in one or more forms including send notification including push notification, in-application notification, in-browser or website or webpage notification contains details regarding viewing of said sent message by calling user to particular called user, wherein details comprises name and unique identity including phone number, email address, user name of called user, date and time of message send by calling user, date and time of message received by called user, date and time of message viewing by called user, date and time of confirmation of viewing of message provide by called user, type of confirmation including immediate or real-time (if message viewed within pre-set duration), not receiving confirmation of viewing of message (if message not viewed within pre-set duration or non-receiving of message viewing confirmation indication within pre-set duration). In other embodiment enabling user or calling user to provide additional details and settings for sending and making CMS, wherein additional details and settings comprises title or subject or agenda, type of message including important, urgent, general, and ephemeral, type of reply including no reply, reply required, reply requested, reply optional, type of message viewing confirmation including confirmation of viewing message required and confirmation of viewing message not required and in the event of preparing message 2504, providing additional details and settings 2502, selecting one or more contacts 2520 from list of contacts 2515 and making CMS 2540/2530, displaying said additional details and settings 2551/2552/2553/2554 in outgoing CMS text call interface 2560 and displaying with message 2586. In an embodiment calling user can prepare message and make said message as ephemeral message by providing setting and pre-set life and view duration of message and make CMS text call to selected contacts. In the event of acceptance of CMS text call, displaying said message and start and display timer for pre-set duration and in the event of expiration of timer, hide or remove said displayed message from receiving or called user's interface, storage of device and/or storage of server.

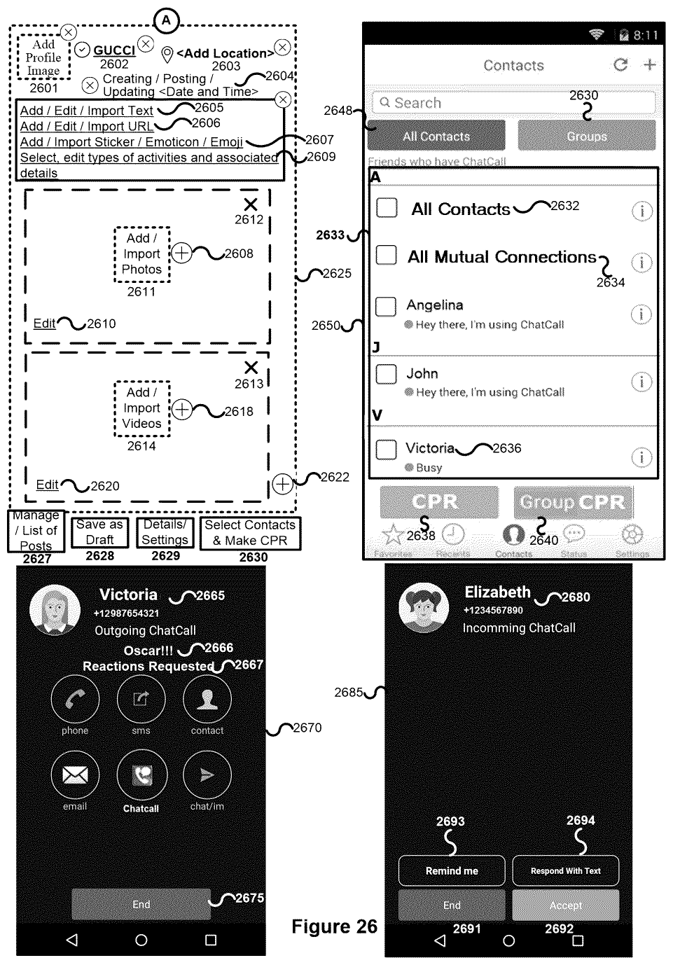

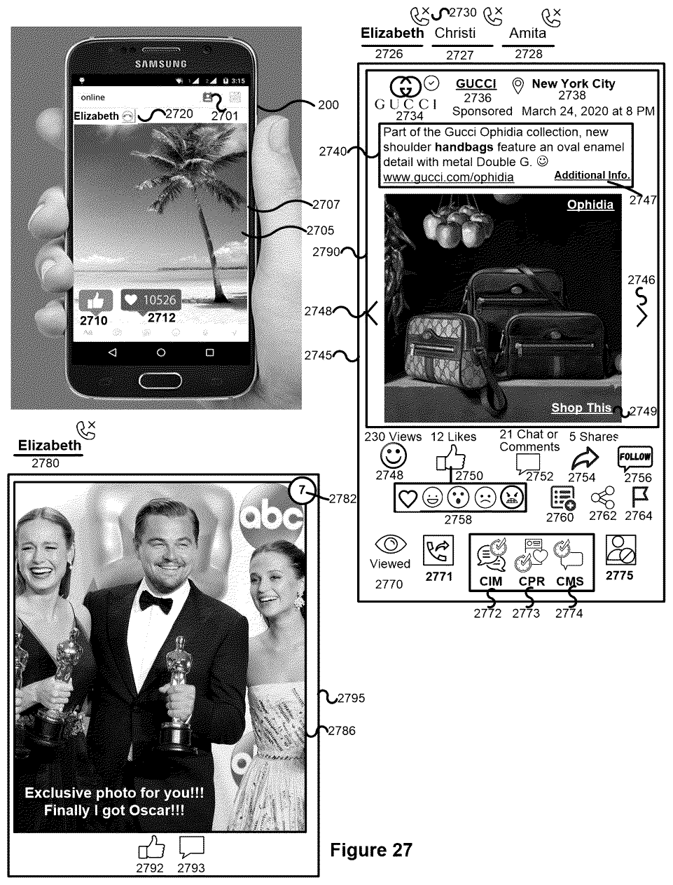

FIGS. 26-27 illustrates exemplary graphical user interfaces (GUIs) wherein enabling user to prepare, draft, sect from list, edit, update, remove, save and augment one or more posts or one or more types of contents including text, photos, videos, audio, voice, image, uniform resource location (URL) or links, location information, emoticons, stickers, files, one or more types of objects, application links, actions or call-to-actions and reactions controls including select emoticons, expressions (e.g. like, dislike, wow), follow, connect, share contact information, book (tickets, table, appointment), buy, add to cart, participate in group deal, claim coupon or voucher or offer, participate in event, become member, make payment, order, sell, view, provide status, location information and updates, reshare and one or more types of digital contents. For example FIG. 26 (A) illustrates exemplary graphical user interfaces (GUIs) wherein user can prepare one or more posts 2622 by using post editor or wizard or user interface 2625 and user is configured to add, update and remove profile photo or image 2601, linked profile, name or user name or brand name or account name or company name 2602, location information including address, selected place or geofence on map, geo coordinates, selected place from list of places or nearby places 2603, date and time 2604, add, edit import, select text or rich text 2605, one or more uniform resource locators (URLs) or web addresses or short links 2606, stickers, emoticons, emojis, images 2607, one or more photos 2608, videos 2618. In an embodiment enabling user to select types of activities and associated selected or inputted or edited details 2609, wherein if type of activity is reading then select book from list of books, if type of activity is eating then select place associated menu items from list of food items or menu or if current location of user is home then select from list or templates, if type of activity is watching and current place of user is movie theater then select movie from list of movies currently running in said movie theatre or multiplexes or current place of user is home then select from templates or list or list of currently playing televisions serials, if type of activity is shopping then select current place, if type of activity is playing then select from list of sports, likewise types of activities comprises talking, studying, listening, walking, running, travelling and like.

In an embodiment user can draft, edit, update, augment post or message or one or more types of contents 2625 including input, select, capture and record text, photos, videos, audio, uniform resource location (URL) or links, location information, emoticons, stickers, files, one or more types of digital contents 2625 and any combinations thereof. User is configured to prepare a new post or search, select and edit or augment post or message or one or more types of contents from a list of drafted posts or messages or list of templates of posts or messages. Users are enabled to save 2628 posts or message 2625 as draft for later use. After preparing 2625 and selecting 2627 post(s) or message(s), user can click or tap on “Select contact and make call for sending and displaying post or message and get reactions” button 2630 for selecting one or more contacts (e.g. select 2636) or all contacts 2632, selected or all mutual connections 2634 including friends and professional connections based on invitation accepted contacts or invitation of contacts accepted by user, followers, groups, unique identities, and queries based users 2633 and make call for posting and getting reactions on post (CPR) 2638 or 2640. In an embodiment in the event of preparing and selecting post or message 2625 and selecting contact 2633 by tapping or clicking on button 2630 to select contact(s) from list 2633 or use default selected contacts including all contacts 2632 or all mutually connected users 2634 and tapping or clicking on “CPR” button 2838 (if individual contact selection from list 2636)/“Group CPR” button 2640 (if more than one contacts or group(s) selection from list 2633) or directly tapping or clicking on individual contact 2636, sending request for call for sending and displaying post message and get reactions on displayed (CPR) 273 from client device 200 to server 110 module 155, wherein request comprises calling user identity and metadata, based on settings location information including current place, map, address and associated details, one or more called users' identities, associated settings including ringtone, allow to save, type of call and metadata, status, preferred type of network, selected one or more applications, user interfaces and media or selected one or more applications and user interfaces of newsfeed or feed or post viewers and any combinations thereof, date and time of call, calling user device's system data and meta data, subject or agenda or title or message or selected and/or edited template or list, type of message including No Reply or Reactions Required, Reply or Reactions Required or Requested and Reply or Reactions Optional (default), level of importance of post or message including important, urgent, general, rank of sender, wherein rank of sender is determined based on number of past accepted CPR calls, number of CPR calls happened between calling and called users, type of relationships, manual rating, favorite contact, frequency of calls and like. In one embodiment displaying outgoing CPR text call interface 2670 with controls including cancel or end control or button 2675 to calling user for cancelling outgoing call for sending and displaying post or message (CPR). In an embodiment displaying incoming CPR text call interface 2685 with accept button 2692 for accepting CPR text call and reject button 2691 for rejecting CMS text call and other controls including remind me 2693, respond with text 2694 buttons to each called user. In the event of accepting CPR text call, sending and displaying said prepared or selected post or message 2705/2745/2786 to each called users in user interface 2707/2790/2795. In another embodiment enabling the viewing user of said post or message or called user [e.g. Victoria] to confirm viewing of said post or message 2770 by tapping or clicking on “Viewed Post” button or icon or image or control 2770. In another embodiment enabling the viewing user of said message or called user [e.g. Victoria] to select emoticons 2750/2710 from a list of one or more types of emoticons, expressions, reactions or stickers 2758. In another embodiment enabling viewing user of said post or message or called user [e.g. Victoria] to block or apply do not disturb settings (schedule, allow or not allow for CPR, accept only after pre-set attempt of CPR calls, accept if message is important or no reply or reactions required) 2775 for CPR calling user or message sender. In another embodiment enabling the viewing user of said post or message or called user [e.g. Victoria] to make reply CIM 2772 or CMS 2773 or CPR 2774 to said called user [e.g. Elizabeth] from inside user interface 2745. In another embodiment enabling viewing user of said post or message or called user [e.g. Victoria] to tap or click on forward 2771 said received post or message 2790 by selecting contacts and making CPR to said selected contacts and in the event of CPR call acceptance by said selected contact(s), displaying said post or message 2790 to said selected contact(s). In another embodiment in the event of non-acceptance of CPR call within pre-set duration, logging and informing calling and called user about missed call with associated details. In another embodiment in the event of rejecting CPR call by called user, logging and informing calling and called user about rejected calls with associated details. In another embodiment enabling the viewing user of said post or message or called user [e.g. Victoria] to select contact(s) from list of contacts 2701 and make CIM or CMS or CPR.

In an embodiment in the event of preparing and selecting post or message or content 2625 and selecting one or more contact(s) 2633 or use default or pre-set contacts including all contacts 2632 or all mutually connected users 2634 and tapping or clicking on “CPR” button 2638 (if individual contact selection from list 2515)/“Group CPR” button 2640 (if more than one contacts or group(s) selection from list 2650) or directly tapping or clicking on individual contact 2636, sending request for call for sending and displaying post or message or content (CPR) 273 from client device 200 to server 110 module 155, server module 155 sends post or message or content 2625 to said called user(s) and directly displaying said received post or message or content 2625/2705/2790/2786 to called user's interface 2707/2745/2795 and enable post or message or content receiving or viewing user to tap on “Post Viewed” button or icon or image or link or control 2770 for providing one or more types of confirmation or indication of viewing of received post or message to calling user in one or more forms including update or display viewing user's name in sent posts of feed of calling user's interface or send notification including push notification, in-application notification, in-browser or website or webpage notification contains details regarding viewing of said sent post or message by calling user to particular called user, wherein details comprises name and unique identity including phone number, email address, user name of called user, date and time of post or message send by calling user, date and time of post or message received by called user, date and time of post or message viewing by called user, date and time of confirmation of viewing of post or message provide by called user, type of confirmation including immediate or real-time (if post or message viewed within pre-set duration), not receiving confirmation of viewing of post or message (if post or message not viewed within pre-set duration or non-receiving of post or message viewing confirmation indication within pre-set duration). In other embodiment enabling user or calling user to provide additional details and settings for sending and making CPR, wherein additional details and settings comprises title or subject or agenda, type of post or message including current, current activity, important, urgent, selfie, general, status, updates, and ephemeral, type of reply including no reply or reactions, reply or reactions required or requested, reply or reactions optional, type of post or message viewing confirmation including confirmation of viewing post or message required and confirmation of viewing post or message not required and in the event of preparing post or message 2625, providing additional details and settings 2629, selecting one or more contacts 2636 from list of contacts 2633 and making CPR 2638/2640, displaying said additional details and settings 2666/2667 in outgoing CPR text call interface 2670 and displaying with post or message 2747. In an embodiment calling user can prepare post or message and make said post or message as ephemeral message by providing setting and pre-set life and view duration of post or message and make CPR text call to selected contacts. In the event of acceptance of CPR text call, displaying said post or message and start and display timer for pre-set duration and in the event of expiration of timer 2782, hide or remove said displayed post or message 2786 from receiving or called user's interface 2795, storage of device and/or storage of server. In various embodiments enabling post viewing user(s) to view updated number of views 2748 of post 2790, real-time chat or sending and receiving messages up-to end of CPR text call or on provide comments 2752 on post 2790, forward 2754 post 2790, follow 2756 post 2790 associated source, share 2760 post 2790, report 2764 post 2790, add post 2790 to list 2760. In an embodiment enabling a user to provide reactions after ending of CPR call, wherein updating reaction statistics in all post received users. In an embodiment user can first select one or more contacts and unique identities and then prepare or select a post and then make CPR call to said selected one or more contacts and unique identities. In an embodiment enabling a user to select one or more contacts and make multiple individual CPR text calls. In an embodiment enabling a user to manage multiple incoming and outgoing CPR text calls. In an embodiment enabling users to automatically select pre-drafted unposted contents and make scheduled CPR calls to followers. In an embodiment in the event of missed CPR call or CPR call rejected by called user(s) then enabling called user(s) to view post later and provide reactions later. In an embodiment enabling calling user to make CPR call and send post and in the event of acceptance of CPR call, updating or removing post(s) or sending new one or more post(s) which call accepted user can view by tapping on next button or icon or control 2746 or view previous posts by tapping on button or icon or control 2748. In an embodiment enabling post viewing user to click or tap on post overlay or post embedded or post integrated one or more types of one or more actions or call-to-actions controls or objects or user interfaces or applications 2749 to take associated action(s) or invoke or access user interface or application or media. In an embodiment in the event of displaying of ephemeral posts, displaying first ephemeral post for associated pre-set duration timer and in the event of expiration of first ephemeral post associated timer, hide or remove first ephemeral post and display second ephemeral post for associated pre-set duration timer and in the event of expiration of second ephemeral post associated timer, hide or remove second ephemeral post and in the event of expiration of timer associated with last ephemeral post, ending CPR call. In an embodiment enabling the user to provide one or more types of reactions 2792 or reply 2793 during displaying of ephemeral posts or during the call session.

In an embodiment enabling the user to publish or update real-time status or status post 2625. Users can pre-select or pre-set or update contacts 2633 to whom the user wants to automatically make CPR calls and in the event of acceptance of call, display new or updated status or status post 2625. In the event of publishing or updating status or status post 2625, automatically make CPR text call to said pre-selected one or more contacts and in the event of accepting of call by called user(s) or clicking or tapping on notification, displaying said updated or published status or status post 2707/2790/2786 and enabling call accepted or viewing user(s) to provide one or more types of reactions 2750/2752/2710/2712/2792/2793 on said status or status post 2707/2790/2786 and updating said reactions to user interface of all viewing users of said status or status post 2707/2790/2786. In an embodiment enabling to associate ephemeral settings with status or status post, wherein ephemeral settings including set viewing duration and life duration, so viewing user can view said received ephemeral status or post for pre-set duration or period of time and in the event of expiration of said pre-set view duration or life duration, hide or remove displayed post. In an embodiment displaying suggested templates of status or status post for enabling user to quickly edit and post current status of user, wherein displaying suggested templates of status or status post based on identifying current place of user and associated possible activities based on monitored and tracked user device's current location and identified said location associated place and place associated possible activities and event, identified current activity, current transaction based on liked system, nearby contacts, current date and time and associated identified activities based on calendar entries and schedules, user profile, logged data, external linked systems, databases and sources, identify activity based on recognition of voice and identified associated information.

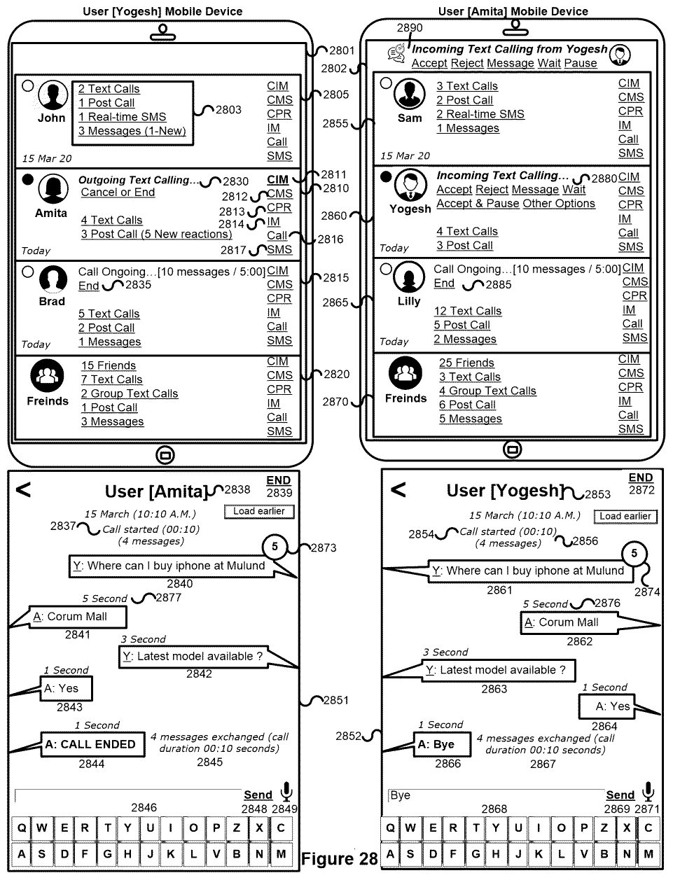

FIG. 28 illustrates exemplary graphical user interfaces (GUIs) wherein displaying list of contacts, groups, different types of unique identities including display most recently communicated, called, interacted, favorite and automatically ranked (based on most engaged, communicated, frequency, recency, ranked by user, relationship, logged data analytics and statistics, and like) contacts, groups and unique identities 2801. In an embodiment enabling user tap or click on call for real-time instant messaging (CIM) button or icon or control 2811 or on contact name, photo or pre-defined region or click or tap on call for sending and displaying message or SMS (CMS) button or icon or control 2812 or click or tap on call for sending and displaying post or message and requesting reactions (CPR) button or icon or control 2813 or click or tap on instant messaging button or icon or control 2814 or click or tap on phone call or voice over internet protocol (VOIP) call or Video call button or icon or control 2816 or tap or click on SMS button or icon or control 2817 to contact associated with list item 2810 from list of contacts, groups, different types of unique identities 2801 for making different types of call and messaging. For example in the event of tapping or clicking on call for real-time instant messaging (CIM) button or icon or control 2811 associated contact [Amita] 2810, displaying call status including “outgoing text calling” with “cancel” or “end” text call button or link or icon or control 2830 for enabling calling user to cancel call before call accept by called user(s) and if called user's device 200 is turned off then send notification including push notification or SMS and enable called user to tap on notification to open application or user interface or if called user device's 200 text call application or user interface 2802 is open but device 200 turned off then turn on device 200 and display in-app notification 2890 or if called user's device 200 is turned on and application or user interface 2802 is open then displaying in-app notification 2890 as well as displaying within called user's list of contact's interface 2802 in calling user's contact 2860, call status including “incoming text calling” with various types of buttons or links or icons or controls 2880 including “Accept” for accepting text call, “Reject” for rejecting text call, “Respond with message” for select template and send message including “I will text call you later” or “I am in meeting” and like, “Remind me”, “Wait” for provide wait for set or selected duration or period of time indication to calling user, “Accept and Pause” for accepting text call but currently pause text call, so calling user need to wait up-to restart of text call by called user. In an embodiment rearrange list of contacts based on incoming text calls, accepted or put in wait status or paused or restarted text calls, manually or automatically determined rank and relationships. In the event of acceptance of a call by called user, displaying chat interface or instant messaging user interface or one or more types of applications, user interfaces for enabling calling and called user to send and receive messages and one or more types of contents. In an embodiment enabling calling and called user to end the call by tapping or clicking on the end button. In an embodiment enabling the user to tap or click on CMS button or icon or link or control 2812 and make CMS call to said clicked or tapped CMS button or icon or link or control 2812 associated contact 2810 (discussed in details in FIG. 25). In an embodiment enabling the user to tap or click on CPR button or icon or link or control 2813 and make a CPR call to said clicked or tapped CMS button or icon or link or control 2813 associated contact 2810 (discussed in details in FIG. 26-27). In an embodiment displaying logs, statistics, status and action controls 2804 within each contact item 2805 in list of contacts and unique identities 2801, wherein logs, statistics, status and action controls 2804 comprises number of CIM calls, CMS calls, CPR calls, number of messages & new messages, number of reactions & new reactions with each post, duration and number of messages send and receive in current call, status including outgoing call, call rejected, call accepted, ongoing call, incoming call, confirm viewing of message, new reactions, call paused, call restarted, call ended, missed calls, call cancelled, particular user added to particular call and like. In an embodiment FIG. 28 illustrates exemplary graphical user interfaces (GUIs) which integrate text call services including CIM, CMS and CPR with instant messenger or phone or SMS application or user interface. So, users can send instant messages or send SMS or make phone calls or voice calls or VOIP calls or video calls or users can make different types of text calls including CIM, CMS and CPR. In an embodiment user can select contacts 2805, 2810, 2815 and make multiple individual text calls, accept multiple incoming calls 2835, manage multiple ongoing calls 2830/2835, make group calls 2820, select contacts 2805, 2810, 2815 and dynamically create group and make group text call (CTM or CMS or CPR), make text call and in the event of acceptance of text call, add to selected currently active text call, accept incoming text call and add to selected currently active text call, switch tabs or contacts or groups 2805, 2810, 2815, 2820 and receive, view and send messages, make call for real-time instant messaging (CIM), make call for sending and displaying message or SMS (CMS) and call for sending and displaying post or message and requesting reactions (CPR).

In another embodiment enabling real-time instant messaging (RIM), wherein first user [e.g. Yogesh] click or tap on contact name or second user [e.g. Amita] and input 2846 and send 2848 message 2840 to said selected contact [e.g. Amita], wherein displaying said message 2861 to second user [e.g. Amita]'s user interface 2852 and starting timer 2873/2874 indicating duration 2873/2874 passed from sending of said message 2840 or receiving of said message 2861. In the event of the first message 2862 send by a second user [e.g. Amita] to first user [e.g. Yogesh] then stop timer, displaying duration 2876 indicating period of time or duration passed to send response on first message of the first user from the second user and displaying duration 2877 indicating period of time or duration passed to receive respond on first message from the second user and displaying start call indication 2837/2854 to user interface of both first and second user and start timer from the sending of first message by the first user 2837/2854. In an embodiment in the event of non-receiving of response on the first message of the first user by the first user within pre-set duration or period of time, cancelling or ending or treating call as rejected call or missed call. In an embodiment in the event of receiving ending of call indication 2839/2872 from the first user or the second user, end call and displaying call ending indication, duration of call and numbers of messages exchanged indication 2845/2867 to both the first and the second user, wherein enabling the first and the second user to end current conversation or session or subject and agenda related messaging or current call by clicking or tapping on “end” button or control 2837/2854 or inputting and sending or providing or executing “end” or “bye” or “#” text command or text or voice command or selecting “end” emoticon(s). In another embodiment in the event of non-receiving or on-sending of a message by the first user or the second user, after sending the first message by the first user, for pre-set duration, ending conversation or call.

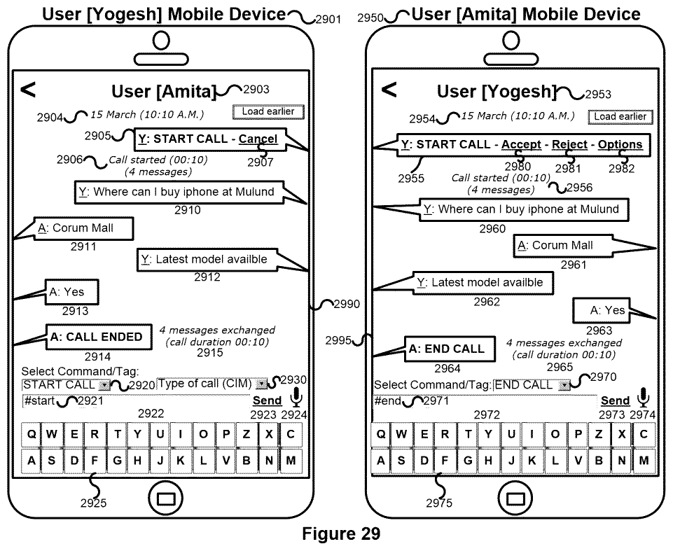

FIG. 29 illustrates exemplary graphical user interfaces (GUIs) wherein enabling user to select one or more contacts, unique identities and group(s) (for example user select contact [Amita] 2903), and after selecting one or more contacts, unique identities and group(s) (for example user select contact [Amita] 2903), in the event of tapping or clicking on individual contact or contact item in list (e.g. [Amita]) or group name or particular button, displaying chat or instant messaging or feed or viewer user interface or one or more types of interface(s) or application(s) and within said displayed chat or instant messenger interface or one or more types of user interface or application, user can send messages to said selected one or more contacts, group members or unique one or more identities associated corresponding users, receive and view messages from said selected one or more contacts, group members or unique one or more identities associated corresponding users. In another embodiment within chat or instant messenger interface or application or instant messaging session, users can input one or more command(s) 2921 or select one or more commands 2920 and provide one or more values for associated one or more parameters (if any or if required or if valid). For example when user input command “# start” and tap or click on “Send” button or icon or link or control 2923 then automatically prepare message and display message “Start Call” 2905 with cancel control or button or link or icon 2907 in calling user's 2901 chat or instant messenger's interface 2990 for enabling calling user [Yogesh] 2901 to cancel or end call 2907 before call accept by called user [Amita] 2950 and display message “Start Call” 2955 with “Accept” 2980, “Reject” 2981, “Options” 2982 controls or buttons or links or icons in called user's 2950 chat or instant messenger's interface 2995 for enabling called user [Amita] to tap or click on “Accept” 2980 to accept incoming text call or tap or click on “Reject” 2981 to reject incoming text call or access options 2982. In the event of acceptance of incoming text call by tapping or clicking on “Accept” button 2980, notifying and displaying indication e.g. “Call started” 2906/2956 about accepting and starting of text call and start timer in both calling and called users interface or in the event of rejecting of text call by clicking or tapping on “Reject” button 2981, notifying and displaying indication about rejection of text call to calling user [Yogesh] in user interface 2990. After acceptance of text call calling and called users can send and receive or view messages 2910-2914/2960-2964. In an embodiment calling or called user can input “#end” 2971 or select “End Call” 2970 to terminate or end text call, For example in the event of inputting “#end” command 2971 or selecting “End Call” from list of commands 2970 by called user, ending currently active text call, end current currently active text call session and in an embodiment enable calling and called user to view, search, save conversed messages or in another embodiment automatically save conversation and close or hide called or calling user or contact related chat or instant messaging user interface or in another embodiment based on ephemeral and privacy settings or sever, calling user and called user, automatically remove said call related conversation from local storage of calling user and/or local storage of called user and/or server storage. In an embodiment in the event of inputting “#end” command 2971 or selecting “End Call” from list of commands 2970 by called user, ending currently active text call and sending or displaying “End Call” message 2914/2964 in calling and called user(s)'s interface(s) and display number of messages exchanged and duration of text call 2915/2965.

In an embodiment calling and called user can input, select and execute or run various types of commands or actions or functions and provide or input or select one or more types of values associated parameters, where various types of commands and associated parameter(s) comprises “#Start Call” or “#start” or “#call” or “#Text call” (default is CIM text call) for make text call or requesting called user to accept or reject text call or providing indication of start of text call, “#Type: CIM|CMS|CPR” for selecting particular type of text call including make call for real-time instant messaging (CIM) within established CIM text call session, make call for real-time sending and displaying message or SMS and get confirmation of viewing message or SMS (CMS) within established CMS text call session and make call for sending and displaying post for real-time or near real-time getting various types of reactions from call accepted users (CPR) within established CPR text call session, “#Start Call: Groups|Multi Calls” for selecting one or more groups and making multi groups call or select multiple contacts and make multiple individual call (if multiple contacts and groups selected then required. if individual contact selected or single group selected then no need), “#Type of message: Normal|Ephemeral <life or view duration and number of times views or remove all messages after end of call>|Real-time|Near Real-time or At earliest|Good News or News|Important|Urgent|Notification|Invitation Advertisement|Group Deals|Status or Current Activity|Location|Updates|Confirmation” for selecting or switching to normal instant messaging (any time view and any time respond), set ephemeral settings including remove sent messages within pre-set duration or after ending of call, providing or indicating importance of call and type of call for dynamically selecting user interface or application for displaying to calling and/or called user in the event of acceptance of call by called user(s), “#Subject or #Title or #Agenda or #Task of call: <Details>” for describing purpose or agenda of call, so user can make decision to accept or reject call, “#Request or #Require: Reply required|No Reply|Reply optional or Request Reactions|Request Reply or Comments|Require or Request Vowing or Viewed Confirmation” for providing various types of settings for instruction or requesting called user(s) to provide or not necessary to provide reply or reactions, status, confirmation and like, “#Cancel” command to cancel call before call acceptance by called user, “#End call” to end any type of currently active call, “#Wait < select duration>” for provide indication of wait for some time or provided time, “#Call Me at <schedule date and time>|<when online>|up-to <time>” for enabling called user to provide indication of call including call called user not now, but call at particular scheduled date and time, when online or call up-to preset time, “#Pause” or “Pause <reason>” or “#Accept and Pause or Wait” and “#Restart” commands for enabling user to pause current communication up-to restart (if not re-started within pre-set duration then automatically end call and tap on restart make call and start call again, wherein—treat both call as single call and save call conversation combinedly with details), “#<respond with message or provide status>” e.g. “#call you soon” or “I am in meeting”, “#Normal” for ending current call and switch to normal instant messaging, “#Block” command to block called user up-to unblock by executing “#Unblock” command, “#Mute <Period or Duration>” to mute call receive from particular contact up-to unmute or up-to provide period of time, “#Apply do not disturb” to apply do not disturb settings on calling user, “#Save” or <#Save <Destination e.g. Folder(s), Local, Remote Storage name(s)> to save call conversation (execute command during call or after end of call (based on permission of calling and/or called users), “#Forward or #Share to <one or more contacts>” to forward one or more selected messages or posts or contents to selected or inputted contacts, “#Like” or “#<Type of Reactions or expressions or emotions>” (e.g. Like, Dislike, Wow, Marvelous, Rating:5, Comment: Hi) to provide various types of reactions to selected or last received message(s) or post(s) or content(s), “#Switch to <Phone|VOIP|SMS|Video Call|CIM|CMS|CPR” to end current call and switch communication, “#View Status” or “#View Log” or “#View profile” to view called user's log or status or profile, “#Add <Contact(s) To <Current call name>” to add incoming call or make call and add, “#Translate <Language>” to turn on message translation in particular language, “#Start Voice to Text” and “#End Voice to Text” to enabling calling and called user to speak message which turn into text and send to calling user or called user (examples of selecting commands 2920/2930/2970 and examples of inputting commands 2921/2971).

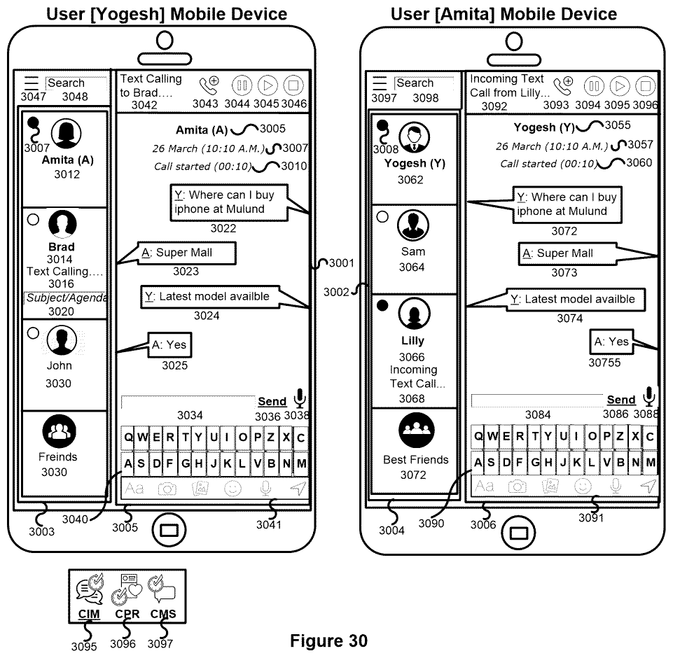

FIG. 30 illustrates exemplary graphical user interface (GUI) facilitating user to quickly make text calls, manage multiple types of multiple text calls, view different types of status of multiple types of multiple text calls, take one or more types of actions during pre-calling, during established call and after call including view online and offline status, prepare message or post, set settings, prepare or select or set additional details, cancel call, accept or reject call, pause or restart call. In an embodiment in the event of tapping or clicking on contact 3012 enabling calling user to send text call request from client application module 271 of user device 200 to server 110 module 153, wherein in an embodiment displaying outgoing text calling status or indication or message 3016 to calling user and in an embodiment server 110 module 153 sends request to text call notification including push notification or SMS message to each called user(s) and enabling called user to click or tap on notification to open incoming text call interface and enable to accept or reject incoming text call or in another embodiment in the event of tapping or clicking on said received notification directly open said calling user's contact associated chat or instant messaging user interface and in the event of tapping or clicking on calling user's contact name or contact item 3062 start text call, initiate session and provided call started indication to calling user and called user 3010/3060 or in another embodiment server 110 module 153, directly instructing client application or module or user interface 271 to directly open said calling user's contact associated chat or instant messaging user interface without displaying incoming text call user interface and in the event of called user sends first message then starting call, initiating session and displaying call started indication (e.g. “call started” 3060/3010) and if not providing of call acceptance indication or not sending of first message within pre-set duration then treat call as missed call or rejected call and informing about said missed call or automatically rejected call to calling and called user(s) or in another embodiment server 110 module 153, displaying incoming text call indication or notification or status or message within client application 271 or in contact user interface 3068/3092 to enable called user to tap on contact name or contact list item or in-app notification to open said calling user's contact associated chat or instant messaging user interface 3046 and enable calling user to view call acceptance indication and displaying said called user's contact associated chat or instant messaging user interface 3005 and enable calling and called users to send and receive messages 3022-3025/3072-3075. In an embodiment enabling calling and called user to end the call by tapping or clicking on the “end” button or icon or link or control 3046/3096. In an embodiment enabling calling user to tap on contact name or contact list item of called user 3012 from list of contacts 3003 to end text call with said called user or contact and terminate text call session and enabling called user to tap on contact name or contact list item of called user 3062 from list of contacts 3004 to end text call with said contact or calling and terminate text call session. In another embodiment users can provide online or availability status 3007/3008 to all or selected contacts to enable other users to take decisions to make text calls to said online or available user or contact. In another embodiment enabling user to provide online or availability status 3007/3008, from lock screen, providing voice command (e.g. “Text call ON” or “Text call Off”), providing pre-set one or more types of user's face expressions which view by lock screen background camera, ON/OFF switch button inside application or user interface, auto determined online or availability based on opening of application, making text call, accepting text call, communicating within particular call session, turn on device, open other pre-set applications (e.g. open browser, phone application (or attended recent call), instant messaging or VOIP or communication or social network application), detect user's pre-set types of activities including user is in transit, user is walking or running, user visiting at particular place or visiting other than pre-set places including office to turn on online status and if user is talking with others or user visiting at office then turn off online status, availability or busy schedule, privacy settings, do not disturb settings and identify calendar entries (holiday, attending events, meetings, travel) to automatically determine whether user is busy or available. In an embodiment automatically hide contact interface 3004/3005 based on acceptance of call, starting sending and viewing messages of particular contact, providing voice command (e.g. “Hide”), providing one or more types of pre-defined face or body expression(s). In an embodiment automatically show contact interface 3004/3005 based on clicking or tapping on icon 3047/3097, incoming text call, double tap or long press within anywhere in or pre-defined region of chat or instant messaging interface or user interface or application 3005/3006, providing voice command (e.g. “Show”), providing one or more types of pre-defined face or body expression(s). In an embodiment enabling the user to search contacts 3048/3098 wherein search results of searched contacts displayed to user in contact interface 3004/3005. In an embodiment enabling user to sort and filter contacts based on rank, name or alphabets ascending and descending order, recency, favorite, relationship, engagements, current activities, actions, place, status, updates, calendar entries, schedules, online or offline status, nearby places or contacts, transactions, communication, linked applications, servers and databases providing user related or user's activities related data or status and view favorite and recent contacts (not shown in FIG. 30). In an embodiment user can add current incoming text call 3092 to selected currently active text call by tapping or clicking on icon 3093. In an embodiment enabling the user to make text call 3042 and in the event of acceptance of said text call 3042 add said text call 3042 to selected currently active text call by tapping or clicking on icon 3043. In an embodiment enabling the user to pause a text call by tapping or clicking on icon 3044/3094, restart paused text call by tapping or clicking on icon 3045/3095 and end call by tapping or clicking on icon 3046/3096. In another embodiment calling user can tap or click on particular contact item 3012 to make text call (default type of text call is call for real-time instant messaging (CIM) or in another embodiment user can select or switch particular type of text call including call for real-time instant messaging (CIM) 3095 or call for displaying message or SMS (CMS) 309 or call for displaying post and getting reactions (CPR) 3097 and then click or tap on contact 3012 to make said selected type of text call) or send request from client 271 to call to server 110 module 153 and view outgoing call status or call acceptance status or missed or rejected or end text call status or indication, called user view incoming call indication in one or more form and can tap or click on calling user's contact's list item 3062 to accept incoming text call or do not click or tap on calling user's contact's list item 3062 for pre-set duration to reject or miss text call and view incoming text call or call acceptance or call started or call rejected or call missed or call ended indication, after accepting of text call calling user can tap on called user's contact's list item 3012 to end call or after accepting of text call called user can tap or click on calling user's contact's list item 3062 to end call. In an embodiment calling user can tap or click on pre-created group name or group list item 3030 from list of contact or groups 3003 and can make group text call to each group members and in the event of acceptance of text call by at least one group member or all or pre-set number of group members then starting text call and initiating session and displaying chat or instant messenger interface to calling user and each call accepted user(s). In another embodiment selecting one or more contacts, unique identities and groups and making multiple individual text calls. In another embodiment selecting one or more contacts, unique identities and groups and making said dynamically created group text call.

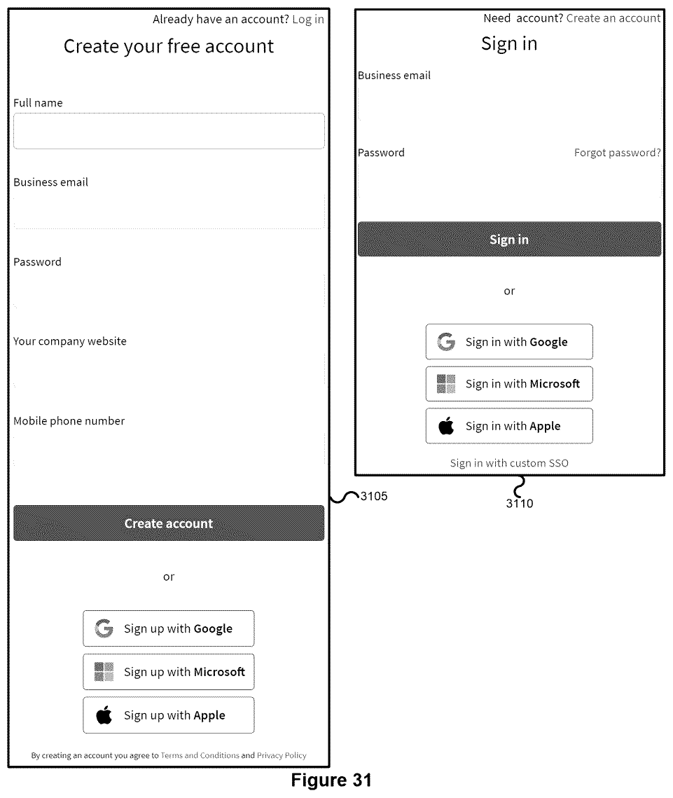

FIG. 31 illustrates graphical user interface 3105 wherein enterprise user or website owner can set up live chat & communication for website or business or place of business. Registered business or website or place of business can use live chat & communication for sales, support, or lead generation. Centralized Live Chat is a tool that facilitates communication between a business application of respective companies or brands and their corresponding centralized live chat & communication application of website visitors or customers.

In one embodiment, a business or enterprise user or owner can create an account by providing details in form 3105 including name, email, password, unique website name, mobile number, business or place name, category, description, products and services details to server 110 module 151 from business application registration module 270. In other embodiments business or enterprise users can create accounts by using log-in via external domains including Google, Microsoft, Apple and like. Enterprise user or business can create account and get pre-set days to try to use business application including smart client or online application for agents to connect with website visitors' or customers' Centralized Live Chat application including online or smart client application for free to decide if it's the right tool for website or business live chat support. When an enterprise user creates an account, the enterprise user automatically logs in and can start setting things up. To log in to an enterprise user account in the future, enterprise users can click or tap on the application log-in page 3110.

When an enterprise user or owner creates an account enterprise user is automatically logged in to the business application including smart client or online application for agents for enabling to connect with Centralized Live Chat application of online website visitors or customers or prospective customers. After creating an account or registration enterprise user can login from business application log in module 270 by entering the email and password enterprise user used during account registration and tap or click on Sign in 3110 which submit log in request to server 110 module 151.

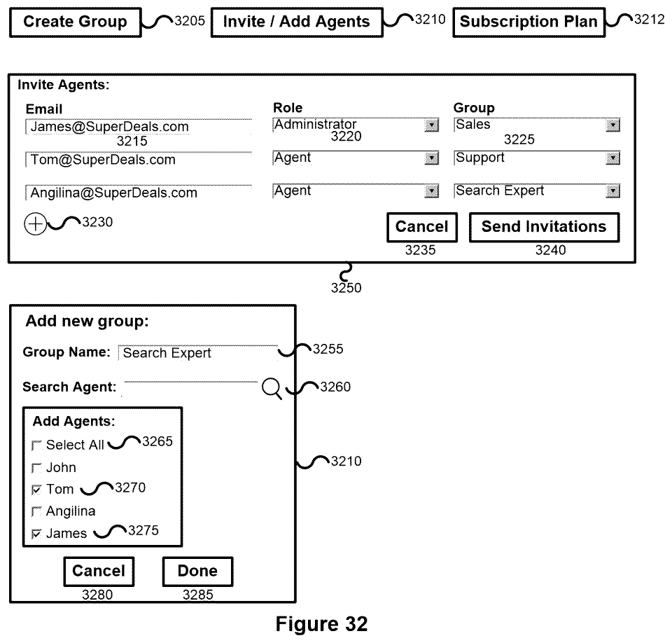

FIG. 32 illustrates after login owners can add administrators and agents, change settings, access reports and archives. They can also access the subscription section including change plans, add seats or agents and set up invoices, add payment methods, access customers data and conduct customization.

In an embodiment owner or authorized administrators can invite agents by clicking or tapping on invite agents 3210 and enter emails 3215 of teammates and select a role 3220 for them, optionally select group(s) 3225 and in the event of sending invitations 3240, teammates will receive an invitation email with a verification link. This link redirects to a login page where the agent can choose a password and sign in. All settings are specific for every individual agent and set by agent. They can be edited by Administrators and Owners. Settings related to agents include: select profile picture, change password, set the job title, assign the agent to groups, set permissions, set chat limits, delete account of agent.

Admin or owner can create groups 3210 for multiple departments handling different cases, e.g., Marketing, Sales including cross sales, updates, current sales and various types of support. Admin or owner can click or tap on “Add new group or create group” 3205 and search one or more members agents 3260 and select 3270/3275 one or more members agents and save group 3285. Single agents can be members of multiple groups. Admin or owner can add or remove one or more groups or one or more member agents in a particular group.

Admin can assign a different group to each web site or page. For example, when a chat starts on an add to cart page, it will be routed to your sales and marketing team. Admin can use groups to route chats from specific uniform resource locator (URLs) to responsible teams. Admin can configure uniform resource locator (URL) rules for routing chats to specific groups of agents.

After created groups and assigned them to web sites via uniform resource locator (URL) rules, admin can edit settings for each group, wherein settings may comprise customization of install or open centralized live chat application widget, language, pre-chat survey, post-chat survey, add and edit canned responses, add and edit tags.

Admin can view various types of statistics and data analytics including number of customers online, number of ongoing chats, logged in agents, number of queued visitors, converted customers or sales, ratings and reviews, duration of chat, duration of visits, so admin can track all website visitors and agents. Admin can access, view, filter, sort and share past conversations stored in archives. Admin can manage all their agents accounts and can access or update name, photo, email, role, logged on status, associated group(s) of agents, last seen, status after log in including accepting or not accepting chats, concurrent chat limits.

Only the owner and admins with access to subscription can select or change a plan 3212 including select number of agent accounts, increase or decrease the number of agents, select billing cycle including monthly or yearly subscription, make payment and subscribe. The owner and admin with access to subscription can switch plans, change the number of paid agent accounts, adjust the billing cycle, and make other subscription-related changes.

Teammates can either be Admins or Agents. Agents can transfer chat to other live chat agents who are experts in a particular matter or question. Agents answer chats, tickets, and see reports, but can't change settings. Admins have all agent permissions, plus they have access to all settings. Admins and the Owner can also change the chat limit. So how many chats an agent can take at a time.

Agents can switch status between accepting and not accepting chats, save template messages to quickly use during chat.

Agents can view everything that customers are typing before they send it over. Agents can search for an answer faster and respond quickly.

Agents can save time on repeated questions by quickly saving responses to common questions and reuse them in conversations. Agents can add tags to messages.

Agents can create customized buttons used for a text message followed by buttons. Useful when agents want to create a clickable response or create a menu. Agents can also create quick replies including pre-defined instant replies that can be selected by users which are convenient for scheduling, surveying, and suggesting possible answers. Agents can create a custom post or user interface that contains an image, a title, a description, and buttons which are perfect for product recommendations. Agents can create custom call-to-action that are temporarily displayed in the chat so the customer can complete an action like paying or get an appointment. Agents can transfer a chat to another selected agent and supervise chat. Agents can read related past conversations, manage cases that can't be solved on chat, and view all important information about the customer.

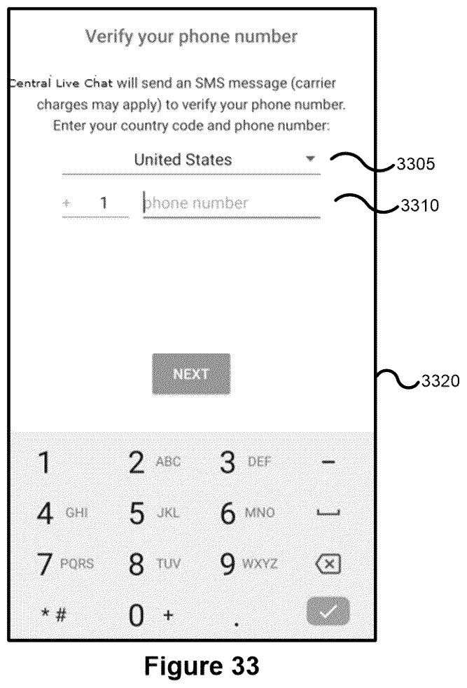

FIG. 33 illustrates exemplary graphical user interface 3320 enabling users or customers to install and access applications or centralized live chats & communication applications for user or customer. Users can register by providing country name (optional) 3305 and mobile phone number 3310 from user client application 270 to server module 151. Server mode 151 sending one-time password (OTP) on user device associated with said mobile phone number 3310 and manually or automatically verifying received one-time password (OTP). After installing, registering, creating an account and log-in, users or customers can open and access centralized live chat & communication applications.

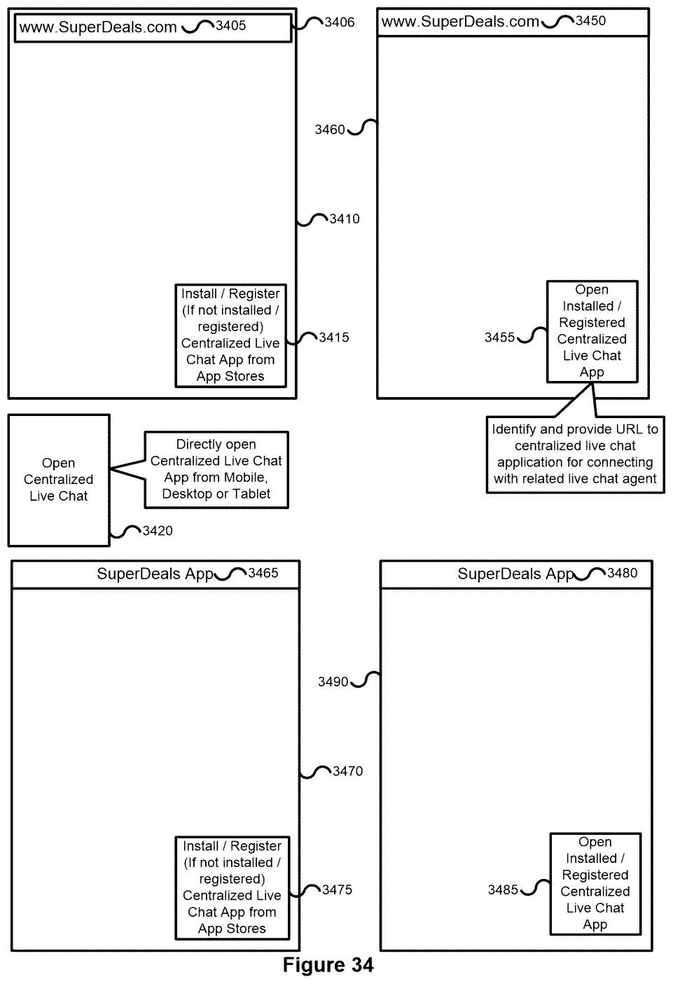

FIG. 34 illustrates an example of integrated centralized live chat application widget 3415/3455 with particular website 3405/3410 or application 3465/3480 of business or place of business.

Registered enterprise user or website admin or authorized admin can customize, add, update and integrate the centralized live chat & communication application widget 3415/3455 to their website(s) 3405/3410 and/or to their business application 3470/3490 for enabling visiting user to click or tap on widget or control or image or link or icon 3415/3455/3475/3485 to open installed/registered application of centralized live chat & communication or if centralized live chat & communication application is not installed/registered then instruct to install/register centralized live chat & communication application. Admin can customize including set appearance, position, and set or change language of website and mobile application widget and chat window language.

In an embodiment user or customer can open website from browser including mobile browser 3410/3460/3470/3490 and enter website name or uniform resource locator (URL) 3405 in address bar 3406 or select website name or uniform resource locator (URL) from auto fill-ups and open entered or selected link or web address or uniform resource locator (URL) 3405 associated website in browser 3410. In another embodiment a user can open a particular company or brand or website or place or place of business-related application 3470/3490.

In an embodiment after opening said website 3410/3460, enabling visiting or viewing user or customer to click or tap on widget or control or image or link or icon 3455 to open installed/registered application of centralized live chat & communication or if application is not installed/registered then instruct to install centralized live chat & communication application 3415. In another embodiment after opening said application 3470/3490, enabling visiting or viewing user or customer to click or tap on widget or control or image or link or icon 3485 to open installed/registered application of centralized live chat & communication or if application is not installed/registered then instruct to install centralized live chat & communication application 3475.

In another embodiment users can directly open, already installed centralized live chat & communication applications or open web based centralized live chat & communication application 3420.

In an embodiment automatically identify currently viewing website's uniform resource locator (URL) 3405/3450 from centralized live chat & communication application based on clicked or selected widget 3415/3455/3475/3485 associated with particular website 3410/3460 from web browser including mobile browser (for example Chrome or internet explorer) or particular application 3470/3490.

In another embodiment the user can install a plug-in with one or more web browsers or mobile browsers of one or more user devices, so centralized live chat application can monitor, track and automatically identify or retrieve currently viewing website uniform resource locator (URL) independently from centralized live chat application.

In another embodiment user can open and access web browser or mobile web browser 3410/3460 from inside centralized live chat application via in-app integrated web browser control and enabling user to enter uniform resource locator (URL) 3405 of particular website in address bar 3406 or select from auto-fill list uniform resource locator (URL) 3405 of particular website, so centralized live chat application can monitor, track and identify or retrieve currently viewing website uniform resource locator (URL) 3405 directly from centralized live chat application.

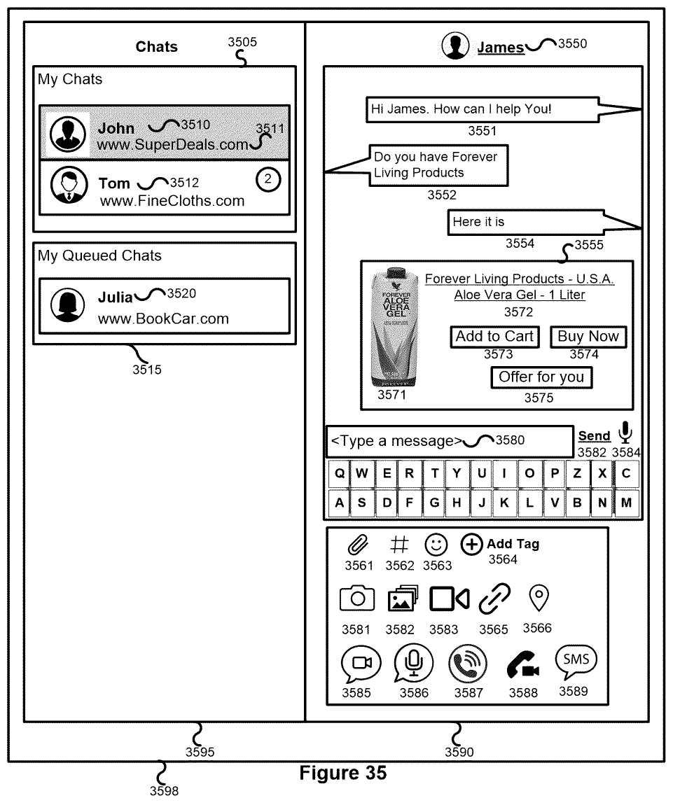

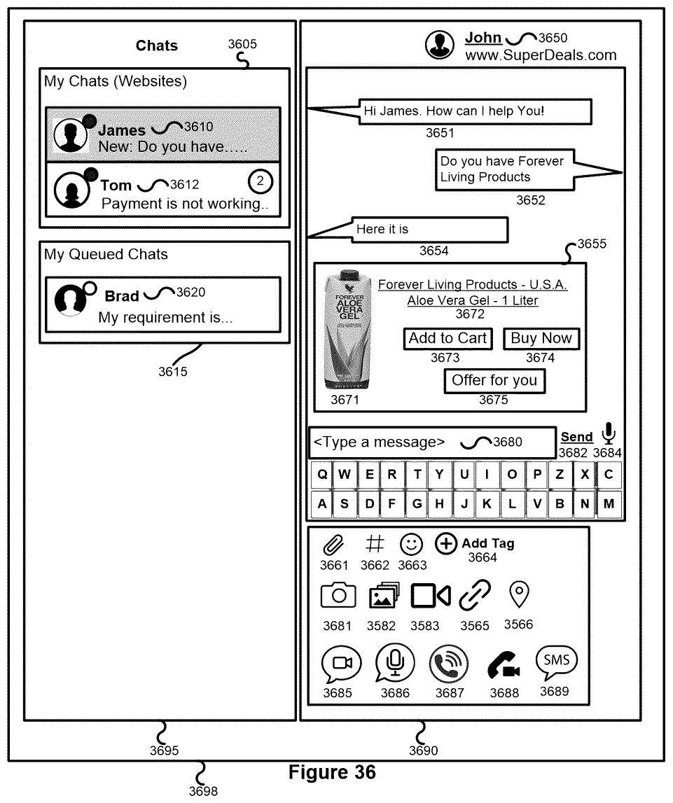

In an embodiment after automatically identifying currently viewing or opened website(s) or business application associated uniform resource locator(s) (URL(s)) by centralized live chat application, sending request from user centralized live chat & communication application 275 (discuss in detail in FIG. 35) to server 110 module 175 to send request to live chat or real-time chat to said identified website or uniform resource locator (URL) 3405/3511 associated business application or agent application 275 (discuss in detail in FIG. 36) and displaying currently opened or viewing one or more websites associated connected or identified or available agents details 3510/3512 in list 3505 and displaying currently opened or viewing one or more websites associated agent which is/are available when free (yet not available for chat) details 3520 in list 3515 and displaying said user details including user name (e.g. “James”) 3610 in my chats list 3605 of connected or call accepted or available agent (e.g. “John”) chat interface 3698. In the event of clicking or tapping on a particular list item 3510 of my chats 3505, automatically opening chat user interface 3590 associated with a particular identified and available agent (e.g. “John”) related to said identified currently viewing or opened website (e.g. “www.SuperDeals.com”) and enabling a user [e.g. “James” ] to type a message in text input box 3580 of chat interface 3590 and sent message 3582, wherein message may comprises text, photo 3581/3582, video 3583/3582, audio or voice file 3584, emoticons 3563, stickers 3563, uniform resource locator (URL) 3565, file or document attachments 3561, ready to use customized list of message templates 3562, create and select tag(s) from list of tags 3564 to add or associate one or more tags with one or more messages or chat or agent, location information 3566, shared structured data, controls including call-to-actions, buttons, widget and user interface, application, forms and any combination thereof. Users can view initial or intro message 3551 sent by agent and other messages 3552 sent by user [e.g. “James” ] and messages 3554/3555 sent by agent [e.g. “John” ].

In an embodiment user or agent can end or disconnect or reconnect chat connections.

In an embodiment user can select or change mode or channel of communication including video call 3588 with or without disclosing user identity and profile information, send video message 3585 in chat, send voice message 3586 in chat, make voice or phone or voice over IP (VOIP) call 3587 with or without disclosing user identity and profile information, send short message (SMS) 3589 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

In another embodiment in the event of clicking or tapping on identified currently viewing unique website name 3511 sending request to connect to available agent and in the event of clicking or tapping on assigned currently viewing visitor or user name 3610, automatically accept request for live chat, open associated chat interface 3690 and start chat session and in event of non-sending or receiving message by user or agent or closing application by user or agent or ending chat by clicking or tapping on “end” button by agent or user, automatically end chat session between agent (e.g. “John”) and user (e.g. “James”).

In my chats 3505 section, the user (e.g. “James”) can access a list of all agents 3505 whom user (e.g. “James”) is chatting and can switch between chats by clicking on names 3510/3512 on the list 3505. In queued chats section 3515, a user (e.g. “James”) can view a list 3515 of all agents 3520 that are currently waiting in the queue. User (e.g. “James”) can select the agent (e.g. “Julia”) 3520 from the queued list 3515 to start a conversation with selected agent 3520. In chat history section (not shown in figure) user (e.g. “James”) can view and access past converted messages by agent and customer. Users can view information shared by agents including files, e-mail address, phone number, call-to-actions, user interface, forms, data, invoice, location, the page they are currently on.

When agent (e.g. John) is connected with particular customer based on agent's online status, availability and chat limits settings or receiving request from customer (e.g. James) to connect with agent (e.g. John) or transferring of chat from another agent to agent (e.g. John), enabling agent [e.g. “John” ] to type a message in text input box 3680 of chat interface 3690 and sent message 3682, wherein message may comprises text, photo 3681/3682, video 3683/3682, audio or voice file 3684, emoticons 3663, stickers 3663, uniform resource locator (URL) 3665, file or document attachments 3661, ready to use customized list of message templates 3662, create and select tag(s) from list of tags 3664 to add or associate one or more tags with one or more messages or chat or agent, location information 3666, shared structured data, controls including call-to-actions, buttons, widget and user interface, application, forms and any combination thereof. Agents can send initial or intro message 3651 to connected users [e.g. James] and via other messages 3652 sent by user [e.g. “James” ] and messages or rich messages 3654/3655 sent by agent [e.g. “John” ], wherein rich messages may comprises product photo 3671, link 3672, user interface, application, widget, video, controls or call-to-actions including add to cart 3673, buy 3674, offer 3675, book, order, get appointment, reserve, participate in deal, select, reactions controls including like, rate, comment.

In an embodiment user or agent can end or disconnect or reconnect chat connections.

In an embodiment agent can select or change mode or channel of communication including video call 3688 with or without disclosing user identity and profile information, send video message 3685 in chat, send voice message 3686 in chat, make voice or phone or voice over IP (VOIP) call 3687 with or without disclosing user identity and profile information, send short message (SMS) 3689 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

In one embodiment the user can view one or more websites on one of the devices related to the user including desktop or tablet or laptop and view associated centralized live chat on another user device including user mobile device.

FIG. 36 illustrates graphical user interface wherein in my chats 3605 section agent (e.g. “John”) can access a list of all customers 3605 whom agent (e.g. “John”) is chatting and can switch between chats by clicking on names 3610/3612 on the list 3605. In queued chats section 3615, the agent (e.g. “John”) can view a list 3615 of all customers 3620 that are currently waiting in the queue. Agent (e.g. “John”) can select a customer (e.g. “Brad”) 3620 from the queued list 3615 to start a conversation with selected customer 3620. In the supervised chats section (not shown in figure), agents can view a list of customers who are chatting with the agent's teammates. Agents can supervise those chats and see how other agents converse with visitors. In the message interface, agents can type messages and send them to the customer. Visitors will be notified that agents have started replying. In the chat history section (not shown in figure) agents can view and access past converted messages by agent and customer. Agents can view information shared by customers including e-mail address, location, the page they are currently on.

Agents can receive different types of notifications during live chat including receiving a new message from a visitor, a visitor has started a new chat, visitor is queued before chat, a new visitor has entered the website, returning visitor on the website.

Agents can enter username and password, and become available for chat. When agent login to the application, depending on previous settings, agent can have the accept chats status or the don't accept chats. To receive chats, monitor customers or visitors, agents need to have the Accept chats status. In the event of applying do not accept chats, agent will not receive new chats, previous chats can be continued, can monitor clients and agent wants to leave. Agents can connect with a customer via chat based on greetings and chat buttons. Upon clicking them, customers will start a chat.

If a customer is waiting for a pre-set duration, provide one or more types of indications to the relevant agent.

Agents can quickly select answers based on pre-stored readymade answers, FAQs, templates via one or more types of shortcuts. Agents can view daily chats, logs and related analytics. Agents can create, send and manage tickets. Agent can view information regarding the ticket and its current state including open, pending, solved, and spam, add an attachment to the ticket, change the status of the ticket, recording of the ticket with timestamps and if the ticket is created from chat, it will include the chat transcript and can enter reply to the ticket and send it over by clicking on the submit button.

Agents can send messages to customers. For example, when an agent sees a customer that is looking at a particular group of services and is confused in making a decision in selecting a particular service, the agent could send an invitation to chat and offer support to make the selection easier.

Agents can track a number of information about your visitors including their name, currently viewed site, and time zone. Agents can view customer shared details and use it for customized communication and offer. When there are more chat requests than agent(s) can handle, visitors may have to enter the queue before chatting and they will have to wait for a certain period of time until the agent is available.

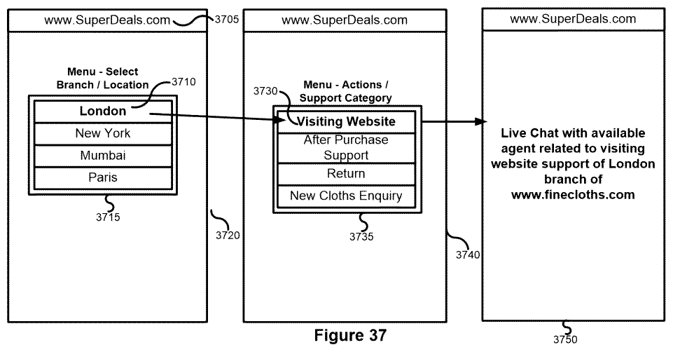

FIG. 37 illustrates exemplary menu options for users and connecting users based on selection options. In one embodiment after identifying unique uniform resource locator (URL) associated with website and opening associated chat interface, displaying associated customized menu which may comprises various options including location names, place names, department names, types of activities, types of call-to-actions, type of support requirements, type of roles, type of transactions, rules, person names, keywords and like. Users are enabled to select a particular option or menu item 3710 from the displayed list of options or menu items 3715. In the event of selecting particular option or menu item 3710 from displayed list of options or menu items 3715, in other embodiments displaying another menu or submenu or list of options 3735 and in the event of selecting particular option or menu item 3730 from displayed list of options or menu items 3735, display chat interface 3750 and connecting user with said selected place or branch or department or option related agent. For example, a user is connected with an available agent related to “visiting website support” of “London branch” of “www.SuperDeals.com”.

In another embodiment enable admin to create and update custom menu, associate one or more rules including display menu based on location, type of customer, current website activities, actions, transactions, user profile including age, gender, interest, location, education, language, interacted or connected entities, current place or visited place, type of user status.

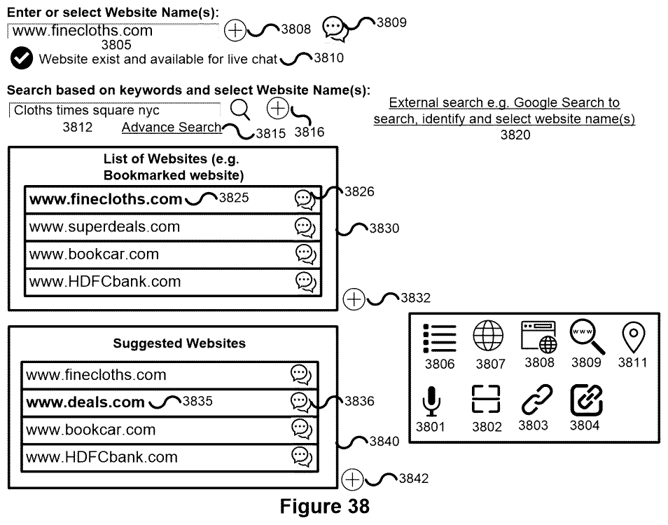

FIG. 38 illustrates exemplary graphical user interface wherein user can enter uniform resource locator (URL) or domain name or website name 3805 and tap on add control or button 3808 to add to my chat list 3911 with intention to connect with available agent 3910 related to said uniform resource locator or domain name or website name 3805/3911. In an embodiment user can enter uniform resource locator (URL) or domain name or website name 3805 and tap on centralized live chat icon or control or button 3809 to open live chat interface and connect with available agent associated to said entered and exited uniform resource locator (URL) or domain name or website name 3805 and start send and receive messages. In an embodiment verifying said entered domain name 3805 and displaying indication whether domain name is existing or not exists and instruct users to correct spell mistakes 3810.

In another embodiment user can input keywords or search query and search 3812 uniform resource locators (URLs) or domain names or website names based on said inputted keywords or search query and select from search results one or more uniform resource locators (URLs) or domain names or website names and add 3816 to my chat list 3911 with intention to connect with available agent 3910 related to selected uniform resource locator or domain name or website name 3805/3911. In another embodiment user can use advanced search to search uniform resource locators (URLs) or domain names or website names based on search query, keywords and one or more selections or criteria, operators including AND/OR/Not, category, search from selected type of list(s) including bookmarked, transacted, visited place or liked products related websites, past live chat conducted websites, date and time ranges. Users can select one or more websites from search results and click or tap on a centralized live chat icon or control to start connecting with available agents corresponding toa and related to selected websites and start conversing with them. Users can live chat with multiple agents related to or corresponding to one or more selected websites. In another embodiment user can use external search engines including Google search, Microsoft Bing search 3820 to search, identify, copy, select one or more uniform resource locators (URLs) or domain names or website names from search results and click or tap on centralized live chat icon or control to start connecting with available agent related to selected uniform resource locator(s) or domain name(s) or website name(s).

In another embodiment user can select uniform resource locator (URL) or domain name or website name 3825 from list of bookmarked uniform resource locators (URLs) or domain names or website names 3830 and click or tap on centralized live chat icon or control 3826 to start connecting with available agent related to selected uniform resource locator (URL) or domain name or website name 3826 or add 3832 to my chat list 3911 with intention to connect with available agent 3910 related to selected uniform resource locator or domain name or website name 3825.

In another embodiment displaying list of suggested websites related to user and currently providing live chat support service and at least one agent available for user, wherein displaying suggested websites based on past logs of visited websites, visited or checked in or transacted places associated websites, user profile including age, gender, education, current location, home and work location, current status and updates, posted or shared contents, calendar entries, interacted or related entities, received or sent emails and associated contents, preferences, likes including foods, restaurants, places, shops, movies, books, newspapers, magazines, and brands, list of currently using or used or like to use brands, products, services, installed applications, searched websites, transacted or subscribed websites, subscribed services, purchased products, bookmarked websites in browsers including desktop and mobile browser, watched movies and television programs, read books, requirement specifications, added to list including bookmarked, favorite, liked, and followed, logged interactions, activities, actions, participations, transactions, communication, from present as well external one or more linked system, databases, servers, social networks, applications, services, networks, platforms and devices. User can select uniform resource locator (URL) or domain name or website name 3835 from list of suggested uniform resource locators (URLs) or domain names or website names 3840 and click or tap on centralized live chat icon or control 3836 to start connecting with available agent related to selected uniform resource locator (URL) or domain name or website name 3835 or add 3842 to my chat list 3911 with intention to connect with available agent 3912 related to selected uniform resource locator or domain name or website name 3835.

In another embodiment user can click or tap on icon 3801 and speak website name via voice, wherein voice recognition techniques recognize voice and identify website name and display live chat interface and connect said identified website associated available agent for enabling user to converse with agent in real-time and send and receive messages.

In another embodiment user can click or tap on scan icon 3802 to scan particular code including QR code or object or image or logo or name or face, wherein based on object recognition and optical character recognition techniques recognize scanned code or object or image associated website name or uniform resource locator (URL) to identify website and connect said identified website associated available agent for enabling user to converse with agent in real-time and send and receive messages.

In another embodiment user can view shared links and click or tap on link object 3803 to open live chat interface and connect with available agent related to said clicked or tapped website name or uniform resource locator (URL).

In another embodiment user can share one or more selected website names or uniform resource locator (URL) or web address object link with one or more selected contacts, groups, or selected contacts and groups on selected one or more external domains, applications, websites, social networks.

In another embodiment user can create one or more categories or types or named lists and add or store or automatically save websites under said created list based on pre-defined rules and select list 3806 and select one or more websites from said selected list and tap or click on live chat to start connecting and communicating with available agent related to said selected website.

In another embodiment user can install plugin with one or more browsers in one or more user devices and monitoring, tracking, storing or bookmarking website names or uniform resource locators (URLs) of searched or visited or viewing websites under user created or automatically created one or more lists based on pre-defined rules, identified associated keywords, website categories, types, products, services, brands, offers, user reactions, time spent by user, number of pages visited by user, transaction or purchasing of products or subscribing of services, becoming member to particular website.

In another embodiment user can open browser 3807 or in-app browser 3808 and in the event of visiting particular website by entering or selecting website name in address bar of browser 3807 or in-app browser 3808 or searching via search engine and selecting website(s) from search results or clicking or tapping on centralized live chat icon integrated by websites via application programming language (API) or clicking or tapping on website link from application or from within chat or instant messenger interface, open website in web browser as well as concurrently automatically open centralized live chat application and display live chat interface and automatically connecting with available agent associated with said selected website or if busy then add user to queue and enable user to converse with agent in real-time and enable to send and receive messages for getting live support related to said selected website.

In another embodiment in the event of tapping or clicking on icon 3811, identifying monitored and tracked user device current location associated place and automatically identifying associated website and automatically open centralized live chat application and display live chat interface and automatically connecting with available agent associated with said current or nearest place or identified place or place associated website or if busy then add user to queue and enable user to converse with agent in real-time and enable to send and receive messages for getting live support related to said selected website.

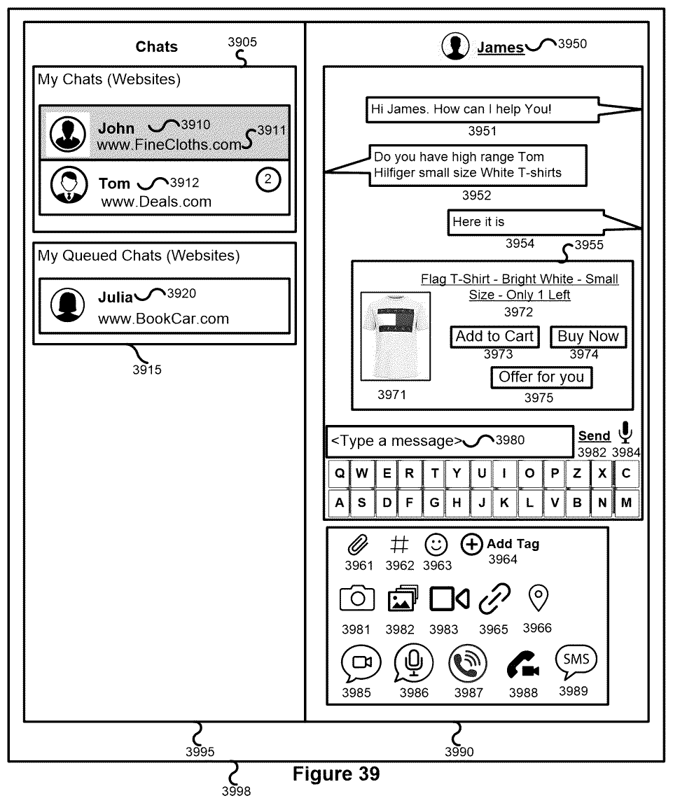

FIG. 39 illustrates an exemplary centralized live chat graphical user interface for users. In my chats 3905 section user (e.g. “James”) can access a list of all agents 3905 whom user (e.g. “James”) is chatting and can switch between chats by clicking on names 3910/3912 on the list 3905. In queued chats section 3915, user (e.g. “James”) can view a list 3915 of all agents 3920 that are currently waiting in the queue. Users (e.g. “James”) can select agents (e.g. “Julia”) 3920 from the queued list 3915 to start a conversation with selected agent 3920. In the chat history section (not shown in figure) users (e.g. “James”) can view and access past converted messages by agent and customer. Users can view information shared by agents including files, e-mail address, phone number, call-to-actions, user interface, forms, data, invoice, location, the page they are currently on.

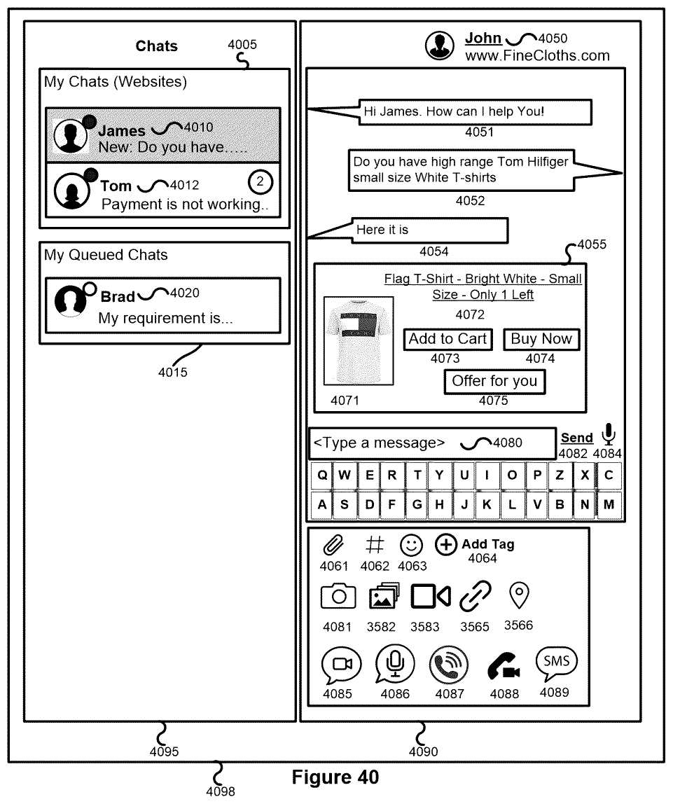

After searching, matching, verifying and selecting one or more website(s) as discussed in FIG. 38, sending request from user centralized live chat & communication application 275 (discuss in detail in FIG. 39) to server 110 module 175 to send request to live chat or real-time chat to said identified or selected website or uniform resource locator (URL) 3805/3825/3835/3911 associated business application or agent application 275 (discuss in detail in FIG. 40) and displaying selected one or more websites associated corresponding connected or identified or available agents details 3910/3912 in list 3905 and also displaying selected one or more websites associated agent which is/are available when free (yet not available for chat) details 3920 in list 3915 and displaying said user details including user name (e.g. “James”) 4010 in my chats list 4005 of connected or call accepted or available agent (e.g. “John”) chat interface 4098. In the event of clicking or tapping on particular list item 3910 of my chats 3905, automatically opening chat user interface 3990 associated with a particular identified and available agent (e.g. “John”) related to said selected website (e.g. “www.SuperDeals.com”) from list 3995 and enabling user [e.g. “James” ] to type a message in text input box 3980 of chat interface 3990 and sent message 3982, wherein message may comprises text, photo 3981/3982, video 3983/3982, audio or voice file 3984, emoticons 3963, stickers 3963, uniform resource locator (URL) 3965, file or document attachments 3961, ready to use customized list of message templates 3962, create and select tag(s) from list of tags 3964 to add or associate one or more tags with one or more messages or chat or agent, location information 3966, shared structured data, controls including call-to-actions, buttons, widget and user interface, application, forms and any combination thereof. Users can view initial or intro message 3951 sent by agent and other messages 3952 sent by user [e.g. “James” ] and messages 3954/3955 sent by agent [e.g. “John” ].

In an embodiment user can select or change mode or channel of communication including video call 3988 with or without disclosing user identity and profile information, send video message 3985 in chat, send voice message 3986 in chat, make voice or phone or voice over IP (VOIP) call 3987 with or without disclosing user identity and profile information, send short message (SMS) 3989 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

FIG. 40 illustrates an exemplary centralized live chat graphical user interface for agents. When agent (e.g. John) is connected with particular customer based on agent's online status, availability and chat limits settings or receiving request from customer (e.g. James) to connect with agent (e.g. John) or transferring of chat from another agent to agent (e.g. John), enabling agent [e.g. “John” ] to type a message in text input box 4080 of chat interface 4090 and sent message 4082, wherein message may comprises text, photo 4081/4082, video 4083/4082, audio or voice file 4084, emoticons 4063, stickers 4063, uniform resource locator (URL) 4065, file or document attachments 4061, ready to use customized list of message templates 4062, create and select tag(s) from list of tags 4064 to add or associate one or more tags with one or more messages or chat or agent, location information 4066, shared structured data, controls including call-to-actions, buttons, widget and user interface, application, forms and any combination thereof. Agents can send initial or intro message 4051 to connected users [e.g. James] and via other messages 4052 sent by user [e.g. “James” ] and messages 4054/4055 sent by agent [e.g. “John” ], wherein rich messages may comprises product photo 4071, link 4072, user interface, application, widget, video, controls or call-to-actions including add to cart 4073, buy 4074, offer 4075, book, order, get appointment, reserve, participate in deal, select, reactions controls including like, rate, comment.

In an embodiment agent can select or change mode or channel of communication including video call 4088 with or without disclosing user identity and profile information, send video message 4085 in chat, send voice message 4086 in chat, make voice or phone or voice over IP (VOIP) call 4087 with or without disclosing user identity and profile information, send short message (SMS) 4089 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

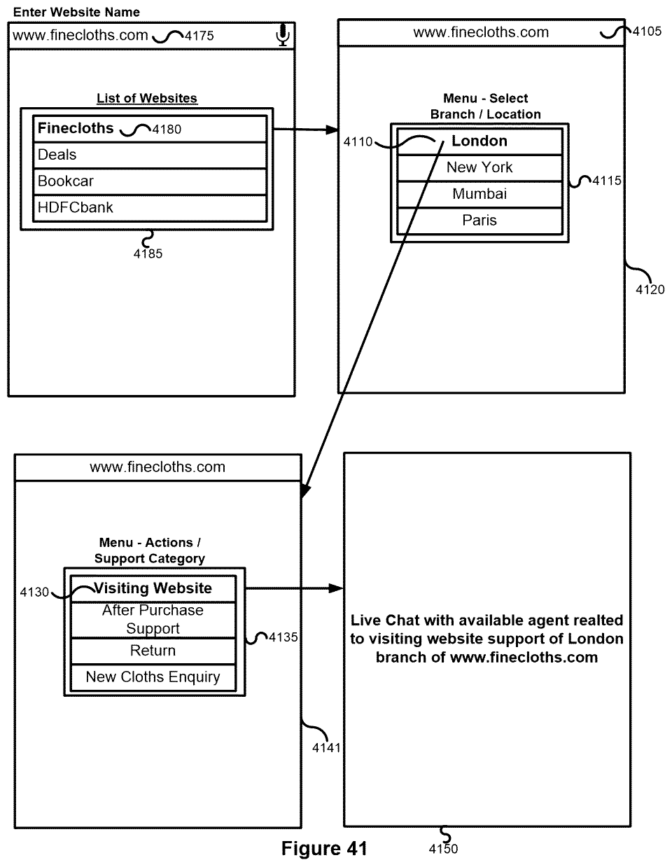

FIG. 41 illustrates exemplary menu options for users and connecting users based on selection options. In one embodiments user can select website from list of websites added by user (as discussed in detail in FIG. 38), in the event of selecting of website 4180 from list of websites 4185, opening associated user interface 4120 and displaying associated customized menu 4115 which may comprises various options including location names, place names, department names, types of activities, types of call-to-actions, type of support requirements, type of roles, type of transactions, rules, person names, keywords and like. Users are enabled to select a particular option or menu item 4110 from the displayed list of options or menu items 4115. In the event of selecting particular option or menu item 4110 from displayed list of options or menu items 4115, in other embodiments displaying another menu or submenu or list of options 4135 and in the event of selecting particular option or menu item 4130 from displayed list of options or menu items 4135, displaying chat interface 4150 and connecting user with said selected place or branch or department or option related agent. For example, a user is connected with an available agent related to “visiting website support” of “London branch” of “www.SuperDeals.com”.

In another embodiment enable admin to create and update custom menu, associate one or more rules including display menu based on location, type of customer, current website activities, actions, transactions, user profile including age, gender, interest, location, education, language, interacted or connected entities, current place or visited place, type of user status.

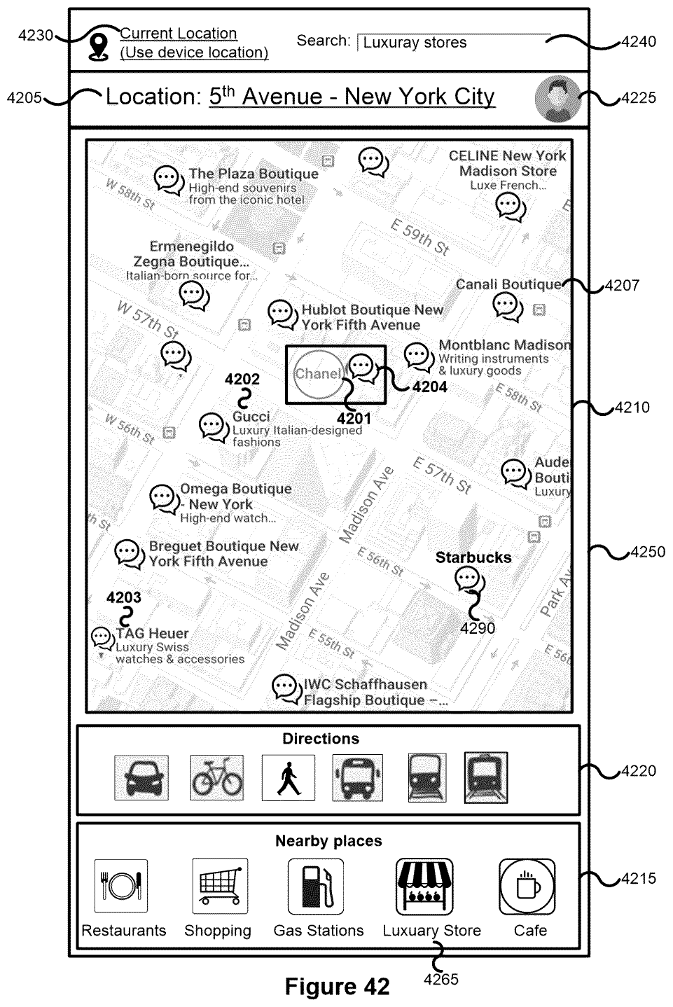

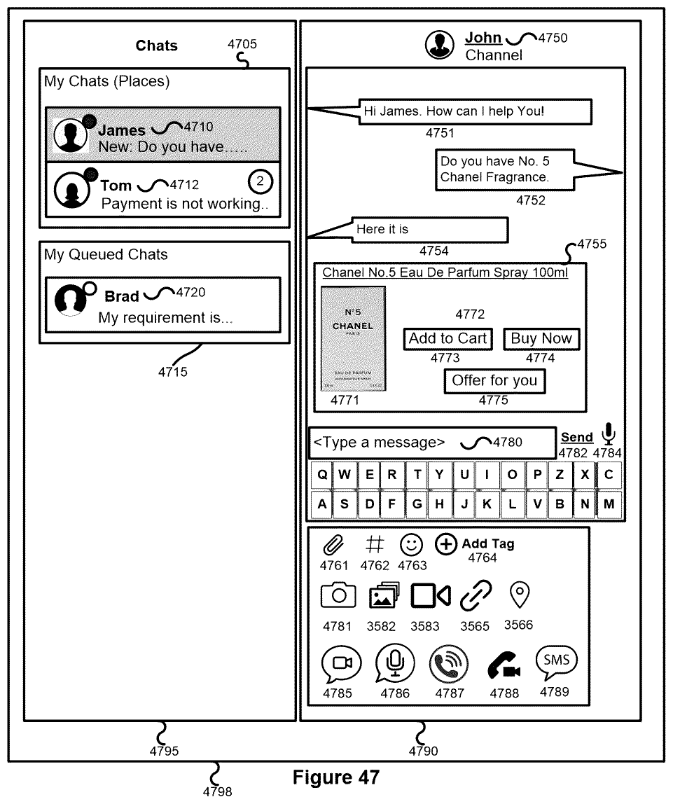

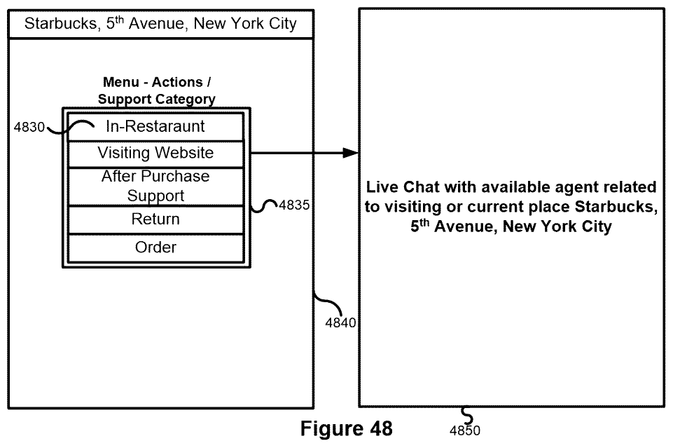

FIG. 42 illustrates maps graphical user interface enabling place associated live chat functionalities. In an embodiment enabling place or place of business owner or authorized person or merchant to create place on map by providing and verifying business and place of business details, wherein business details may comprises business name, categories and sub-categories, icon, logo, description, business hours, business address (identify GPS coordinates or Geo coordinates or latitude and longitude coordinates and one or more types of geocodes) in the form of country specific address format, GPS coordinates or Geo coordinates or latitude and longitude coordinates, selected and marked pointer on maps, automatically identified location and associated address based on monitored and tracked current location of user mobile device, defined geofence, provided selected location or place on map, contact person name, contact information including phone number, email address, website uniform resource locator (URL), merchant information including merchant payments, accounts and bank details including country specific bank code and account number, bank account linked mobile number and other required details, unique number and requested details of one or more types of country specific identity proofs and one or more types of required documents for proving business name, business address and location, business owner, business contact information, and merchant information including bank account details. After verifying said details, listing or publishing or making said verified place of business e.g. 4201 available on maps 4250 for users of network and enable users to view current place (e.g. 4201) or nearest place or nearby place(s) based on monitored and tracked location of user mobile device 200 and enable to view specific place or selected place (e.g. 4201) associated details and enable user to access selected place (e.g. 4201) associated live chat feature or user interface or service or application. In the event of clicking or tapping on live chat control or icon 4204 associated with selected place (e.g. Chanel) 4201 on maps 4210, displaying selected place associated centralized live chat application or graphical user interface (discuss in detail in FIG. 47) for enabling user to communicate with or converse with or real-time chat with online connected or available or connected or assigned agent via business or agent live chat application or graphical user interface (discuss in detail in FIG. 48).

User can view current location 4230 specific or surround place(s) 4210 on maps 4250 or searched places 4210 on maps 4250 or nearby places 4210 surround current location 4230 or selected category 4265 specific nearby places 4201/4202/4203 surround current location 4230 of user device 200 based on monitored and tracked location of user device 200 or current location of user or user device 200 including mobile device 200. In an embodiment in the event of clicking or tapping on “Current Location” (user device location) option 4230 or in response to receiving, from the presence-sensitive display, an indication of a input detected by the presence-sensitive display at a location of the presence-sensitive display associated with the icon or graphical representation for example “Current Location” (user device location) option 4230 from the application 275 of the client device 200, displaying current location associated place or place of business 4201 on map 4210, wherein current location is determined based on monitored and tracked location of user device 200 including mobile device 200. In another embodiment based on search query 4240 user can search on map 4250, places and associated details 4201, 4202 and 4203 based on inputting or selecting or providing one or more types of search queries 4240 including keywords, specific businesses or place name (e.g. Chanel), types of places (e.g. coffee near central park), or can narrow results by using the city and state (e.g. groceries in new York city, NY), narrow results by using a zip code (e.g. Chanel in 10010), find an intersection (e.g. 23rd and mission), address, city, state, country, or airport (e.g. 1234 parkway NYC, LAX, Los Angeles Airport, or Gateway of India, Mumbai), Latitude and longitude coordinates (e.g. 41.40338, 2.17403), friends and other contacts (e.g. Yogesh Rathod, Amita, Lily James) and in response to receiving said search query or selection 4640, displaying on map 4610 search results including searched places or businesses 4201, 4202 and 4203 on map 4210, so user can select any place or business (e.g. user select “Channel” 4201) displayed on map 4250. In an embodiment user can navigate map 4210 and can select any place or business 4201 or 4202 or 4203 from millions of places of businesses of the world on map 4210. In an embodiment user can use the auto fill option while searching 4240. In an embodiment user can select place or specific business 4201 from maps 4210. In another embodiment user can set or select location based on search queries or selections and in the event of settings or selections of particular location including specific place or business, identified location or place based on full or part address, one or more keywords, taxonomies, categories and types, contact information including phone number, email address, website name, and user name, contact person name, connections or contact name of user, brand name, product name, service name, defined geofence name, geocodes, geo coordinates or latitude and longitude coordinates or GPS coordinates specific, displaying on maps 4210 said inputted or searched or pre-set or selected location surround searched places and businesses 4210 including places within the predefined radius or within the threshold distance of the location of the user or automatically determined nearby places based on automatically determination of user activities, actions, events, interactions with places or entities or websites, transactions, status, updates, reactions including liked products and services, schedules, calendar entries, communications, messages and emails, past logs of activities, actions, events, interactions, transactions, and user profile data, user contacts and associated data, preferences, settings, privacy settings, interacted, visited, interacted, transacted, liked, bookmarked, searched places and associated data and contents including products and services purchased, ordered, transacted, reacted including liked by user or connections of user including friends and family.

In an embodiment the user may provide a search query 4240 related to a type of business 4215 that the user desires to locate within a particular range of location in the digital map 4210. In an embodiment the user may initiate a search of businesses 4240 located within the predefined radius or within the threshold distance of the location of the user or user device 200.

The server 110 may search via server module, a database 115 of businesses, along with associated business name, categories, sub-categories, logo, one or more types of contents including photos, videos, and text, products and services offered and associated details including name, categories, price, offer and like, business hours, ratings, reviews, business location information including location on visual digital map, address, defined geofence on visual digital map and business contact information including phone number, website URL, and email address based on one or more types of search queries, selections and current location of user mobile device.

Search engine may execute a query 4240, received from a user at a client 200 from map 4210 application, on the entity location information stored in the repository 115 and may provide a graphical digital map 4210 based on the executed query 4240.

Using the graphical interface 4250, a user may search 4240 the location listings to identify entities, such as businesses e.g. 4201, that are the most relevant to a given search query 4240 and that are located within an entire area of a map 4210 view presented to the user at user device 200.

In an embodiment in the event of selecting option “Current Location” 4230, displaying current location specific place or business or place of business 4201 on map 4210, wherein identifying current location specific place based on monitored and tracked user device accurate location by employing or accessing accurate location detection or identification technologies. Recent changes in hardware and standards make one-meter accuracy possible. In Android location in smartphones, introduces Wi-Fi round-trip time technology and standards, and the Wi-Fi application programming interfaces. Technology hardware standards and Android application programming interfaces (APIs) are all evolving simultaneously to enable an improved location accuracy that has not previously been possible when using smartphones. There continues to be improvement, and now indoor accuracy is better than 10 meters, but round-trip time (RTT) is the technology that will take accuracy to the one-meter level. In terms of GPS accuracy in the open sky, the GPS accuracy from mobile device or phone is about five meters, and that's been constant for a while. But with raw GNSS measurements from the phones, this can now improve, and with changes in satellite and receiver hardware, the improvements can be dramatic. One-meter measurement accuracy can be made available in smartphones by using the key technologies including Wi-Fi RTT, GPS dual-frequency and carrier phase measurements, other current or in future available location accuracy technology. To help mobile devices or phones get a more accurate location, users can apply location settings (For example users can Turn Improve Location Accuracy on or off). For example, when users have Google Location Accuracy turned on then the phone uses GPS, Wi-Fi, Mobile networks, Sensors and other location accuracy technologies or sources to get the most accurate location. To help apps get better location info, users can let their phone scan for nearby Wi-Fi access points or Bluetooth devices.

When particular user physically reached at particular physical place or place of business or store (e.g. “Channel, 15 E 57th St, New York, NY 10022, United States”) 4201 then based on monitored and tracked current location of user device 200, server 110 module identifies nearby places 4201 based on default or pre-defined or user defined distance of the location of the user and displaying and highlighting places 4201 on the maps or on a list to the user device if more than one seller is within the predetermined distance of the location of the user. Users can view current or top nearest place 4201 and associated details first on maps and can select other displayed or highlighted places from searched places.

Server employs one or more types of location accuracy technologies to exactly identify current place of user based on monitored and tracked user device continuously updated or current location or location or due to some reason non-detection or identification of exact current place of user based on monitored and tracked user device continuously updated or current location or location, server 110 displays list of nearby places from user device's 200 or user's location.

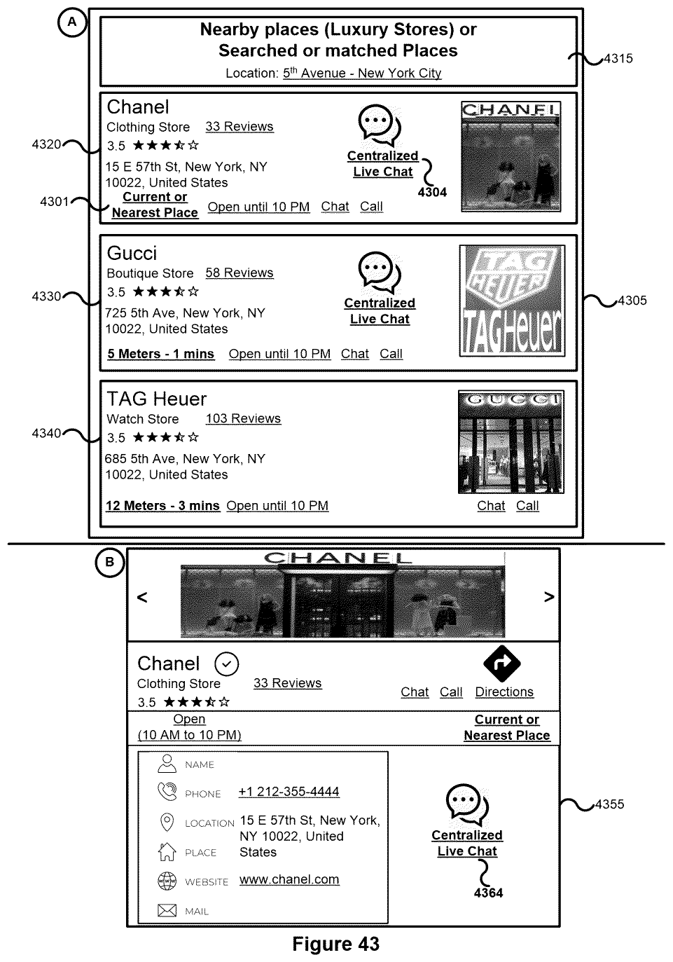

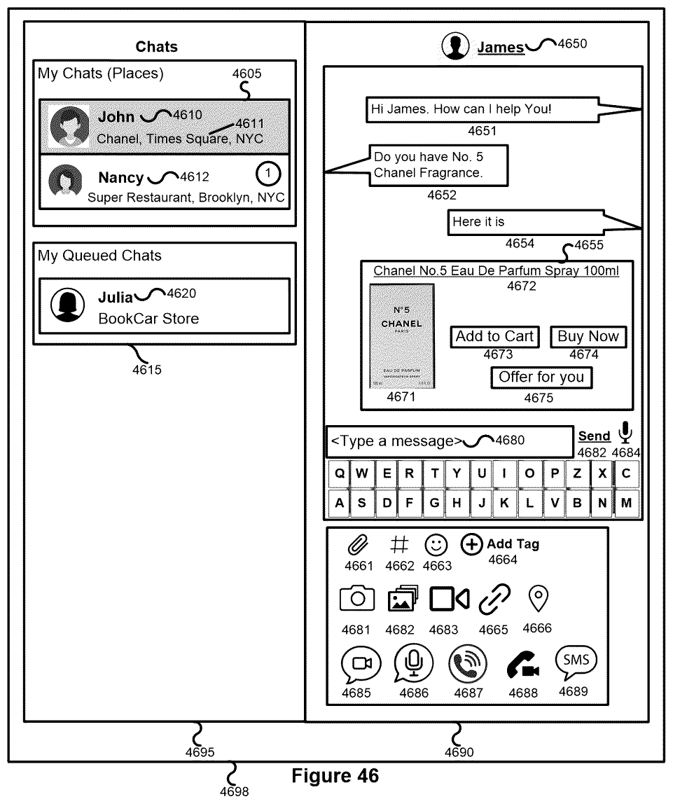

FIG. 43 illustrates in an embodiment displaying in list 4305, searched places 4320/4330/4340 or nearby places 4320/4330/4340 from current or pre-set location or selected category specific nearby places 4320/4330/4340 from current or pre-set location with place details and configuring user to select “Centralized Live Chat” 4304 on particular list item 4320 and in the event of selection of “Centralized Live Chat” 4304 on particular list item 4320, displaying centralized live chat user interface to user (discuss in detail in FIG. 46) and connecting user with available agent of list item 4320 associate place (e.g. “Channel”) for communication, live chat, displaying and conducting of actions, sending and receiving of messages or rich messages.

In an embodiment displaying current location of user device associated identified place 4201 on maps 4210 based on monitored and tracked location of the use or user device including mobile device. In the event of clicking or tap on graphical representation or icon or visual geofence or area of place or name of place 4201 on maps 4210, FIG. 43 (B) illustrates displaying graphical user interface for enabling user to view verified information 4355 including said selected place associated name including shop name, brand name, company name, business name, logo, photos including exterior or interior of said place, category, sub-category, ratings, reviews, contact information, business hours, status of place including open current place and one or more types of call-to-actions including in-store order, online order, order online and pickup, reserve tael, book, get appointment, buy, participate in deals, share, make call, send message, share contact information, connect and reactions including like, comments and one or more types of emoticons and “Live Chat Now” control 4364 (accessible button, link, image) or user action or call-to-action.

User can view place 4201 surround areas, road names and places on map and immediately identify current place 4201 on map 4210 and user can view or read said details and identify current place name and can select “Live Chat Now” button 4204/4304/4404 from maps 4210 or graphical user interface 4355 or list 4320. In the event of clicking or tap on “Live Chat Now” control or button or icon or link 4204/4304/4404, displaying centralized live chat application or graphical user interface (discuss in detail in FIG. 47) for chatting with said selected place associated available or connected or assigned agent on agent client application (discuss in detail in FIG. 48).

In an embodiment if the system indicated current place is not actual current place then the user can select place from maps or nearby places on maps or from list of nearby places or user can search and select preferred place from map or list.

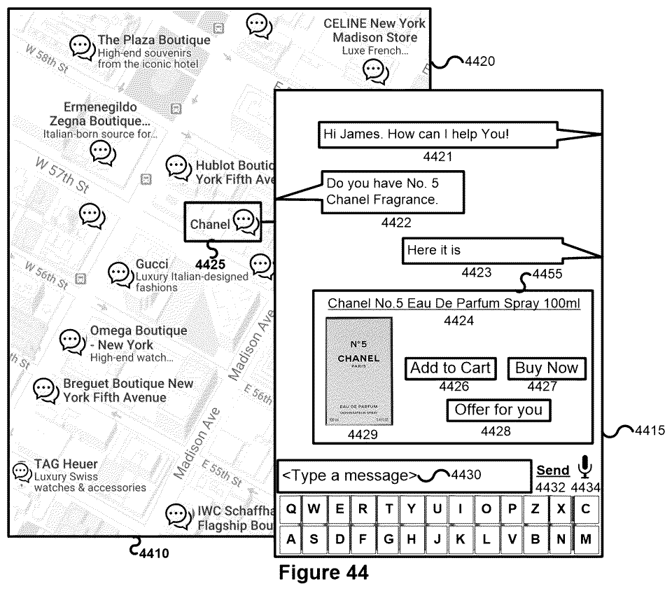

FIG. 44 illustrates in an embodiment in the event of entering at location of particular specific place (e.g. Chanel 4425) or defined geofence associated with location of particular specific place (e.g. Chanel 4425) and dwelling at said place for pre-set duration then identifying current place or nearest place 4425 and send notification to user with pre-set or default ringtone notifying user about current place 4425 and in the event of clicking or tapping on notification or providing place name via voice or clicking or tapping on place 4425 on maps 4420, displaying said identified current place or nearest place 4425 associated graphical user interface (GUI) 4415 and enabling user to communicate or real-time chat with currently available or online or connected or identified or assigned agent related to said selected place 4425.

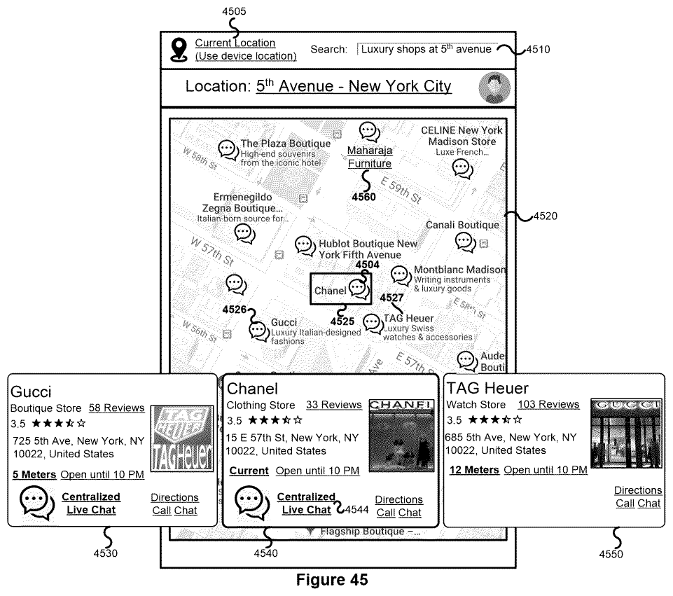

In an embodiment FIG. 45 showing a map 4520 presented to the user based on current location or user device location 4505. Maps 4520 displaying current location 4505 associated place 4525 or nearby places 4530/4540/4550 based on current location or user mobile device location 4505. Maps can also display search query 4510 specific searched places 4530/4540/4550 on maps 4520. Users can navigate maps 4520 and can view and access any place of world on maps 4520. Users can view place 4525 associated place icon, place name, place category, place short description and like.

In an embodiment FIG. 45 showing a map 4520 displaying current location 4505 associated nearby places 4525/4526/4527 based on user mobile device 200 location. Map 4520 can also display search query 4510 specific each searched place 4525/4526/4527 situated on different locations on map 4520 associated corresponding graphical user interface (GUI) 4530/4540/4550 comprises respective place associated information and “Live Chat” control for conducting live chat. When user click or tap on particular graphical user interface (GUI) 5440 then linked map 4520 automatically jump to and display visual representation or name of clicked graphical user interface (GUI) 4540 associated place 4525 on maps 4520 so user can easily jump on selected place from searched places on map and can visually view map location, directions, address information, surround places and nearby places on map. User can select place associated graphical user interface (GUI) 4540 and can click or tap on “Live Chat Now” control or button or link or icon 4544

FIG. 46 illustrates an exemplary centralized live chat graphical user interface for users. In my chats 4605 section user (e.g. “James”) can access a list of all agents 4605 whom user (e.g. “James”) is chatting and can switch between chats by clicking on names 4610/4612 on the list 4605. In queued chats section 4615, user (e.g. “James”) can view a list 4615 of all agents 4620 that are currently waiting in the queue. Users (e.g. “James”) can select agents (e.g. “Julia”) 4620 from the queued list 4615 to start a conversation with selected agent 4620. In the chat history section (not shown in figure) users (e.g. “James”) can view and access past converted messages by agent and customer. Users can view information shared by agents including files, e-mail address, phone number, call-to-actions, user interface, forms, data, invoice, location, the page they are currently on.

After searching, matching, and selecting or identifying one or more places on maps as discussed in FIGS. 42-46, sending request from user centralized live chat & communication application 275 (discuss in detail in FIG. 46) to server 110 module 175 to send request to live chat or real-time chat to said identified website or uniform resource locator (URL) 4204/4304/4404/4504/4544/4625 associated business application or agent application 275 (discuss in detail in FIG. 48) and displaying selected or identified one or more places associated corresponding connected or identified or available agents details 4610/4612 in list 4605 and also displaying selected one or more websites associated agent which is/are available when free (yet not available for chat) details 4620 in list 4615 and displaying said user details including user name (e.g. “James”) 4810 in my chats list 4805 of connected or call accepted or available agent (e.g. “John”) chat interface 4098. In the event of clicking or tapping on particular list item 4610 of my chats 4605, automatically opening chat user interface 4690 associated with particular identified and available agent (e.g. “John”) related to said selected place (e.g. “Chanel”) from list 4695 and enabling user [e.g. “James” ] to type a message in text input box 4680 of chat interface 4690 and sent message 4682, wherein message may comprises text, photo 4681/4682, video 4683/4682, audio or voice file 4684, emoticons 4663, stickers 4663, uniform resource locator (URL) 4665, file or document attachments 4661, ready to use customized list of message templates 4662, create and select tag(s) from list of tags 4664 to add or associate one or more tags with one or more messages or chat or agent, location information 4666, shared structured data, controls including call-to-actions, buttons, widget and user interface, application, forms and any combination thereof. Users can view initial or intro message 4651 sent by agent and other messages 4652 sent by user [e.g. “James” ] and messages 4654/4655 sent by agent [e.g. “John” ].

In an embodiment user can select or change mode or channel of communication including video call 4688 with or without disclosing user identity and profile information, send video message 4685 in chat, send voice message 4686 in chat, make voice or phone or voice over IP (VOIP) call 4687 with or without disclosing user identity and profile information, send short message (SMS) 4689 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

FIG. 47 illustrates an exemplary centralized live chat graphical user interface for agents. When agent (e.g. John) is connected with particular customer based on agent's online status, availability and chat limits settings or receiving request from customer (e.g. James) to connect with agent (e.g. John) or transferring of chat from another agent to agent (e.g. John), enabling agent [e.g. “John” ] to type a message in text input box 4780 of chat interface 4790 and sent message 4782, wherein message may comprises text, photo 4781/4782, video 4783/4782, audio or voice file 4784, emoticons 4763, stickers 4763, uniform resource locator (URL) 4765, file or document attachments 4761, ready to use customized list of message templates 4762, create and select tag(s) from list of tags 4764 to add or associate one or more tags with one or more messages or chat or agent, location information 4766, shared structured data, controls including call-to-actions, buttons, widget and user interface, application, forms and any combination thereof. Agents can send initial or intro message 4751 to connected users [e.g. James] and via other messages 4752 sent by user [e.g. “James” ] and messages 4754/4755 sent by agent [e.g. “John” ], wherein rich messages may comprises product photo 4771, link 4772, user interface, application, widget, video, controls or call-to-actions including add to cart 4773, buy 4774, offer 4775, book, order, get appointment, reserve, participate in deal, select, reactions controls including like, rate, comment.

In an embodiment based on customer's or user's privacy settings and applied rules associated with agent's associated business account [e.g. Chanel], agent can select or change mode or channel of communication including video call 4788 with or without disclosing user identity and profile information, send video message 4785 in chat, send voice message 4786 in chat, make voice or phone or voice over IP (VOIP) call 4787 with or without disclosing user identity and profile information, send short message (SMS) 4789 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

FIG. 48 illustrates displaying in graphical user interface 4840 selected place e.g. 4290 on maps 4250 associated menu or options for live chat & communication 4835, wherein user can select for example “In-Restaurant” 4830 option from user application to connect with in-store agent of Starbucks, 5th Avenue, New York City and converse with agent via centralized live chat & communication application 4850, make order and payment, instruct customization, review offer and update order and make payment for further updated in-store order, read messages about ss including current updated queue number, order is ready, picked-up order, exit from store and can provide reactions including like food and store.

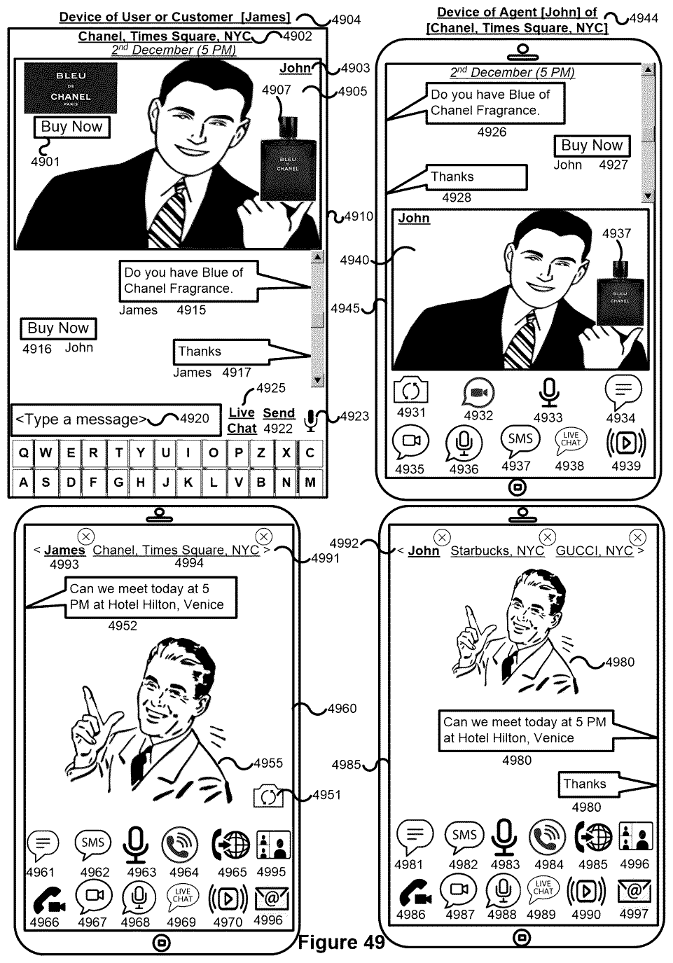

FIG. 49 illustrates graphical user interface wherein users can access select business account 4902 associated communication interface 4910. Users can set privacy settings including users can communicate via text message or rich message whereas allow all or selected businesses to respond to users via video chat, voice chat and text message or rich message chat. In an embodiment user can select live chat option 4925 which connect user with available agent, so user can send message 4915 from client application module 277 to said connected and available agent associated with particular business account or place of business or website or particular type of unique identity including phone number, email address, unique username, unique code number via server 110 module 176 and in another embodiment user can type message 4920/4915 and click or tap or select live chat option 4925 to connect user with available agent, so user can send message 4915 to said connected and available agent associated with particular business account or place of business or website or particular type of unique identity. User [James] connected and available Agent [John] can view said received message 4926 in agent interface 4945 and start video chatting 4940 to provide response of said received message 4926 which user [James] 4940 real-time view said live video of agent 4905 in user interface 4910. Agent [John] can view only text messages or rich messages of user [James] whereas user [James] can view live video 4905 of agent [John] who use camera of agent's device and real-time live streaming or sending or broadcasting video 4940 to answering user's questions, showing product to user [James] which user [James] can view 4905 real-time in user interface 4910. Agent [John] can switch camera to front camera or back camera via icon 4931 and also can select or set or switch communication medium including change video chatting to voice chatting or select voice 4933 to provide response via voice or voice message or change video chatting to text chatting or select message (instant message or SMS) 4934 to provide response via text message including instant messaging or short message service (SMS).

In another embodiment user can type instant message or short message service (SMS) 4920 and can send 4922 message 4920/4915 from client application module 277 to said business account 4902 associated identified agent 4944 or admin or authorized person and display message 4926 in interface 4945 via server 110 module 176. Agent 4944 or admin or authorized person can select type of communication channel or medium or interface including video message 4935, voice message 4936, text message including instant message 4934 or SMS 4937 or select real-time video 4932 or audio 4933 chat and start responding if user is available online or accept that user is online else convert real-time video into video message or real-time audio into voice message and send and in the event of next message, can select video message 4935, voice message 4936, text message including instant message 4934 or SMS 4937 or select real-time video 4932 or audio 4933 chat and start responding if user is available online or accept that user is online else convert real-time video into video message or voice message and send.

In another embodiment does not disclose user's or customer's identity including photo, name, contact information. In another embodiment based on user's privacy settings, disclose user's nickname, image uploaded by user, user status including online, offline, busy, available, away, online within particular duration and custom status set by user or automatically identified by system, user location information, user ratings based on number call-to-actions for each type of call-to-actions including buy, book, participate in deals, order, reserve, share contact information, visits website, make calls, send messages, follow, install applications, provide reactions including likes, comments, and ratings to business account and associated agent or staff, past number of conversation within particular period, ratings, reviews, likes, dislikes and reports by business accounts associated agents, staffs and admins and associated data analytics and statistics in any combination thereof.

In another embodiment a first user can select a first communication medium or a channel or a tool or a service or a user interface or an application including instant messenger 4961, short message service (SMS) 4962, real-time voice message 4963, cellular phone call 4964, Voice over Internet Protocol (VoIP) 4965, video call 4966, video message 4967, voice message 4968, live chat or real-time chat with available agent or staff person or selected contact 4969, live video broadcasting or streaming or sending live or real-time video from one or more types of camera including mobile phone video camera, portable and movable wireless video camera, in-store selected wall or shelf/shelves video camera(s) 4970 from a first user interface 4960 of first client application from a first user device 130 to communicate or broadcast for presentation or converse with a second user including one or more selected contacts including phone contacts, email-contacts, social network or professional network connections, followers, business contacts, business account names, places or place of businesses, websites, applications, instant messenger contacts or connections, shop name, one or more types of lists, search query or structured query language (SQL) specific contacts or users of network, one or more types of persons or entities in network, applied one or more filters specific contacts on a second user selected or pre-set or automatically identified or switched or first user selected or fist user requested or fist user pre-set second communication medium or a channel or a tool or a service or a user interface or an application including instant messenger 4961, short message service (SMS) 4962, real-time voice message 4963, cellular phone call 4964, Voice over Internet Protocol (VoIP) 4965, video call 4966, video message 4967, voice message 4968, live chat 4969, live video broadcasting and viewing 4970 in second user interface 4985 of a second client application from a second user device 135.

For example, a first user [John] selects a contact [James] and selects an instant messenger 4961 and sends an instant message 4952 to selected contact [James] which will display the message 4980 to the user [James] on the user interface 4985. User [James] selects a live video 4990 and responds to the message of [James] via the live video 4980 which will real-time display the video 4955 to User [John] on user interface 4960.

In another example a first user [John] select a contact [James] and select or request or pre-set live video communication channel or tool for the second user for response from the second user and select an instant messenger 4961 and send an instant message 4952 to selected the contact [James] which will display the message 4980 to the user [James] on the user interface 4985. User [James] need to provide response on live video 4990 as per instruction or request from the first user [John] and automatically display the live video interface 4980 and enable the second user [James] to respond the message of [James] via the live video 4980 which will real-time display the video 4955 to User [John] on user interface 4960.

In various examples a first user send message to a second user and the second user taps or clicks on cellular phone call and speak over phone, which in the event of call acceptance by the first user, listened by the first user, wherein second user does not hear voice of the first user then first user sends next message via SMS to the second user and the second user can tap or click on video call and respond on video call which view and listened by the first user on user interface, wherein first user does not need to respond via video call and second user does not view user and listen voice of user but first user respond via instant message to the second user.

In another embodiment enabling user to send or receive rich messages, wherein rich messages comprise call-to-actions including buy, get scheduled appointment, order, reserve, book, and participate in deals, forms, selections, widget, product photo, link, user interface, application, widget, video, controls and reaction controls including like, rate, share, refer, comment.

In another embodiment enabling user to communicate with multiple users or business users which will display in tabs 4991, so users can switch tabs to communicate with selected tab associated user or business account associated agent or admin or particular staff person. For example, users can select tab named user “James” 4993 to view responses or communicate with user [James] or user can select tab [Chanel, Times Square, NYC] 4994 to communicate with said selected store associated live chat agent or admin or staff. In another embodiment enabling user to end communication by tap or click on “end button” or “close” icon or close user interface or application and in the event of ending or closing of communication automatically remove related tab from tabs 4991 and in the event of starting of communication with particular user or business account associated agent or admin or staff person, automatically add named person or account name or website name or email address or phone number or one or more type of unique identity tab 4994 in tabs 4991.

In another embodiment user can view in threads all exchanged communications via relevant types of communication medium or channel including instant message, short message service (SMS), video message, voice message, video call, voice call, cellular phone call, and associated communications in text message, video message, recorded phone call(s), recorded video calls(s), recorded live chat conversations, saved video or audio or live chat and converted script of video to voice and text format metadata including sender name or nick name of sender, receiver name or nickname, date and time, type and name of communication, duration, number of characters.

In another embodiment users can add to a bookmark list or add to follow-ups list one or more communications with date and time and notes for enabling the user to later communicate with a related person for follow-ups or later take one or more types of call-to-action(s).

In another embodiment enabling user to select real-time or near real-time or any time communication type, so receiving user come to know in responding communication.

In another embodiment user can enter or select one or more types of unique identity including user name, business account name, particular agent name related to particular business account name, phone number, website name, unique place name, email id to connect them.

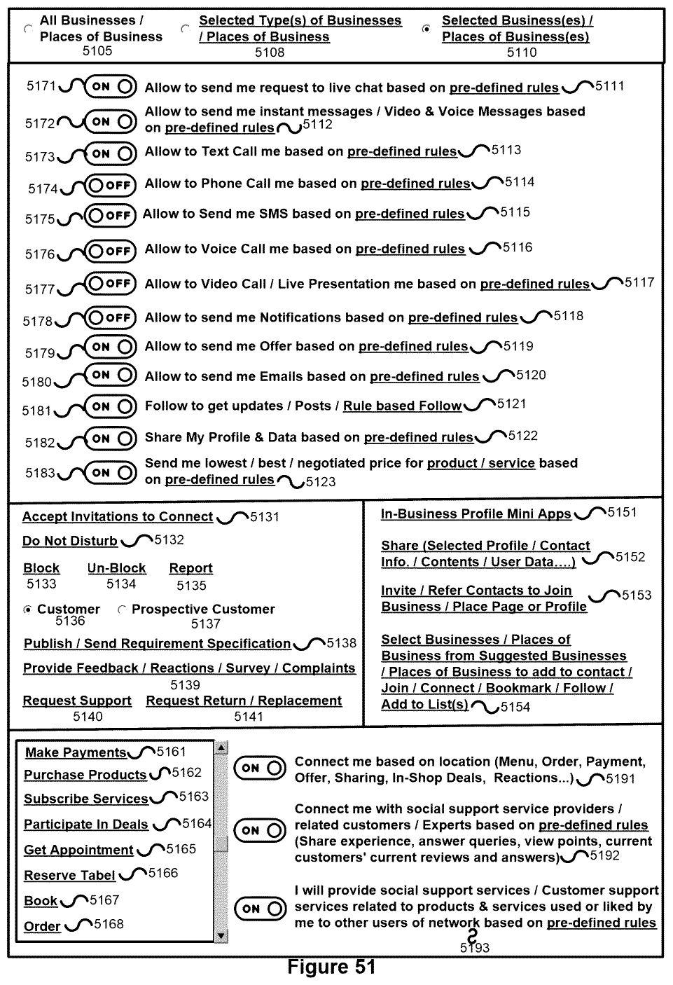

In another embodiment user can apply privacy settings with selected businesses or place of businesses or business accounts (discussed in details in FIG. 51).

In another embodiment real-time communication comprises user to user, user to one or more users, user to business. Caller can make call and use text and/or voice and set communication channel(s) including video and/or voice for callee, so callee can respond only on said preset communication channel(s).

In another embodiment user or customer can conduct conference communication 4995 with more than one other users of network or business accounts or websites or applications or stores or places of businesses associated agents or admins or staff and view products, compare products, negotiate with them and take decision, make payment and purchase selected products and services. User can select multi model conference communication 4995 and then user can select one or more contacts, groups, business accounts or place of businesses and select communication channel including message including instant message or SMS or real-time live chat or video or voice and pre-set or instructor make compulsory or request said selected contacts, groups, business accounts or place of businesses associated agent(s) or admin(s) to respond via said one or more user selected communication channels including video, voice, live chat and send communication via user selected communication channel which receive by said selected contacts, groups, business accounts or place of businesses associated agent(s) or admin(s) and respond via said user selected (if requested or made compulsory by communication initiator user or customer) or selected communication channel (if not pre-set by communication initiator user or customer).

In another embodiment enabling user to accept innovations of other users of network or send invitation to other users of network including contacts, phone contacts, email contacts, social network connections on external one or more selected domains or websites or applications or related users or business accounts and in the event of acceptance of invitations of other users of network connect with each other and enable each other to make live chat to each other or in the event of acceptance of live chat request allow user to make live chat to said connected user or business account.

In another embodiment enabling user to schedule particular type of communication including live chat with other users of network including connected or requested users or business accounts and before pre-set duration of schedule send notification of upcoming particular type of communication including live chat.

In another embodiment user or customer can initiate multiple communications each via same or different communication modes or channels or mediums or types and each with selected one or more contacts, groups, business account, selected agent(s) or admin(s) associated with selected business account or place of business and request or make compulsory to respond on user or customer selected or pre-set or requested communication channel(s) or medium(s) or type(s).

In another embodiment enabling to integrating multiple types of communication mediums for particular communication with vendors or business or sellers page or business account or published posts or advertisements in one or more types of applications and websites or webpages or user interfaces including e-commerce or social network websites or applications or instant messenger applications via application programming interface(s) (APIs), web service(s), software development toolkit(s) (SDKs), control including button or link or image, so visitors or customers or users can search, browse and select and view catalogues of products, published post(s) of product(s) and details of one or more products and services related to particular online vendor or seller in e-commerce or social network website or instant messenger and select published or displayed product or service or profile page or business page associated or integrated or attached or overlays or linked or embedded control or icon or button or link of “multiple types of communication mediums for particular communication” and in an embodiment open application including online webs abed or offline or installed (if not install then instruct to install application) or smart client for enabling user or customer or visitor to select communication medium or type e.g. instant message and send communication and request vendor or business account associated owner or admin or staff or agent to respond on said user or customer or visitor selected or pre-set communication medium or type e.g. real-time or live video communication, so user or customer or visitor can communicate via instant messages whereas connected or available agent or user or admin associated with business or place of business require to communicate via live or real-time video, so customer or user or visitor can instantly get clear visual and voice responses in details including ask alternatives, size, color, characteristics, negotiate price, ask how to use, ask queries, request customization and make payment and purchase selected product(s), vendor can get opportunities to properly convey customer, sell other relevant products and services, make custom offer and service.

In another embodiment user can select one or more menus and associated one or more sub-menus associated with particular other user or business account or place of business or website or application to select one or more options including type of support, type and name of product(s) and/or service(s) or brand(s), name of location(s) or department(s) or branch(s) or place name(s) or person(s) or agent(s), type of membership or service, type of activity or action or call-to-action or reaction(s) or status, type of follow-ups.

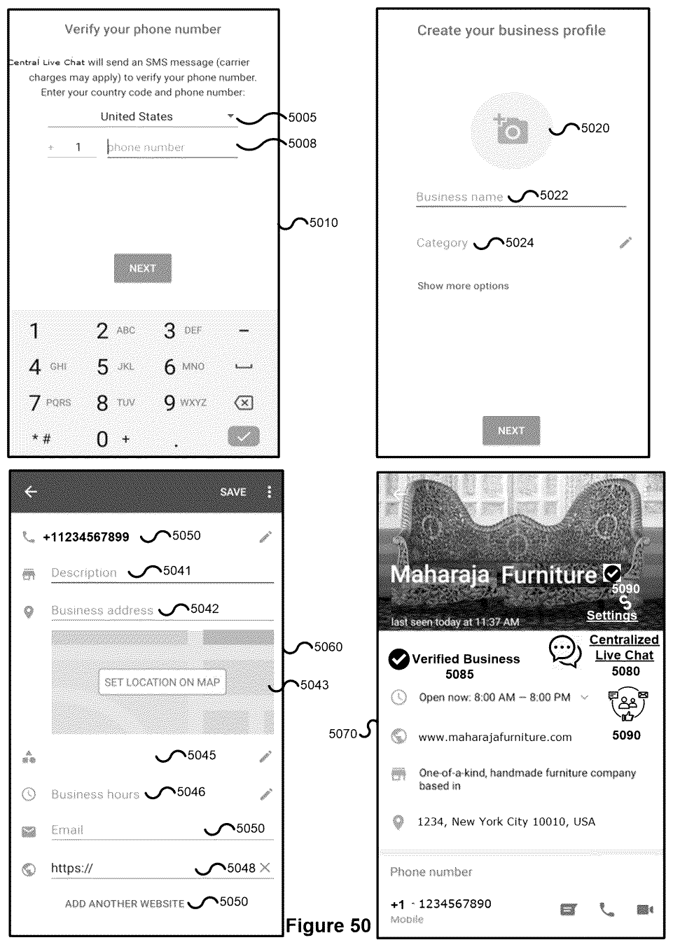

FIG. 50 illustrates graphical user interface wherein business or place of business owner or admin can install application and register or create account with the server or platform or service by selecting country code 5005, inputting mobile phone number 5008 for receiving one time password (OTP) on said mobile number and manually input said received one time password (OTP) or automatically detect said received one time password (OTP) to verify mobile number. After registering or creating account business user can create business profile, wherein business profile may comprise photo or image 5020, business name 5022, category 5024, contact phone number 5050, business description 5041, business address 5042. selected or set location of place of business on maps 5043, business hours 5046, email 5047, website name or uniform resource locator (URL) 5048, location information including geo-coordinates or GPS coordinates including latitude and longitude, selected or updated location on map, address, geocode, geofence including pre-defined, selected and drawn geofence, contact information including messaging account name, media including photos, videos, 360 degree views, data fields and associated values, description, products and services details, menu, one or more types of offers including discounts, sale, voucher, free samples or trails, redeemable points, cashback offer, group deals or deals, reactions controls including ratings, reviews, like, dislike, and emoticons, distance, estimated time to reach or arrive from particular place, routes, traffic conditions, one or more types of user actions or call-to-actions, including directions, share, bookmark, save, view nearby places, make voice call, send message, send e-mail, make video call and report, associated or related merchant information including payment information, account information, bank account information, and one or more types of unique identities and accounts details.

After providing and submitting business details, sever verifies business or place of business by employing one or more types of verification techniques and after successful verification, publishing and make searchable said business or place of business details to users of network. User can search, select from list business profile or visit business or place of business profile and view business or place of business associated details 5070 and apply associated settings, rules and privacy settings 5090 (discuss in detail in FIG. 51). User can view verified badge 5085 related to business. User can contact or connect business via live chat, hone or VOIP voice call, video call, chat, text call, SMS and email. Business can connect or contact with customer via live chat, hone or VOIP voice call, video call, chat, text call, SMS and email based on user's permission, privacy settings, rules.

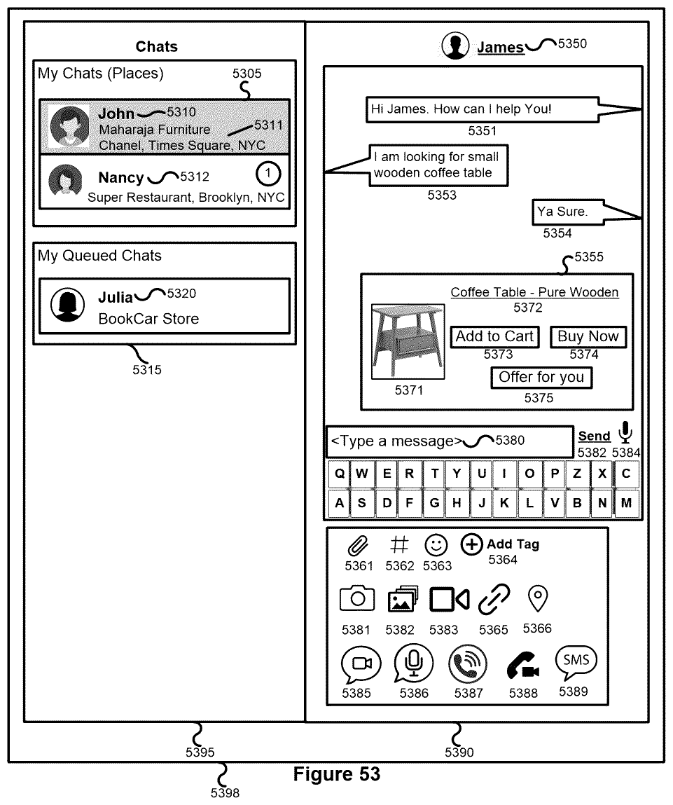

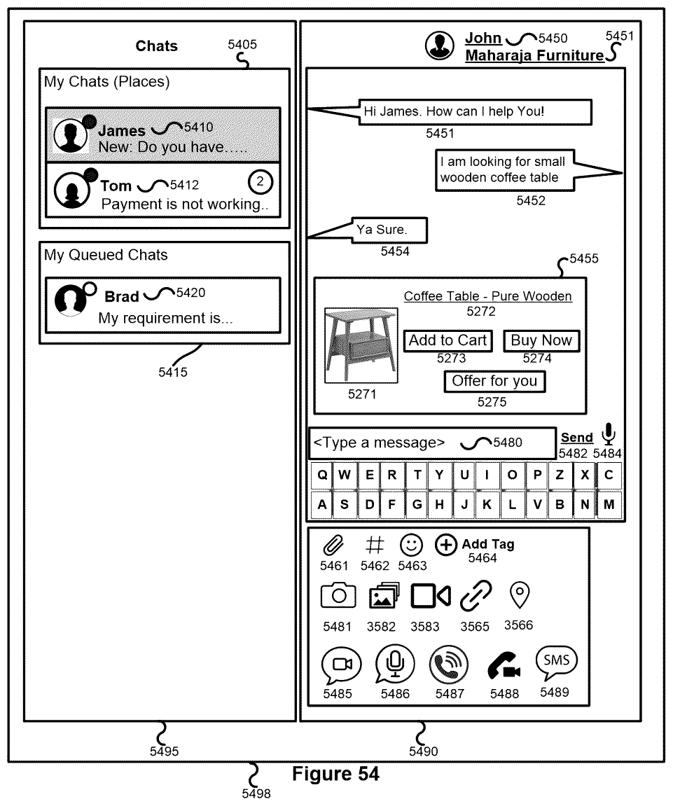

In another embodiment user can click or tap on “centralized live chat” control or icon or link 5080 for connecting business account [e.g. Maharaja Furniture] associated currently available or connected or identified or assigned agent (discuss in detail in FIGS. 53 and 54) and start sending and receiving messages from agent.

FIG. 51 illustrates graphical user interface for enabling user to apply privacy settings and define rules on selected one or more business accounts for enabling business account owner or admins or staff or agents to communicate with user as per said applied privacy settings and defined rules. Businesses allows users or customers to communicate with them via multiple communication channels, modes and medium for conveying, converting and supporting customers. But user wants to communicate with selected businesses or products and services providers which they used, using, purchase and like and further users or customers only want to communicate for one or more purposes, tasks, requirements, support requirements, and need as per customer's continent time.

In an embodiment user can apply privacy settings and defined rules for all business accounts 5105 added by user in contacts and/or added to one or more types of lists and/or connected and/or followed by user at present or in future. In another embodiment user can apply privacy settings and defined rules on selected one more types of businesses or predefined groups of businesses 5108 including day today general used products and services, travel, education, medicine, health or types of products and services related to businesses in business accounts added by user in contacts and/or added to one or more types of lists and/or connected and/or followed by user at present or in future. In another embodiment user can apply privacy settings and defined rules on selected one more business account 5110 added by user in contacts and/or added to one or more types of lists and/or connected and/or followed by user.

After selecting one of the options and associated selections from options 5105/5108/5110, user or customer can use default privacy settings or apply one or more types of privacy settings and select associated default rules or define custom rules including allow or do not allow selected business account(s) to send user live chat request 5171, wherein enable user to use default or define or update associated rules 5111 including send to user live chat request as per schedule time (excluding days, dates) for pre-set duration only, send to user live chat request for selected products and services, send to user live chat request for selected purposes only including presenting new arrivals, providing or explaining offers, sending competitive price based on requirement specification published by user and received by business account based on matchmaking of business requirements with business profile, availability of required products and services, for particular issue(s) and follow-ups, allow or do not allow selected business account(s) to send instant messages 5172 including text, voice and video messages and open or more types of contents and rich messages, wherein enable user to use default or define or update associated rules 5112 including send message other than disliked by user, send messages for particular selected types of tasks, requirements, products, services, brands, activities, call-to-actions, offers, mute or set ringtone or message tone or vibrations, particular defined or selected issue(s) or type of issue(s) related only, receive message from particular person(s) only, allow or do not allow selected business account(s) to text call 5173, wherein enable user to use default or define or update associated rules 5113 including sent text call request as per scheduled date and time and applied do not disturb policies, only for particular selected types of real-time requirements, notifications, reminders, updates, status, issues(s), tasks including arrival of new products, new plans, call-to-actions, offers, follow-ups, only for selected or purchased or liked products, services, memberships and brands, daily limit of number of text calls within scheduled time (including or excluding days and dates), allow or do not allow selected business account(s) to phone call 5174 or voice call 5176, wherein enable user to use default or define or update associated rules 5114/5116 including do not disclose my identity and contact information, allow real-time phone call only for selected or selected types of purposes, tasks, activities, call-to-actions, issues(s), requirements, notifications, reminders, support, queries, daily limit of number of text calls within scheduled time (including or excluding days and dates) and apply do not disturb policies, allow or do not allow selected business account(s) to send SMS 5175, wherein enable user to use default or define or update associated rules 5115 including only for notifications, reminders, transaction details, updates and status for particular products, services, brands, tasks, call-to-actions, allow or do not allow selected business account(s) to video call 5177, wherein enable user to use default or define or update associated rules 5117 including selected or allowed business person to communicate or present via video and/or voice but user can communicate via text or voice or view only, pre-notified and video calls at particular date and time or accepted scheduled only, make video call for particular selected purposes including presentation of arrived new products and services, new plans, offer, providing support for purchase products including how to use purchased products, issue(s) raised by customer, allow or do not allow selected business account(s) to send notification 5178, wherein enable user to use default or define or update associated rules 5118 including send notification only for selected or selected type of status, transaction, call-to-actions, reminders, updates, offers for all or selected or purchased products and services, allow or do not allow selected business account(s) to send offer 5179, wherein enable user to use default or define or update associated rules 5119 including send only selected types of offers including voucher, coupon, cashback, discount, discount only for me, free sample or gift, redeemable points, new plans, offer for you, send offer only for purchased or updated new or selected products and services, automatically accept vouchers, coupons and one or more selected types of said offers, allow or do not allow selected business account(s) to send email 5180, wherein enable user to use default or define or update associated rules 5180 including send email only for selected types of notifications, status, offers, reminders, response of requirement specifications, transaction details including receipt, invoice and bills, new arrivals of products, invitations, support answers or scripts, allow or do not allow selected business account(s) to send or share posts or one or more types of contents 5181, wherein enable user to use default or define or update associated rules 5113 including receive one or more selected types of posts including posts related to selected or purchased one or more products and services, selected one or more types of posts including offers, new arrivals of products and services, how to use products, coming soon products and services, presentation, new features, tips, limit daily particular number of posts, allow or do not allow selected business account(s) to access selected type of user profile, logged data and shard or published contents 5182, wherein enable user to use default or define or update associated rules 5122 including share requirement specifications, share liked products and services, share logged activities, transactions, posts, updates, checked in places, list of past used, currently using or like to use types or named products and services and associated details, interacted entities details with matched or contextual business accounts, allow or do not allow selected business account(s) to send negotiated or competitive or lowest price based on published requirement specification or particular products and services 5183, wherein enable user to use default or define or update associated rules 5123 including receive competitive price from matched businesses who sells products or provides services, only receive lowest price compare to last received lowest price for particular products or services.

Send said applied or updated privacy settings and defined or configured rules from client application module 276 to server 110 database 115 for store via module 175.

In one embodiments user is configured to accept selected invitations from businesses or place of businesses or business accounts.

In an embodiments user can manually or automatically turn on and apply or set Do Not Disturb policies 5132 for business accounts or selected business accounts only. Do Not Disturb mode can silence notifications, alerts, phone calls, and text messages from all or selected business accounts. Do Not Disturb can also be scheduled to run automatically at a specific time of day. User can customize the settings so specific business accounts related people can reach user regardless of whether Do Not Disturb is on or not. When a Do Not Disturb is turned on, it sends incoming calls from businesses to voicemail and does not alert user about calls or text messages. It also silences all notifications from business accounts, so user is not disturbed by the phone. User might want to enable Do Not Disturb mode when user go to bed, or during meals, meetings, holiday, movies and when set away or offline or busy status. Do Not Disturb can be set to activate automatically on a schedule. To allow calls or messages from people in business contacts list or only favorites to ring through, tap “Calls from” or “Messages from” and choose which business contacts user want to allow. User can allow repeat callers (business contacts who calls twice within 15 minutes) to ring through if you turn on “Repeat callers”. User can also allow event notifications and reminders from business contacts or business accounts to alert user by turning those options on. With Do Not Disturb, user can silence calls, alerts, and notifications that user gets while user's device is locked or receive calls, alerts, and notifications only when user device is turn on.

In an embodiment enabling user to block 5133, Un-block 5134 and report 5135 one or more selected business accounts or business contacts.

In an embodiment enabling user to select one or more business accounts or business contacts and discloses that user is customer 5136 or prospective customer 5137 for said selected business accounts or business contacts related all or selected brands, products and services.

In an embodiment enabling user to draft, prepare, collaboratively draft, update, send and publish requirement specifications or list and details of required products and services 5138.

In an embodiment enabling user to provide one or more types of reactions including like, dislike, provide emoticons or stickers, comments and ratings, fill survey form, feedbacks and complaints to selected one or more business accounts or business contacts 5139.

In an embodiment enabling user to request and schedule one or more types of support including pre, while and post purchase support 5140, request return or replace purchased products, change plans 5141.

In an embodiment enabling user to invite or refer all or one or more selected contacts and groups to add to contact or follow or join selected one or more business accounts or business contacts or business mini application or business page 5153.

In an embodiment enabling user to manually share user related one or more types of contents, user profiles, contact information, connections, logs of activities and associated details, requirement specifications with one or more selected business accounts or business contacts 5152.

In an embodiment enabling business owner or admin or place of business or business account holder to develop, customize, generate or create, submit, verify, list or publish or associate with business account or integrate with business profile page or business page or business application or make accessible or allow to use or make available or make searchable for users of network or members or followers or customers of business account one or more mini applications, wherein mini applications comprises order, book, reserve, buy, participate in deals or group deals, get support, offer for you, schedule appointments, communications, participations, transactions, call-to-actions, collaborations, sharing related applications.

In an embodiment enabling user to search, select, bookmark, share and use and share selective data or updated data or contents with one or more mini applications or sub programs related to one or more selected business accounts or business contacts 5151, wherein mini applications comprises order, book, reserve, buy, participate in deals or group deals, get support, schedule appointments,

In an embodiment displaying suggested business account(s) 5154 to user based on searched websites, liked products, services, brands, identified transactions, received emails, calendar entries, logged activities, actions, transactions, visited places, checked in places, participations and interacted entities, visited websites, installed applications, subscribed services, user related data on one or more external or linked systems, databases, domains, applications, websites, servers and social networks and enabling user to add to business contacts or add to one or more lists or connect or follow one or more selected business accounts from said suggested lists of business accounts 5154.

In another embodiment enabling business account holder or owner or admin to associate with business account or integrate with business page one or more call-to-actions or custom call-to-actions for all or specific users or members of business (e.g. claim offer for you, play game and win, visit shop for new products presentation, claim virtual goods gift, view video and get discount, refer 10 friends and get free pizza in your next visit and like) and enable user to search, select and add or remove or integrate one or more call-to-actions related to selected business or place of business or business account with user's profile for easy access or select one or more call-to-actions including request payment link or make payment vis received pushed link from business or place of business or enter amount and make payment of particular amount from selected user's payment account to said business's bank account 5161, search, match, sort, filter, browse, select, bookmark, add to one or more types of lists, negotiate, compare, purchase products and subscribe services and make payments 5162/5163, participate in business account admin or authorized person published deals or group deals and make payment 5164, get appointment 5165 as per scheduled date and time, reserve table 5166 as per scheduled date and time, book 5167 as per date and time and order 5168 one or more selected products and on-demand services.

In an embodiment making current or past customers or users of particular types or named or branded products and services as support service providers or live chat agents to answer queries of requestors or customers or prospective customers related to said products and services. Enable user to register as social support service provider including customer support service, live chat service. Social support service provider user can set privacy settings and define rules including schedule availability dates and time or dates and time ranges, like to attend or contribute for particular duration or number of times within particular duration, provide support only to contacts and/or contacts of contacts or users related to particular location or language, turn on or off providing social support service 5193.

In an embodiment user can turn on or off receiving social support service from matched other social support service provider users of network 5192. In the event of selecting social support service control or icon or button 5090 from business account profile page or business page or from business website or business application or from business place on maps, matching requesting registered customer support service providers or identify business account related or matched and available at least one or one or more social support service provider(s) for real-time chatting or live chat or communication with said requesting user and enabling requesting user and social support service provider(s) to start sending or receiving messages or real-time chatting or communication 5192.

In an embodiment enabling user to allow to monitor current location of user device, identify associated place and displaying associated call-to-actions controls, user interface, application, one or more types of contents and rich messages 5191 (options, selections, controls, widgets, form, custom call-to-actions, one or more types of contents and any combination thereof) in instant messenger or chat interface or application of user client device 200.

In an embodiment monitoring and tracking user device current location and based on monitored and tracked current location of user device identifying current location associated place or nearby or nearest place [e.g. Starbucks] where user frequently visit then automatically show maps and direction, offer for user and coupon for user to attract nearby user to visit place [e.g. Starbucks]. In the event of visiting said place [e.g. Starbucks] or current location associated place [e.g. Starbucks], automatically connect user [e.g. Yogesh] with said place associated business account [e.g. Starbucks] and display said place [e.g. Starbucks] associated actions or call-to-actions controls, user interface, application, widget, forms, rich messages, one or more types of contents 5295 to visiting user [e.g. Yogesh] and enable to view menu, make order, make payment, view invoice or receipt or bill, ask query or assistance 5294. In the event of exiting from said place remind payment if payment not done, display feedback or reactions from or user interface for enabling user to like, provide ratings and comments, participate in survey 5295.

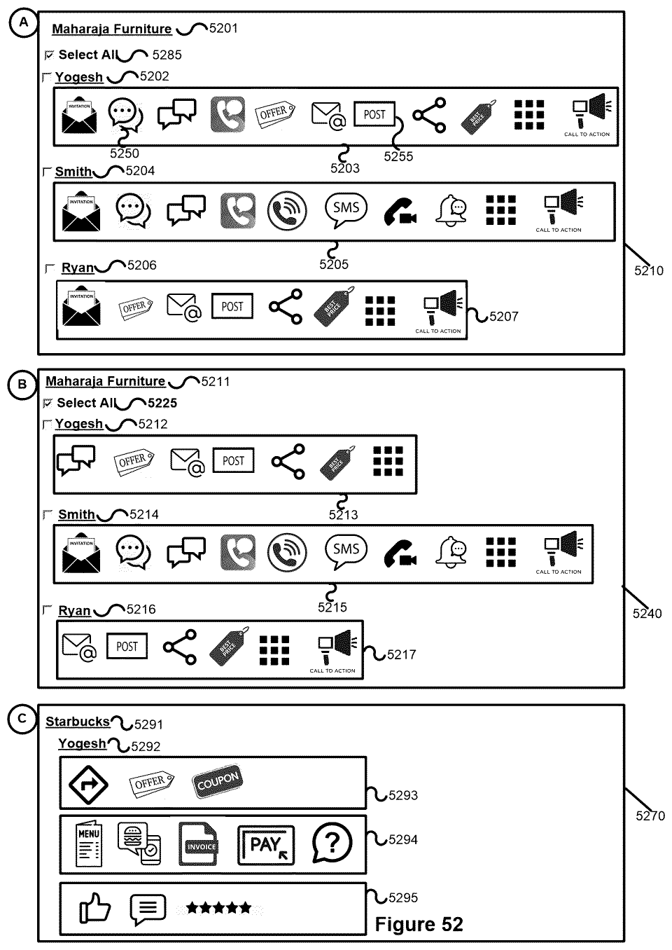

FIG. 52 illustrates graphical user interface wherein in one embodiment receiving request from identified user from module 276 to apply privacy settings and defined rules on selected one or more business accounts (as discussed n FIG. 52 in details) and storing said corresponding applied privacy settings and defined rules associated with respective selected one or more business accounts on server 110 database 115 via module 175. Displaying to each business account associated owner or admin or authorized person, business associated applied privacy settings and defined rules by each users and showing or activating or enabling, by server 110 module 175 in each business account related graphical user interface 5210, communications, sharing and call-to-actions controls 5203/5205/5207 associated with each users 5202/5204/5206 based on applied privacy settings and defined rules by corresponding each users 5202/5204/5206 related to business 5201.

In an embodiment receiving communication or sharing or call-to-action request 5250 from the business account 5201 associated graphical user interface 5210 to selected one or more users 5202/5204/5206. Identifying. by the server 110 module 175, applied privacy settings and defined rules associated with said selected each users 5202/5204/5206 and based on identified applied privacy settings and defined rules, communicating received communication or establishing communication session, executing call-to-action(s), send or display shared contents and call-to-actions to one or more selected users. In an embodiment showing or hiding or enabling or disabling or activating or deactivating controls related to user based on user applied privacy settings and defined rules, wherein rules comprises allow one or more selected types, medium, channels of communication, sharing, call-to-actions based on included or excluded selected days, dates ranges and time ranges, allow number of times communications or sharing of contents within pre-set duration including per day, allow for selected types of purposes, tasks, actions, transactions, and offers, allow only for selected named products, services, brands, selected categories or types of products, services, brands, allow per communication for maximum pre-set duration only, allow incoming real-time communication based do-no-disturb policies, allow based on each time ser acceptance of communication or content, allow if offer lowest price then published price disclosed by user for particular product or services, allow only for purchased products and services, automatically connect me if purchase or subscribe or order or participate in deals or book or get appointment, automatically connect me with current location associated place or place of business, do not allow if global off setting, allow if requirement send, allow for new products and services or allow for selected types of products and services, response me only if send message or SMS or email, allow to send message only if connect, if video call allow only my voice, if video or voice call send messages.

For example User [Yogesh] applied privacy settings and defined rules to/with business account [Maharaja Furniture] (discussed in detail in FIG. 51) and based on applied privacy settings and defined rules automatically displaying or showing or activating or enabling in graphical user interface or page or application 5210 related to owner or admin or authorized person associated with business account of [Maharaja Furniture], one or more types of controls 5203 including invitation, live chat, instant messaging, text call, offer, email, post, sharing, mini apps, call-toa-actions controls or icons or buttons or links related to user [Yogesh] 5202. In the event of triggering of triggers or based on privacy settings and rules applied or updated by user [Yogesh] on particular business [e.g. Maharaja Furniture], automatically show or hide said controls 5203. For example, FIG. 52 (b) shows only controls 5213 related to user [Yogesh] 5212 which falls in pre-set scheduled days, date and time range applied or associated with controls. For example, user [Yogesh] allow live chat only on Saturday morning 10-11 AM and at present because time is e.g. 2 PM, do not showing live chat control 5250 in currently available controls section 5213 related to business account [Maharaja Furniture] admin or agent or authorized person.

In another embodiment admin or agent or authorized person of business account request user to allow business account or business to turn on particular type of settings so business can help them in providing support, provide custom offer, provide support on live video, and like.

In another embodiment admin or agent or authorized person of business account can select all 5285 or one or more displayed users 5202/5204/5206 and can select particular action displayed in user interface 5210 (5202/5204/5206) to apply on all 5285 or selected one or more users 5202/5204/5206 for conducting group action. For example, authorized person of business account [Maharaja Furniture] selects all users 5285 (5202/5204/5206) and click or tap on “Post button” e.g. 5255 to post or send selected or drafted contents to all selected users.

FIG. 53 illustrates centralized live chat graphical user interface wherein user can view in list 5295 (5305/5315), displayed business accounts or place of business names 5210/5312/5320, wherein displaying business accounts or place of business based on selecting of business account name or visiting business account profile page or business page [e.g. Maharaja Furniture] 5070 in application or instant messaging or chat application and selecting of “Centralized live chat or communication” control or icon or link or button 5080 or selecting place of business [e.g. Maharaja Furniture] 4560 on maps 4520 or visiting website of business [e.g. Maharaja Furniture] or in-person visiting of place of business [e.g. Maharaja Furniture] or selecting “Centralized live chat or communication” control or icon or link or button 5080 on website or in application of business [e.g. Maharaja Furniture] or based on user [e.g. Yogesh] applied privacy settings and rules associated with business [e.g. Maharaja Furniture] receiving of request of live chat from requested or available agent of business [e.g. Maharaja Furniture]. In the event of clicking or tapping on particular list item 5310 of my chats 5305, automatically opening chat user interface 5390 associated with particular identified and available agent (e.g. “John”) related to said selected business account (e.g. “Maharaja Furniture”) from list 5395 and enabling user [e.g. “James” ] to type a message in text input box 5380 of chat interface 5390 and sent message 5382, wherein message may comprises text, photo 5381/5382, video 5383/5382, audio or voice file 5384, emoticons 5363, stickers 5363, uniform resource locator (URL) 5365, file or document attachments 5361, ready to use customized list of message templates 5362, create and select tag(s) from list of tags 5364 to add or associate one or more tags with one or more messages or chat or agent, location information 5366, shared structured data, controls including call-to-actions, buttons, widget and user interface, application, forms and any combination thereof. User can view initial or intro message 5351 sent by agent and other messages 5352 sent by user [e.g. “James” ] and messages 5354/5355 sent by agent [e.g. “John” ].

In an embodiment user can select or change mode or channel of communication including video call 5388 with or without disclosing user identity and profile information, send video message 5385 in chat, send voice message 5386 in chat, make voice or phone or voice over IP (VOIP) call 5387 with or without disclosing user identity and profile information, send short message (SMS) 5389 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

FIG. 53 illustrates exemplary centralized live chat graphical user interface for user. In my chats 5305 section user (e.g. “James”) can access a list of all agents 5305 whom user (e.g. “James”) is chatting and can switch between chats by clicking on names 5310/5312 on the list 5305. In queued chats section 5315, user (e.g. “James”) can view a list 5315 of all agents 5320 that are currently waiting in the queue. User (e.g. “James”) can select agent (e.g. “Julia”) 5320 from the queued list 5315 to start a conversation with selected agent 5320. In chat history section (not shown in figure) user (e.g. “James”) can view and access past converted messages by agent and customer. User can view information shared by agent including files, e-mail address, phone number, call-to-actions, user interface, forms, data, invoice, location, the page they are currently on.

FIG. 54 illustrates exemplary centralized live chat graphical user interface for agent 4050 associated with particular business account 5451. When agent (e.g. John) is connected with particular customer based on agent's online status, assignment, availability and chat limits settings or receiving request from customer (e.g. James) to connect with agent (e.g. John) or transferring of chat from another agent to agent (e.g. John), enabling agent [e.g. “John” ] to type a message in text input box 5480 of chat interface 5490 and sent message 5482, wherein message may comprises text, photo 5481/5482, video 5483/5482, audio or voice file 5484, emoticons 5463, stickers 5463, uniform resource locator (URL) 5465, file or document attachments 5461, ready to use customized list of message templates 5462, create and select tag(s) from list of tags 5464 to add or associate one or more tags with one or more messages or chat or agent, location information 5466, shared structured data, controls including call-to-actions, buttons, widget and user interface, application, forms and any combination thereof. Agent can send initial or intro message 5451 to connected user [e.g. James] and via other messages 5452 sent by user [e.g. “James” ] and messages 5454/5455 sent by agent [e.g. “John” ], wherein rich messages may comprises product photo 5471, link 5472, user interface, application, widget, video, controls or call-to-actions including add to cart 5473, buy 5474, offer 5475, book, order, get appointment, reserve, participate in deal, select, reactions controls including like, rate, comment.

In an embodiment based on customer's or user's privacy settings and applied rules associated with agent's associated business account [e.g. Maharaja Furniture], agent can select or change mode or channel of communication including video call 5488 with or without disclosing user identity and profile information, send video message 5485 in chat, send voice message 5486 in chat, make voice or phone or voice over IP (VOIP) call 5487 with or without disclosing user identity and profile information, send short message (SMS) 5489 with or without disclosing user identity and profile information to connected or available agent. In another embodiment user can share contact information and selected profile information including age, gender, location, interest, requirement specification, and like, so agent can conduct customized communication and offer for user and also with user permission if require make voice or video call, send information, share posts, send SMS, send push payment links, send voucher or coupon and like.

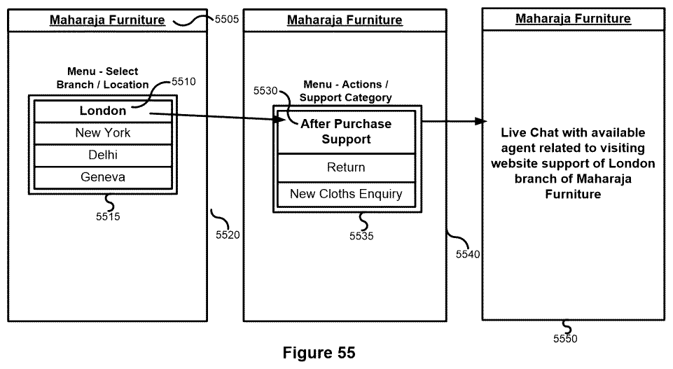

FIG. 55 illustrates in one embodiments in the event of selecting of live chat and communication option from particular business profile page of business account [e.g. Maharaja furniture] in application or instant messenger application or business page opening associated chat interface, displaying associated customized menu which may comprises various options including location names, place names, department names, types of activities, types of call-to-actions, type of support requirements, type of roles, type of transactions, rules, person names, keywords and like. User is enabled to select particular option or menu item 5510 from displayed list of options or menu items 5515. In the event of selecting particular option or menu item 5510 from displayed list of options or menu items 5515, in another embodiments displaying another menu or sub-menu or list of options 5535 and in the event of selecting particular option or menu item 5530 from displayed list of options or menu items 5535, display chat interface 5550 and connecting user with said selected business account related to business or place of business or website or company or branch or department or option related agent. For example, user is connected with available agent related to “After Purchase” 5530 of “London branch” 5510 of “Maharaja Furniture” business account related to business or place of business or website or company or branch.

In another embodiment enable admin to create and update custom menu, associate one or more rules including display menu based on location, type of customer, current website activities, actions, transactions, user profile including age, gender, interest, location, education, language, interacted or connected entities, current place or visited place, type of user status.

In another embodiment in instant messenger application associated business accounts or businesses, monitoring, tracking and identifying response time on user or customer's message by admin or agent or staff or owner associated with business account and in the event of sufficiently identifying real-time response on user or customer's message by admin or agent or staff or owner associated with business account, enabling or activating or automatically showing or allowing live chat option or control or feature or graphical user interface or application in business account or allowing business account owner or admin or authorized person to integrate or add or activate live chat option or control or feature or graphical user interface or application for customers of business or users of instant messengers and enabling them to communicate with selected business's real-time available agent for getting live chat support.

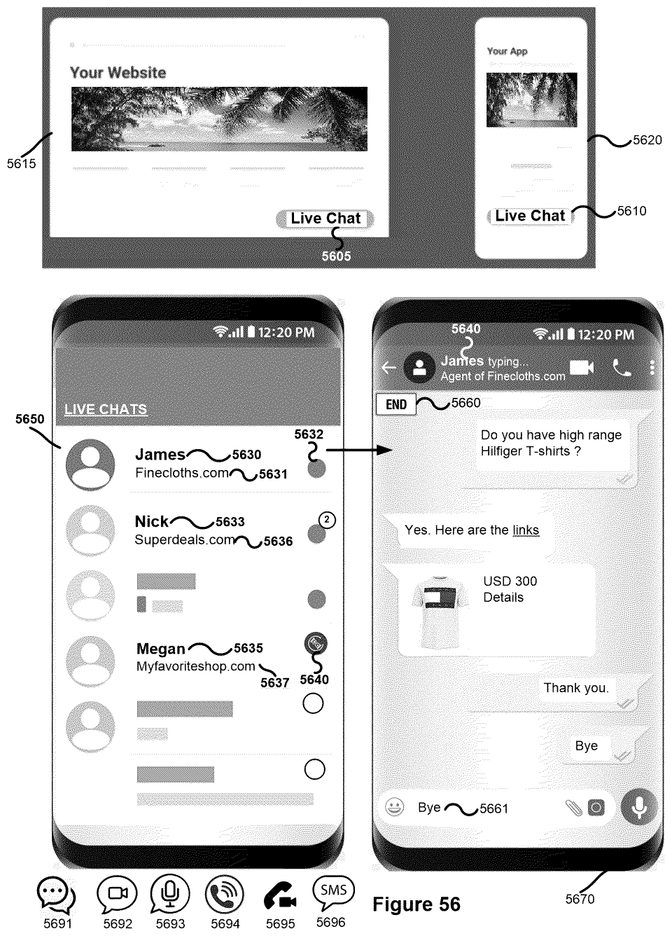

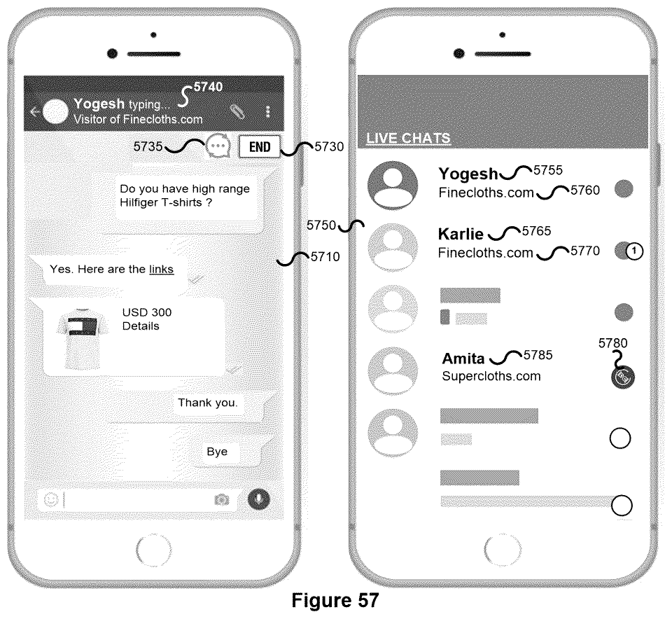

FIGS. 56-57 illustrates example wherein website or app visiting user can select or click or tap on pre-integrated “Live Chat” icon or button or control 5605/5610 in webpage or website 5615 from web browser or mobile web browser or in installed application or mobile application 5620 to download, install and register application (if application not installed) or if application installed then open application 5650. In the event of selecting or clicking or tapping on icon or image or link or button or control 5605/5610 in webpage or website 5615 from web browser or mobile web browser or in installed application or mobile application 5620, invoking or opening installed and registered application 5650 in user device and In another embodiment user can select pre-integrated “Live Chat” icon or button or control 5605/5610 from one or more webpages or websites 5615 from web browser(s) or mobile web browser(s) 5620 or in installed application(s) or mobile application(s) and in the event of selecting or clicking or tapping on icon or image or link or button or control 5605/5610 in webpage or website 5615 from web browser or mobile web browser or in installed application or mobile application 5620, invoking or opening installed and registered application 5650 in user device and getting currently viewing one or more webpage(s) or website domain name(s) or unique application name(s) via website or webpage or app integrated button associated website domain name and other information including place name, business name, owner or person name, contact and location information and displaying said currently viewing or open one or more unique website(s) or app names 5631, 5636 and 5637 and other associated information. In an embodiment if user currently viewing only one website 5615 or application 5620 then in the event of selecting button or control 5605/5610, open application and directly displaying chat interface 5670 and connecting visitor or user with currently available live chat agent associated with said selected website and in the event of establishing connection, starting live chat session, displaying name, photo or image and other information of currently available and connected agent 5640, displaying typing indicator of agent and enable user to enter text 5661 or select or take one or more types of media and sent to agent which connected agent receive on agent's interface 5710.

In an embodiment identifying currently available live chat agent based on one or more types of queuing logic. Chats are routed according to a few simple rules. They can be automatically routed to agents or they can go to a queue from which they are picked up. In an automatic chat routing, each new chat goes to the first available agent with the accept chats status on by agent. When all agents have one chat each, the next round will be distributed. It will go on until the concurrent chat limit of all the agents accepting chats at the time is reached. Admin can set a limit to the number of chats each agents can have at a time by providing settings or editing agent profile. With manual chat routing, the customers who started chat will be directed to the queue. All agents with the accept chats status will receive a notification about that event, and can pick up the customer from the queue and start a chat. They can do that by selecting a customer from the queued chats list and clicking on start chat button or by using a keyboard shortcut. As soon as one of the agents picks up a chat, others won't be able to do so. User who are in queue can view queuing status in the form of icon or animation 5640.

In an embodiment user can switch between multiple current live chats by selecting particular website name from displayed currently viewing website names.

In an embodiment agent can switch between multiple chats with multiple users or customers or business website visitors or business application users by selecting particular chats 5755 from list of currently attending chats 5650.

In an embodiment agent can manually select particular user 5785 in queue 5780 and attend chats. In an embodiment agent can attend multiple chats from same website or multiple websites of same or different owners or businesses.

In an embodiment user or agent can end chats between user and agent by selecting end button or control 5660/5730. In an embodiment in the event of selecting end button or control 5660/5730 by agent or user, ending live chat session and removing name from currently viewing list of websites and displaying website name in logged or saved chats list, so user can vie past chats related to selected website name.

In another embodiment in the event of viewing website in desktop browser and selecting “Live Chat” button or control by user or visitator, identifying selected “Live Chat” button or control associated website domain name from user desktop browser to user's mobile device application based on employing one or more existing techniques including app stores, browsers, and external domains' multi devices connecting and log-in techniques.

In another embodiment in routing between groups, chats are also distributed according to groups. Automatic chat routing distributes chats from a specific group to agents from that group. With the manual chat selection enabled, only agents from a particular group will receive a notification when a new chat for that group is available. In another embodiment admin or agent can also transfer chats 5735 between various groups.

Business owner registration described in detail in FIG. 31. Agents management described in detail in FIG. 32. User registration described in detail in FIG. 33. Menu options associated with particular website or application or business described in detail in FIG. 37.

In another embodiment enabling user to anonymously connect with agent without disclosing user's identity or enable user to show or hide user's details based on privacy settings to connected agent of selected website.

In another embodiment user can select or switch one or more communication mediums or channels or interfaces for live chat or live communicating with available agent of user selected or user visited particular website, wherein communication mediums or channels or interfaces comprises chat, video, voice or VOIP, phone or video call and SMS communication. In an embodiment when user select chat 5691 then user can send and receive messages with connected and available agent of selected or currently viewing website. In an embodiment when user select video message 5692 then user can send and receive video messages with connected and available agent of selected or currently viewing website. In another embodiment if user select audio message 5693 then user can send and receive audio messages with connected and available agent of selected or currently viewing website. In another embodiment if user select voice call including cellular phone call or Voice over Internet Protocol (VoIP) 5694 then user anonymously connect and converse with currently available agent of selected or currently viewing website. In another embodiment if user select video call 5695 including cellular video call or video call over internet protocol then user anonymously connect and converse with currently available agent of selected or currently viewing website. In another embodiment if user select SMS 5696 then user can anonymously connect and converse via SMS with currently available agent of selected or currently viewing website. User can hide user's identity including name, photo, contact information including phone number (hid phone number via phone number masking), user name, location information. In an embodiment user can also hide user's face or body parts or off video and turn on only audio whereas agent can communicate with user via video and voice communication.

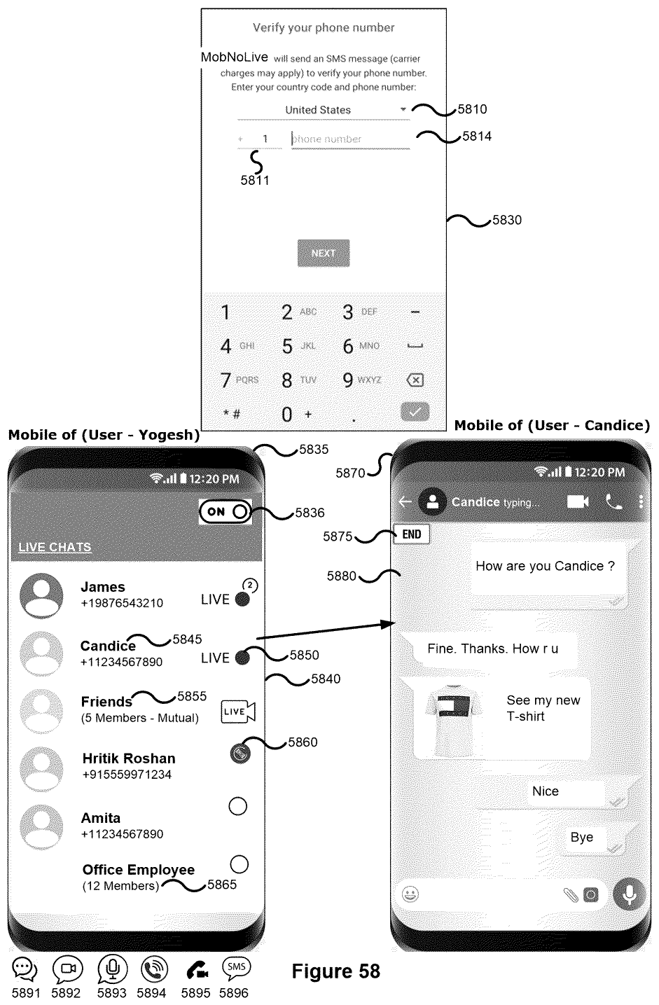

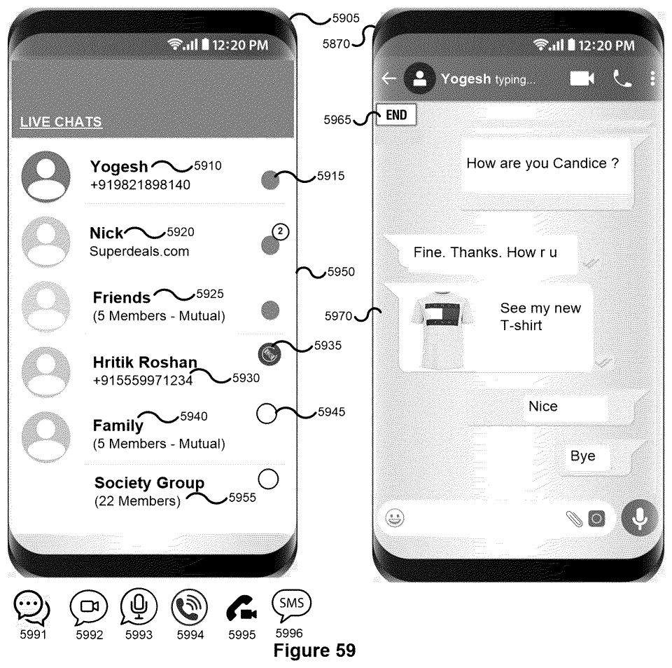

FIGS. 58-59 illustrates user registration, verification, importing phone book contacts, identifying contacts who installed and registered application or not, updating contact lists who installed and registered application. In one embodiment individuals may download application from a variety of on-line application stores or websites. In some cases, the application is pre-loaded to an individual's phone by a network carrier or device manufacturer. Once the application has been downloaded and installed to a mobile device 130/135, an individual is required to register with a server or platform using his or her mobile device 130/135. During the registration process, individuals may be asked to read and accept Terms of Service and Privacy Policy. The Terms of Service and Privacy Policy may be provided in a pop-up window at the time of registration and may also available on-line website. Once an individual has read and accepted terms of service, displaying user registration interface 5830 and he or she may be asked to specify the country 5810 in which they reside and to provide their mobile phone number 5814. In some cases, the application may also ask a registrant for their preferred notification name (i.e., the name the user wishes to appear in out-going messages). Once an individual has provided his or her country name 5810, automatically identify country code 5811 or user can manually select or enter country code 5811 and mobile telephone number 5814, the application may collect the following information from the registrant's mobile device including device identifier information, mobile subscriber ID, mobile country code, and mobile network code. Using that information, server module 151 may send an account confirmation message to the registrant by way of standard short message service (SMS). In an embodiment using the registrant's reply to that message, server module 151 then verifies that the personal information provided by the user during the registration process matches that attached to the mobile device. Once confirmed, a user is registered and his or her account is activated.

In an embodiment based on received country name 5810, identifying country code 5811. In an embodiment automatically identify the user's country name, country code and mobile phone number and automatically send one time password (OTP) and automatically verify one time password (OTP).

In an embodiment displaying information including user's country name, country code and mobile phone number and enabling the user to select country name, country code and mobile phone number. In some embodiments the system displays sign-in hints or phone selector or suggested mobile phone numbers for user selection of the user's mobile number from the list. In some embodiments systems employ or implement mobile phone number verification via on time password or automatic SMS verification or automatic SMS verification with the SMS retriever API, voice verification and other types of verification process.

In an embodiment server 110 module verifies phone number based on employing one or more mobile number or phone number verification techniques including sending one time password (OTP) on user provided mobile number associated user device 130/135.

The user may then begin using the application 5840. In order to facilitate contact between application users, service relies on a user's address book to populate his or her mobile phone number related “All Contacts” list. Once a user consents to the use of his or her address book, contact information from the user's mobile device is periodically transmitted to server(s) 110 connected database(s) 115 via server module to assist in the identification of other users on network. In one embodiment, the application is designed to upload a user's mobile address book to server(s) 110 module up to one or more times daily or periodically, or as initiated by the user during a contact refresh. Personal information collected during the contact discovery process may comprise contact details including contact name, photo, phone number, email addresses, social accounts and mobile phone numbers or only mobile phone numbers. Association between contact names and phone numbers may occur on server 110 database 115 or a user's device 130/135 only, and not by virtue of any data matching by server 110. Once a user has consented to the use of his or her contact information for contact discovery, contact details or mobile numbers from the user's address book are transferred securely to server(s) 110 module 153 securely including using Secure Socket Layer/Transport Layer Security or SSL/TLS encryption. Once uploaded, a contact number is categorized by server(s) 110 module 153 as being either “in-network” (i.e., registered with server 110 or platform or network 100) or “out-of-network”. In an embodiment only numbers listed as in-network can be contacted using the server 110 or platform or network 100. In another embodiment an out-of-network number would only become associated with user once the application was installed and registered on a device with that number. In-network numbers may store as original values (i.e., in clear text) on server(s) 110. In an embodiment out-of-network numbers are stored as one-way, irreversibly hashed values. Application may use a multi-step treatment of the numbers, with the key step being an “MD5” hash function. The phone number and a fixed salt value serve as input to the hash function, and the output is truncated to 53 bits and combined with the country code for the number. The result is a 64-bit value which is stored in data tables 115 on server(s) 110. This procedure is designed to render out-of-network numbers (i.e., the mobile numbers of non-users) anonymous.

In an embodiment identifying contacts in user's phone book contacts who installed and registered an application. Receiving or accessing, by server module, user phone contacts including phone numbers or user mobile phone or user device's phone address book. Identifying, by server module, contacts who installed application and registered with the system or platform or network or application or service or server 110 (“in-network”) and remaining contacts who not installed and registered application (“out-of-network”) based on said received or accessed phone numbers by automatically compares all the phone numbers from the device's address book with server's 110 central database(s) 115. Server module, automatically add identified contacts who installed application and registered with the sever 110 to the user's contact list and also in client-side user's contact list and enabling user to select one or more contacts from list of added contacts to live chat with selected contacts or groups who are currently set status is ready for live chat for all users or for user.

In another embodiment based on identification of “out-of-network” users or contacts of a user who yet not installed and registered an application, server sends SMS or instant message on instant messenger and invites each said contacts of user to install and register application. In other embodiments a user can select an invite option and can send SMS or instant message via client application or via server module on instant messenger application or SMS application and invite each said contacts of user to install and register application and connect with user an based on privacy settings enable to live chats with each other.

While installing or opening or using application, system ask user to provide various types of permissions including show nearby places, take a photo, record a video, open another app's media or documents, Identify the device that is running an instance of your app, pair with a device over Bluetooth, Calendar: Use your default calendar, Camera: Use your camera to take pictures or videos, Contacts: See your contacts list and read, create, or edit your contact list, as well as access the list of all accounts used on your device, Location: Ask to get your device's location, Microphone: Record audio, SMS: See and send SMS (text) messages and read, receive, and send MMS and SMS messages, Storage: Get photos and other files on your phone, Files and media: Use photos, media, and other files on your phone, send notification, access device identities, access to storage and personal information, such as contacts, calendar appointments, etc., location tracking, access to the device's internal camera and/or microphone, internet access, sending and reading text messages, the ability to perform in-app purchases.

In another embodiment user can apply settings including publish user's “currently I am available for live chat status” or allow or enable selected one or more types of one or more contacts and groups to live chat with user when user turn on live chat status 5836 or when system automatically determine or turn on user's live chat status based on while user turn on automatically determine or turn on user's live chat status, wherein automatically determine or turn on user's live chat status based on all or selected or identification of one or more factors, events, triggers, activities, actions, transactions, updates from user related linked systems and status including when user open application, when user open application and send at least one message to other user or contact, while viewing websites or particular type of or named or selected websites or applications, while open device during particular duration or range of timings or scheduled date and time, while visiting one or more selected types and/or named of places including restaurants, malls, shops, hotels, tourist places, in transit, while conducting one or more types of digital activities including visiting website, purchasing products, reading or viewing contents, transacting, booking, reading news, reading tweets, clicking or tapping or selecting “Make Me Live” or “currently I am available for live chat” status control or button, while recognizing in voice one or more types of keywords, providing pre-defined voice commands,

In an embodiment turn on “live chat” status means user s now available for live chat with all or selected contacts or groups up-to turn off “live chat” status by user. In an embodiment after turn off “live chat” status by user, if any contacts send message and user's reply or respond message within pre-set duration then automatically turn on “live chat” status for all or only for said message sender contact.

In an embodiment when user opens application, automatically make user live or automatically show or publish user's live status to all or user selected contacts or groups or contacts who are also currently live or turn on “live chat” status, wherein contacts comprises phone contacts, email contacts, one or more external applications, websites, social or professional networks' mutual connections, followers, like minded or interest specific users of network, user can manually select ON or OFF switch control or button 5836 to turn on or turn off user's “live chat” status and updating or notifying about said status to pre-set or all or selected contacts of user.

In another embodiment automatically turn off user's live chat status based on manually turn off “live chat” or “currently available for live chat status” to make it “currently not available for live chat” status based on closing of application, detecting incoming calls, switching to other application(s) of user device, recognizing of voice including one or more types of keywords, recognizing voice commands, currently nobody turn on “live chat” status in user's contacts, identification of particular type and named place including inside movie theatre, school, college, class, office, when do not disturb on, as per scheduled timings, dates, and days.

In an embodiment in the event of manually turning on 5836 or automatically turning on user's live chat status, indicating, sharing, advertising, sending and publishing user's live chat status to all or default or pre-set or one or more selected contacts, one or more selected types associated one or more selected contacts one or more groups, one or more contacts or members of one or more groups, followers, one or more types, filtered, keywords, natural query, advance query(ies), structured query language (SQL) query(ies) specific users of network or users of one or more external domains or linked systems and enable user to view live chat status of other users and contacts who allowed user or based on privacy settings auto determined by system to allow user to view their status. in an embodiment displaying in user interface in list of contacts who are currently turned on live chat status or contacts whose live chat automatically turn on based on privacy settings and plurality types of factors as discussed in detail above. In another embodiment ordering list item based on contacts who are currently started live chat with user, ranking or rating, relationships, frequency and duration of live chat in live chat sessions, who turned on their live chat status or contacts whose live chat status automatically tuned on, and contacts who yet not available for live chat or their live chat status is not turned on and contacts who yet not installed and registered application.

In another embodiment user can allow contacts and other users to communicate with one or more communication mediums, interface, applications and channels including live chat, VOIP, Video call

In another embodiment user can request selected one or more contacts to turn on live chat status. In another embodiment user can request selected one or more contacts to turn on live chat status and in the event of accepting request, turned on live chat status of recipient user. In another embodiment user can send message to one or more selected contacts and in the event of responding message within pre-set duration, automatically turned on live chat status of users who respond said message within pre-set duration.

In another embodiment in the event of turning on live chat status and in the event of communicating by or sending of message by any contacts of user, automatically turn on live chat status of said contacts for user or selected contacts of said user. In another embodiment enabling user to end 5875/5965 current live chat session. In an embodiment display lime communication availability indication icon including “Live Chat” 5850 or “Live Video Chat”. In another embodiment display “Queue” icon 5860 who user is waiting for conversation with particular contact. In an embodiment integrate live chat application icon within each phone contact of phone book contacts of user device, each phone contact of user in detail phone contact profile and phone dialer. In an embodiment within live communication including chat session, participant or connected users can converse or exchange messages 5880/5970. In an embodiment while user and contact of user available for live chat, they can show each other's live chat availability status 5850/5915. User can view live chat availability status of one or more members in group.

In another embodiment user can select or switch one or more communication mediums or channels or interfaces for live chat or live communicating with contacts, wherein communication mediums or channels or interfaces comprises chat 5891/5991, video communication or messages or call 5892/5895/5992/5995, voice or VOIP or phone communication or messages or call 5893/5894/5993/5994 and SMS 5896/5996 communication. User can hide user's identity including name, photo, contact information including phone number (hid phone number via phone number masking), user name, location information.

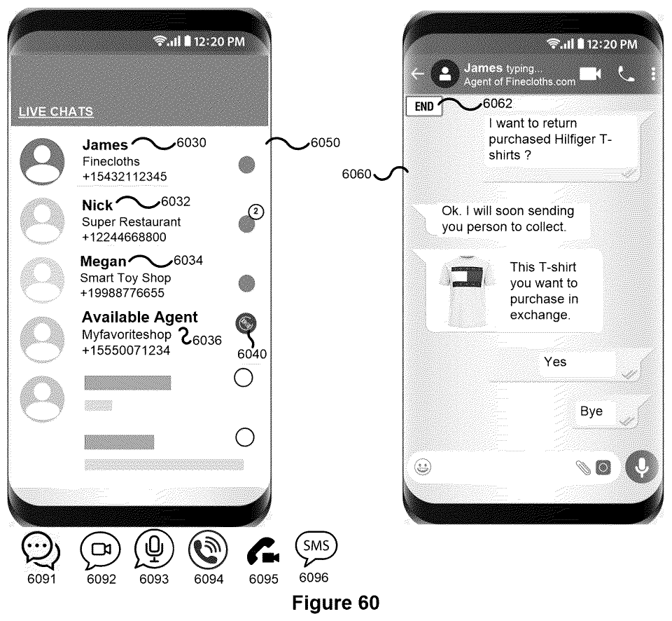

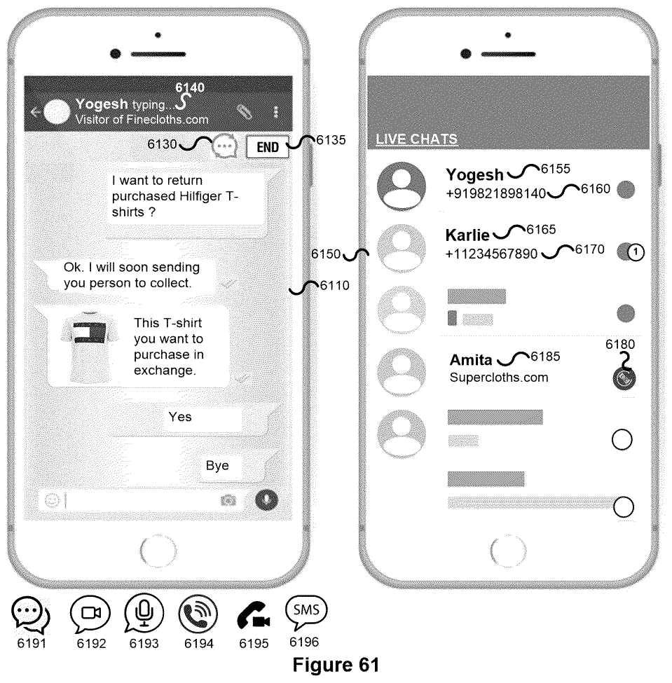

In another embodiments FIGS. 60-61 illustrates phone number based live chat by businesses with customers. Enterprise user or shop or place of business or admin or owner of business can register with the server 110 or system or platform by providing country code and phone number or mobile phone number and conducting verification of said phone number based on sending one time password (OTP). After registration Enterprise user or shop or place of business or owner can provide additional details or business profile including business name, logo, photos, categories, description, opening and closing hours, products and services details, address, profile of available live chat agents including name, photo, category, working hours and like. Enterprise user or owner of business can add and invite agents, set and/or allow agents to add or update profile, work schedule, add or update password, role of agent, category of agent, number of chats agent can handle (chats limits), accepting or non-accepting live chats, current status of availability for live chats, create groups of agents, define and set queuing logic and remove agents, schedule shifts.

User can register with the server 110 or system or platform by providing country code and phone number or mobile phone number and conducting verification of said phone number based on sending one time password (OTP). After registration user can provide additional details or profile information including name, photo, age, gender, interests, interacted entities details, currently using and like to use products and services details, home and work addresses, allow to access location of user device.

After user registration, system or server importing phone contacts from user phone device and compare with all phone number to identify enterprise users who registered with the server or system or platform or not and displaying list of enterprise users who registered with the server or system or platform in user interface of user device and identifying and displaying list of enterprise users who yet not registered with the server or system or platform in user interface of user device. In another embodiment server or system also identifies and displays non-enterprise user or non-business phone contacts and enable user to invite all or selected phone contacts to download, install and register application.

In an embodiment user can search and browse categories directories of registered or listed profiles of businesses, shops, companies, organizations, schools, colleges, service providers and different types of entities and view their profiles and manually add to user's one or more types or categories of list of contacts. In an embodiment user can also search and browse categories directories of un-registered or un-listed profiles of businesses, shops, companies, organizations, schools, colleges, service providers and different types of entities and view their profiles and manually add to user's one or more types or categories of list of contacts.

In another embodiment automatically identifying or automatically adding to contacts or suggesting for user, contextual or relevant contacts of businesses who are registered and listed on server 110, system, network and platform or also who are yet not registered or listed on server 110, system, network and platform, wherein automatically identify contextual or relevant contacts of businesses for user based on monitored and tracked current place of user device and length of stay of duration at particular identified place, received emails and messages and calendar entries associated entities, transacted entities, accessed user related data from linked systems, user profile, purchased or ordered products, booked or subscribed services, list of currently using and liked products and services, scan QR code or image, recognizing voice in user's conversation including name of businesses, logged live chats associated keywords and types of businesses to whom user interacted. In another embodiment user can select from suggested list of businesses and add to user's one or more types of categories lists of contacts.

User can view different types of lists of contacts 6030/6032/6034 for live chat in user interface 6050. User can select or search or browse directories or lists and select particular phone contact or list item related to business or place of business. In the event of selecting particular phone contact 6030 or list item 6030 related to business or place of business, automatically sending request to live chat to server 110, wherein server 110 forward said request to registered phone number associated business on application 6110 of authorized user or in another embodiment identifying phone contact associated currently available agent from list of agents defined by owner or administrator of business account and connect user with currently available agent, start live chat session, notifying user to starting of live chats and enable user and connected currently available agent to send and receive messages 6060/6110 with each other. In an embodiment in the event of selecting end button or control 6062/6135 or closing of application by user or agent, ending live chats or ending live chats session.

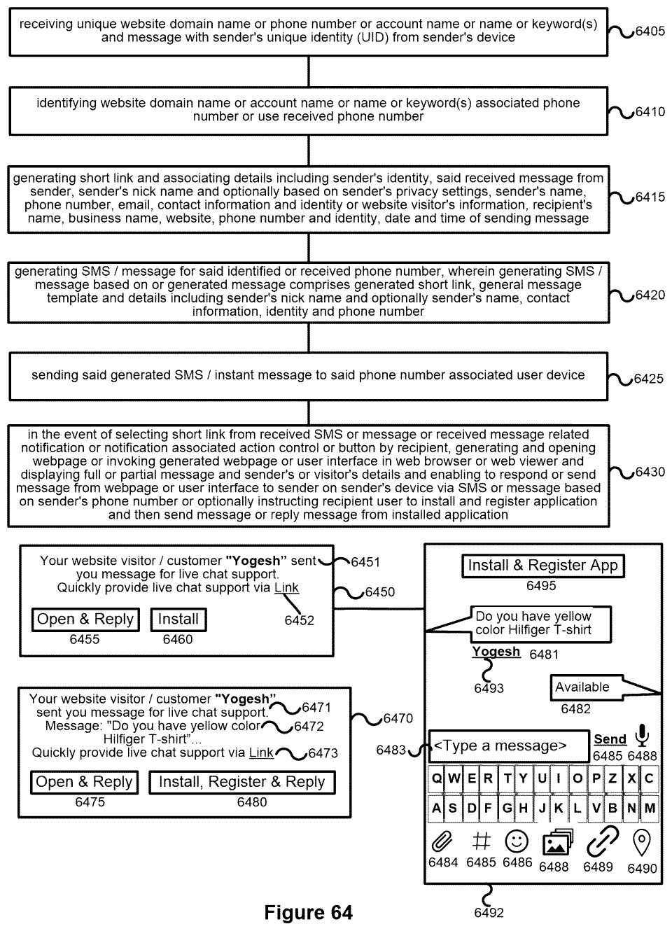

In another embodiment user can live chat with un-registered or un-listed businesses or agent of businesses as discussed in detail in FIG. 64.

In an embodiment identifying currently available live chat agent based on one or more types of queuing logic. Chats are routed according to a few simple rules. They can be automatically routed to agents or they can go to a queue from which they are picked up. In an automatic chat routing, each new chat goes to the first available agent with the accept chats status on by agent. When all agents have one chat each, the next round will be distributed. It will go on until the concurrent chat limit of all the agents accepting chats at the time is reached. Admin can set a limit to the number of chats each agents can have at a time by providing settings or editing agent profile. With manual chat routing, the customers who started chat will be directed to the queue. All agents with the accept chats status will receive a notification about that event, and can pick up the customer from the queue and start a chat. They can do that by selecting a customer from the queued chats list and clicking on start chat button or by using a keyboard shortcut. As soon as one of the agents picks up a chat, others won't be able to do so. User who are in queue can view queuing status in the form of icon or animation 6040.

In an embodiment user can switch between multiple current live chats by selecting particular phone number of list item from particular list.

In an embodiment agent can switch between multiple chats with multiple users or customers or business website visitors or business application users by selecting particular chats 6155 from list of currently attending chats 6150.

In an embodiment agent can manually select particular user 6185 in queue or showing in queue status 6180 and attend chats. In an embodiment agent can attend multiple chats related to same or different or multiple businesses of same or different owners of businesses.

In an embodiment user or agent can end chats between user and agent by selecting end button or control 6062/6130. In an embodiment in the event of selecting end button or control 6062/6130 by agent or user, ending live chat session. User can search, select, access or view and take one or more types of actions on one or more logged past chats or conversed messages.

In another embodiment in routing between groups, chats are also distributed according to groups. Automatic chat routing distributes chats from a specific group to agents from that group. With the manual chat selection enabled, only agents from a particular group will receive a notification when a new chat for that group is available. In another embodiment admin or agent can also transfer chats between various groups.

In another embodiment user can use menu and select option to connect with said option associated available or identified live chat agent.

In another embodiment enabling user to anonymously connect with agent without disclosing user's identity or enable user to show or hide user's details based on privacy settings to connected agent associated with particular phone number.

In another embodiment user can apply or update privacy settings to allow one or more selected businesses or types of lists or groups of businesses to allow to communicate or not communicate with user including allow or do not allow to send or share message, contents, posts, rich messages, call-to-actions, send live chat request to user or send live chat request to user if user turn on live chat, payment transaction, one or more types of notifications, voice call including voice over internet protocol (VOIP) or phone call, video call, SMS, access one or more types of user data including user profile.

In another embodiment user can select or switch one or more communication mediums or channels or interfaces for live chat or live communicating with available agent of user selected phone number or in another embodiment based on user's privacy settings (discussed in detail in FIGS. 51-52) agent(s) associated with phone number can communicate with user or phone contact or customer, wherein communication mediums or channels or interfaces comprises live chat 6091/6191, video, voice or VOIP, phone or video call and SMS communication. In an embodiment when user select video message 6092/6192 then user can send and receive video messages with connected and available agent of selected or currently viewing website. In another embodiment if user select audio message 6093/6193 then user can send and receive audio messages with connected and available agent of selected or currently viewing website. In another embodiment if user select voice call including cellular phone call or Voice over Internet Protocol (VoIP) 6094/6194 then user anonymously connect and converse with currently available agent of selected or currently viewing website. In another embodiment if user select video call 6095/6195 including cellular video call or video call over internet protocol then user anonymously connect and converse with currently available agent of selected or currently viewing website. In another embodiment if user select SMS 6096/6196 then user can anonymously connect and converse via SMS with currently available agent of selected or currently viewing website. User can hide user's identity including name, photo, contact information including phone number (hid phone number via phone number masking), user name, location information. In an embodiment user can also hide user's face or body parts or off video and turn on only audio whereas agent can communicate with user via video and voice communication.

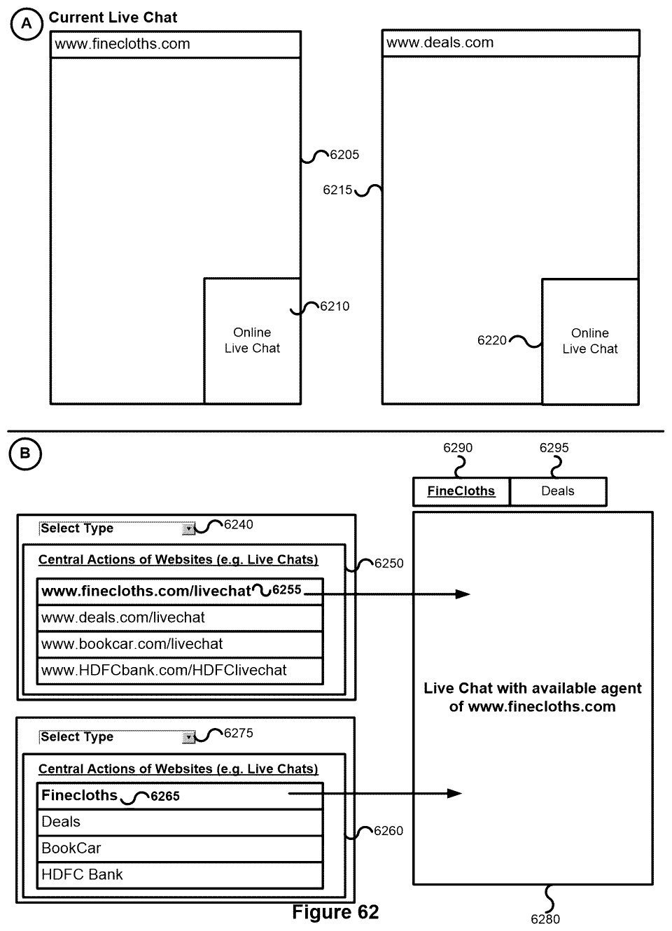

FIG. 62 (A) illustrates graphical user interface wherein currently website owner develops own or integrating 3^{rd} parties or external software as service providers or vendors or provider's one or more software, interfaces, action controls, features including live chat interface 6210/6220 with website or webpage 6205/6215 for enabling administrators, staff and website visitors to use one or more software, interfaces, action controls, features including enabling visitors to use live chat software. But user need to visit website and use each website integrated software, interfaces, action controls, features including live chat software or interface which lacks central access of generalized software, interfaces, action controls, features including live chat software or interfaces related to multiple websites and applications, store logs of conversations, activities, actions, reactions at central user client application including mobile client application and not able to utilize or employ mobile device resources, sensors, storage and smart client application advantages including fast sending and receiving messages, push notifications, push messages, fast search, interactive interfaces, large fonts, complex process, quick and automatic refreshing of interface, online status, typing indicators, read receipts including indication regarding receiving of message by server, by client application and viewing or reading message, identifying an accessing current location of suer device and associated identified place, security features including biometric, recognition of user's face, payment options, maps features, capturing or recording photos, audios and videos, background message queuing, sending and receiving, offline access, view internet network speed and status, local storage of data, multi-user, multi-device and multi-tsking features and functionalities.

FIG. 62 (B) illustrates graphical user interface wherein enterprise user or website owner or authorized user can provide and upload details of listing and verifying of one or more software, interfaces, action controls, features including live chat interface including website or webpage domain name or uniform resource locator (URL) to server or integrating one or more software, interfaces, action controls, features including live chat interface with user's client application or webpage provided by server for making them selectable, accessible, searchable and available for users of network or authorized persons or accounts or users of network from single client application including mobile client application.

User can select type of listed 6240 or integrated 6275 software, interfaces, action controls, features including live chat interface and then can select or search or browse and select or select from one or more types of list including suggested list, listed 6250 or integrated 6260 one or more software, interfaces, action controls, features including live chat interface. In the event of selecting listed one or more software, interfaces, action controls, features including live chat interface 6255 or selecting integrated one or more software, interfaces, action controls, features including live chat interface 6265, invoking or opening selected one or more software, interfaces, action controls, features including live chat interface 6280, wherein each listed or integrated one or more software, interfaces, action controls, features including live chat interface called from sever or respective server of website or application. In another embodiment user can switch selected and invoked or opened one or more software, interfaces, action controls, features including live chat interface via tab interface 6290/6295 and can use, access it.

For example user, from the client application of the user mobile device, select live chat type 6240 and select listed 6255 website domain name 6255 or application name, then server opens live chat type specific live chat application or interface or webpage 6280 associated with selected website domain name 6255 and enable user to connect with identified and available live chat agent and start live chat session for enabling user and agent to converse within live chat and in the event of ending of live chat by user or agent, ending live chat session and store conversation within said live chat server for later access.

For example user, from the client application of the user mobile device, select live chat type 6275 and select integrated 6265 website domain name or application name or business account name 6265, then server opens selected type 6275 associated select business account 6265 associated live chat application e.g. 6280 and enable user to connect with identified and available live chat agent and start live chat session for enabling user and agent to converse within live chat and in the event of ending of live chat by user or agent, ending live chat session and store conversation within said live chat server for later access.

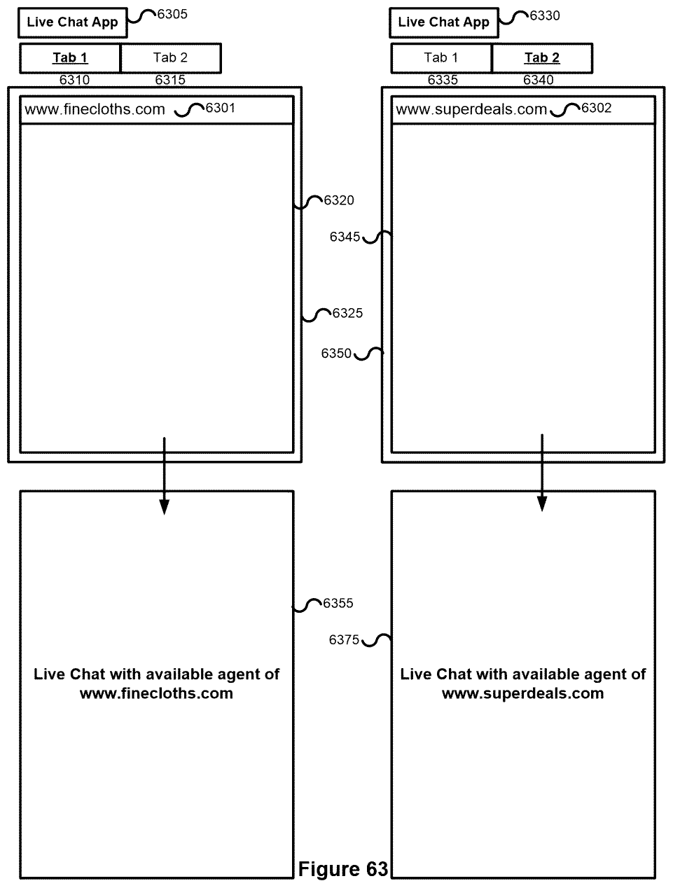

FIG. 63 illustrates graphical user interface wherein server receiving from a first user, selection of control or button 6305 integrated within web browser or mobile browser 6325. In the event of selection of control or button 6305, identifying currently viewing website domain name or a uniform resource locator (URL) 6301/6320 and invoking or opening a client application 6355 from a mobile device of the first user or enabling a client application 6355 of user mobile device to access the website domain name or the uniform resource locator (URL) 6301. Server 110 receive from a mobile client application 6355 of a first user, the website domain name or the uniform resource locator (URL) 6301, a request or an invitation for initiating a communication including live chat. Likewise server 110 receive from a second user, selection of control or button 6330 from a website or webpage 6302/6345 from a web browser 6350, wherein control or button 6375 associated with a website domain name or a uniform resource locator (URL) 6302 and invoking or opening a client application 6375 from a mobile device of the second user or enabling a client application 6375 of user mobile device to access the website domain name or the uniform resource locator (URL) 6302. Server 110 receive from a mobile client application 6375 of a second user, a website domain name 6302, a request or an invitation for initiating a communication including live chat. In an embodiment server module or in another embodiment client application module puts the request or invitation for initiating a communication including live chat from the first user and the second user in a communication including live chat queue of the website or the uniform resource locator (URL) associated account, for available or identified or relevant agents to pick up. In an embodiment routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept communication including live chats status turn on by agent. In an embodiment when all agents have one communication including live chat each, the next round will be distributed and it will go on until the concurrent communication including live chat limit of all the agents accepting communication including live chats at the time is reached. In an embodiment with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein in an embodiment start a communication including live chat by selecting particular request or invitation for initiating a communication including live chat from the queued communication including live chats list or list of requests or invitations for initiating a communication including live chat or in another embodiment selecting particular request or invitation for initiating a communication including live chat from the queued communication including live chats list or list of requests or invitations for initiating a communication including live chat and in an embodiment selecting or clicking or tapping on associated start communication including live chat control or button or by using a keyboard shortcut or by issuing voice command or by sending or responding or replying message.

In an embodiment enable or disable web browser integrated communication including live chat button based on availability or non-availability of communication including live chat or availability or non-availability of communication including live chat current status associated with currently viewing website.

In an embodiment in the event of closing opened website or webpage in browser, based on settings automatically end communication including live chat or notifying user and agent to end communication including live chats.

FIG. 64 illustrates flowcharts explaining sending message by registered user to non-registered user or enterprise user/website/business owner or admin or staff and enable to respond or reply or send message. At step 6405, receiving unique website domain name or phone number or account name or name or keyword(s) and message with sender's unique identity (UID) from sender from sender's device. At step 6410, identifying website domain name or account name or name or keyword(s) associated phone number or use received phone number. At step 6415, generating short link or global unique identity (GUID) and associating details including sender's identity, sender's received message, sender's nick name and optionally based on sender's privacy settings, sender's name, phone number, email, contact information and identity or website visitor's information including currently viewing webpage, location information, IP address, length of time spending on website or webpage, recipient's name, business name, website, phone number and identity, date and time of sending of message. At step 6420, generating SMS/message for said identified or received phone number, wherein generating SMS/message based on or generated message comprises generated short link, general message template and details including sender's nick name and optionally sender's name, contact information, identity and phone number. At step 6425, sending said generated SMS/instant message on said phone number associated user device. At step 6430, in the event of selecting short link from received SMS or message or received message related notification or notification associated action control or button by recipient, generating and opening webpage or invoking generated webpage or user interface in web browser or web viewer and displaying full or partial message of sender and sender's or visitor's details and enabling to respond or reply or send message from webpage or user interface to sender on sender's device via SMS or message based on sender's phone number or optionally instructing recipient user to install and register application and then send message or reply message from installed application.

In an embodiment when user select particular website name or phone number or business name or place of business name or place name or entity name or account name or name or one or more keywords from list or automatically identify website name or phone number or business name or place of business name or place name or entity name or account name or name or one or more keywords based on currently visited website or application, current place of user device, selected place on map, voice command, scanning of code including QR code, identified activity, status, action, interaction, notification, communication, incoming message or call, calendar entry(ies), transaction via linked system and identifying website domain name or account name or name or keyword(s) associated phone number or use received phone number. Then system generates unique short link and associating details including sender's identity, said received message from sender, sender's nick name and optionally based on sender's privacy settings, sender's name, phone number, email, contact information and identity or website visitor's information, identified recipient's name, business name, website, phone number and identity, date and time of sending message based on recipient associated phone number. Then system generates SMS/message for said identified or received phone number, wherein generating SMS/message 6450/6470 based on or generated message 6450/6470 comprises said generated unique short link 6452/6473, general message template and details including sender's nick name and optionally based on sender's privacy settings, sender's name, contact information, identity, photo, profile details and phone number. In another embodiment generated SMS or message comprises sender's full or part of message 6472. In the event of selecting short link 6452 from received SMS 6450 or message 6450 or received message related notification or notification 6450 associated action control or button 6455 by recipient, generating and opening webpage 6492 or invoking generated webpage 6492 or user interface 6492 in web browser or mobile browser or web viewer and displaying full or partial message 6481 and sender's or visitor's details 6493 and enabling to type message 6483 or select message template or ready message 6485 from list and respond or send 6485 message 6482 from webpage 6492 or user interface 6492 to sender on sender's device via SMS or message based on sender's phone number. In another embodiment identifying and extracting said received SMS or message 6482 and displaying said extracted and formatted or processed SMS or message 6482 in application and enabling user to further send message (which further follow flowcharts steps 6405-6430).

In another embodiment instructing or suggesting recipient user to install and register application 6495 and then send message or reply message from installed application.

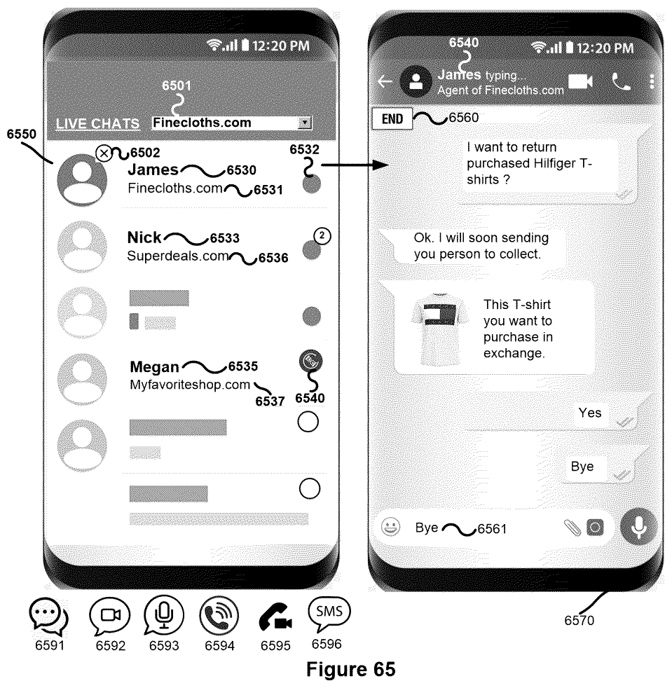

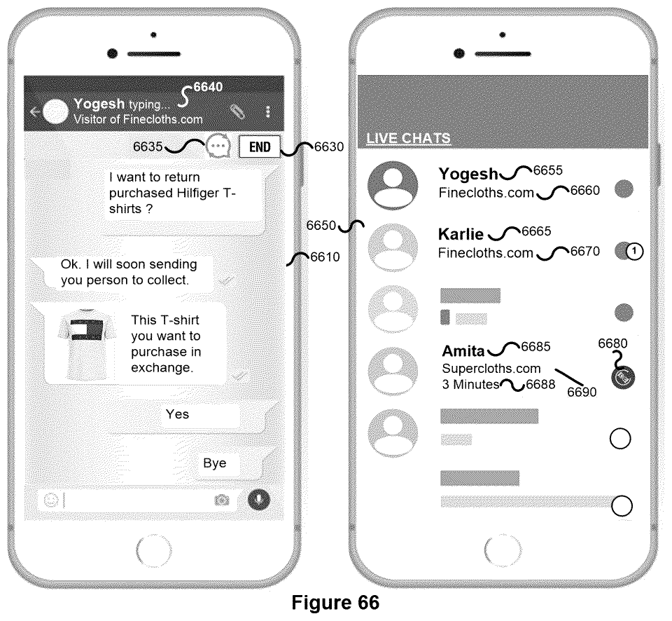

FIGS. 65-66 illustrates graphical user interface of user device's client application including mobile client application wherein user is enabled to input 6501 or in the event of entering or typing character in input box auto suggest or auto fill-ups name of website or website domain name or business name 6501 for user's quick input and selection or enable user to select 6531 from list 6550 website domain name or uniform resource locator (URL) or automatically identifying currently visited website's unique domain name or uniform resource locator (URL) or unique application name. Receiving by a server 110 from a mobile client application of a first user, said inputted or automatically identified and selected or manually selected website domain name or uniform resource locator (URL), a request or an invitation for initiating a communication including live chat. Receiving by a server 110 from a mobile client application of a third user, a website domain name or uniform resource locator (URL), a request or an invitation for initiating a communication including live chat. In an embodiment server module or client module, puts the request or invitation for initiating a communication including live chat from the first user and the third user in a communication including live chat queue of the website or a uniform resource locator (URL) associated account, for available or identified or relevant agents to pick up. In another embodiment routing request or invitation for initiating a communication including live chat from the first user and the third user according to a pre-set rules including automatically routing request or invitation for initiating a communication including live chats to agents or can go to a queue from which they are picked up, wherein in an embodiment automatic request or invitation for initiating a communication including live chat routing, each new request or invitation for initiating a communication including live chat goes to the unique website domain name associated first available agent with the accept communication including live chats status turn on by agent. In another embodiment when all agents have one communication including live chat each, the next round will be distributed and it will go on until the concurrent communication including live chat limit of all the agents accepting communication including live chats at the time is reached. In another embodiment with manual request or invitation for initiating a communication including live chat routing, the request or invitation for initiating a communication including live chat of the first user and the third user will be directed to the queue and all agents with the accept communication including live chats status will receive a notification about that event, and can pick up the displayed request or invitation for initiating a communication including live chat of the first user or the third user from the queue and start a communication including live chat, wherein in an embodiment start a communication including live chat by selecting particular request or invitation for initiating a communication including live chat from the queued communication including live chats list or list of requests or invitations for initiating a communication including live chat or in another embodiment selecting particular request or invitation for initiating a communication including live chat from the queued communication including live chats list or list of requests or invitations for initiating a communication including live chat and in some embodiments selecting or clicking or tapping on associated start communication including live chat control or button or by using a keyboard shortcut or by issuing voice command or by sending or responding or replying message. Enabling connected first user and the second user associated connected available agent to exchanges messages.

In another embodiment automatically identifying, selecting, or displaying for user selection currently viewing website domain name or a uniform resource locator (URL) via in-application browser, in-application browser control, application programming interfaces (APIs) and software development toolkits (SDKs) and in user's device installed add-ons and in-browser(s) installed plug-in(s) or add-ons or control(s) or integrated feature or function.

In another embodiment enabling user to select one or more website domain name(s) or a uniform resource locator (URLs) from one or more lists including categories, bookmarked, past used, or search results. In another embodiment suggesting website domain name(s) or a uniform resource locator (URLs) based on monitored and tracked user device current location or associated identified place, scanned code including QR code or object(s), voice command, recognizing user voice associated identified keywords, past visited places, activities including digital activities, interacted entities, transactions, linked systems, incoming notifications, emails, messages and one or more types of communications, calendar entries, sharing, search results, user profile and user related data, user added or created lists of website domain name(s) or a uniform resource locator (URLs).

In another embodiment receiving by a server from a mobile client application of a first user, request for cancelling 6502 the request or the invitation for initiating a communication including live chat and cancel the request or the invitation for initiating a communication including live chat.

In another embodiment displaying online status, typing indicator, and message read receipts 6540/6640.

In another embodiment receiving by a server from a mobile client application of a first user, selection of an option from displayed menu options including support, maintenance, a request or an invitation for initiating a communication including live chat; automatically routing request or invitation for communication including live chat to menu option associated agent or available agent from agents.

In another embodiment in the event of selecting end button or control 6560/6630 by the agent or user, ending communication including live chat session.

In another embodiment in the event of selecting end button or control 6560/6630 by the agent or the user, ending communication including live chat session and store conversation between start and end session.

In another embodiment allowing owner or admin to set a limit to the number of communication including live chats each agents can have at a time by providing settings or editing agent profile.

In another embodiment as soon as one of the agents picks up a communication including live chat, others won't be able to do so.

In another embodiment user who are in queue can view queuing status in the form of in-queue icon or animation 6540/6680.

In another embodiment admin or agent can transfer 6635 communication including live chats between various groups.

In another embodiment displaying communication including live chat request 6690 within agent client application, for enable agent to starting the communication including live chat session.

In another embodiment enabling agent to view how long a visitor has been waiting 6688 to communication including live chat.

In another embodiment enabling user to show or hide user identity and user profile information including photo, user name, user account name, user identity, phone number, email address, and one or more types of address(es) and user device location information.

In another embodiment user can select or switch one or more communication mediums or channels or interfaces for live chat or live communicating with available agent of user selected or user visited particular website, wherein communication mediums or channels or interfaces comprises chat, video, voice or VOIP, phone or video call and SMS communication. In an embodiment when user select chat 6591 then user can send and receive messages with connected and available agent of selected or currently viewing website. In an embodiment when user select video message 6592 then user can send and receive video messages with connected and available agent of selected or currently viewing website. In another embodiment if user select audio message 6593 then user can send and receive audio messages with connected and available agent of selected or currently viewing website. In another embodiment if user select voice call including cellular phone call or Voice over Internet Protocol (VoIP) 6594 then user anonymously connect and converse with currently available agent of selected or currently viewing website. In another embodiment if user select video call 6595 including cellular video call or video call over internet protocol then user anonymously connect and converse with currently available agent of selected or currently viewing website. In another embodiment if user select SMS 6596 then user can anonymously connect and converse via SMS with currently available agent of selected or currently viewing website. User can hide user's identity including name, photo, contact information including phone number (hid phone number via phone number masking), user name, location information. In an embodiment user can also hide user's face or body parts or off video and turn on only audio whereas agent can communicate with user via video and voice communication.

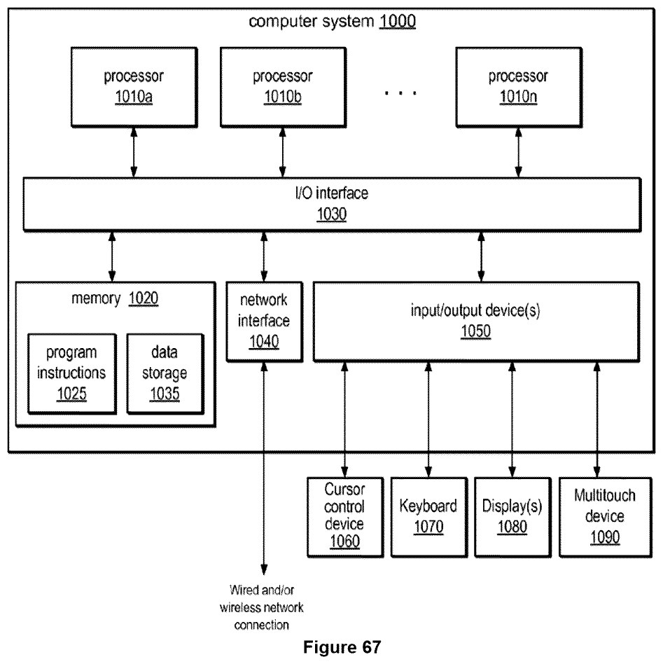

Various components of embodiments of methods as illustrated and described in the accompanying description may be executed on one or more computer systems, which may interact with various other devices. One such computer system is illustrated by FIG. 67. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 67, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object-oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. The invention is not limited to any particular type of communication system, network, protocol, format or application.

1-358. (canceled)

359. A computer-implemented method, performed by a processor configured by a computer-readable code to perform the method comprising the steps of:
a) receiving from a first user by a server, selection of control or button from a website or webpage from a web browser, wherein control or button associated with a website domain name or a uniform resource locator (URL); invoking or opening a client application from a mobile device of the first user or enabling a client application of user mobile device to access the website domain name or the uniform resource locator (URL); receiving by a server from a mobile client application of a first user, the website domain name or the uniform resource locator (URL), a request or an invitation for initiating a live chat;
b) receiving from a second user by a server, selection of control or button from a website or webpage from a web browser, wherein control or button associated with a website domain name or a uniform resource locator (URL); invoking or opening a client application from a mobile device of the second user or enabling a client application of user mobile device to access the website domain name or the uniform resource locator (URL); receiving by a server from a mobile client application of a second user, a website domain name, a request or an invitation for initiating a live chat;
c) puts the request or invitation for initiating a communication including live chat from the first user and the second user in a communication including live chat queue of the website or a uniform resource locator (URL) associated account, for available or identified or relevant agents to pick up;
d) routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept chats status turn on by agent;
e) when all agents have one communication including live chat each, the next round will be distributed and it will go on until the concurrent communication including live chat limit of all the agents accepting communication including live chats at the time is reached;
f) with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued chats list or list of requests or invitations for initiating a communication including live chat or selecting particular request or invitation for initiating a communication including live chat from the queued communication including live chats list or list of requests or invitations for initiating a communication including live chat and selecting or clicking or tapping on associated start communication including live chat control or button or by using a keyboard shortcut or by issuing voice command or by sending or responding or replying message.

360. The computer-implemented method of claim 359 wherein based on uniform resource locator (URL) identifying website domain name associated sub-account or unique identity of website associated user including vendor or seller, advertiser, listing user, publisher, service provider, developer.

361. The computer-implemented method of claim 359 wherein receiving by a server from a mobile client application of a first user, request for cancelling the request or the invitation for initiating a communication including live chat; and cancel the request or the invitation for initiating a communication including live chat.

362. The computer-implemented method of claim 359 wherein receiving by a server from a mobile client application of a first user, selection of an option from displayed menu, a request or an invitation for initiating a communication including live chat; automatically routing request or invitation for communication including live chat to menu option associated agent or available agent from agents.

363. The computer-implemented method of claim 359 wherein in the event of selecting the end button or control by the agent or the user, ending communication including live chat session and store conversation between start and end session.

364. The computer-implemented method of claim 359 wherein in routing between groups, communication including live chats are also distributed according to groups, wherein automatic communication including live chat routing distributes communication including live chats from a specific group to agents from that group and with the manual communication including live chat selection enabled, only agents from a particular group will receive a notification when a new communication including live chat for that group is available.

365. The computer-implemented method of claim 359 wherein admin or agent can transfer communication including live chat between various groups.

366. The computer-implemented method of claim 359 wherein displaying communication including live chat request within agent client application, for enable agent to starting the communication including live chat session.

367. The computer-implemented method of claim 359 wherein active communication, initiated manually by the agent or automatically by the communication including live chat system as soon as the requestor of communication including live chat meets the predefined criteria, wherein predefined criteria comprises searched keyword, time spend on website or application, encountered error, add to cart one or more or particular numbers or amounts of products and services, wherein once the criteria is met, communication including live chat displays a invitation with a customized message.

368. The computer-implemented method of claim 359 wherein when queue exceeds the set limit, disabling or automatically making unavailable communication including live chat option and any new requestor won't be able to request a communication including live chat session, and will instead see an offline message.

369. A computer-implemented system, performed by a processor configured by a computer-readable code to perform the system comprising the steps of:
a) receive from a first user by a server, selection of control or button from a website or webpage from a web browser, wherein control or button associated with a website domain name or a uniform resource locator (URL); invoking or opening a client application from a mobile device of the first user or enabling a client application of user mobile device to access the website domain name or the uniform resource locator (URL); receiving by a server from a mobile client application of a first user, the website domain name or the uniform resource locator (URL), a request or an invitation for initiating a live chat;
b) receive from a second user by a server, selection of control or button from a website or webpage from a web browser, wherein control or button associated with a website domain name or a uniform resource locator (URL); invoking or opening a client application from a mobile device of the second user or enabling a client application of user mobile device to access the website domain name or the uniform resource locator (URL); receiving by a server from a mobile client application of a second user, a website domain name, a request or an invitation for initiating a live chat;
c) puts the request or invitation for initiating a communication including live chat from the first user and the second user in a communication including live chat queue of the website or a uniform resource locator (URL) associated account, for available or identified or relevant agents to pick up;
d) route request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept chats status turn on by agent;
e) when all agents have one communication including live chat each, the next round will be distributed and it will go on until the concurrent communication including live chat limit of all the agents accepting communication including live chats at the time is reached;
f) with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued chats list or list of requests or invitations for initiating a communication including live chat or selecting particular request or invitation for initiating a communication including live chat from the queued communication including live chats list or list of requests or invitations for initiating a communication including live chat and selecting or clicking or tapping on associated start communication including live chat control or button or by using a keyboard shortcut or by issuing voice command or by sending or responding or replying message.

370. The computer-implemented system of claim 369 wherein based on uniform resource locator (URL) identifying website domain name associated sub-account or unique identity of website associated user including vendor or seller, advertiser, listing user, publisher, service provider, developer.

371. The computer-implemented system of claim 369 wherein receive by a server from a mobile client application of a first user, request for cancelling the request or the invitation for initiating a communication including live chat; and cancel the request or the invitation for initiating a communication including live chat.

372. The computer-implemented system of claim 369 wherein receive by a server from a mobile client application of a first user, selection of an option from displayed menu, a request or an invitation for initiating a communication including live chat; automatically routing request or invitation for communication including live chat to menu option associated agent or available agent from agents.

373. The computer-implemented system of claim 369 wherein in the event of selecting the end button or control by the agent or the user, ending communication including live chat session and store conversation between start and end session.

374. The computer-implemented system of claim 369 wherein in routing between groups, communication including live chats are also distributed according to groups, wherein automatic communication including live chat routing distributes communication including live chats from a specific group to agents from that group and with the manual communication including live chat selection enabled, only agents from a particular group will receive a notification when a new communication including live chat for that group is available.

375. The computer-implemented system of claim 369 wherein admin or agent can transfer communication including live chat between various groups.

376. The computer-implemented system of claim 369 wherein display communication including live chat request within agent client application, for enable agent to starting the communication including live chat session.

377. The computer-implemented system of claim 369 wherein active communication, initiated manually by the agent or automatically by the communication including live chat system as soon as the requestor of communication including live chat meets the predefined criteria, wherein predefined criteria comprises searched keyword, time spend on website or application, encountered error, add to cart one or more or particular numbers or amounts of products and services, wherein once the criteria is met, communication including live chat displays a invitation with a customized message.

378. A computer-implemented method, performed by a processor configured by a computer-readable code to perform the method comprising the steps of:
a) receiving, by a server, from a first computing device of a first user automatically identified currently viewing website domain name or a uniform resource locator (URL), wherein automatically identifying currently viewing website domain name or a uniform resource locator (URL) via in-application browser, in-application browser control, application programming interfaces (APIs) and software development toolkits (SDKs) and in user's device installed add-ons and in-browser(s) installed plug-in(s) or add-ons or control(s) or integrated feature or function;
b) receiving, by the server, from a mobile client application of a first user, said automatically identified website domain name or the uniform resource locator (URL), a request or an invitation for initiating a communication including live chat;
c) receiving, by a server, from a second computing device of a second user, automatically identified currently viewing website domain name or a uniform resource locator (URL);
d) receiving, by the server, from a mobile client application of the second user, said automatically identified website domain name or the uniform resource locator (URL), a request or an invitation for initiating a communication including live chat;
e) puts the request or invitation for initiating a communication including live chat from the first user and the second user in a communication including live chat queue of the website or the uniform resource locator (URL) associated account, for available or identified or relevant agents to pick up;
f) routing request or invitation for initiating a communication including live chat from the first user and the second user according to a pre-set rules including automatically routing request or invitation for initiating a communication including live chats to agents or can go to a queue from which they are picked up, wherein in an automatic request or invitation for initiating a communication including live chat routing, each new request or invitation for initiating a communication including live chat goes to the unique website domain name associated first available agent with the accept communication including live chats status turn on by agent;
g) when all agents have one communication including live chat each, the next round will be distributed and it will go on until the concurrent communication including live chat limit of all the agents accepting communication including live chats at the time is reached;
h) with manual request or invitation for initiating a communication including live chat routing, the request or invitation for initiating a communication including live chat of the first user and the second user will be directed to the queue and all agents with the accept communication including live chats status will receive a notification about that event, and can pick up the displayed request or invitation for initiating a communication including live chat of the first user or the second user from the queue and start a communication including live chat, wherein start a communication including live chat by selecting particular request or invitation for initiating a communication including live chat from the queued communication including live chats list or list of requests or invitations for initiating a communication including live chat or selecting particular request or invitation for initiating a communication including live chat from the queued chats list or list of requests or invitations for initiating a communication including live chat and selecting or clicking or tapping on associated start communication including live chat control or button or by using a keyboard shortcut or by issuing voice command or by sending or responding or replying message.
